(19) United States
(12) Patent Application Publication
(10) Pub. No.: US 2007/0128899 A1
(43) Pub. Date: Jun. 7, 2007

(54) System and method for improving the efficiency, comfort, and/or reliability in Operating Systems, such as for example Windows

(76) Inventor: Yaron Mayer, Jerusalem (IL)

Correspondence Address: YARON MAYER, 21 AHAD HAAM ST., JERUSALEM, 92151, IL

(21) Appl. No.: 11/382,698

(22) Filed: May 10, 2006

Related U.S. Application Data
(63) Continuation-in-part of application No. 10/775,027, filed on Feb. 8, 2004.
(63) Continuation-in-part of application No. 10/756,839, filed on Jan. 11, 2004.
(63) Continuation-in-part of application No. 10/907,274, filed on Mar. 28, 2005.
(63) Continuation-in-part of application No. 10/939,494, filed on Sep. 14, 2004.
(60) Provisional application No. 60/464,171, filed on Apr. 14, 2003.
(60) Provisional application No. 60/452,362, filed on Mar. 3, 2003.
(60) Provisional application No. 60/464,171, filed on Apr. 14, 2003.
(60) Provisional application No. 60/557,454, filed on Mar. 28, 2004.
(60) Provisional application No. 60/561,160, filed on Apr. 9, 2004.
(60) Provisional application No. 60/575,981, filed on May 31, 2004.
(60) Provisional application No. 60/602,946, filed on Aug. 20, 2004.

(30) Foreign Application Priority Data
May 10, 2005 (GB) 0509451.1
Aug. 9, 2005 (GB) 0516308.4
Sep. 2, 2005 (GB) 0517795.1
Sep. 30, 2005 (GB) 0519932.8
Oct. 21, 2005 (GB) 0521475.4
Nov. 21, 2005 (GB) 0523627.8
Nov. 28, 2005 (GB) 0524183.1
Dec. 5, 2005 (GB) 0524764.8
Dec. 19, 2005 (GB) 0525740.7
Feb. 7, 2006 (GB) 0602413.7
Feb. 21, 2006 (GB) 0603399.7
Apr. 10, 2006 (GB) 0607131.0
May 9, 2006 (GB) 0609047.6
Feb. 7, 2003 (IL) 154349
Sep. 29, 2003 (CA) 2444685
Jan. 12, 2003 (IL) 153893
May 3, 2003 (CA) 2428648
Jan. 6, 2004 (CA) 2457957
Feb. 9, 2004 (CA) 2457981
Oct. 5, 2004 (GB) 0422065.3
Jan. 5, 2005 (GB) 0500002.1
Aug. 26, 2005 (GB) 0517366.1

(51) Int. Cl. H01R 13/62

(52) U.S. Cl. 439/152

(57) ABSTRACT

Although MS Windows (in its various versions) is at present the most popular OS (Operating System) in personal computers, after years of consecutive improvements there are still various issues which need to be improved, which include for example issues of efficiency, comfort, and/or reliability. The present invention tries to solve the above problems in new ways that include considerable improvements over the prior art. Preferably the system allows for example a “Reset” function, which means that preferably an Image of the state of the OS (including all loaded software) is saved immediately after a successful boot on the disk or other non-volatile memory and is preferably automatically updated when new drivers and/or software that change the state after a boot are added, so that if the system gets stuck it can be instantly restarted as if it has been rebooted. Other features include for example solving the problem that the focus can be grabbed while the user is typing something, allowing the user to easily define or increase or decrease the priority of various processes or open windows, a powerful undo feature that can include preferably even any changes to the hard disk, improved undo features in word processing, improved file comparison features, being able for example to track changes retroactively, improved backup features, and many additional improvements. The application covers also improvements that are related for example to Word processing (since for example in Microsoft Windows, Word behaves like an integral part of the system) and things that are related to the user's Internet surfing experience (This is important since for example in Microsoft Windows, Internet Explorer is practically an integral part of the OS). The invention deals also with some preferable improvements in the performance of the hard disk and also with some other smart computerized devices.

This Patent application is a CIP of U.S. application Ser. No. 10/775,027 of Feb. 8, 2004, which claims priority from Israeli application 154349 of Feb. 7, 2003, hereby incorporated by reference in its entirety, and also claims benefit and priority from U.S. provisional application 60/464,171 of Apr. 14, 2003 and from Canadian application 2,444,685 of Sep. 29, 2003 and from Canadian application 2,457,957 of Jan. 6, 2004, hereby incorporated by reference in their entireties.

This patent application is also a CIP of U.S. application Ser. No. 10/756,839 of Jan. 11, 2004 (which claims priority of from Israeli application 153893 of Jan. 12, 2003 and from U.S. Provisional patent applications 60/452,362 of Mar. 2, 2003 and 60/464,171 of Apr. 14, 2003, and from Canadian patent application 2,428,648 of May 3, 2003), hereby incorporated by reference in their entireties.

This patent application is also a CIP of U.S. application Ser. No. 10/907,274 of Mar. 28, 2005, which is a CIP of the above U.S. application Ser. No. 10/775,027 of Feb. 8, 2004 and of the above U.S. application Ser. No. 10/756,839 of Jan. 11, 2004, and which also claims priority from Canadian application 2,457,981 of Feb. 9, 2004, and from U.S. provisional application 60/557454 of Mar. 28, 2004, and from U.S. provisional application 60/561,160 of Apr. 9, 2004, and from U.S. provisional application 60/575,981 of May 31, 2004, and from U.S. provisional application 60/602,946 of Aug. 20, 2004, and from U.S. application Ser. No. 10/939,494 of Sep. 14, 2004, and from British application GB0422065.3 of Oct. 5, 2004, and from British application GB0500002.1 of Jan. 5, 2005, hereby incorporated by reference in their entireties.

This application also claims priority from British application 0509451.1 of May 10, 2005 and from British application 0516308.4 of Aug. 9, 2005, and from British application 0517366.1 of Aug. 26, 2005, and from British application 0517795.1 of Sep. 2, 2005, and from British application 0519932.8 of Sep. 30, 2005, and from British application 0521475.4, of Oct. 21, 2005, and from British application 0523627.8 of Nov. 21, 2005, and from British application 0524183.1 of Nov. 28, 2005, and from British application 0524764.8 of Dec. 5, 2005, and from British application 0525740.7 of Dec. 19, 2005, and from British application 0602413.7 of Feb 7, 2006, and from British application 0603399.7 of Feb 21, 2006, and from British application 0607131.0 of Apr. 10, 2006, and from British application 0609047.6 of May 9, 2006, hereby incorporated by reference in their entireties.

### BACKGROUND OF THE INVENTION

1. Field of the Invention

The present invention relates to operating systems, and more specifically to a System and method for improving the efficiency, comfort, and/or reliability in Operating Systems, such as for example Microsoft Windows. This can include for example also things that are related for example to Word processing (since for example in Microsoft Windows, Word behaves like an integral part of the system) and things that are related to the user's Internet surfing experience (This is important since for example in Microsoft Windows, Internet Explorer is practically an integral part of the OS). The invention deals also with some preferable improvements in the performance of the hard disk.

2. Background

Although MS Windows (in its various versions) is at present the most popular OS (Operating System) in personal computers, after years of consecutive improvements there are still various issues which need to be improved, which include for example issues of efficiency, comfort, and/or reliability. In the area of efficiency, one of the things that still need improvement is the time it takes the system to boot. For example if windows 98 gets stuck, the user might have to re-boot the system, a process which can take up to a few minutes, especially if there are many programs in the start-up folder and/or if the system starts to scan the disks (If the user does not interrupt the disk scan). Although Windows Me and XP for example include a Hibernate function, it does not help much if the system gets stuck, since Hibernate is mainly useful if the user requests the system on his/her own initiative to “go to sleep” for fast awakening afterwards. This is accomplished typically by saving an Image of the current state of the computer's memory on the disk when the user issues the “Hibernate” command, and reloading it quickly when the user requests “wake-up”. U.S. patent application Ser. No. 20020078338 filed on Dec. 15, 2000 by IBM, describes an improvement in which the Image is saved automatically immediately after the normal boot sequence has finished, so that, during the next boot, the boot can be automatically set to much faster if there is an Image of the state of the computer and the OS at the end of the last boot. However, this still does not solve the problem completely, since for example if Scandisk is needed, it can still take considerable time, such as for example a number of minutes or even more, and also for example some peripheral devices checks and/or initializations might still be needed and can take for example even up to a minute even during the “instant” boot. The IBM patent does not even mention the problem of the peripheral devices or drivers. Issues of convenience can include for example the fact that various things happen automatically in Windows without asking the user's permission—for example one thing that can aggravate users is the ability of other programs to suddenly snatch the focus from the current Window. If this happens for example while the user is trying to type something, it can be very irritating, especially if it's for example some pop-up commercial advertisement in a browser window while the user is surfing the web and is trying for example to type some data in a form input line or in the URL line. Another convenience issue is for example the problem that when installing a new version of Windows over an existing system, typically the user has a choice of either overwriting the current system, in which case the desktop will remain the same as much as possible (but the user will have to give up the option of still booting the old system), or to install it in a new partition, in which case the user typically has to install almost everything again from scratch. An example of a reliability issue is the fact that making errors, such as for example launching a program which contains a virus or a malicious code, or installing a program which accidentally causes damage for example to the Windows registry or to various directories, can be very difficult to correct. Although, for example, starting from windows ME, there is an option to undo the last installation, it is typically limited to only very specific types of changes in the system, such as for example changes in the registry, but cannot undo other changes, such as for example ruining other directories or files. Clearly it would be desirable to have improved versions of Windows or of similar Operating Systems, where such problems are solved.

### SUMMARY OF THE INVENTION

The present invention tries to solve the above problems in new ways that include considerable improvements over the prior art.

Regarding the boot problem, preferably the system allows a “Reset” function which means that preferably an Image of the state of the OS (including all loaded software) is saved immediately after a successful boot on the disk and/or on other non-volatile memory and is preferably automatically updated when new drivers and/or software that changes the state after a boot is added. Another possible variation is that more than one Image can be saved, so that for example if something goes wrong after updating the Image, the system can preferably go back for example to the previous Image. Whenever the system gets stuck (and/or for example if the user simply wants to clear the computer's memory and go back to a state like after a normal boot), preferably the user is able for example to press some special button or some key or keys on the keyboard and/or for example click on some icon or menu item or link (however a hardware key at least as one of the available activation options is important since otherwise the user might not be able to activate it for example if the system got stuck for some reason) in a way that causes the computer's memory to instantly Reset from the saved Image, without a need to go through a boot sequence at all. The special button or key (or icon or menu item, etc.) is preferably sensed either by hardware or by some process which preferably runs below the Operating system and thus in not affected even when the system becomes stuck. In addition, preferably any cut & paste buffers are preferably automatically saved also on the disk and/or other non-volatile memory preferably whenever they are created, so that they can be immediately available on the next boot or after the next Reset. Similarly, preferably any currently edited files or windows are preferably automatically saved on the disk and/or on other non-volatile memory preferably after sufficient minimal changes have accumulated (such as for example after at least 10 new characters, or any other convenient number, have been added or changed) or every short while (for example every 30 seconds), so that they can be immediately available on the next boot or after the next Reset. Preferably, during or after a fast-boot or a Reset that uses the memory Image (and/or even during or after a normal boot), if the FAT of the disks needs to be checked, preferably it is done in the background and without significantly slowing down the disk or the CPU, after the user can already start working, since waiting for scandisk to finish can take several minutes and can be very aggravating to most users. Preferably the system runs a minimal scandisk in advance at most only on the area where the image itself is stored or does that only if there is for example some CRC problem when trying to get the image, since only that area might have to be scanned before the boot or Reset if there is a problem. Another problem is that even without scandisk usually after the system boots typically various start-up applications keep loading (for example both in Windows 98 and in Windows XP) and during this time the user can almost do nothing since the start-up applications take control most of the time. So preferably this is improved so that after the boot preferably the OS automatically gives higher priority to actions taken by the user (such as for example clicking with the mouse on something and/or typing text. This can be done preferably for example by increasing the frequency of sampling for user input and/or increasing the priority to any task which the user is interacting with, so that the user can preferably start working immediately without having to wait for the start-up programs to load. Preferably this works of course in combination for example with the feature described elsewhere in this application—of avoiding snatching away of the focus while the user is for example typing something. However, preferably the user can also mark for example some programs in the startup menu to have higher priority so that they are loaded first, such as for example the firewall or for example the DirectCD application, so that for example the firewall will be fully loaded before the user connects to the Internet and the DirectCD will be loaded before the user tries to access the writeable CD, and/or the OS monitors automatically what the user normally does and/or knows for example which program is the firewall and gives it automatically higher priority to load earlier. Another possible variation is that for example when the system tells the user during boot that unless he/she presses some key a scandisk will start in N seconds (as is done for example in Windows XP), preferably the system also gives the user an option for example to press a key that start the disk scan immediately, thus saving an unnecessary wait of for example additional 10 second each time. Another problem is that for example in Windows XP, if the user did not click on something to skip the scandisk during boot, he/she can not stop it once it started. So preferably this is improved so that even after the scandisk started the user can for example click for example on Esc or some other key or click with the mouse on something and stop the scandisk immediately. Another problem is that if the user doesn't watch closely as this scandisk-during-boot progresses, he/she has no way if knowing if and what error were found and/or corrected because the OS does not keep a record. So preferably this is improved so that preferably the scandisk (or similar disk-checking application) during boot and/or also when activated normally after boot, preferably automatically leaves a log of what errors were found and what was done so that the user can know for example which files are now truncated because of errors even if he/she did not attend during the boot (Preferably there are multiple such log or for example the log is cumulative, for example with dates and times, so that the user can see also what happened at earlier Scandisks. Another possible variation is that this automatic log automatically contains also at least some undo information so that the user can for example request automatic undo of the recent changes or some of them. Another possible variation is that the OS keeps for example also a table of all the files that have been truncated for example due to various scandisk operations, so that the user can know exactly which files need to be restored for example from backup or installed again (preferably this is marked also for example in the directory entry of each such file, so that if the user fixes the file the mark that the file was truncated is preferably automatically removed and preferably when removed this updates automatically also for example the central table of truncated files. Another problem is that for example in Windows this dialogue about scandisk during the boot is presented at a refresh rate of 60 Hertz, which can be very painful to the eyes, and also for example the boot selector in Windows Vista is in 60 Hertz, and also the boot logo for example in Windows XP and Vista is presented at 60 Hz, which probably occurs because Windows does not load yet the appropriate display driver. So preferably this is improved so that preferably any text or images displayed during the boot are presented at the refresh rate which the user last used before restarting the computer, or at least for example at 85 Hz. This is preferably done for example by keeping the last used normal refresh rate and preferably also the monitor plug and play identifier in variables which can be read during the boot so that, at least if the monitor has not been changed, the OS can be sure that the monitor is able to display this refresh rate (for this preferably at least the parts of the driver that talk to the plug and play element on the monitor are loaded at the beginning of the boot). Another possible variation is that, since typically during the boot the resolution used is relatively low anyway (for example 640×480), preferably the OS can assume that any normal monitor is capable of using at least a refresh rate of 85 Hz at this resolution or can protect itself by switching to a lower refresh rate automatically if it can't. Another possible variation is that the normal display driver is preferably loaded in advance at the beginning of the boot (preferably together with the parameters that were used in the last normal work before the restart), before the first boot logo even appears, and so preferably not only the correct refresh rate can be safely used at this stage but preferably also the higher resolution which the user is used to. If more than one OS is available, preferably the last known refresh rate and the plug and play identifier of the monitor are available in a standard place for to all the OSs, or at least available to the boot selector, so that even the boot selector itself can be displayed that way, unless for example it is in text mode like in windows XP, since the text mode at 70 Hz is readable without problems anyway. Of course various combinations of the above solutions can also be used. Another problem is that if for example there is more than one bootable OS installed on the same computer and the user for example switches between two monitors on the two monitor connectors on display cards that support dual monitors, or for example disconnects one of the monitors and then reconnects it and disconnects the other, or switches monitor connectors for any other reason, it will be updated properly on the current OS but other OSs which for example expect the monitor on the other monitor connector will show a blank screen. So preferably this is improved so that if the OS and/or for example the display card driver or for example some other relevant application discovers that the monitor is now connected to the other connector and there is no monitor on the original connector, preferably the display driver automatically switches to the connected connector and preferably also displays a notice about it to the user (this is no problem since virtually all monitors today are plug-and-play monitors, and even for example with a non-plug and-play monitor its presence or absence on a connector can be easily sensed electronically). This is also important for example in case the user has to restore the system into an earlier checkpoint in which the monitor was connected to the other connector. Similarly for example if the user switched between the two monitors and the OS discovers that their positions on the connectors are now reversed, preferably the OS and/or for example the display driver (or for example other application or service which is in charge of this) preferably automatically switches also the definitions between the two monitors (such as for example resolution, refresh rate, color corrections, video overlay definitions, etc.) so that the user does not have to do this manually. Another possible variation is that the Scandisk (or similar software) is backed up by hardware, for example in a way similar to the hardware that supports automatic disk rollback, described below. Preferably this is done by using hard-disks or other non-volatile memory wherein a special area or areas is dedicated for FAT information, and preferably independent head or heads or other access means are used for read and write in those areas. This has the further advantage that any reading or writing of files can become faster even if they are fragmented, since less movements of the heads are needed to access the FAT area each time some jump is needed (Of course the FAT can be also for example loaded into RAM or into cache memory for reading, but due to safety reasons changes to the FAT have to written to the hard-disk or other non-volatile media as soon as possible, and that is why these improvements are very important). Since each disk can have more than one partition, preferably the FAT areas of all partitions are kept in the same special area or areas. Preferably these areas are also guarded better in terms of security, so that for example any write-access to them is monitored more closely. Of course the Image and/or any other saved data can be kept also, in addition or instead, on any non-volatile type of memory, such as for example MRAM (Magnetic RAM), which will become available in a few years, 3d Nano-RAM chips, etc. In such cases, instead of separate or independent heads, for example separate or independent access channels or processors can be used. Another possible variation is that for example the hard disk has one or more separate heads which are used for example only for checking the media for errors and for example move automatically all the time or periodically once in a while to check this without interfering with the normal function of the hard disk. Another problem is that for example in Windows XP many times after a program has finished installing it requests the user to do a complete restart of the computer, which can take considerable time especially for example if the motherboard contains a RAID driver for some of the devices (typical for example in new motherboards which support for example both IDE and SATA), while in almost all cases logging-off and logging-on again into Windows would be quite sufficient and of course much faster. Full restart should normally be required only for example if a new hardware has been added (in most cases this requires turning off the power so a full restart happens anyway) or for example in some cases of rewriting the flash memory of some devices. So preferably by default either the OS automatically determines if a full restart is needed (for example according to the nature of the new installation), and then preferably the OS automatically performs just logoff and logon instead of a full restart whenever it can determine that this is sufficient, and/or for example standard installers are improved so that the software vendors can easily indicate (for example through some flag or flags) if logoff-logon is sufficient (for example even mark it as a set of automatic conditional rules, depending for example on various parameters, such as for example the OS version and/or various hardware parameters). Another possible variation is that preferably when the user himself/herself initiates a restart command (especially for example if no new software has been installed since the last boot and/or for example if the user has not recently inserted a bootable diskette or CD into one of the drives), preferably the OS automatically asks the user if he/she really wants a full reboot and, if not, preferably offers the user to automatically perform logoff-logon instead. Another possible variation is that at least for example the logon/logoff is added also to the normal Restart/Turnoff menu, so that for example instead of showing only 3 options (Standby, Turnoff and Restart) preferably the option of fast Logoff/Logon is also added. Another possible variation is that for example if the user connects new hardware while the computer is running, such as for example a different keyboard or a different mouse and/or other hardware, preferably the OS automatically detects the change in the hardware and preferably automatically updates the relevant drivers or drivers preferably without having to reboot the system. For this preferably the OS can use for example an additional abstraction layer for example between programs and device drivers so that for example there is a meta-driver layer with which the applications talk which intermediates between them and the actual drivers, and so if a driver has changed the OS for example preferably only has to update this layer without having to let the applications know about the change, and thus does not have to restart them. Another possible variation is that for example if the OS detects a new device (whether added while the OS is running or before the boot) and does not succeed to automatically find a sufficiently appropriate driver, preferably it tells the user also the specific hardware Id of the device (such as for example what type of device it is, the manufacturer and the model—which is no problem since the OS automatically reads this data from the hardware itself before starting to search for the driver), so that the user can know exactly for example what driver to try to download from the Internet. This is better than the prior art, in which Windows can for example tell the user that it is a display device or a sound device, but does not indicate the manufacturer and/or the exact model, and then the user might have to turn off the computer and open its case to check what is written on the card and then reboot, which is very inefficient. Another possible variation is that if the user is trying to install a device for example from a certain directory in a CD or DVD or other device and the system for example does not succeed to find an appropriate driver there or does not succeed to install it, preferably the user can or example use a Back arrow or icon to go back to the previous menu and for example choose a separate directory, instead of having to start again form the initial menu of updating the driver. Another possible variation is that when the user removes a device from the device manager preferably the OS offers the user also an option of marking the removed device so that the system will not rediscover it again automatically for example on the next boot for example until the user removes this mark. Another problem is that if the user for example wants to install another copy of the OS (for example Windows XP) on a separate partition and for example the original CD did not include service pack 2 and the user already installed service pack 2, the OS does not allow the installation while running, claiming that this is a lower version of the OS, and for example the OS makes it almost impossible to install for example Windows XP home if for example Windows XP Professional is already installed, even when booting from the CD for installation, even if the user wants to install it on another partition or for example another hard disk. So preferably this is improved so that if the new installation is on a separate partition the existing OS does not prevent the user from installing the other OS even if it is considered a downgrade (or for example at least unless the existing OS thinks that the new OS might screw up for example the boot selector). Another possible variation is that preferably when installing the OS preferably the user is asked all the needed questions at the beginning or at the end of the installation—including for example the country settings, so that the installation can preferably really complete unattended. Another possible variation is that for example during installation and/or during normal boot or when shutting down or logging off the system preferably displays automatically to the user at least some general feedback on what it is doing at each stage (such as for example the applications that are being loaded or closed or at least some general categories of activities), which is useful for making the time seem to flow faster and can also help the user to find for example problem areas that slow down the process). Another possible variation is that if for example the user installs a new installation of Windows on the same partition of a previously existing version of Windows, preferably common standard directories, such as for example “My Documents” and “Program Files” are automatically renamed or moved to be a subdirectory of some other directory—for example those of the original installation and/or those of the new installation, and preferably the OS in which the change is applied preferably automatically makes this the new default for example for Word documents or for new installations. Another possible variation is that these directories become virtual directories which appear for example to all applications as if they are in their normal places but are in practice for example a subdirectory of another directory, as explained above. Another possible variation is that when the computer is in standby (hibernate) mode, even if the user for example turns the power off or even plugs the electrical wire out of the wall, preferably when the user returns the power, the system preferably still automatically returns from standby instead of normal boot. This is very easy since the saved image of the system is still the same, and the system can preferably identify from it and/or from some flag or other indication that it should be returning from hibernation, even if it had been for example completely powered off. This means that preferably when the user activates for example standby mode, preferably the system first creates the image and then can for example go into a mode where power is preferably used only or mainly for keeping the RAM refreshed (and for example the CPU, disk and screen are off), and so for example if the power remains on, when waking up the system preferably does not even have to restore itself from the image, and if power has been turned off then preferably the system automatically checks first to see if there is a recent image and then recovers from the image if possible, and only if there is a problem then it preferably automatically switches for example to normal boot. Another problem is that sometimes when the user requests for example to enter standby mode or to restart the computer or to logoff for example in Windows XP. The system says for example “Windows is shutting down” or “entering standby mode” but the sometimes system gets stuck indefinitely after this message and the user has to press reset. This typically happens if for example one or more services or drivers get stick and do not terminate. So preferably in order to prevent this the system preferably explicitly shows the user the list of services and/or drivers and/or other processes that still have to be closed and preferably indicates when each service or driver or process is closed, so that preferably the user can see where the system is stuck, and preferably the user can for example press a key which hastens the shut down in cases of processes or services that have not closed and/or the system for example automatically terminates (or for example freezes if needed in case of entering standby) such services or processes after a certain preferably short time limit for example even if it is stuck. In order to enable this preferably there is at least one or more processes below the OS which can automatically monitor such situations and preferably take the appropriate actions even if for example important parts of the OS have already shut down. Another possible variation is that if for example the system still gets stuck for example while trying to shutdown or for example while trying to enter Standby mode, preferably at least the screen saver is automatically activated (preferably after the normal time without user activity for activating it has passed), since would typically mean that user is not around and does not know that the system did not succeed to shut down or enter standby. This means of course that preferably even while shutting down or entering standby there is at least one or more active processes, for example below the OS and/or which remain open till the end, which preferably can still activate the screen saver as long as the system has not actually completed the shutdown or standby. Another possible variation is that the user can for example choose in the normal restart menu between normal standby/hibernate (with mirror image) and standby in which only the activity is turned off and power is at minimum, in which case preferably the system can instantly freeze any activity without having to wait for example for any services and/or drivers and/or applications to reach a certain state, and/or for example even when creating the image preferably the system can freeze anything instantly without having to wait for any services and/or drivers and/or applications. Another possible variation is that preferably when the system creates the image for hibernation it can preferably save only the changes instead of the entire image, for example by separating in advance parts of the booted OS image that do not normally change between boots and keeping them at a separate place, and preferably when the system returns from hibernate the changing parts are preferably automatically added to the constant part to recreate the OS image. (Even if new drivers are installed for example, typically there will still be large parts of the booted OS image that would not change). Another possible variation is that preferably if the user chooses for example full reboot and/or even if he/she chooses just logoff and the system begins to close applications, preferably first of all only user applications are closed and not system processes and preferably the user can still for example press some key or click on some icon if he/she changes his/her mind in order to abort the reboot, and then for example the attempt to reboot is preferably aborted if it has not gone too far, and/or the system can automatically undo the process and even return the OS to the state it was before the reboot was requested (for example by keeping in one or more buffers also the state of the open files and/or windows and/or processes so that they can be restored automatically to their state before the reboot was requested). Another possible variation is that preferably one of the logoff-related options which the OS offers the user (for example in the normal logoff menu) is to logoff with immediate automatic logon again, which means that preferably as soon as the logoff is complete the system automatically log-on again to the same user. Another possible variation is that preferably one of the options for restart is fast-restart or fast-logoff (available preferably for example as one of the options when pressing Ctrl-Alt-Del and/or in the restart menu), which means that preferably the OS waits until the first few seconds (or other threshold) when there is no disk activity and then preferably instantly freezes all further disk activity and logs off or restarts immediately without waiting for any services or processes to close. This can also work for example with the instant Reset described elsewhere in this application, instead of the normal restart.

Of course, various combinations of the above and other variations can also be used.

Regarding the focus-grabbing problem, preferably when the user is in the middle of typing something, preferably the focus cannot be automatically snatched away by another program, so that for example the change of focus can occur only after the user has stopped typing for a certain minimal period, such as for example a few seconds or more. Another possible variation is that other programs can snatch the focus only in case of emergency, such as for example an event that is intercepted by the computer's security system, the firewall, or the OS. Preferably this is done by allowing this only to the OS and/or the security system of the computer and/or for example the firewall, and/or any other software which has been given explicit permission by the user to have such rights. Another possible variation is that programs are not allowed to snatch away the focus while the user is in the middle of typing something, as above, but for example in case of emergency, for example instead of snatching away the focus, important messages can be displayed for example by flashing a message on some part of the screen and/or by any other conspicuous visual means and/for example by audible sound (for example a spoken vocal message), so that the user's attention can be immediately grabbed, without automatically disturbing his typing efforts. Another possible variation is that if the focus is snatched while the user was typing, preferably his/her keystrokes continue to be kept for example in a special buffer, so that when the user notices that the focus has changed and goes back to the original window where he/she was typing, the keys that he/she typed while the focus has changed are again available. This can be done for example by a special process (for example part of the OS, or some dedicated service) that keeps a copy of the most recent keystrokes and can replay them even if the keystrokes were supposedly wasted in another process that popped up during the typing. Of course, various combinations of the above and other variations can also be used.

Another possible variation that is also related to the focus issue, is that for example clicking with the mouse on any part of the desktop (or for example pressing some key or keys on the keyboard) will immediately bring the desktop fully into the foreground like clicking on any other windows, so that there is no need to click for example on the special icon in the taskbar to do that, as exists today for example in Windows. In the prior art clicking on the desktop does not cause other windows that cover parts of it to move down to the task bar, eventhough it can change the focus, so the user has to click on a special icon if he wants to get a clear view of the desktop. Preferably this option is made available to the user in addition to and not instead of the icon that brings the desktop to the foreground, since sometimes there is no piece of the desktop available for clicking on it, but on the other hand, if part of the desktop is in view, it is much easier to click on it than to have to go down to the specific location of the small icon, and also in the current prior art situation it can be quite frustrating that clicking on a visible part of the desktop does not automatically bring the desktop to the foreground, unlike any other windows where clicking on any part of it does bring it automatically to the foreground. Another possible variation is that for example the clear desktop view is automatically added to the list of available options when pressing for example Alt-Tab (or other similar keys or controls for jumping between open windows or applications, including for example the flip 3d), so that preferably the user can also jump to the clear desktop for example by keeping the Alt key pressed and pressing Tab until the correct icon is reached, and/or simply pressing for example one or more keys on the keyboard in order to jump directly to the clear desktop.

Another possible variation that is also related to the focus issue is to add for example a feature that allows the user more easily to define or increase or decrease the priority of various processes or open windows, since for example many times the user wishes some program to continue working on something lengthy in the background while he/she is doing other things, but many times the OS automatically assumes that if the user diverted the focus to something else, the processes that are in the background (i.e. not in focus) can be given much lower priority and so left to work much slower, so that the user finds that very little progress has been made when he/she goes back for example to a process that could have been finished in a few minutes if it was in the foreground or given higher priority (This can happen for example especially with programs that are running in a DOS window for example in Windows 98). Preferably the user can easily define the desired priority level for such background processes, for example in terms of percentages, and/or in terms of increasing or decreasing some default values for example in a few discrete steps, and/or for example in terms of more general definitions such as for example “Very high, high, medium, low, very low”, etc. Although typically a programmer can define the level of priority for a process, the user for example in Windows 98 does not have such a choice except in a few programs in which the programmers chose to explicitly give the user such an option, and also the user does not typically know which priority was set by the programmer. So preferably the OS also indicates to the user clearly, for example by colors (for example brighter colors for higher priority process) and/or by numeric and/or textual values and/or by appropriate icons, the level of priority that has been given to each process, for example by indicating it near or on each square in the for example bottom taskbar that shows active processes, and/or indicating it for example at the top line of the window of each process. For example on the square in the taskbar it can be more preferable to indicate this by a color, since there is little space, and for example on the top line of a window it is easier to indicate this for example by a combination of color and/or for example more exact numeric indication. Therefore, the default first priority shown to the user can be for example a default priority automatically set by the OS or the priority set by the programmer, or for example the priority set by the user the last time the program was run. Preferably the user can easily change the priority for example by clicking on the place where the priority is indicated at or near the taskbar and/or on the window of the process (for example at the top line), so that for example the clicking opens a preferably small windows where the user can choose the priority or for example a lever is shown which the user can pull up or down. Preferably the OS remembers the priorities given by the user to various processes and uses these defaults or at least takes them into consideration for assigning automatically the priorities the next time the user does similar things or activates the same processes, unless the user again changes the priorities. Although Windows XP for example allows the user to choose between more or less priority to background processes in general, this does not allow the user to choose it for individual processes, and the user has to go into the control panel to reach the place where it can be changed. On the other hand, in Windows XP the user may choose among a few priority levels for each process by pressing Control-Alt-Del and entering the task manager, however this does not show automatically the priority for each process, and the user has to click on each process in the task manager separately and choose from a menu in order to view or change its priority. On the other hand the user may for example use the Process Viewer (Pviewer.exe), a tool on the Windows NT Resource Kit 4.0 CD, to change also the priority of individual processes, but this requires entering a special window where all the processes are listed. Similarly for example a shareware called Priority Master (version 3.2) includes even more options, and can indicate for example the priority of a process if the user hovers the mouse for about a second above an item in the bottom task bar, and also shows this indeed on the title line of an open window. However, the above suggested improvement of constantly displaying the priority near each square in the task bar is more convenient and more efficient. Another possible improvement is that the taskbar can show automatically for example also how much percent of CPU is being used on average by each open process. Although windows XP for example allows the user to view CPU usage of various processes in a special window, preferably the user can also see this directly on the task bar without having to go through special menus for that. Another possible variation is that the priority of background and/or foreground processes is automatically dynamically increased according to the type of the work the user is doing in the foreground window, so that if the user is for example typing on Word or surfing with Netscape, more CPU resources can be automatically allocated to the background programs. This is especially important for example when DOS programs are involved since in the prior art usually if they are in the background for example in Windows 98, they can remain with very low priority even if the user is just typing or even if the computer is not really doing anything, whereas much more CPU could have been allocated to them. Another possible variation is that for example when the user enters the task manager (for example by pressing Control-Alt-Del), he/she can for example mark multiple programs or processes (for example by dragging the mouse over a range of them and/or for example by marking a group with the shift or control key pressed down and/or for example by requesting to close all the instances of the same program, for example even if they are stuck) and tell the OS to close all of them at once, instead of the prior art where the user has to mark and close them one at a time and also press Control-Alt-Del again each time (Although windows XP allows marking and closing multiple applications at the same time it does not enable doing this for processes). Another preferable variation is that preferably the task manager automatically shows near each process also to which program and/or path and file name (for example on the hard disk) it belongs. Another possible variation is that preferably the user can choose to automatically sort the processes shown in the task manager for example alphabetically and/or according to how much resources they consume (for example CPU, memory, Internet bandwidth, disk space, etc.), and/or for example according the programs they belong to, and/or other criteria. Another problem is that for example in windows 98 many times the user has to try multiple times to close an application through Control-Alt-Del (or for example when the system tells the user that the application performed an illegal action and asks the user if to close it) until the application is really closed. So preferably in case it hasn't been closed the OS automatically tries again repeatedly to close it, preferably for example at least for a certain number of times and/or till a certain time limit, and preferably the OS lets the user know if there is still a problem after the number of times and/or the time limit has been reached if the OS was still unable to close the application. (Preferably the automatic re-attempting is also accompanied by some visual indicator which preferably shows that the system is automatically continuing to work on closing the chosen program or programs and preferably lets the user automatically know when the system has finished closing the program or group of programs). Preferably the OS can also show the user automatically in which stage the OS is in trying to close the application and/or for example what is the specific problem or problems if there is a problem or problems. Of course, various combinations of the above and other variations can also be used.

Regarding installation of a new operating system in a new directory or partition, preferably during the installation the new system preferably automatically copies the desktop configuration and links from the old system into the desktop of the new system. Since some installed components will not work the same between two different versions of Windows (such as for example when running installed components of windows 98 on windows XP), preferably the system automatically checks which programs can work automatically without problems also in the new system (for example applications that don't have to access the registry, etc.), and preferably for example indicates to the user which applications might need some adjustment and/or tries automatically to solve this problem for those applications too. There are a number of possible preferable solutions for this, of which preferably at least one is used:
1. During installation of the new system, preferably the system tries to automatically convert components that are different between the two systems to work on the new system, for example by automatically converting system calls, memory structures (if needed), etc.
2. During installation of the new system, preferably the system tries to locate the original files which were used for the installation and then tries to reinstall automatically the correct drivers or components that are needed for the new system.

For this, preferably each Windows system keeps information (for example in the registry and/or in one or more of the directories where the installed program or component or drivers resides) about the path and name of the original file from which it was installed, so that the installation can be automatically repeated into the new system, this time with the components that are needed for the new system. If for example the same item can run also on the new system as is (and/or for example the new system is in general compatible with the old system anyway—for example Microsoft Vista is installed on an additional partition and the previous installation is XP) then preferably the user is automatically asked for example if he/she wants for example all or some (or for example asked for each icon separately) if the copied desktop icons should point to the same application as installed on the previous OS or for example a new separate installation should be created for example in the new partition for the new OS, and/or for example a Copy-on-Write version of the application should be created.
3. If the system does not succeed in converting the relevant links or components to work on the new system or for example the original installation program is limited only to the old system (for example Windows 98) and does not contain for example drivers for the new system (for example Windows XP), then preferably the system marks the relevant links on the new desktop as non-operational (for example by giving them dim gray color) and encourages the user to look for other versions of those programs that are fitted to work on the new system. Another possible variation is that in such cases the system allows the link to activate the version that runs under the old system (or for example creates another copy of it) and uses emulation of the old system when needed in order to let it run (at least temporarily until the user installs the new version). Another possible variation is that the system can automatically try to locate on the Internet (preferably in a limited list of well certified sites) any needed variations or drivers that will work on the new OS and for example recommends them to the user and/or for example can download them automatically from certified sources (preferably of course only after user authorization for each downloaded file). (This is relevant mainly for example for shareware programs).
4. Preferably a new protocol for installing programs is implemented so that each installation of new software preferably installs both the appropriate drivers or components (for example Windows 98 drivers on a windows 98 system) and one or more sets of alternate drivers or components (for example for Windows NT/XP or other Operating Systems), and preferably each time the program is loaded into memory the appropriate set of drivers or components is automatically chosen by the OS. However, since in some programs part of the installation requires for example updating registries and/or installing various components in system directories, preferably those parts of the installation are suspended and are executed automatically for example the first time that the new OS is activated for the first time after installing it.

Another possible variation is that when installing the new system the new OS first copies the old system, preferably as is, into a new partition (which preferably the user can specify, and the system preferably creates it automatically if it doesn't exist before), and then preferably all the references to the drive letters of the original partition in the OS and preferably also in the existing applications are preferably automatically replaced to refer to the new drive letter (for example by changing them on the disk or for example by an application which runs below the application and corrects the driver letter on the fly when needed—for example whenever the relevant file access services are activated). After that preferably the system installs the new OS over the new copy of the old OS (or for example over the original copy of the previous OS—preferably by offering the user to choose between these options), in a way similar to a normal upgrade installation. After that if there are for example compatibility problems with programs that are not fit for the new OS, as explained above, preferably any of the above described solutions can be used to solve this. The end result is that the user has a new OS either on the original partition or on a new partition, without losing the original OS. Another possible variation is that preferably the same principles can be used also for example for poring the OS together with the installed programs to a new computer—by first creating an image of the installed OS of the old computer preferably in a way that is independent of specific disk sectors, then loading this image on the new computer, and then installing over it the new OS, or for example again installing it in another partition, thus creating on the new computer for example preferably a bootable working mirror of both the old OS and the new OS.

Of course, various combinations of the above and other variations can also be used.

Regarding the undo problem, preferably any changes in the entire hard disk or other types of preferably fast mass storage non-volatile memory after or during the installation of new software, are preferably completely undo-able at least for a certain time period. This is more comprehensive than the current “undo” feature that Microsoft for example offers after installing new software, since the current features only allow restoring the registry and system files, and even that not always completely, whereas any other changes to directories or files cannot be undone. A more extreme variation is that for example any changes at all that happen on the hard disk or other non-volatile memory (and possibly even on other connected media) at any time are completely undo-able at least for a certain time period, in a way similar for example to the undo feature in a single Word document. The above Undo features are preferably accomplished by keeping one or more rollback log, preferably backed up by appropriate hardware on the disk—as explained below in the reference to FIG. 2.

Other possible improvements in word processing programs such as for example Microsoft Word can include preferably at least one of the following:
1. Adding to word processors such as for example Word, for example a smart file-compare features that can show exactly the textual differences between two or more files while disregarding irrelevant data such as line breaks, fonts, etc. In the prior art this can be done for example by a text file compare program after saving the word file as text files with line breaks, but then the comparison might show many irrelevant changes for each paragraph because of changes in line breaks for example if even one word was changed near the beginning of the paragraph. Another possible variation is to allow the program to merge for example two files into a single file with highlighted changes just as if one of the files was created out of the other while keeping the “highlight changes” option to On. This is very useful for example for checking changes between a current version of a file and any of the previous versions retroactively even if no change tracking was used during the time that the changes were made. In order to accomplish this preferably the changes are checked in a way similar to the non-merging file comparison, except that the results are displayed in the form of the merged file. Another possible variation is that for example cut & paste of one file over another file (and/or in fact cut & paste a section, such as for example a few words or a few lines or one or more paragraphs, over another section) when “highlight changes” is set to ON automatically generates the highlighted changes between the two sections as if they were made by actually changing one to the other, instead of the current prior art in which the results of such cut & paste are that the old text area is simply marked as deleted by strikeover and the new text is simply marked as added (this is preferably accomplished, again, by simple automatic comparison between the original text and the pasted text, and marking the differences by the conventions of highlighted changes, as if the changes were made manually). Although Microsoft Word currently allows an option of file comparison, which marks the changes between the two files as if the “track changes” was set to On between the old file and the new file, as explained above comparing sections by cut and paste does not work (the previous text is simply marked as deleted and the pasted text is marked as new, instead of making a comparison), and even the comparison of two files is not sufficiently reliable and has at least the following problems:
   a. If at least one of the two compared files already contains marked changes, Word warns you that it may not be able to show all the changes, and there is no differentiation between previous marked changes and the changes that are indicated by the comparison itself. In order to solve this preferably in such cases a different indication is used between the old changes and the new changes generated by the comparison, for example by using additional colors, and/or using for example different special icons and/or marks near the old changes and/or near the new changes, and/or using for example different special squares and/or other frames around the old and/or the new changes, and/or using for example special fonts and/or other font characteristics, and/or other preferably clearly visible indications. However, using for example different colors could be problematic since different colors are already used for indicating who made each set of changes, so this might be confusing, and in addition, if such a file (that resulted from a comparison) is then again compared with another file, more and more colors might be needed. A more preferred variation is that for example in each stage of the comparison the old changes are automatically marked for example by more faded or less lit colors (but preferably keeping the original colors), and if comparison steps continue then preferably at the next step preferably all previous changes now become faded, and the new comparison changes are marked with brighter colors. Another possible variation is that for example at any time the user can activate a command which tells the word processor to start using a new color for the changes, which can be very useful for example when the user wants to keep previous changes marked but also to differentiate between them and new changes. Eventhough the user can achieve today a similar result in Microsoft Word by changing the author, such a change just in order to change the color of the tracked changes is confusing, so preferably the user can change the color without changing the author. This is preferably done for example by adding an option to the menu of track changes, which preferably enables the user to choose separately the color of changes that were made so far and the color of subsequent changes (preferably with a free independent choice of colors for each and preferably much more than 10 colors are available—preferably for example any color which is available for graphics), or for example the user can indicate for example a time and date from which the new colors apply (and/or for example also until a certain time and date) (which can be useful for example if the user already started to type in the new changes and then decides for example that all the new changes for example since today should be marked with a different color). Preferably the user can also change any color of tracked changes to any other color, which is very important since sometimes for example Word decides on its own to suddenly for example switch colors between authors (for example simply closing and reopening the document can cause the color to change), which can be confusing or annoying since the user can already be used to a certain color as the color of the current changes), or the user might for example simply prefer a different color. For changing the colors preferably the user can for example use the search and replace command with the color as a parameter, so that for example changing the color of tracked changes can be done the same way as changing the colors of normally colors sections, as described elsewhere in this application, and/or for example the user can for example right click with the mouse (or for example use some other command or control) on one of the sections with the old color and then for example choose the new color from a menu, so that all the tracked changes with the same color change into the new color, and/or for example the user can (for example in the menu of the track changes options) for example edit a table which lists all the current colors of tracked changes (preferably together with the name of author of each color or for example the range of dates covers by each color) and then the user can for example mark near each of them the new desired color and then for example click on an option which activates the changes, which is most convenient for example in case the user for example wants to switch between two colors, for example convert the blue tracked changes to red and vice versa). Another possible variation is that preferably the word processor saves also a code of the specific color used for each set of track changes and does not change it on its own. Another possible variation is that even with the prior art method of having to change the user in order to change the color, preferably more than 10 color are available and preferably the word processor displays in advance all the available colors and the user names that can be associated with them (for example the same name with an incremental number) so that the user can know in advance what color will be given to the next user name instead of having to guess or use trial and error even just to find the desired color. Another possible variation is that preferably the user can tell the word processor for example to avoid marking tracked changes for example on the page numbers and/or the date and/or this is preferably the default, since this marking this is unnecessary and makes the title line ugly. Another possible variation is that for example when the user executes the “accept changes” command he/he can for example request to accept automatically for example (with or without individual confirmation for each change) for example only the changes of a specific authors and/or color and/or for example group of color and/or for example accept all changes except a specific color or colors, and/or for example accept all changes from and/or until a certain date of when the change was made, for example automatically accept all the changes that were made until Dec. 12, 2005). Another possible variation is that the user can preferably also change the author for example for only a specific document or specific group of documents (instead of only globally as it is in the prior art Word 2000 and even Word 2003), and in this case of course this definition preferably carries on also every time the user saves the file under a new name until the user explicitly changes the author again. However, these are just examples and any type different marking can be used. Another possible variation is that for example a summary table or other type of index is automatically generated so that the table or index indicates which color was added on which date (preferably taken automatically from the date of the file which each color of changes represents), so that the user can clearly see which change was entered at each date (and/or time). Another possible variation is that, in addition or instead, the date in which each section or element was added or changed is automatically indicated near the relevant text, for example by a bubble that is shown when the user points the cursor or the mouse on the relevant section, but more preferably this is marked all the time, preferably at the side of each section, so that it is clearly visible even without having to indicate the section, and preferably it is clearly visible also in the printed version near each section (of course the user can preferably also request to disable or hide this for example on the screen and/or when printing, and/or for example activate this only for example only for a certain section—for example a certain sentence or an area which he/she marked with the mouse). In order to accomplish this preferably the files are automatically sorted by date before creating the comparison, and each new section or element is dated automatically according to the first time it appeared. (Although for example Word 2003 can show the time and date each marked section was added when the user puts the mouse over it, this works only while the section is marked and cannot be reconstructed after the changes have been accepted, as described above, and for example when two files are merged for comparison the added parts are marked as if they were added at the date of the comparison. So according to the above this is preferably improved so that if the added section was not previously marked as a change then the date shown is the date of the file from which it was added, and if it was marked then of course the original date is kept as originally marked in the changed section). Another possible variation is that preferably the word processor can save for example the time and/or date information for each section also after it is accepted, but in that case preferably it is saved locally, for example in the same directory, preferably with some link which relates it to the file, but preferably does not become part of the file, so as not to damage the privacy of the user if he/she for example sends the file to someone else. Another possible variation is to use similar fading for example also with normal incremental changes when track changes is used, so that for example the user can use a command that fades (or otherwise changes) the color of preferably all the older changes so that all the new changes from that point on will stand out. This is very important for example when a file is changed in incremental steps and each time for example the new version is sent by email to someone else. Another possible variation is that for example the OS and/or the word processor can identify automatically incremental updates of the same file (for example according to the beginning of the file name and/or date and/or for example by keeping automatically a log of the sequence of updating a file incrementally), so that the OS and/or the word processor can use the knowledge of the update sequence of a series of files for example to search for example for each section or sentence when was the first time that it was entered.
   b. The file comparison is not always reliable and may get sections confused, so that for example when comparing two patent files, the comparison can confuse for example between a claims section and a specification section, thus marking entire areas as deleted and added instead of properly comparing them. In order to prevent this, preferably the system uses preferably various heuristics in order to extract from the document important information about its structure, so that for example a section that appears after a clear headline (which is typically for example on a separate line and is typically emphasized for example by boldface and/or by underline and/or sometimes for example by capital letters) is preferably automatically recognized as a different section of the documents, and this way for example a section that appears after the headline CLAIMS will not be confused with a specification section. In addition, the system can use for example other cues about each section, since for example the claims section is clearly characterized by short paragraphs that each start with a consecutive number, which is unlike any other part in the document. Such cues and/or heuristics are preferably used in a fuzzy manner, so that they are considered as part of the evidence but not as absolute guidelines, so that for example if there is more evidence that indicates otherwise, such cues can preferably also be ignored. For example a thorough academic article from 1988 about file comparisons at http://citeseer.nj.nec.com/cache/papers/es/6985/http:zSzzSzwww.ime.usp.br zSz˜iszSzpapirzSzsctp.pdf/simon88sequence.pdf shows that the file comparison problem is theoretically and practically not completely solved yet, but this article deals mainly with various methods of increasing the speed of such algorithms (which is far less critical today, now that computers are thousands of times faster than 15 years ago), and much less with how to improve the reliability of such algorithms. U.S. Pat. No. 6,526,410, issued on Feb. 25, 2003 to the Hitachi company, shows how to improve such algorithms in explicitly structured documents, such as for example XML documents, by making the comparison first between the XML structures, and then comparing the text only between structures that are determined to be within the corresponding sub-structure, and typically working with a table of explicit comparison rules. However their solution does not solve the problem for example for Word documents, which are the most common type of documents for example in legal documents such as for example contracts and for example patent applications, where file comparison can be very important. Therefore, the above suggested solution is much more general since it can work for example also with word processing documents, such as for example Word documents, where there is no explicit hard-definition structure, but smart heuristics can easily use relevant cues to identify actual sections, and in addition the above solution is more flexible since the identified sections preferably don't become absolutely binding, so that for example if other criteria (such as for example the percent of the common sequences found) indicate that it is better to ignore one or more apparent section indicators, this is preferably done. In addition, preferably the same principles are used and applied recursively when needed. Another possible variation is that for example if the user sees that a certain part of the documents (or more than one part) has not been properly merged (for example the end of the specification together with the claims), then the user can preferably for example mark, for example with the mouse, the problematic section or sections, and then tell the system to try again to merge more properly the problematic section or sections, and then for preferably the word processor (or other application) can work much better because is has a much smaller problem area on which to concentrate.
   c. Only 2 files can be compared at each step. So instead, preferably the system allows to compare also more than two files in each step, and so in the merged file of for example 3 files, changes that come from different files are preferably marked in different colors (for example in a way similar to marking changes that were added by different people in different colors), or marked differentially by other methods, for example such as those mentioned in clause ‘a’ above.
2. Another big problem with the current track-changes features that exist for example in Word 2000 and Word 2002 and even in Word 2003 is that if the user for example breaks an automatically numbered paragraph, where for example each part is automatically marked by a letter or by a number (such as for example in patent claims) into two paragraphs, the part after the break becomes marked (typically in red) as if it is a new text, instead of marking only the real change, which is the new line break and the changes in the subsequent automatic numbers. On the other hand, if the user makes the changes without the track-changes feature On and then uses file-compare, the comparison does not mark the text after the break as a new text (which is good) but now the showing of the changes in the subsequent automatic numbers is not done). This is of course a problematic lack of consistency. So preferably this is improved so that when the track changes feature is On and the user breaks an automatically numbered paragraph, only the new break and the change in subsequent renumbering is shown and the part after the break is not marked as new text, and when comparing files the same consistent difference is shown. In addition there is a problem that when a text is marked as deleted, for example as a result of track changes or of file comparison, if the user wants to undelete it or part of it, the user cannot do it directly (unless it is the most recent change and can be restored by normal Undo), and the user cannot even mark and copy the deleted text and convert it to non-deleted text. Although in the prior art Word the user can do it by marking the deleted text with the mouse and then going the “accept/reject changes” and rejecting the changes in the marked area, but this is much more cumbersome. So preferably this is improved so that when a text is marked as deleted as a result of track changes or of file comparison, the user can mark the deleted text or part of it and press for example a key or button or for example right-clicking with the mouse und choosing undelete from a small menu or otherwise execute a preferably single command which can instantly undelete it. In addition, the user can preferably also mark and copy text that is marked as deleted or any part of it and can preferably paste it back at the same place or elsewhere for example as normal text. (Another possible variation is that he can choose for example if to paste it as normal text or as text marked as deleted). Another preferable improvement is that preferably the user can switch between the Track changes On and Off states also by some control key instead of having to go through a series of menu choices, as it is currently in Word. In addition, preferably when the user copies and pastes text that contains marked changes (for example within the same file or between files), the user can preferably indicate, preferably when pasting, if he/she wants the pasted text to contain the marks of the ‘track changes’ or not. Another possible variation is that the user can for example mark one or more areas in which track changes is marked as On (or Off), so that the other areas for example remain with track changes Off (or On), etc. This can be very useful for example with the new required format for amendments in the USPTO, since when answering for example an Office action the user typically has to use track changes when making changes in the area that contains the amended claims but remove the track changes when moving to the comments section. In addition, in the prior art, even when just working on the section of the amended claims, the user has to switch to track changes Off when adding for example the words “(Original)” or “(Currently amended)” at the beginning of the claim and then switch back to track changes On when changing the claim itself, etc. So preferably, the user can for example automatically add for example the default of the word “Original” at the beginning of each claim for example by using a command that allows defining an automatic rule for this structure, as explained above, and then for example define or choose in the automatic rules command (or for example mark the entire claims area and define in the claims area) a mode which automatically adds for example the “(Currently amended)” when the user makes changes in that claim, so that the user does not have to switch to Track changes off, and the words “(Currently amended)” are preferably automatically added without track changes. Similarly, in this mode preferably for example deleting an entire claim preferably automatically causes the deleted text to disappear, and the word “(Canceled)” to automatically appear instead, as if track changes has been temporarily suspended. Similarly, for example when adding new claims at the end of the claims section, preferably the track changes is automatically set to Off and the word “(New)” is preferably automatically inserted at the beginning of the new claim. Another possible variation is that if the user for example made a mistake and typed text in “track changes off” mode and wants to make the new text marked, he/she can for example use ˆz to temporarily remove the newly entered text, activate the track changes and then for example type ˆy and the new text preferably automatically becomes marked. Another problem with the track changes feature is that typically on the screen the changes are most conspicuous when shown in color (especially for example in red, which is the default for example in Word, if only one user makes the changes), however when printing the file for example in laser printers the red typically becomes a weak gray shade which can be difficult to read. Although Word allows the user to change the color of the marked changes for example from the typical red/blue to black, in the prior art this affects both the on-screen display and the printing, which is very inconvenient for the above reasons. So instead preferably this is improved so that the user can preferably define separate colors for displaying the changes on the screen and when printed. Preferably by default the on-screen display is the automatic colors, and the printing is preferably by default in black if a black and white printer driver is used and preferably automatically by default in color if a color printer is used (or for example black by default also in color printers unless the user changes it)(Typically the system knows which type of printer is used either by plug and play or by the default printer driver). Another possible variation is that the user can for example also change these definitions in a way that applies only to a given file, instead of being able only to change it globally in a way that affects all files until changed again by the user, and/or for example change these defaults for all the files in the same directory and/or for example change it automatically in all the files with have a very similar file name or for example identical first characters (for example first 7 characters or for example first 50% of characters, etc), or for example all files which are previous versions of the same current file (which means that preferably the word processor also keeps automatic track of version history and/or for example generates this automatically for example according to file names and/or sequential numerals and/or time & date, etc.). Another possible variation is that preferably the user can for example automatically convert marked additions for example to normal underlines, and/or for example vice-versa—automatically convert underlined sections into sections marked with track changes. Preferably the word processing program can ask the user automatically for various types of changes in the way the word processor operates if the change is intended only for the current file or for example for all the files in the same directory or for example all of the files of the same sequence all the files in general or for example one of the other options detailed above. Another problem is that the strikeout on some characters is almost invisible—for example the digit 4 has a horizontal line almost at the exact position of the strikeout line. So preferably the strikeout line is automatically moved higher or lower on such characters, or for example in a line or a word or a section where such characters exist the entire strikeout line is automatically made lower or higher as needed (for example by 1 or more pixel lines), and/or for example the strikeout line is automatically made of a different thickness and/or length and/or angle and/or color (for example just over the problematic character or over the problematic word or section or line). Another problem is that for example in Microsoft Word if the cursor stands on a word that is marked as deleted and the user enters the dictionary, the word is not seen by the dictionary, and trying to access it in the dictionary can also cause the cursor to jump one word backwards. So this is preferably improved so that the striked-out words behave like normal words on the dictionary. Another possible variation is that for example when a section (for example one or more characters or words) is deleted and then reentered next to the deleted text (for example a deleted digit 9 next to a newly entered digit 9), preferably the word processor can automatically decide to integrate them by removing the deleted redundant part, since it adds no information and looks confusingly like a change where there is really no change, so that for example “the” becomes automatically “the”. Another possible variation is that preferably, when the color of the changes is set to be according to the user, the word processor allows the user to choose by himself/herself what color his/her new changes will be (and/or what the color of previous changes will be), since in the prior art this is determined automatically and sometimes for example Word can assign to the user by mistake a color that already belongs to one set of changes even if these comments were not made by him/her. Another problem is that for example in Word 2003 the marked changes are shown in a way that might be confusing or inconvenient for example to users who are accustomed to the way that the changes are shown for example in Word 2000 (especially for example the way deleted text is marked with comments at the side). Although Word 2003 allows the user to view the changes in the old format by choosing “Normal View” instead of “Print layout” in the “View” menu, this is problematic because in this mode the user cannot see the page numbers and in fact cannot see at all the headline of each page, and graphic images are not shown. So preferably this is improved so that the user can choose to view the track changes in the old or the new format preferably without affecting the way the headlines and page breaks and/or images are shown, and preferably the user can toggle between showing the page numbers and headlines or not independently of the format of the marked changes. Another problem is that in the new marked changed format if the user for example simply moves the mouse over for example text which is marked as newly added, many times suddenly a yellow square appears which repeats the inserted text and gives the time and date that it was inserted, but this yellow square many times covers partially the original text, which can be very annoying. So preferably this is improved so that the time and date or at least the date appears only at the side without covering the original text, and there is no need to repeat it anyway.
3. Preferably the word processing program behaves consistently with cut & paste where Internet pages are involved, so that for example images are kept properly as an internal part of the document (preferably including also any internet links that the images are pointing to), just as if they were included out of a file for example. For example the way Microsoft Word currently behaves is that if you save a remote Internet page by cut & paste (such as for example http://news.google.com) then the images don't show up at all. On the other hand, if you first save the page locally and then use cut & paste then the images do show up, however they are linked to the local directory where the images were saved, so if the user for example later sends the same Word file to someone else then the images are again missing when that someone else opens the file. (This same problem happens also if the page that was saved locally is properly opened by Word as a local web page and for example is then saved as a Word document). This is inconsistent with the behavior of other images, which become an integral part of the file. so this is preferably solved as follows: If the links are to local images then preferably they are automatically inserted into the document file itself, and if they are based on links to the actual Internet then preferably they are also included internally in the document and/or they can also be saved as links (preferably the user is asked which these options he/she prefers).
4. Preferably the word processing program (or other programs that deal with opening files, such as for example other Office programs) remembers automatically for example in the “Open file” dialogue box and/or in the “Save” dialogue box if the user typed last time a filename (or path) in English or in another language (for example Hebrew) and preferably leaves this as the default for the next time. This is very important since it can be very aggravating if the program for example insists each time to start the dialogue box in Hebrew even though the user wants each time to type a name in English. Preferably this default is remembered of course also after closing and re-opening the word processor (for example by saving it automatically in some preferably small configuration file). Similarly preferably when the user opens a new file preferably the word processor automatically moves to the language in which most of the opened file is written (For this preferably the word processor simply counts for example the number of words or letters in each language, so that for example if the file is mostly Hebrew preferably after opening the file the word processor automatically expects to get new input in Hebrew) or for example in the language which the user used when working on it the last time. (In the prior art, since Word for example changes its language within the normal text according to the language of the file name, if the user for example has Hebrew files which have an English file name, the word processor always enters them waiting initially for input in English instead of in Hebrew). Preferably the word processor also remembers similarly according to the last internal search in which language the user prefers to perform the search within the file. Another possible variation is that preferably the word processor and/or other applications and/or the dialogue box for example remembers and displays automatically the last requested file pattern when the user tries to open a new file (for example ‘f:\pats\betwin*13*’) and for example if the user for example enters new input—instead of for example pressing enter (to use this pattern) or for example using the arrows and making changes—then the pattern is removed, instead of the prior art, where the input line is empty and the user has to search in a scroll list to find previous search patterns. Another problem is that if for example Word and/or Windows crashes, the next time that the user opens the word processor he/she is typically given the option to re-edit an automatically saved copy of the files that were open before the crash, but if he/she closes them he/she cannot automatically regain access to them, even if for example he/she later finds out that he/she does indeed need one or more of them. So preferably the word processor is improved so that even after the user closes those automatically offered files, he/she can preferably still activate an option that restores them, preferably even if the user in the meantime closes the word processor and then later reopens it. For this preferably the word processor keeps one or more buffers which point to these automatically saved files and preferably has an indication which groups of files belong together and/or to which crash event they are related, and preferably these files are kept in the original directories of the relevant files (and/or for example in a special directory) for example at least for a certain time period and/or for example as long as there is sufficient disk space and/or for example until their cumulative total space exceeds some value (and then preferably the oldest files are deleted if needed). In addition, since many times the user does not know if he/she needs the automatically offered files, another possible variation is that preferably the word processor automatically runs file comparison between each such file and the equivalent last saved version and preferably shows the user by track changes the differences between this and the saved version, and preferably if there are no differences then the word processor automatically does not even offer that file. When showing automatically the differences, preferably the word processor marks them differently (for example by a different color even if the 2 files for example already contain marked changes), and preferably the word processor automatically indicates the amount of difference (for example in terms of number of letters and/or words and/or sentences and/or sections changed), and preferably the word processor can let the user jump automatically to those sections where the changes are. This is important since in the prior art most of the times the user assumes that he/she saved whatever was important and so usually ignores the offered files. Another problem is that when the user for example wants to open a file or use “save-as” for example in Word 2003 on windows XP it usually takes quite a long time till the dialogue box shows the available files in the directory (at least if there are many files and/or subdirectories in the current default directory), even if this is done for example just a few seconds after the previous access to the dialogue box. So this is preferably improved so that this is done preferably instantaneously or almost instantaneously. Preferably this is done for example by saving automatically the structure of the current directory in one or more buffer in memory (and/or even in the disk)(preferably in the same sorted order in which it is displayed), and preferably the OS automatically updates this buffer in memory (and/or on the disk) for example even if some other process which is running at the same time for example changes something in that directory. Preferably this is done for example automatically for any directory recently accessed by the dialogue box, and/or for example the word processor (and/or other applications) can preferably tell the OS already for example when they are activated to prepare the buffer of their current default directory in memory, and/or for example any directories are automatically saved also in the sorted order (For example the OS keeps for each directory or at least for many directories automatically also a sorted copy of the file names and/or sub-directory. This is good anyway since it can serve also as another backup of the directory table). In addition, preferably any changes in file names and/or additions and/or deletions of files are preferably automatically updated for example in the buffer by simply merging them with the already sorted directory, instead of re-sorting it again each time. What is even more annoying in the dialogue box of Word 2003 is that when there are many files in the directory (for example a few thousands), while it is scanning the directory, the dialogue box may not even show the user what he/she is typing in the input line until 5-10 seconds later. So preferably this is improved so that the dialogue box samples more frequently what the user is typing and preferably displays it immediately. In addition, preferably the dialogue box monitors all the time the user's input line and for example if the user starts typing the path to another directory (for example typing a “\” at the beginning of the line followed by one or more letters which are different from the current path) then preferably any scanning or sorting of files in the current directory is preferably immediately aborted. Another possible variation is that preferably when the list of recently opened files is displayed for example in the Word processor preferably the user can for example mark more than one such file at the same time and for example automatically open all of the marked files for example into new windows or new tabs. Another possible variation is that preferably the word processor or for example the dialogue box can also keep more than one default directory (for example according to recency and/or frequency of use) and so for example when the user starts typing a file name to open preferably the list of most likely paths is preferably shown near it, for example as a pull down menu which the user can choose from if he/she wishes. Another problem with the dialogue box is that for example in Microsoft Word (including Word 2003) when the dialogue box is open (for example for opening a file or saving a file), if the user tries to jumps to another open Word window, the box of the other window on the task bar seems to be activated but in practice the open dialogue box still remains in front and the user still remains in the original Word window, which can be both confusing and annoying, especially for example if the user is trying to look for example at the file name of the other window in order to decide what to answer to the dialogue box. So preferably this is improved so that the dialogue box is linked only to the Window from which it was opened, so that when the user open a dialogue box from one Word window preferably the user can jump to other Word windows just like he/she can jump to windows of applications even while the dialogue box is still open, and preferably each Word window can have its own dialogue box open even at the same time independently of other Word windows. Similarly, for example in the Opera browser, if the dialog box is open the user cannot at all jump again to the tab from which it was opened or to any other tabs (eventhough the user apparently can jump to other Opera windows with no problem) until the dialogue box is closed. So preferably this is improved so that opening the dialogue box does not prevent the user from returning to the original tab from which it was opened or to other tabs, and if the user does that then preferably the dialogue open box becomes accessible again for example through a special icon or for example the open dialogue box becomes accessible though a special handle like the other tabs (so that preferably when that icon or handle is clicked the user is returned to the last tab from which it was opened and the open dialog box shows on top of that tab) or through reopening the dialogue box. Another problem is that for example in Word (both Word 2000 and even Word 2003), when the user searches for a word or string and the string requires jumping to a new page (i.e. is not within the current text that is already shown on the screen), the word processor always displays the line with the found text on the top line of the screen, which is not efficient since it prevents the user from seeing better the context, and if the user for example wants to see also for example 2-3 lines before the found string he/she has to scroll backwards. So preferably this is improved so that the found text is automatically shown by default for example with at least 1 or more previous lines on the same screen, and/orpreferably the user can easily change the default position, for example through an option in the search menu, and/or or for example if the user scrolls back for example 1 or 2 or more lines after a string is found and shown, preferably the word processor learns this automatically and adds automatically 1 or 2 or more previous lines when a string is found and shown on text that was not previously on the screen. These principles can be used of course also in other applications, such as for example when searching for strings for example in documents displayed by the web browser or for example when searching in pdf documents, etc.
5. Preferably the user can use for example ˆz (Control-z) (or other similar commands) to undo the last changes even after closing and reopening a file, unlike the prior art, in which this can only be done as long as the file remains open. This is preferably done either by saving the undo data in the file itself, or (more preferably) by saving it preferably in another local file, so that the original file preferably only contains a link to the associated local undo file. This has the advantage that when sending for example the file to someone else the previous versions and last changes are not transmitted together with that file to the other person, and yet the original user has flexibility to use the undo even after the file was already closed, as explained above. In this case preferably the system indicates to the user when he/she is about to undo things to a state before the last saved version of the file and preferably asks for his/her confirmation for that. Another possible variation is that for example the word processor or browser or other application can keep in memory different search strings in different open windows of the same application (and especially for example if some are for example in English and some are in for example in Hebrew or some other language), so that for example the user indicates if he/she prefers sharing search strings between the open Windows or having one for all. Another possible variation is that for example the word processor or browser or other application (for example pdf viewers) can remember the last search strings or search strings that were used the pervious time one or more windows of the application were open (for example by saving it in some configuration file or other file on the disk), and preferably lets the user choose automatically the last search string or for example chose from a group of recent search strings. Another possible variation is that for example after the user makes changes in a certain position in a document which causes jumping there (for example presses ˆZ and then ˆY) preferably he/she can also jump back to the position he/she was before the jump and/or for example if the user changes something in a certain area in the document and then jumps to another area and changes something there and forgets where he was before, preferably he/she can automatically jump back there without having to undo the last change. This can be done for example by a command which for example keeps a list of the most recently areas of the document in which the user was working, so that for example pressing some key (for example ˆj) or choosing the appropriate option in a menu) causes the user to jump back to the previous area he/she was working on, and/or for example open a pull down list which shows the relevant sections for example each in one or more lines and/or show preview windows and the user can click on the desired choice. Another possible variation is that when copying text for example by copy & paste into an empty new file preferably the headers (for example containing author name, date and page numbers, etc.) are automatically inserted into the new file and/or for example other file parameters are also copied automatically. Preferably the headers and/or other parameters are copied automatically but the user preferably can also choose for example to disable this feature or for example to disable parts of it. Another possible variation is that for example copy & paste and/or for example print are automatically available from any messages displayed on the screen (This can be accomplished for example by supplying standard communication tools that support this to various software, and/or for example the OS or for example some special application automatically allows the user to copy and paste and/or print for example from any text that appears on the screen, regardless of which program it belongs to).
6. Preferably the word processor program allows the user also options of searching and/or substituting for example based on style (including of course for example text color and/or background color and/or underline and/or boldface and/or italics and/or font type and/or any other feature) and/or shape and/or size instead of just character strings, so that for example the user can request to find the next underlined word (or words or section), or for example the next words that are in italics or for example to jump to the next marked change (when changes were marked for example by using the “track changes” feature or the file comparison feature, for example any marked change in general or for example only changes of a specific author or color—in general or in combination with searching for a specific search string) or for example jump to the next word marked as possible error (preferably there is for example also a specific control key combination for each of these options) or for example request to automatically convert all the words that are in italics to underline or vice versa, or for example to automatically convert all fonts of size 13 to size 14 for example without affecting other font sizes, or for example to increase automatically all the font sizes by a certain additive or multiplicatory factor (so that for example each font size will increase by 1 pixel), or for example to convert one or more word to another word or words and define that the new word or words will for example be marked by underline and/or other style and/or shape and/or size in each occurrence that is thus substituted, etc. (Although when activating the “accept changes option” Word for example allows the user to jump to the next marked change, this is much less convenient and for example marks the found change in black block, and the user has to click on a number of menu options to reach this, whereas it would be much more convenient if it became a standard available search option like any other search, so that the user can preferably also afterwards for example simply jump to the next such text preferably by a 1-key or 2-key command, for example by simply pressing Ctrl-PgDn, like in other repeat-searches). Of course preferably this can also be combined, so that for example after normal search the user can preferably with a single click or key request also to accept or reject the change, and/or for example after using the search of the accept/reject window preferably the user can close the window and continue searching for the next section (for example by simply pressing Ctrl-PgDn, like in other repeat-searches. Another problem is that for example when the user searches for a letter preceded by a “ˆ” in Word (for example ˆS or ˆN or ˆT), the word processor for some reason is unable to find them. So preferably this is improved of course so that the word processor can regard this search string as normal text and find it normally. Another problem is that when searching for the next change if for example a paragraph number has changed, word marks in black the entire paragraph even though just the number has changed, so preferably this is improved so that only the changed number is marked. In addition, at least when normally searching for text marked by track changes, preferably the word processor does not mark the changed section in black (since that makes it much harder to read) but preferably simply jumps preferably to its beginning, since it is of course sufficiently marked anyway. Another possible variation (which can be used for example for any situations where marked sections are used) is that the user can for example preferably easily define or chose from a number of available options how marked text for example in general will be shown (for example with a preferably slightly different background and/or different foreground color and/or other visually convenient ways instead of inversing it). Of course, preferably this can also be used in combination with other search criteria, so that for example the user can preferably search for example for a specific text which has one or more such specific attributes, such as for example search for all instances of the word “drivers” in which the word is marked as deleted, or for example in which the word is marked as newly added, etc. Of course these additional search options can be very easily supported by the word processor since these text areas have these attributes marked anyway. Another possible variation is that for example when searching for word combinations the word processor has an option of automatically ignoring redundant spaces (for example if there are 2 or more spaces between two words instead of one space for example by user's choice or by default). Preferably the word processor by default offers this option automatically unless the user sets it to look only for the exact amount of spaces between words. Another problem is that when the user for example tries to make a repeated change in Word but confirm it at each step (instead of just global change), the position of the search-and-replace dialogue box many times changes (in cases where otherwise it would cover the relevant text), which forces the user to move the mouse to the new position instead of just keeping his/her hand at the same place and just pressing the Replace or Find-next buttons. So preferably instead, either the position of the search-and-replace dialogue box is always kept constant and the text itself is automatically always scrolled so that the relevant part is visible, or if the position of the search-and-replace dialogue box does move, preferably the mouse cursor automatically jumps with it, so the user does not have to move the mouse to correct for the change in the position of the search-and-replace dialogue box. Another problem with the search and replace dialogue box is that even for example in Word 2003 the text length that can be entered into this dialogue box is limited to about 3½ lines. So preferably this is improved so that there is preferably no such limitation or at least the limit is much larger, such as for example whole paragraphs or even a length of a full page or even multiple pages. Another possible variation is that the user can mark one or more areas in the file and activate the “accept changes” command and then the “accept changes” (for example accept ALL changes) can be automatically done only in the marked areas. Another possible variation is that when there are for example different sets of marked changes (for example according to the time or file version in which the set of changes was made, and/or according to the source of the changes), preferably the user can for example instruct the word processor to automatically accept all the changes but only for example from a certain date or dates or a certain source or sources. For this preferably the word processor automatically shows the user a menu of the available options and allows him/her to choose for example by marking one or more of the desired options. Another possible variation is to include in the search also logical paragraph numbering, so that the user can for example search for a clause that starts with an automatically numbered letter or number (for example “a.” or “35.”). Another possible variation is to allow the user for example to automatically reformat all the logically numbered paragraphs and/or for example to use a certain constant indentation factor without having to mark them, so that for example in patent claims (numbered automatically with numbers, in which some of the claims contain for example sub-clauses marked automatically by letters), the user does not have to mark and move the sub-clauses for each claim separately (as he would have to do in the prior art, since marking for example all the claims together would change both the clauses and the sub clauses to the same indentation) but can for example change some global definition that automatically affects each type of automatically numbered element or for example affects all of them only in the marked section (for example all the claims)—for example a definition for all the 1^{st} level clauses, a definition for all the 2^{nd} degree sub-clauses, etc., or for example the user can define general indentation rules, so that for example for each sub-level the indentation is defined for example as 3 more characters to the right, than the previous level, etc. Similarly, preferably the user can also preferably easily define other rules which apply to all similar structures (preferably by defining an example or choosing for example from general rules), so that for example the user can easily define that in structures such as patent claims each sub-clause within a claim will automatically end for example with a “;” and only the last sub-clause will automatically end with a “.”, etc. Similarly, when the user changes for example the left margin of the document (in left-to-right languages, and/or for example the right margin in right-to left languages), for example for the entire document or for one or more marked sections by moving the border on the ruler. preferably the entire structure of the paragraphs is moved right or left without changes in the structure itself (so that for example the same indentations remain for the beginning of paragraphs and/or for clauses and/or automatically numbered clauses, etc.). This is better than the prior art, in which changing the margin this way for example in Word causes the internal relations within the structures to change, since in most case when the user wants smaller or larger margins he/she does not intend to change any structures. On the other hand, if this is enabled, preferably there remains also an additional preferably separate command which the user can use in the unlikely case/that he/she indeed does wants for example to collapse all the structures within the marked area to start at exactly the same place, thus changing the internal relations. Actually Word does allow this but only from the “Page setup” submenu of the “File” menu (which is less intuitive and takes time to discover), but it is page oriented, so that if the user for example changes this way the left margin of a selected section, the selected section is forced to become alone on a separate page, which can be very annoying if the user only wanted to change its margin without moving it to a separate page, broken from the text before and after it. So preferably this becomes available directly also for example when merely marking a section and moving the left edge of it (for example in English or for right for example in Hebrew) on the ruler, and preferably no page breaks are added there unless the user requests them explicitly. This has the additional advantage that the margins can be moved directly visually and intuitively instead of specifying a distance in numbers. Preferably for example the normal triangle on the ruler keeps, at least by default, the internal indentation when moving the margin, and for example the user can change this default or for example an additional separate marker can be dragged in order to change the margin in a way that destroys the original internal indentations, or for example when dragging the left triangle in English (or right one in Hebrew, etc.) an automatic submenu preferably appears which asks the user if the keep the internal indentation relations within the dragged section or destroy it. Another preferable variation is that the user can for example mark one or more sections (for example with the mouse) and then for example toggle automatically between modes so that for example automatic numbers and/or letters can become manual letters and/or numbers and vice versa (for example in the CLAIMS section of a patent). This is much better then the prior art, where the user has to manually convert each number or letter one at a time from automatic mode to real numbers and letters one after the other, or vice versa. The word processor can do this very easily for example by simply changing the attributes of the relevant text and adding the appropriate characters or vice versa. (Of course, a conversion from automatic to real numbers and/or letters can be done for example by saving the Word document as a text file, but that is much less convenient and has other disadvantages because it entails losing other format features).
7. In the prior art Microsoft Word, deleting the “Enter” between two paragraphs can cause for example the first paragraph to change automatically its font (for example become bigger or smaller or a different font or in a different style) for example according to some qualities of the empty line that was deleted between the paragraphs or some other reason. Since obviously at least in most cases the user does not intend to create such changes by merely deleting an empty line between two paragraphs, preferably no such changes are created automatically. Preferably fonts and/or style are automatically changed for example only in the 2^{nd} paragraphs after connecting it with the 1^{st} paragraph (and in this case preferably to become like in the first paragraph and not like some empty line in between them), and even that is preferably not done automatically but only if the user allows this by default or requests this specifically for example by pressing some key or some button.
8. Another problem with word processors such as for example Word, is that URL links (typically Internet links) (for example http://www.opnix.com/products services/orbit1000/Middle Mile Mayhem.p dt) are not treated properly when paragraphs are automatically aligned, so that for example a URL link that is too long can jump to the next line and cause the words in the previous line to become with too many spaces between them (as it happens for example with the above exemplary link), and if the user manually fixes this for example by breaking the URL for example at the position of one of the slashes, this will cause the link not to work properly, and also, if the paragraph is then changed again, the broken part of the link might come back to the previous line, thus causing the link to appear as if there is a space between the two parts. On the other hand, if the link is too long to fit even an independent line, it is currently broken by Word at the last character that fits the line (as happens in the above exemplary link), instead of breaking it more smartly, preferably according to the closest slash. So preferably this is improved, so that links are preferably automatically and dynamically broken and restored between the lines as the paragraph changes, preferably according to slashes (and/or for example sometimes underlines and/or dots and/or question marks and/or other special characters), and preferably when the user presses the link, it is treated as one consecutive link regardless of this automatically changing break between the lines. Similarly, if the link for example occupies almost all of the line (so there is no room for adding any additional word), and the paragraph is block-aligned (i.e. made straight on both sides), since the url typically does not contain spaces, preferably the alignment for example to the right (for example in an English paragraph) (or for example to the left in right-to-left languages) is preferably done in this case by adding automatically for example micro-spaces between letters (an/or for example increasing the length of underlines between words when such underlines exist in the url). Another very serious problem with URL links is that for example if the user copies and pastes a new http link over a previous http link for example in Word, the address appears as if it has been changed, but when the user presses the link he actually gets the original link. So preferably the word processor (or other application) automatically replaces also the internal link to automatically comply with the visible link, or for example saves only the visible link and uses that information when the user tries to access the link, so there is no additional internal link which can become different from the visible link.
9. Another problem is that in large files if the user wants to mark large areas with the mouse (for example from a certain point till the end of the file), he/she must continue to hold the mouse pointer near the bottom of the page with the mouse key pressed, which can be quite annoying. So preferably for example while the mouse key is still pressed (or for example even if the user lets go of it but presses an appropriate command), the user can for example use other location commands, such as for example Control-PageDown or Control-End or for example End or preferably other single key, or search commands, and then preferably the entire area till the next location becomes marked, instead of having to wait for the page to scroll. Another possible variation is that the user can for example simply jump between two places and then press some key (or for example click one of the mouse buttons) which marks the entire block between them, or for example mark one place (for example with the mouse or by pressing some key) and then jump to another place and when reaching the desired destination press some key (or for example a mouse button) and the entire area between the two marks becomes marked. Another possible variation is that for example pressing some key can significantly increase the speed of the scrolling or for example moving the mouse further to a more extreme position significantly increases the speed of the scrolling (preferably this is linear, so that the speed changes gradually according to how extreme the position of the mouse is, but it can also be for example exponential so that for example going the extreme bottom position will almost instantly cause the position to jump to the end of the file). Another possible variation is that if the user already marked a section for example with the mouse and then for example uses the mouse to click on something else and then wants to go back and for example increase or decrease the marked area, he/she can still use the mouse and/or other keys for example to go back and extend or reduce the section without having to start marking again from the beginning. This can be also useful for example if the user first uses for example ˆa to mark the entire file and then for example uses the mouse and/or other keys to reduce the marked section or remove parts of it. Another possible variation is that the user can mark more than one area with the mouse at the same time, for example by pressing some key that tells the application not to remove the mark from the previous marked area or areas. Preferably these options are done for example by pressing some key which tells the word processor (or other application) to keep the previously marked area and add to it and/or for example to automatically restore it if the user clicked on something that already created a new marked area instead of the previous marked area, and then the user can for example increase the marked area or reduce it or for example mark one or more additional sections while the original marked section remains marked. Of course these and/other features can be used also with other types of files and not just in word processing programs, such as for example with Internet browsers, etc.
10. Another important improvement is that preferably the user can for example choose a specific font color and/or for example specific font attribute (for example underline) which preferably is kept automatically until changed again, so that this text preferably appears wherever the user adds it to previous text, regardless of the color or other attributes of the section of the previous text in which the new text in inserted. This is very convenient for example for keeping track of additions (for example when the user does not want to activate the automatic track changes), or for example for adding comments for example in another color. This is in contrast to the prior art, where for example in Word such options must be chosen again in each section, otherwise when the user starts to add text at a different place it automatically assumes the color and attributes of the surrounding text.
11. Another improvement is that preferably the word processor can allow the user to easily define page numbering that starts from a certain value other than 1, for example since page 50 (or any other desired number) since for example sometimes the user might want to print pages that will be attached after other already printed pages as if they are part of the same file. This can be defined for example by letting the user use a formula, so that for example if the current page number is marked for example in Word as “#”, the user can preferably specify for example “#+49”, so the page numbering will start for example from 50 instead of 1, and then preferably for example the total number of pages is automatically updated accordingly even if the user does not enter the formula there too. Another possible variation is that for example when the user enters for example in the top page title for example the # mark, which in Microsoft Word means automatic page number, the system automatically shows for example a scroll window near it with the default of 1 and the user can instantly for example increase the number by scrolling the window or typing a different number there. (Although for example Word allows the user to cause the page numbering to start at a different number, it is done in a much less intuitive way since the user has to go to the “addition” menu, then choose “page numbers”, then go to “Pattern” and then indicate a page number to start from). Another possible variation is that the user can for example change the rules of page numbering in a way that affects for example only the current page or for example a group of marked pages or for example from the current page until another such change is defined, so that for example the user can define the last pages in a parent which contain figures to be automatically renumbered starting from there as 1 and/or for example change other things in the header of these pages without affecting the headers of the rest of the pages. For this preferably the word processor keeps in the saved file information for multiple headers, preferably each set tagged with a beginning page and end page, for example.
12. Another problem is that for example Word sometimes decides to move paragraphs to the next page without any apparent reason, thus leaving sometimes a large empty space in the previous pages. So preferably the user can for example click in any such case for example on the empty space or on the moved paragraph and/or for example enter a command that tells the word processor that the user does not want such empty spaces, and/or for example the user can activate a command that automatically fixes all such unnecessary empty spaces globally and/or prevents them from being created.
13. Another problem is that in Word for example when switching between the Hebrew dictionary to the English dictionary or vice versa, the language in the small window where the checked word is entered does not automatically change in accordance, so many times the user has also to press Alt-Shift in order to switch to the desired language in the small window, which can be very aggravating if the user starts typing and then sees that the language is the wrong language. So preferably this is improved so that switching the dictionary also automatically switches the language correspondingly in the small window or area where the word has to be entered, so that for example if the user switches to Hebrew/English dictionary then the language in the small window preferably automatically becomes Hebrew, and when the user switches the English/Hebrew the language in the small window or area where the word has to be entered preferably automatically becomes English. Another preferable improvement is that when switching language, if the user has already entered a word in the translation window, preferably the word is not automatically erased when the user switches the language. Similarly, if the user for example switches the language in the small window, preferably this can automatically switch the direction of the dictionary accordingly, so that for example if the user changes to typing a Hebrew word the dictionary preferably automatically becomes Hebrew->English, and vice versa. Another possible improvement is that preferably when using the dictionary the user can use also forward and/or backwards movement (for example by clicking on an appropriate icon or a keyboard key), so that he can go back or forward to previously checked words (in a way similar to browsing a directory or to browsing the Internet). Of course this preferably done with any relevant languages. Another preferable improvement is that the dictionary preferably allows the user to use back arrows in order to go back to previous points in the dictionary for example if the user clicks on various words in a sequence. Another preferable improvement is that when the thesaurus is used preferably the dictionary shows near each newly found word of the thesaurus also its translation to the other language (for example Hebrew) and/or a short description of its more precise meaning in a few words, for example within brackets next to the word, and for example clicking on any of the words or explanation words or the translated words (for example in Hebrew) preferably activates the thesaurus and/or the dictionary again recursively on the clicked word. In addition, preferably the thesaurus and/or the dictionary automatically takes into consideration the context in which the word exists in the file (for example the next few words and/or the sentence and/or the general subject) so that preferably when displaying semantic trees or groups of semantic branches preferably the groups or branches are pre-sorted according to the most likely meaning when taking said context into consideration and/or for example only the most likely meaning branch is shown. Similarly, preferably the automatic typing-error-correction system preferably also takes into account also the context and so preferably chooses the word most likely according to context when there is more than one reasonable correction (and/or for example in cases the system is not sure it preferably shows the user that there is more than one likely correct word and asks him/her to choose the correct one for example by scrolling to the preferred one), since in the prior art many times the automatic error correcting system for example in Word corrects a word which contains a spelling error into a different word which the user didn't mean at all and then if the user doesn't notice it the sentence might be perhaps even dangerously wrong. (The context can be for example based on pre-gathered automatic statistics for example from Internet knowledge bases and/or for example specifically from the user's files and/or for example from the specific file or similar files (for example those that have a similar name or were part of the same project, which preferably the word processors knows automatically by keeping automatically a list of file renaming history), so that for example if the word “windows” appears a lot in the same file or for example in the series of files from which the current file evolved, the word processor preferably gives wrong words that could be “windows” a higher chance for being corrected into this, and so for example the frequency of the word itself in the user's document or relevant documents and/or the chance of it occurring with the actual next word or words (for example before and/or after it) is preferably also taken into account. Another possible variation is that for example the automatic logging of the evolution of the file name can also be used for example to automatically increment the numbers and/or letters which the user has been incrementing, so that for example the save menu contains an option (which can be called for example “Save next”), which automatically increments the correct element and thus saves the new version in a new file (this is no problem since the automatic logging preferably automatically indicates to the word processor for example which number and/or letter the user has been incrementing in each subsequent saving of the file). Another problem is that for example Word does not allow an open file to be backed up for example by pkzip, and typically also keeps preventing this even if the file is saved for example with incremented numbers if is the first file which was opened. So preferably this is improved so that Word does not block programs from accessing open Word files if they only open the file for reading, and preferably after the file is saved with a new name the original file with which Word was opened is released. Another problem is that for example in Word changing the language in the text (for example form English to Hebrew or vice versa) can affect also the text when the user saves or opens a file name, so preferably this is made independent, since the user might for example want to type in Hebrew but prefer for example the file name to remain in English all the time. Similarly preferably changing the language in the dictionary does not change the language in the text of the document or vice versa. This is very important, since for example even in Word 2003, if the user is working for example on an English document and types for example a word in Hebrew in the dictionary in order to find the English word for it, then when continuing to type on the document itself the new text is typed in Hebrew until the user changes it back again, which is certainly not what the user intended. Another possible variation is that preferably the user can copy words from the dictionary into the main text also for example by a single click instead of having to use cut & paste—for example by simply clicking on the word preferably the word is copied preferably to the current position of the cursor. Another problem for example in bilingual Word is that for example numbers or brackets can exist in either of the 2 languages, and for example many times Word breaks brackets or numbers that are attached to words in a way that the user did not intended—such as for example putting an opening bracket alone at the end of the line or braking between the word and the number even if they are attached without a space between them. So this is preferably improved so that these things are automatically avoided regardless of the language in which the digits or brackets are. Another problem is that for example in Word 2000 if the user tries to translate a world in plural the system shows that it exists but does not show the translation until the user converts it to single, and in word 2003 in this case the single form is indicated and the translation is in single. So preferably this is improved so that if the word is in plural the translation can preferably show the translated word also in the plural (in addition to or instead or showing it in the single form, but preferably in addition). Similarly, preferably if the word is for example a verb in the present form (ending with “ing”) preferably the Word processor's translation or dictionary can show also the translated form also in the present form in addition to or instead or showing it in the single form, but preferably in addition). Another possible variation is that the user can for example activate a command which automatically indicates all the words in which spelling errors were previously automatically corrected by the word processor, so that the user can check specifically these words to see if there were any such errors of changing the word to something that was not indented by the user. (This means of course that preferably the word processor (or other application) preferably keeps for each word in the same file or in a separate file a tag that says if it was automatically corrected and preferably also what it was before the correction). Another problem is that for example in Word if the user for example inserts by mistake a digit in the middle of a word (for example “t6hat” or “smart hom1e”) the error correction function ignores this and does not mark this as a possible error. So preferably this is corrected so that for example at least if there is a digit in the middle of a word (and/or for example also if it is attached at the beginning of the word and/or for example also if it is attached at the end of the word) it is preferably at least marked as a possible error. Actually it turns out even word 2000 allows the user for example to change the default so that words which contain digits will not be ignored, but there is no differentiation according to the position of the digit or digits within the word, so preferably this is improved so that the user can define separately if to report an error for example for cases where the digit or digits are at the beginning of the word before the letters, cases where the digits or digits are in the middle of the word, or cases where the digit or digits are at the end of the word after all the letters. Another possible variation is that preferably error checking and/or automatic correction is also for example enabled by default when the user is writing an email message for example in the email client or in the browser, preferably for example by including an error checking engine in the browser and/or the email client or for example the browser or email client can be configured to communicate for example with the error checker of the word processor. Similarly preferably search engines (for example Google) preferably automatically offer in such cases the correct word or words without the digit, for example “did you mean ‘smart home’?” Another preferable improvement for example in words processors, and especially for example in editors that are used for editing software programs (such as for example in integrated visual compiler environments), is that preferably the editor can mark automatically matching pairs of brackets in a way that the user can easily see the matching pairs—preferably by automatically showing each pair in a different color, and/or for example an unmatched bracket is immediately marked as an error. Another possible variation is to show them for example, instead or in addition, in a different style or for example in a somewhat different height, however changing the color is more preferable since it is more conspicuous and much more variations are available. Another possible improvement is that when the user wants for example to correct intermittently two (or more) sections in the same file (for example the claims and the relevant part of the specification in a patent application), preferably the user can for example press a key or combination of keys which causes the position in the word processor to jump automatically between the various last edited sections. This is preferably done by the Word processor preferably automatically saving a buffer of all the last separate positions that the cursor was last on (for example if the distance between them is more than N characters), and then pressing for example some key or key combination moves the position accordingly (This can be done for example automatically between the last two places, and if the user wants more jumps backwards preferably a different command is used). Another preferable variation is that preferably the automatic error checking of the word processor includes also at least some statistical and/or semantic checking of unreasonable words or word combinations that are probably a typing error even if there is such a word and/or eventhough it is grammatically possible, such as for example if the user writes by mistake “any pother way” instead of “any other way”. Since the word “pother” does exist and the combination is apparently grammatically possible, Word does not indicate any error, eventhough any normal human reader would immediately see that it is a mistake and the correct word is “other”. In order to accomplish this preferably the word processor uses at least some taxonomy of semantic knowledge, and/or at least the word processor preferably has a preferably large database of typical texts, for example form newspapers and/or books and/or web pages, and preferably all single words and/or up to a few word combinations are indexed according to how many time they appear, so that preferably the word processor can instantly check for example for highly irregular combinations and/or at least run the check for example when a rare word is involved, etc., and preferably the word processor issues the error message especially if there is clearly a very similar word combination that is much more common (such as for example if the user typed by mistake “the if” instead of “then if”, or “than preferably” instead of “then preferably”, or “fir example” instead of “for example” (which can preferably be marked as possible error also for example because it is too consecutive nouns), or for example “id that” instead of “is that”, or for example typed “more then” instead of “more than” for example without a “,” or “.” between the words—since that will almost always be an error, or for example types “be replaces” instead of “be replaced” or for example similarly with any other verb is this combination). Another possible variation is that the word processor preferably uses also some additional preferably easy heuristics for catching grammatical errors, such as for example marking automatically as suspect cases where for example two verbs or two nouns appear one after the other, for example without a ‘,’ or ‘-’ or ‘/’ or other punctuation marks between them, which is usually a very good heuristic (which can also catch for example errors like “he book” instead of “the book”, etc.), or for example the combination of words like “the” followed immediately by a verb instead of noun or followed by a conditional like ‘if’, etc. Although there are some exceptions they are relatively rare, so this can give very good results without having to really parse the grammatical structure (much more real positives than false positives)(preferably the word processor marks these suspect grammatical errors for example less conspicuously than word that don't exist in the dictionary). This is also very easy to apply since typically the word processor, such as for example Word, already has a built-in dictionary, so looking up to see for each word if it is for example a verb or a noun or other part of the sentence can be done almost instantly, for example by using a hashed look-up table. In cases of words that can be both a verb or a noun the word processor can for example avoid the marking as suspect error or for example take into account the likelihood of the combination according to the known statistics for example as explained above. Another possible variation is that for example the word processor can automatically correct for example all the cases of a comma appearing after a space, coupled to the next word, into appearing coupled to the previous word and followed by a space (and vice versa for example in Hebrew or other right to left languages), or at least mark these places as suspect errors. Another possible variation is that for example the word processor can mark as suspect errors for example cases where a verb ends with an ‘s’ after a noun in plural or without an ‘s’ after a noun in single (which is again very easy since the word processor can easily know if the noun is plural or single according to the built-in dictionary). Another possible variation is that if the word processor is not sure enough for making an automatic correction for an error the user can for example press a control key or choose a menu option which automatically lists more than one possible corrections for the same word for example as {word1/word2/word3 } and then preferably the user can simply click on the correct option and it instantly replaces the word. Preferably the word processor also takes into account for example the layout of the typical keyboard (so that for example an error of adding a ‘p’ before the ‘o’ or for example substituting ‘o’ with a ‘p’ or vice versa is much more likely than for example making a substitution of far letters) and/or also takes into account acoustic information (for example words that sound alike, etc.). Another possible variation is that the word processor for example learns from recording the user's own behavior when such errors are made and then corrected by user (especially for example if this occurs repeatedly), and then preferably warns the user automatically when such errors are made again and/or for example automatically corrects it the way the user has typically corrected it before. Of course various combinations of the above and other variations can also be used.
14. Another problem is that when opening files for example with the windows dialogue box (for example from Word) the dialogue box does not display the full file name if the file name is too long. In windows 98 the problem was even worse since the dialogue box cannot even be enlarged at all, whereas in Windows XP at least the user can enlarge the window of the dialogue box by dragging for example its bottom right corner with the mouse. However, this is still not convenient, since the system allows for example to define file names of length up to 256 characters, but the dialogue box by default will typically display only up to a little more than 80 characters. So preferably this is improved so that the dialogue box preferably automatically adjusts its size to a size that is sufficiently large to display the full file name if one or more of the file names that are displayed is longer than the default, and/or for example a slide bar is added (for example at the bottom) that allows the user to scroll and see the full name (in other words preferably the dialogue box automatically finds the largest name and adjusts its size according to it). However, sometimes the name is even too long to fit the line even when the box is in full size and/or for example too long to fit the top line of the Word Window (and/or in other applications), and/or for example it shows truncated in the yellow explanation box that Word shows when holding the mouse over the file name, so preferably is such cases the filename is preferably automatically for example wrapped into two or more lines and/or for example the font that displays the file name is automatically reduced in size for example by making it smaller and/or thinner, but more preferably by making it only thinner, and/or for example the user can click or otherwise jump to the end of the line and see the rest of the file name and/or for example cause the filename to scroll for example sideways for example my moving a bar. In the prior art the slide bar is enabled only if more file names are displayed sideways, but moving the slide bar jumps one column to the side without letting the user see the rest of the name if the name is too long. The automatic resizing can be done for example also in other types of Windows, so that for example when sending email with attachments for example in Netscape preferably the size of the right internal window that shows the attached file names preferably automatically increases if the file name is longer, at least for example if there is sufficient room, since typically the email addresses on the left internal window are not very long. Another problem is that if for example one file name is very long the dialogue box shows a large gap between the columns of file names even if for example between two columns which don't contain such a long file name. So preferably this is improved so that the distance between each two columns is for example preferably just a little more than the length of the largest file name in the left column. Another possible variation is that for example even in the dialogue box file names that are too long can for example be automatically wrapped into more than one line instead of further increasing the distance between the columns beyond a certain threshold and/or for example the fonts of the long name can for example be automatically reduced in size or at least only made thinner, preferably without affecting the rest of the display (preferably for example the dialogue box decides about this automatically on a need basis). Another possible variation is that for example the dialogue box can automatically display also the date of last modification for each file name (for example near each file name automatically, or for example at least if the user hovers the mouse over the file name), and/or the user can for example request to sort the dialogue box display by the last modification date instead of alphabetically. Another possible variation is that for example before sending the email with attachments the user can for example easily change the order within the list of attachments, for example by pointing the mouse to one of the attachments and dragging it to a different position in the list. Another preferable improvement is that for example when deleting a file in the dialogue box that displays existing file names, preferably by default immediately after the deletion the display is updated so that the list of files is displayed more or less in the same position (preferably the display up to the deleted file remains the same, and is updated only from the deleted position onwards), since typically the user will want to continue at the same place after the deletion. In the prior art deleting a file in the dialogue box causes the display to jump back automatically to the beginning of the list. Another problem is that the dialogue box that allows the user to choose directories and files and the explorer Window show file extensions only when the file type is unknown, so for example if the same file name exists both as an rtf file and as a Word doc file the user has no indication which is which (unless he/she tells for example Word to show only files of one of the types). So preferably this is improved so that in the dialogue box and/or in the explorer Window or for example in the automatic list of recent files which can be reopened the extension is shown even when the associated application is known and/or for example if the user opens it for example with Word (or with some other application), then preferably the extension is displayed for example on the top bar of the window, so that the user knows which file he/she opened and so that if for example he/she opens for example both a doc and an rtf version of the same file he/she knows which is which. Another problem is that when the user searches for a specific file or file pattern (for example a file name with a wild card) the explorer window or dialog box shows first directory names and only afterwards files, which can be very inconvenient if there is a large number of sub-directories in the directory where the relevant files are. So preferably in the windows explorer and/or dialog box and/or in similar utilities either the files are displayed by default before the directory names or for example the user can easily indicate which of these orders he/she prefers. Another possible variation is that for example instead of or in addition to the icon that shows the associated application (for example Word) the window can show also an Icon that represents the general type of the file (for example music file, video file, word processing file, C program file, HTML file, etc.) regardless of the associated application. Another possible variation is that for example even when an internal Window of a program is in front of a background window of that program and does not allow accessing the background window for example until the front window is closed, preferably the OS automatically allows the user at least to move the previous window and/or perform at least other acts that preferably do not change the way the software behaves but allows the user at least to control the view of the background window.
15. Another problem for example in Word is that drawing tools are very limited so that for example various lines can only be positioned at certain minimal jumps of a few mm distance from each other instead of at any desired pixel positions. This creates unnecessary limitations on the available resolution and other problems. So preferably this limitation is removed, so that the user can preferably position any object on any position where a valid pixel exists (an object can also be for example a line within a more complex object—for example a rectangle, so this can mean of course not only moving the objects but also for example moving parts of them, i.e. preferably the user can also change their size in pixel-level resolution). Similarly there is a problem that the user cannot for example simply mark one or more images for example with the mouse, for example in order to delete it or cut and paste it elsewhere. In the prior art Word the marking usually works only on a group of images depending for example if there is a text before and after them that can be included in the marked block, and so that normally the user has to mark manually multiple elements in an image in order to copy or move it or has to manually group the image. So preferably this is improved so that the user can simply mark any area in an image or part of it (for example even according to pixel lines and/or columns, or for example by marking a rectangle or other shapes around whatever part he/she wishes like in paint programs) and then for example delete it or copy it or move it. This is very easy to do since the word processor (or other application) knows which part of the image or images is displayed within the marked area. Another possible variation is that for example after the user marks such a section he/she can for example not only cut & paste and/or copy or delete the marked section but also for example rotate it so that preferably all the elements in the marked section are rotated in synchrony, etc. (for example in any desired amount of degrees, etc.) and/or for example move it without having to tediously mark all the elements one after the other, and/or preferably the user can also for example reduce or enlarge the image for example by pulling its corner (for example like any image from a file) while preferably keeping the proportions (this should be no problem at all since for example images composed of lines or dots or squares or other automatic shapes are vectorial anyway and so are true type fonts, so the word processor can for example automatically increase or reduced the font size in the same proportion that the other vectorial elements are increased or reduced). Another possible variation is that for example if the user is marking multiple elements in the image and the for example clicks on the next element without keeping the finger ion the shift key (thus losing all the previous marks), preferably by pressing for example ˆz or some other control the user can undo the last click, thus restoring all the previous marks. The application can do this for example by vector graphics manipulations or by computing the changes on a pixel basis. Another possible variation is that preferably when using for example the wavy line (in the automatic shapes menu) preferably the user can use undo (for example ˆz) to cancel the last curve or go back to previous curves. This is better than the prior art for example in Word, in which if the user makes a mistake he/she has to delete the wavy line start creating it again.
16. Another possible variation is that preferably for example in word processing programs and/or for example Internet browsers and/or other software preferably the user can move any icon and/or for example any menu item and/or sub-menu item (preferably including for example within pull-down menus) to any desired position (preferably simply by dragging it with the mouse) and preferably the same icon and/or menu item automatically continues functioning on the new position (this means of course that preferably the user can also for example change the position of the tab handles line to be lower or higher or even for example move it to the bottom of the browser windows instead of the top part), and this new position is preferably saved automatically also after the user closes the application, and preferably the user can also undo any such changes, preferably even after the application has been closed and reopened (which is preferably accomplished by keeping a rollback log in a separate configuration file and preferably for example by using variable pointers for the menu items). This is better than the prior art in which for example the user can sometimes move certain groups of elements together but not in a consistent manner and not for each item independently (for example in Microsoft Word). This feature is preferably supported automatically for example by compilers such as for example visual C, so that preferably the programmer does not have to do almost anything in order to enable it. Another possible variation is that the user can also for example change the position of the normal boxes on the taskbar that represent normally running programs (preferably by dragging them with the mouse), so that the user can conveniently re-arrange their position without having to close and reopen these programs.
17. Another possible variation is that preferably the user can for example mark an area in the word processor with the mouse and preferably activate a command which for example automatically removes any table or other structured formatting from that area, so that preferably the text is still divided preferably the same way, but after this the user can for example make any other changes as if the table or other structure never existed. Another possible variation is the opposite—so that the user can for example enter text that looks like in a table but without the actual structure and then activate a command which automatically adds the structure—for example by guessing the most likely structure that fits the given shape of the text.
18. Another possible variation is that for example the copy command (typically ˆC) can also be activated cumulatively (for example by activating some flag), so that for example a certain sequence of ˆC commands can create a cumulative buffer of for example consecutively pasted texts, so that afterwards for example ˆV at a certain position will preferably paste back the consecutive group of pasted texts as one sequence.
19. Another possible variation is that preferably the word processor automatically checks the date in the system in short intervals (for example every few minutes) and thus updates the date field automatically whenever it has changed (for example when the user has included the date field in each page header), and not just if the user reopens file or prints it, as is done for example in the prior art Word. Another possible variation is that for example the user can change page definitions (for example size of top and bottom margins and/or other parameters) also for example for a single page or range of pages and not just automatically for all the pages as in the prior art Word.

Of course, like other features of this invention, these features can be used also independently of any other features of this invention.

Additional improvements in the OS preferably include also at least one of the following:
1. Preferably the OS allows the user to define at least one User which the system (such as for example Windows NT or XP) will enter by default and without a password if the user does not request to enter a particular User after a certain time (for example 50 seconds) after the system reaches the menu that's asks to choose a User. This has the advantage that for example after a temporary power failure the system can automatically resume the original User. Preferably this is accompanied by the ability to define for example a sequence of actions to be taken upon entering this User by default, such as for example connecting to the Internet and activating a server and/or whatever other program or programs need to be resumed after a power failure. This is somewhat similar to programs in the startup menu, except that this feature is preferably more powerful, so that it enables for example to define also various sequences of actions or for example to carry on automatically certain activities only if the User was entered automatically by default. Another possible variation is that preferably the user can, preferably easily, also define the priorities for programs in the startup list (for example by dragging them to the top of the list or marking their priority), so that for example the user can specify that for example the firewall will always start before any of the other programs or at least for example among the first 3-4, and/or for example the OS itself and/or for example the security system for example automatically moves the security system and/or the firewall to the top of the list and/or makes sure that it runs below any other applications and/or drivers and/or for example in a ring below the other drivers and/or below the OS and preferably also makes sure that it stays there, and/or for example at least part of the security system starts running even before the OS or below it, as explained in other applications by the present inventor. In addition preferably the system also allows the user for example to add programs to the startup list for example by simply dragging them onto the list. Another possible variation is that if the system enters the default User without password, preferably it enters a limited mode where for example it takes no commands from the keyboard or mouse and/or has other limitations, for example until the user for example comes back and enters some password. For example the system can enter immediately the state that it would be in if a screen saver was activated and a password is needed to resume operation with the keyboard or mouse. Another possible variation is that the user can for example request that the user selection screen will not be shown at all for example when returning from sleep mode and/or for example from any mode (including for example normal boot), so that for example every time the system comes back for example after sleep mode it will go directly into the desktop (for example of the last user that was working, if more than one user is defined), and/or for example into the user which is defined as default.
2. Preferably if the user uses for example write-once CD's (and/or for example DVDs) for backup and uses direct writing software, such as for example DirectCD, if the user copies the same file more than once onto the same CD (to the same directory), then preferably the backup software can automatically rename the old files for example with some automatically sequenced extension, so that the user can automatically keep and track also older versions this way. This is quite useful for version tracking and is better than simply overwriting the file, since in such CDs the old data cannot really be overwritten anyway. Of course, preferably the user has an option of turning this feature on or off, and/or for example can activate it retroactively for example for write-one CD's or DVD's in which it has not been used (in this case preferably the system automatically reconstructs the version sequencing according to the time and date each “deleted” previous version was saved). Another possible variation is to apply such automatic sequencing automatically for example also to other drives and/or directories that the user defines as back-up drives or directories and/or to other types of backup devices. Another possible variation is to enable by default (or for example to allow the user to request it) automatic backup of important files to the default backup directory and/or drive and/or device, so that for example each doc file (or for example program source file, or other for example office type of file) that has been created or changed and has not been updated for more than a certain time period (for example 1 day or a few hours or a few minutes), and/or more preferably for example after a certain threshold amount of change even if less time has elapsed (such as for example after every few words), is automatically backed-up on the default back-up media and/or for example on the hard disk (for example in a special backup directory or in the same directory but preferably with some extension to the name so that even if the user for example erases something important by mistake and then saves the file, preferably the backup with the missing part also exits), and/or for example the word processor or other application saves only a roll back log of the changes in order to save space, and/or for example browser bookmark files are back-up like this, etc. (The important types of files are preferably defined automatically by default and/or user-defined). This can be a great help for example for users who forget to make backups. After the media becomes full and/or for example shortly before that the system can for example report this to the user and prompt him/her for example to insert a new blank writeable CD (or other media), etc. (In case of backup on the hard disk preferably the older backups can be deleted automatically for example after a certain amount of time has elapsed and/or after there are for example too much space taken up). (In case of the bookmarks file for example, if for some reason the latest version has crashed or was damaged in anyway, preferably the system can automatically reconstruct the latest version for example by taking the last backed-up version and adding to it preferably automatically all the links that were visited from that time onwards, for example according to the browser's recent history list). Another possible variation is that for example normal CD creation programs which write a CD file image as a single transaction, such as for example CD Creator, preferably enable compressing files on the fly (for example as zip or other common compression formats). This is better than the to the prior art, where such compression is available only when the CD is accessed like a disk, for example through programs like “Direct CD”, which when there is a large number of files write to the CD significantly slower than for example programs like CD creator. Another possible variation is that the user can for example select files for backup according to a certain range of sizes (for example backup automatically all the files that are smaller than 1 megabytes or 10 megabytes, etc.) or for example define automatic backup rules for files according to their types (so that for example every new doc file is backed up automatically for example more frequently than less important files, etc.). Another preferable improvement is that like smaller pocket-sized CD's, preferably DVDs and/or similar larger capacity drives (such as for example blue-ray or High Definition DVDs) support also smaller pocket-size DVD's, preferably both as burn-able media and as ready pre-recorded media. Another possible variation is that instead of or in addition to selling high definition DVD movies as Mpeg2 files on Blue ray or HD DVD media, preferably the content suppliers make available high definition movies on normal DVD's (at least for example for the next few years until the blue ray and HD DVD drives and/or devices become cheaper and more prevalent)—preferably by using mpeg 4 (for example divx or xvid) or similar high-compression format, while preferably keeping the normal DVD menu system and anything else with the normal look and feel of DVDs. Similarly, preferably programs that convert from Mpeg2 to Mpeg4 or avi or divx or similar high compression formats preferably automatically keep also dvd menus at least as an option and/or at least keep automatically also the information that divides the stream into chapters, so that on playback the user can preferably instantly jump between chapters. In addition, if the user is normally working at a resolution below the maximum resolution available on the giver monitor and graphic card, preferably when playing high-definition movies or videos (from whatever source or method of compression), preferably, at least when the user is watching the movie at full-screen mode, preferably the player can automatically switch the display to a higher resolution (which is preferably the highest resolution supported by that monitor and graphics card, but preferably the user can define or pre-define what resolution to jump to in this mode, since the user might for example prefer to go in this mode to a resolution below the highest one available in order to have for example a higher refresh rate), and preferably when increasing the resolution the player preferably automatically scales for example its skins and menus (including preferably fonts, icons and anything else in the user interface, and preferably also for example the font size of the subtitles) to appear preferably the same size as in the lower resolution which the user normally works with, so that preferably everything seems the same size at the higher resolution except that the picture is sharper, with more details. (However, preferably the user can also change for example the size of the above mentioned elements and/or user interface and/or for example of the subtitles, preferably independently of the resolution, if for example he/she prefers them bigger or smaller in general). Another preferable variation is to improve DVD capacity even much more for example by using UV or extreme-UV lasers instead of red or blue. However, preferably the media for such DVDs are made sensitive to writing only at a strength and/or frequency which is sufficiently different from normal UV radiation from the Sun, so that for example exposure to the Sun will preferably not have a degrading effect on the media or at least only a small effect. Another possible variation is that for example when making backups onto multiple CD's or DVD's, for example with programs like Nero (multi-volume backups), preferably the backup system automatically tries to optimize the division of files between volumes in a way that takes into account file sizes, so that preferably there is no need to break large files between volumes (unless of course the file itself is too big to fit on one volume). Another problem for example with programs like Nero is that the user can only request a backup with file compression or without but cannot request that only some files be compressed and some not. So preferably this is improved so that for example the user can mark near each selected file or directory if to back it up compressed or not, and/or for example the backup system can automatically decide for example according to file type or extension or other characteristics if to compress a file or not (thus for example automatically avoiding compressing of files that cannot be compressed efficiently or are already compressed, such as for example mp3 files, mpeg files, avi files, zip files, etc.) and/or for example automatically compressing text files (for example doc files or program source files), unless for example the user explicitly requests not to compress them anyway. Another possible variation is that preferably DVD and/or CD drives and/or other devices that have a moving mechanical part when they are opened preferably have sensors that automatically detect for example if there is a mechanical obstacle, such as for example if a chair or other object does not allow the tray to fully come out, or for example if the CD or DVD has not been placed properly at the center of the tray and gets stuck when the tray starts to go in, and preferably when the senor or sensors detect such a problem preferably for example the engine that moves the tray preferably immediately stops and/or moves a little back in the other direction and/or for example the engine releases the tray in such cases and allows the user manually to push it in or pull it out without resistance, for thus for example making the drive behave temporarily like a cd or DVD drive in a laptop in which the tray is pushed in or out manually by the user. This is important since otherwise mechanical damage can be caused to the tray or to the media. Another possible variation is that preferably the CD and/or DVD drive has also at least one additional eject button, preferably for example at the left and/or top side of the front of the drive (or instead of the normal eject button on the right, but more preferably in addition to it), because many times the PC is in a tower case on the floor to the right of the user, and so in the prior art the user many times finds it less convenient to reach the eject button on the right and also usually has trouble seeing it when the drive is open, which causes many users to close the cd or DVD tray by pushing it (instead of pressing again the eject button), which is more dangerous. Another possible variation is that for example in interfaces that allow switching between internal hard disks without opening the computer box (for example by sliding a disk and out of a box that sits in an empty 5¼ inch slot), preferably the box contains a mechanical element which is automatically moved when the computer power is on—to a position that locks the disk in, and is moved back automatically when power is turned off into a position that allows removing and inserting a disk—in order to make sure that the user does not swap a disk while he computer is working. Another possible variation is that for example the mainboard is improved so that the user can indeed swap disks even without turning off the computer—for example by an automatic switch that can automatically temporarily turn off the power supply to the hard disk in a safe way. Another possible variation is that the user can switch between 2 or more disks for example by pressing or moving or rotating a preferably external preferably one or more electric switches on the outer side of the computer case, which preferably switches between them preferably through a hardware multiplexer, so that it preferably cannot be overridden by software, except that the user does not have to physically slide disks in or out. This is preferably done for example by creating computer cases which have the multiplexer built-in and preferably the hard disks sit in their normal places and the switch that operates the multiplexer preferably is connected electrically to the multiplexer and preferably protrudes for example at the front panel of the computer case, or for example in existing computer cases preferably the multiplexer and the switch can preferably be added for example by locating the multiplexer at the position of one of the possible externally accessible drives (so that for example the multiplexer can preferably occupy for example the space of a 5¼ drive or the space of a 3½ drive, but preferably it can use either of them for example by being the size of 3½ and coming with a removable frame that makes is also fit 5¼), and in this case the electrical switch is preferably at the front panel of the drive which the multiplexer occupies. In both cases preferably the set of 2 or more disks that the user want to switch are preferably all connected for example to SATA or IDE connectors on the multiplexer, and the multiplexer is preferably connected for example to a normal SATA or IDE connector on the mainboard or for example to both of them, so that preferably the user can even witch for example between disks of either type, in which case preferably the multiplexer connects SATA disks to the SATA connector and IDE disks to the IDE connector. Another possible variation us that the user can either switch only between disks of the same kind (for example all disks in the switch-able set have to be SATA or all of them have to be IDE). Another possible variation is that the mutiplexer connects only for example to a single SATA connector or only a single IDE connector on the mainboard an preferably has circuitry and/or DSP and/or processor which can convert SATA interface to IDE or vice versa so that the set of switchable disks can still contain multiple types of disks. Another possible variation is that the multiplexer is for example integrated on the mainboard, so that the disks that the user want to switch between are preferably connected to various for example SATA or IDA connectors on that multiplexer section of the mainboard. Of course similar configurations can be used also to switch for example between additional or different types of disks which might exist today or in the future. The multiplexer preferably works only on the data connector so that the each of the disks is preferably connected to the power even when switched off, or for example the multiplexor switches also the power between the disks—preferably in systems in which the switching is done when the computer is off. Another possible variation is that the disks are connected normally and all the switching can be done for example through the BIOS but there is preferably at least part of the BIOS which cannot be accessed through the OS or through software (so that preferably even in order to flash it preferably the user for example has to press a special switch that enables it, so that the OS or various software cannot override this switching), or for example through a program that preferably runs below the OS (such as for example the hypervisor for example in systems that are supported for example by Intel's by Vanderpool or for example the similar AMD technology), so that preferably the disks that are switched out become invisible to any OS's or other software running in that computer. Of course the hypervisor can preferably also segregate between virtual environments for example at the level of partitions and/or directories and/or even files or sub-files, (preferably based on saving only the changes separately), so that preferably one or more of these can me for example made accessible to only one of or some of the guest OSs, however segregating at the level of physical hard disks can involve even stronger hardware enforcement, for example by the hypervisor electronically activating such a hard-disks multiplexer when switching between Ross (at least in this case preferably the multiplexer works only on the data connector, so that preferably the all the switched disks are of course preferably fully powered and rotating all the time). Of course this can preferably be done also for example in a configuration in which one or more of the disks can be shared between the OSs. Another possible variation is that preferably through the hypervisor the user can define for example which physical disks are visible to which OS or OS's, so that preferably any OS or software installed on the computer can only access the hard disks through the hypervisor (preferably by enforcing this through the processor itself). This is much better than the prior art, in which the user can enable or disable disks through the BIOS but for example an OS like Windows Vista ignores these BIOS definitions and sees all the disks anyway. In addition, preferably if the multiplexer is used then preferably it connects to one or more connectors on the mainboard that enable booting, and if for example the solution with the hypervisor or the hidden BIOS part is used then preferably all the connectors can be made bootable, since otherwise the switching ability might be limited. Another possible variation is that preferably the bookmarks list automatically shows also near each bookmark for example the date it was entered, and/or for example the bookmarks are automatically grouped for example by days, for example with a different color for each group and/or some border marked between the groups, and then for example the date can appear once for the entire group instead of near each bookmark in the group. Another possible variation is that the user can for example tell the browser to automatically merge two or more bookmark files while keeping for example the date of visiting (and/or any other criteria) as the ordering factor. Preferably the user can also choose for example if the two (or more) bookmark files will be merged as is or for example duplicates (same urls that appear more than once) will be automatically deleted, and/or for example the user can activate a command that deletes duplicates from the current bookmarks regardless of how the duplicates were created. When deleting duplicate bookmarks deleted preferably for example the remaining entry can indicate for example more than one creation date, or for example the date of creating the first created of the duplicates of the same url becomes the date of creation and for example the latest visitation date of the duplicates become the last visitation date, or for example the last creation date is used, since this can mean for example that the user bookmarked the url more recently in another browser and thus might be more interested in it than earlier created bookmarks, and this is especially important for example if the bookmarks are sorted according to their creation date. Preferably the user can choose between these options for example in a menu. Another possible variation is that for example when merging bookmarks and/or when activating the “remove duplicate bookmarks” command the user can preferably choose for example between removing all duplicate urls or only duplicates which have also the exact same entry time (which is what happens for example if the user imports bookmarks back and forth for example between different browsers on the same computer or for example between two or more computers), which means that bookmarking the same url at different times is not considered a strict duplicate. This has the advantage that this way the merged bookmarks list can behave as if the different browsers are sharing the same bookmarks file (and in any normal browsing the user can for example bookmark the same url twice without the previous entry being deleted), but this way the bookmarks file does not multiply itself each time the user makes two-way merges. Another possible variation is that for example if the user uses two or more different browsers on the same computer (for example MSIE, Firefox and Opera), preferably the user can tell a browser for example to automatically regularly (for example once every hour or for example once very day or any other convenient time) merge new bookmarks from the bookmarks file of one or more of other browsers (preferably the browser can automatically find the location of the requested browser's bookmark file), and so the bookmarks remain synchronized as if the browsers are sharing the same bookmarks file. Another possible variation is that for example the user can indeed tell for example Opera to save its bookmarks in the active Firefox bookmarks file or vice versa (preferably in the appropriate format), so that they can indeed share the same physical bookmarks file, for example in the way that two different installed versions of Netscape can for example share the same bookmarks file, but that is less preferable since it is more safe to have two independent copies, and also by keeping its own bookmark file each browser is not limited by the limitations of the other browser. Another possible variation is that the user can for example define more than one email account in the same browser or email client and thus choose each time for example between the available sender accounts for example from an automatic menu that shows up when composing an email message (so that for example the user can use 2-4 different sender accounts for different activities) Another possible variation is that the user can request for example to sort the list of programs in the Add/Remove programs menu according to the date and time they were added, and preferably this date and time is automatically displayed near each program there. Although Windows XP allows to sort them according to time last used, this is much more useful. In addition, preferably the Add/Remove programs menu includes also information about the path and file name of the installation file from which the program was installed, and preferably for example the desktop search or the OS or some other application also automatically follows this file (for example according to some digital signature), so that if the file is for example moved to another directory the desktop search or OS or other application can still locate it, and/or for example the desktop search or the OS or some other application also for example monitors these files automatically and can for example report to the user if it was removed and copied for example to a cd or DVD and thus the user can at least for example know from the date in the log in which dvd or cd to look for the file if for example it was erased form the hard disk but needs to be reinstalled for some reason. Another possible variation is that for example programs that try to protect deleted files while there is sufficient space, such as for example Norton, and/or for example even the OS itself, preferably can keep for example in or near the entry of deleted files in the directory (or elsewhere—for example in a cumulative log that covers multiple files) the name of the application that deleted it or the user interface from which it was deleted and/or the time and date it was deleted. Another possible variation is that for example the word processor has special icons for various saving options, such as for example an icon for saving a copy of the file on CD and/or for example an icon for saving on diskette or for example other removable media (and preferably when clicking on such an icon the word processor preferably saves a copy of the file with the same name on the CD or other removable media and preferably also for example automatically saves at the same time also on the default directory hard disk in order to keep the synchronization between the hard disk and the backup), and/or for example an icon for “save as” (the normal icon is for saving under the same name), and/or for example an icon for “save with automatic increment”, as explained elsewhere in this application. Preferably when clicking for example after that on ˆS, preferably the file is automatically saved also on the back-up or backups. Another possible variation is that this does not change the behavior of ˆS or for example when clicking again on ˆS the user is asked if to save it also on the backup, or for example the user can toggle between these options for example by clicking on some icon or menu option.
3. Preferably the OS allows the user to access at least one CD-ROM drive (and/or dvd drive) even when the OS is started for example in “safe mode”, otherwise it can be very frustrating when the user might not be able to fix various things for example because he/she cannot fix anything from the installation CD while in safe mode. Another possible variation is that preferably at least as one of the options (but preferably by default) safe mode starts with the correct display driver loaded and so preferably uses the normal resolution and/or refresh rate which the user uses normally (for example unless the user explicitly requests otherwise or for example a specific problem with the display driver is automatically detected) and/or at least preferably uses by default a resolution of at least 75 Hz or more preferably at least 85 Hz and/or preferably at least a higher resolution than 640×480, since otherwise working in safe mode can be slow and painful to the eyes without justification. Another possible variation is that at least after the safe mode boots the user can preferably increase the refresh rate and/or the resolution while in safe mode, so that preferably it is lowered again only if there is for example a problem with the display driver which causes this mode not to work properly, but as explained above more preferably the safe mode boots like this by default, for example unless for example there is a problem with the display driver. Another possible variation is that preferably if for example the user for some reason still chooses to use safe more with a lower resolution than the normal resolution he/she uses in normal boots (or for example it becomes necessary for example due to a problem with the display driver), preferably any changes made in the arrangement of icons on the desktop are preferably automatically undone when the user returns to normal mode and/or at least the user is preferably at least automatically offered the opportunity to automatically restore the icons to their normal arrangement. Another possible variation is that for example any change in resolution that results in a changed arrangement of the icons is preferably automatically un-doable for example automatically upon return to the previous resolution and/or by offering this option to the user. Preferably this is done by saving automatically the relevant information about the arrangement of the icons on the desktop preferably separately automatically for each resolution, and if for example the users adds or removes a specific icon and/or installs or uninstalls the relevant application, preferably this can be taken into account for example after restoring the previously saved arrangement. Preferably the undo option is available anyway for any changes in the arrangement of the icons, preferably by saving automatically a rollback log of such changes, preferably by the OS (and/or preferably the user can also save various specific arrangements of the desktop as various snapshot points), as explained elsewhere in this application, which is preferably done independently of the various System Restore Checkpoints. In addition, if for example the OS becomes unstable or cannot complete a boot for example because of a problem with some driver, preferably the system is able to automatically remove and/or ignore and/or report to the user the driver that is causing the problem. Even if the problem for example crashed the computer completely so that the OS could not report anything, preferably during each boot the system for example keeps a log of all successful steps in the boot, and so even if a certain step causes a crash so that the system can't even report the problem, preferably in the next boot the system knows by the incomplete step in the log exactly where it crashed the last time and can preferably automatically complete the boot this time without the problematic step and preferably reports to the user exactly what the problem was and/or preferably automatically removes the problem and/or offers the user for example to chose among a few possible corrections to the problem so that the problem does not occur at all again after that. Another possible variation is that various data (such as for example the condition of the CPU, heat, various memory parameters and/or other parameters) are constantly kept at preferably small intervals, for example in one or more circular buffers, and preferably for example a special mark is added to the current position of the buffer after each new boot, so that if for example the system crashes for an unknown reason and resets (for example even while being unattended), the user and/or the OS can automatically know after the next boot what caused the crash. Another possible variation is that whenever the system crashes these parameters are automatically saved for example by some special application that preferably runs below the OS and can still perform this operation even if the OS is completely stuck. This application can for example also be responsible for an automatic reset if it senses that the system has indeed crashed or got stuck or for example if it senses that the CPU or some other element or device has become too hot or is otherwise dangerously malfunctioning (in which case preferably an automatic shutdown is activated instead of an automatic reset), and/or for example some special hardware element is responsible for that. Of course, various combinations of the above and other variations can also be used.
4. On the other hand, preferably the user can disable the Autorun feature that enables programs on CD's to start running automatically when the CD is inserted into the computer, preferably without having to disable for that the Auto insert notification for that drive, since this feature is very unsafe in terms of security. In the prior art the user can disable this in Windows only by disabling also the auto insert notification, which is not desirable, since disabling the auto insert notification can cause other problems.
5. Preferably the Windows OS allows executing files in DOS (CMD mode in Windows XP or NT) also by clicking on or near their name instead of having to type it. This is very important for example in Windows NT or XP, since, unlike for example Windows 98, the user has to type the whole name of the command instead of being able to type also instead only the 8 character DOS name of it. Since for example in Windows NT and XP the user can in DOS mode click on the mouse in order for example to mark a name for cut and paste, preferably the execute command is added for example to the menu of these available options. (Of course there are programs that can be used for example for automatic file completion, but this is another option that allows more flexibility and convenience to the user). Another possible variation is that preferably the log of screen output in DOS or CMD windows at least when the user is in the normal shell mode is preferably kept automatically in a log or buffer, so that for example the user can use for example a lever for example at the right of the DOS or CMD window which preferably allows the user to go back and see for example the previous lines that were scrolled out, preferably for example until a limit of a few thousands of lines (or any other reasonable limit, which can preferably be changed by the user), and/or for example until the beginning of the open session with that DOS or CMD window.
6. Preferably the OS itself and/or various relevant applications can display for certain activities approximately how much time it is going to take and/or for example the percent completed and/or the percent remaining—even if these are complex activities such as for example when scanning for viruses. Although many applications do give such information—these are typically applications that deal with a single file or a pre-specified list of files, whereas for example virus scanning programs do not, which can be aggravating to users, since such activities can typically take for example anywhere between 5-20 minutes. So preferably the relevant applications and/or the OS can automatically calculate for example the number of files and/or their cumulative size (preferably of course only for the relevant types of files that are to be scanned), and thus for example the application and/or the OS can display to the user an estimate of time and/or percent done and/or percent remaining. Preferably this is made available for example also to the application's programmer, for example as an OS function that can return for example the total number of files of a certain type and/or extension and/or their cumulative sizes, for example on the entire computer or for example on a given drive or directory (preferably automatically including all of its sub-directories). Another possible variation is that if the user for example aborts a virus scan and later wants to continue, the program can automatically continue from the last point reached. This can be done for example by saving the position in the directory structure and continuing automatically from there, preferably for example if the time since the last scan is no longer than a certain time (for example 1 hour or any other reasonable time gap), and for example if the time gap is bigger then preferably the program asks the user if he/she wants to continue from the same point or restart the scan.
7. Preferably commands such as for example “copy” are extended so that multiple destinations can be used, so that for example copy “bet*.doc 1: n:” will copy all the relevant files to all the destination drives/directories. Another possible improvement is that preferably when copying a large group of files (for example from one directory to another, for example in a DOS window or with the Windows explorer) the user also has an option of “No to all” if he is asked if to overwrite files with the same name. In the prior art the user has to answer this for each file that has the same name individually or can choose “yes to all” but there is no “no to all” option.
8. Preferably various Undo commands are applied also to various memory related commands where they do not yet exist, so that for example if the user works with an Internet browser and presses a “clear form” button, preferably the user can undo it for example by pressing control-z or for example pressing for example some undo button for example on the browser. Similarly, preferably the browser itself keeps in memory for example recent changes to various form fields in the same page and/or for example also on previous pages, so that for example jumping back to a previously filled field on the same page or for example also on previous pages will still allow the user for example to undo changes in that field, for example by pressing ˆz. Another problem is that for example browsers can remember various form fields in order to fill them automatically for the user, but for example Netscape and MSIE remember only according to searching for keywords in the simple text near the field and remember only the last value. Therefore anther possible variation is that preferably the browser (or other application) can remember preferably automatically more than one value for each field—for example the last N values, so that for example if the user is not satisfied with the automatically inserted value he/she can preferably for example use the mouse or arrows or other keys in order to scroll back to other previously filled values. (This scrolling back can preferably be activated for example for the current field or for example for the current section or for example for the entire form). Another possible variation is that the browser (or other application) can preferably remember preferably automatically also more complex structures, so that for example if a form contains a name filed or address or phone or other types of fields in multiple places (for example the form at https://strategis,ic,gc,ca/secure/cgi-bin/sc mrksv/cipo/patbrev-filing/patent,cgi, which contains such fields in different sections, for example “4.1 Applicant”, “7. Patent Agent or Associate Patent Agent” and “8. Canadian Representative”), so preferably if the user has previously used different values for example for the name and address etc. in the different sections, preferably the browser preferably remembers also the values per section, and if the user later uses again the same or a similar form preferably the browser suggests to the user the appropriate recently used values according to each the section. Another possible variation is that when the browser for example asks the user if to install some plug-in preferably the user can also, preferably as one of the options, tell the browser not to ask again about plug-ins of that type or general type. In addition, preferably, as explained also in Canadian applications 2,455,342 of Dec. 17, 2003 and 2,452,778 of Dec. 29, 2003 by the present inventor, preferably the HTML command set and/or for example the Javascript command set is improved, so that preferably it is possible to define for example which button (or buttons) will be activated by default for example if the user presses for example the Enter Key and/or for example the Space Key, and/or for example what action (if any) is to be performed when various keys are pressed. Preferably the keys can be linked for example to Javascript buttons for example by a definition in each button (however, if for example in more than one button the same key is defined as activating the button then preferably there are rules that define which button overrules), and/or for example additional commands are added (preferably within HTML tags that define directly various actions that can be performed and/or buttons that should be activated when a certain key is pressed). This is very important since for example in standard HTML forms there is a problem that pressing the Enter key for example when an input text line (or even for example a radio button or a checkbox button) is in focus can cause the form to be submitted. Sometimes this is undesirable (for example when the user is required to fill a form with multiple items), and in the prior art the only solution is adding various Javascript checks and issuing error messages for example if there are still empty fields. But if the user pressed enter for example after filling in a text line and did not intend to submit the form, such messages are aggravating. So preferably to prevent this, the above additional commands can be used for example to generally define for example that pressing the Enter key for example anywhere in the form (for example by adding the appropriate command within the “<form . . .” tag that appears at the beginning of the form or for example within the tag that defines the submit button) will have no effect or at least will not cause the form to be submitted, or for example this can be defined in specific fields (for example within the tag that defines the field).
9. Another problem with Internet browsers is that in some cases lines are truncated when printed, which can happen sometimes for example when forms or tables are used. In order to prevent this, preferably the browser and/or the OS and/or the printer driver (and/or of course for example any other software) preferably automatically check if this is about to happen (preferably by simulating the printed page into memory and checking the representation of the results) and, if so, this is preferably automatically prevented, for example by automatically converting to landscape mode, and/or by automatic additional line wrapping if possible (for example, if it does not damage a format of a table), and/or for example by automatically reducing the left and/or right page margins and/or by automatically reducing the font size (for example just in the horizontal dimension or both horizontally and vertically, in order to keep the aspect ratio), and/or for example informing the user about the problem and asking him to choose from a number of possible solutions (such as for example any of the above described solutions) and/or allowing the user for example to decide to truncate less important parts on the left of the pages (for example if the user is printing an article and the left column for example contains only links and/or advertisements and/or irrelevant images). Another possible variation is that the user can for example mark just part of the displayed HTML page (for example with the mouse)—for example just a specific column, and then use a command that prints only the marked area. Another possible variation is that the user does not even have to mark the entire area (which can be annoying for example if it is a long page) but can for example simply click for example on the relevant column (typically the middle column) and for example then print only the relevant column or columns till the end if he/she so desires (for example as one of the print options or for example by right clicking with the mouse on the column and choosing from a menu automatic marking of the column till its end and/or printing of only the column which was clicked upon till its end as one of the options, or for example using a control key or keys or clicking on an option or icon which automatically marks the column till the end). Another possible variation is that for example when the user prints for example a web page the browser for example automatically offers a number of possible printing options such as for example print the entire page or print for example just the main column or columns or the column which the user last clicked on, or the column which the mouse currently hovers on, etc. The browser can preferably automatically identify the main column or columns (for example by finding the largest consecutive sections that contain mainly text, and/or by checking for example first of all if the middle column is indeed the main one and/or offering it to the user as default and asking him/her to confirm, since that is usually the case). The Opera browser for example prints only the marked section in a web page if a section is marked but does not allow automatic marking or printing till the end of the column or choosing if to print just the marked section or all the page. Also, if the user for example searches for a word or word combination in the page it becomes marked when found and then when printing Opera prints only the marked word or words. So preferably this is improved so that text that was marked for example as a result of a search does not automatically cause the printing to be limited to just the search word or string since it is very unlikely that the user intended this (preferably the browser remembers how the word or words got marked and preferably also takes into account the number of words marked). And also, when printing only a marked section Opera does not print the url but only the page title, whereas as explained below preferably the url is also printed automatically of course, and also when printing only the marked section the Opera browser prints just text and ignores any formatting information, including for example html links (which are typically blue with underline), and so in the printed version only normal text appears instead of the link, so when reading the printed page the user is even not aware of the links that were in the page—which is clearly not properly printing the column (unless the user for example explicitly wants such a thing. Of course in the current prior art the user can for example mark an area in the page that is displayed by the Internet browser and then use copy and paste and print it for example from Word (when using cut & paste to copy web pages from most browsers—for example MSIE, Netscape and Firefox—the copy usually transfers of course also images and page formatting, including the links), but the above option allows the user preferably to do this in a faster and more convenient way, and also at least the url address is preferably automatically also printed, even if only part of the page has been marked and printed. Another possible variation is that for example at least the headline and/or logo and/or first few lines of the page are also printed automatically, for example with some mark that indicates the jump between that till the marked section, since this can give the user a better feel of identifying later the page from which the extract was printed. In addition preferably the user can also mark multiple sections is the same page, for example by pressing the shift or control key or some other key while marking with the mouse a new section, so that the previous marked section or sections remains also marked , and/or for example after marking a section (or for example even without marking one or more sections) preferably the user can for example “unmark” or unselect” one or more sections or images that he/she does not want printed, such as for example if there are one or more large images that are advertisements for example in the middle of the desired column or for example to the side of it. Preferably this is done for example by right clicking on the undesired image or images for example with the right mouse button and selecting from a menu an option to ignore it while printing (preferably this option is used for example if the user wants to print the entire page excepts for example one or more large images or advertisements), or for example after marking a section which includes the undesired image, holding for example the shift key or control key and then clicking with the mouse on one or more marked images, and thus unmarking them while leaving the rest of the desired area still marked. This is very important, since it can be very annoying for example if the user can mark a single column, which will print properly with all the normal images and links, etc, but cannot get rid of annoying large advertisement images which can for example waste a lot of ink on inkjet printers. Another possible variation is that for example at least by default the browser automatically unmarks images which are labeled as advertisements, so that they are preferably automatically not printed for example unless the user marks them explicitly for printing or changes this default. Recently (a long time after this feature was already included in prior applications of which this application is a CIP), Microsoft indeed added to the Beta of MSIE 7 the feature of printing only the marked area when there is a marked area, and without the loss of images or text formatting within the printed section, and including the URL. However, both Opera and MSIE for example enable only marking one consecutive section in the web page, and in MSIE this means for example that the user cannot get rid of undesired images—for example advertisements—within the section that the user wants to print. (Also, like Opera, MSIE does not ignore the marking of a few words due to searching for one or more words, as explained above, and thus will print just a few words in such a case). Another possible variation is that when the user requests to print for example a marked column and/or for example even when printing a whole web page the browser for example asks him/her if to print it with or without the images, but of course at least the links are preferably always printed properly as links even when printing without the images. In addition, preferably the user can tell the browser for example if to print the chosen column with the original width of the marked column or for example to automatically expend it to make better use of the width available, preferably without changing for example the original separation into paragraphs (preferably this automatic widening is the default, since otherwise it still wastes more pages and much of the advantage of printing only the marked column is gone) and/or for example it is printed at the best width and the user cannot change that. As explained above preferably apart from preferably automatically widening the column to fill the page, preferably all the other formatting such as for example marked links, text color, font type and size, etc. is kept as the original (or for example the user can choose differently for example when printing or by changing some parameters for example in the print menu). This means that preferably for example if the paragraph ends with <br> after every line then preferably these <br> controls are automatically removed or relocated and/or for example the browser identifies automatically the paragraphs (for example by finding an empty line between them and/or by finding other commands which can separate paragraphs) and preferably respects the paragraph separators but ignores other commands which are used for line breaks. Another possible variation is that for example when printing the browser asks the user for example if to print backgrounds of text which are non-white as they are or convert them automatically to white (and/or for example the user chooses this once as preferences and it stays like that until the user changes this). Another possible variation is that preferably if links are for example marked by blue or some other color without the normal underline (as is done for example in all the Wikipedia pages) or for example marked with an underline but an unconventional color, preferably by default the browser automatically adds the underlines (and/or for example corrects the color for example to the convention of blue for not yet visited links and purple for visited links) for example on the screen and/or when printing the page, and especially for example at least adds automatically the underline if the printer is a black and white printer, such a for example a non-color laser printer. In the prior art when printing for example Wikipedia pages the links don't even show in blue on color printers, so preferably the browser at least by default automatically disregards any commands which can cause this and/or simply automatically adds the color and/or underline to the links when printing, regardless of the commands which prevented it. Another possible variation is that the user can also request for example when printing to expand the links, which means that preferably the browser automatically adds near each link in the printout also the url (for example in brackets next to it). Another possible variation is that preferably the user can also apart from printing for example save the currently marked sections together in a file (preferably, like in the printing, including at least the title and the URL and preferably also the headline or headlines) or for example send them to a cumulative open file or window or tab where they are added cumulatively (in this case also preferably each such marked sect group of section is preferably automatically added with the title and url at the beginning of it. Another problem is that for example Opera and MSIE enable the user to save a web page in a way that saves also its images only if the user has opened the page itself and not if is saved by right clicking on the ink and requesting to save its target. So preferably this is improved so that for example when right-clicking on a link the user is offered for example one option to save the target including images and one without it or for example the images are automatically saved also in this case unless for example the user changes some general flag that enables or disables it. Similarly when clicking for example on a marked group of links as explained elsewhere in this application, preferably the same is done automatically for the entire group of marked links, and preferably they can be also saved either as multiple files or as one consecutive file (for example if the user wants to save chapters from an ebook which are each on a separate page into a single file, and/or for example also the normal save-as option in the browser's menu can either save on a new file or add to a cumulative file. Another possible variation is that the browser enables the user for example to normally click (or for example to right-click and choose from a menu) also on html addresses within the web page which are not links (i.e. appear as simple text) and thus open them for example in a new tab or new window. Opera for example enables this only if the user marks the link, so the above variation is better and faster. Another possible variation is that the browser also automatically shows such html addresses as normal links (as if they have been defined with the normal href tag) for example with the normal typically blue underline convention, or for example with a special color or other identifier that indicated that this was not officially defined as a link in the page. Another possible variation is that the user can for example mark any set of words in the text of the web page and then can for example right-click on it with the mouse and then preferably one of the options in the menu that appears is to open for example a new search tab with these words, wherein the default search engine's is preferably pre-defined by the user (for example http://google.com) and preferably stays like that as default until the user changes it again. (For this preferably the browser opens the search page with those words added after a “?” to the url of the search engine, however since the format of the query might be different for various search engines preferably the browser has in advance pre-defined information about the correct query format for accessing at least the most common search engines and/or can get automatic updates about that for example from the site of the developers of that browser. Another possible variation is that this data contains also information or templates for processing the search results from these engines and so preferably the user can also request the search from more than one search engine at the same time and thus the browser preferably does for the user the integration of the results like a meta-search engine. Another preferable improvement is that for example the browser or the printer driver shows the number of pages that will be printed before the user starts the actual printing. (For example the browser can show the logical division of pages if the Internet page will be printed or at least show the total number of printed pages at the bottom of the page display on the screen, or for example when the user presses Control-P, preferably the print dialogue window shows the projected number of pages that will be printed). In the prior art the user had to start the printing of normal html pages in the browser and wait till the first page has been printed in order to see on the first page how many pages will be printed from the displayed Internet page. In addition preferably the user can easily reduce or increase the size of the printed fonts, for example by a specific command when printing, or for example by reducing or increasing the size of the fonts on the screen so that this affects automatically also the printing. In the prior art for example in Netscape the user can reduce or increase the font size of web pages on the screen by pressing Control+ or Control−, but these changes have no effect on the printing of web pages, and also they affect only the fonts and not the images. Preferably this reducing or increasing of fonts can be also done for example for a specific web page and/or for a specific site instead of Globally, since for example in Netscape the changed size remains also when the user moves to other web pages (however preferably the browser remembers the changed size of the page or for the site for which it was made). Another possible variation is that the same command that reduces or increase the font size on the page (and/or another command) can cause also the images to automatically grow or shrink in addition to or instead of the fonts, and this preferably also affect also the printing (for increasing the image sizes, preferably the images are vector-based images, or for example the browser simply enlarges them eventhough the resolution remains the same, or for example the http protocol is improved so that images are automatically saved by web servers and/or by relevant web authoring tools in more than one size and for example the browser can automatically request the same image again with some parameter that tells the server to send it in a larger size and then the server automatically sends again the same image in a larger size. If the last variation is used then it means that preferably the web page designer includes an image of higher resolution and preferably the web authoring tool or the web server and/or the user's browser can automatically generate also the reduced resolution versions). Preferably when the user for example increases or reduces the size of a web page (preferably both fonts and images, as explained above) or for example Word (or other word processor) documents, preferably the browser (or other application) preferably automatically keeps the point that was at the cursor or at the center of the screen at the same position after the reduction or enlargement (and preferably similarly also for example if the user increases or reduces the line spacing or the font size or the margins or for example makes other changes which change the page size), so the current center of attention preferably remains more or less at the same place. (In case of web pages the cursor position is preferably determined for example by the position of the mouse, since usually the user keeps the mouse pointer at approximately the text area which he/she is currently reading, and/or for example the word that is currently at the center of the page is considered the current position and/or for example the position which the user last clicked on with the mouse is considered the current position (for example if the click has been within a certain time window from the time of enlarging or reducing the page), and/or for example if there is a central column then preferably the central column is automatically identified and the enlargement automatically preferably keeps the sideways center of the column at the same position sideways as the text expands to the right and to the left, and/or for example a sensor is used which tracks the user's eye movements) Another possible variation is that preferably the user can also for example activate a command which reduces or enlarges the fonts and/or images for example for all the open tabs at once instead of having to do it for each tab individually. Another possible variation is that the user can mark a section (or sections) of the page and then preferably these changes can affect for example only the marked section. Another problem is that unlike the printing of web pages, in which the browser adds the URL usually at the top or at the bottom of the page, when printing for example pdf files from the Internet, the pdf Acrobat reader does not add this info and so the user can later forget where he/she found the document. So preferably this is changed so that for example the pdf viewer preferably automatically adds this info also preferably on each page or at least on the first page of the printing. Another problem is that when saving web files both normal browsers and for example the pdf viewer do not include anywhere the url information. So preferably this is also improved so that preferably the browser and/or pdf viewer and/or other applications automatically add the url info for example at the beginning of the file (for example in the form of a comment or any other form which does not effect the way the file is displayed but can for example be automatically displayed for example by the browser, or for example pdf viewer in case of pdf files, when the file is later reopened locally, or for example it is automatically inserted as a visible text for example on each page or at least on the first page so that it can be viewed automatically when displayed by any editor or viewer). Another possible variation is that preferably any text that the user adds to a pdf file (for example in pdf files that are designed with fillable areas or for example with programs like for example Foxreader 1.3, which allow the user to add text anywhere even on an ordinary pdf file, preferably the user can save the version with the added text, for example as a file that contains both the original pdf data and the added text or for example the application saves the added text automatically separately on a file which preferably point to the original pdf file, thus saving a lot of space. Another possible variation is that the user can for example reduce the size of fonts and/or icons and/or images on the computer's desktop by a similar command that preferably affects the entire desktop (and/or for example a marked section in it) automatically, preferably by any desired factor, and preferably without having to restart the computer to see the change. Preferably this change is seen instantly, like when increasing or reducing for example the font size in the browser. Another possible variation is that preferably the user can for example use the corners of the box surrounding the text of desktop icons to charge the width and/or height of the box, so that the text of the icon name can be made for example wider and in less lines or vice versa and/or change the font size and/or type of this text (for example for the current icon or for a grouped of marked icons or globally for all the icons on the desktop), instead of the prior art where the use has no control about this. In addition, for example in Windows Vista there is a problem that if the text contains 2 or more words many times the OS automatically hides the end of the text when the user is not on the icon. This can be very annoying since many times for example the user might have more than one version of the same software installed and so the end of the text near the icon (which typically ends with the version number) is the most important for differentiating between them. So this is preferably improved so that the used can choose if to enable this truncation of text or not, and preferably by default it is not truncated (and also there is no need for this truncation, especially if the user can for example change the font size of this text), and if truncation is used then preferably the system automatically finds the differences between similar names and automatically hides only the identical parts (preferably except the beginning) and not the differentiating parts. Another possible variation is that for example if the text of an icon becomes too long preferably the OS can automatically for example reduce its size or for example only make it thinner without reducing its height, thus saving space with much less burden on the eyes. In addition, if for example increasing the size of fonts and/or of icons on the desktop and/or changing the screen resolution causes a problem that some icons no longer fit on the desktop, preferably this is automatically handled by creating vertical and/or horizontal scroll bars at the edge of the desktop, like in a normal directory window in which there items that don't fit in the Window. This way the user can for example drag items back in and/or resize the desktop in order to get rid of the scroll bars. Another possible variation is that in this case the system can automatically reduce spaces between icons and/or recommend to the user the maximum size that can be used without problems. In addition, the OS preferably supplies the user with an Undo command (and preferably also a Redo command) for example for changes in the desktop icon sizes and/or for moving icons (and/or for example also for other changes, such as for example removing or adding or changing the position of items that constantly appear near the taskbar, for example at the top or the side of the taskbar, etc.), and this undo is preferably also available for example when moving and/or resizing icons in a directory and/or in other windows. Preferably this undo is incremental, so that the user can preferably roll back for example till the start of the changes (Preferably this is accomplished by automatically saving the positions or the changes between the various configurations for example each time after the movement of one or more icon has been completed or for example after the user closes the window, which is less preferable). (In the prior art Windows undo is not available for resizing windows and/or changing positions of icons). This is much better than the prior art in which changing the font size and/or the resolution might cause icons to become invisible on the desktop or to crowd over each other. Preferably this undo and/or redo is available also if the user installs new applications (and preferably, like explained in other places in this application, the user can even do a redo that branches into more than one path if the user for example undo's some icon movement and then changes something and then activates the redo again), and preferably the user can also for example use a command with saves a snapshot of the desktop and can preferably also restore such a snapshot of the desktop preferably instantly (preferably without having to reboot the system—unlike when restoring for example from a system restore point). Preferably this is done in a smart way so that preferably if the user for example restores an earlier state of the desktop that does not include some newly added icons, preferably the system automatically adds the missing icons after restoring the previous state of the desktop. These icons are preferably restored according to the most recent positions in which they were, and/or they are marked in a special way at least when doing the restore so that the user can notice them, and move them to a different position if he/she so desires, and/or for example the user can also scroll back separately to previous positions of these new items. Another possible variation is that preferably the OS saves automatically information about the positions of the icons for each resolution and/or icon size, so that for example if the user tries a new resolution and/or enlarged icons and there is less place for the icons and the user has to move them or they are moved automatically and then changes his/her mind and returns to a higher resolution or smaller icon size, preferably the system can restore automatically the icons to their previous positions or at least asks the user if he/she wants to do this, and then for example newly installed icons are preferably dealt with as explained above. Similarly, preferably the user can also save and later restore for example various resolution settings (such as for example dpi settings, font size, icon size, etc., preferably as a group), and this can preferably be restored for example independently without losing installations of new programs that were done after this and preferably independently from saving the order of icons on the desktop. For this undo and or Redo preferably the OS (or other software) keeps automatically a rollback log of the changes and/or for example also various snapshots of the icon arrangements, at least once in a while (for example according to time periods and/or amount of change, in order to have additional backup for example in case the cumulative log gets corrupted). This is very important since for example in Windows XP it is very annoying that many things can cause multiple icons to suddenly jump into different positions, such as for example opening some side tools, activating an additional screen, changing the screen resolution, etc. Another possible variation is that preferably the user can for example set as wall papers not just still images but for example also animated gifs or video files (for example avi, mpeg, VBO, and/or other formats). Preferably without needing to install any specific software for this, and then preferably the OS (or some other application) can preferably automatically use this as an animated wallpaper on the desktop (for example a sea view like the popular Azul XP wall paper, except that for example the waves really move and/or for example the palm trees sway a little in the wind or ships move around. Another possible variation is that this preferably moving scenery (or a stationary scenery) contains 3d depth information (for example by being photographed in advance by stereo cameras) and preferably the user can choose for example to move into 3d desktop or back and forth between 2d and 3d, and in the 3d mode preferably the user can for example move icons into various depths of the wallpaper, so that for example icons that are moved to far way (deeper) portions of the scenery (for example an island or mountain in the depth of the scenery) become smaller, and preferably the user can also zoom into various section of the 3d view and thus see them more clearly. Of course this can work even better when stereo view displays become more popular. Another possible variation is that if a web page for example contains multiple links to images which show for example just an image, preferably instead of pressing each time a link in order to view just one image and then return to the main article, preferably the user can for example press some key in the browser which automatically expands all the images in the text and thus preferably integrates them into the text as if instead of href links they were “IMG src” commands (or for example at least in a marked section of the page), for example for viewing on the screen and/or for example in a way that automatically affects the printing of the page. Another possible variation is that for example the browser enables the user to dynamically change various elements in the outline of displayed web pages (preferably without needing any change or cooperation from the web server), for example by a drag of the mouse, so that for example the user can move various icons or images to various places on the page and/or for example change their size (for example only of a specific image) and/or change font type and/or arrangement (so that for example a column becomes wider or narrower, etc.) and/or for example add content from other web pages, including for example dynamic content, such as for example streaming video boxes or RSS feeds, and preferably the browser can remember this automatically also the next time the user enters that page. Preferably the browser accomplishes this for example by making automatically a few corrections in the html code accordingly each time after fetching the page to the user's local computer and/or for example associating some transformation command over the existing html code, and preferably the user can also undo the last change or series of such changes for example with ˆz. Another possible variation is that for example the user can tell the browser to automatically reverse the text in pages with negative text to positive (i.e. cases where the background is more dark than the color of the text fonts, which is much harder on the eye and can be every annoying, and in this case preferably the inversion can be done for example by automatically switching the color between the text and its background or for example choosing automatically from one or more typical most common or convenient text color-background color pairs. Another possible variation is that the user can tell the browser for example to automatically adjust the size of too small text, so that for example any text that is below a certain font size is (for example the equivalent of a font size of 10 or 11 or less in a word processor) is preferably automatically increased by the browser to the minimum specified size by the user (for example size 13), and preferably in this case the text is increased automatically without automatically increasing also the near images, but preferably for example adjacent headlines are preferably also automatically increased by the same ratio in order to preserve the proportions. Another possible variation is that the user can preferably for example tell the browser to automatically fit for example the size of web pages to the screen so that for example web pages that do not take advantage of the full available space are preferably automatically increased (in this case preferably the text together with the images), and/or for example if the font is already big enough (as determined for example by being of a certain threshold size or larger, which can preferably also be changed by the user) for example paragraphs can be automatically reformatted to take better advantage of the wider space, and/or for example web pages that contain for example a horizontal scroll bar (for example because of containing a table) can preferably automatically be reduced in size and/or for example at least the browser automatically makes the fonts for example in the relevant table areas preferably automatically at least thinner. Preferably the user can specify independently if he/she wants pages to be increased in size automatically and if he/she wants pages with a horizontal scroll bar reduced automatically. Another possible variations is that preferably the OS or the firewall or security system or some other application preferably also prevents programs or drivers from changing or switching for example between icons for example on the desktop or on the quick launch line without user permission, since if icons are switched for example by a virus or worm or trojan or other malicious application (even without changing the linking of file types to applications that run when the user clicks on them) then the user can be misled to activate the wrong program while intending to activate another program (and if the user has for example allowed this by mistake, preferably the above described undo can also fix that, preferably without having to launch for example system restore). Another possible variation is that the system or for example the security system can for example display automatically for example upon request a list of which applications are the default opener currently associated with each type of file, and preferably the user can also edit this table in order to correct or change associations. Another possible variation is that the OS for example enables the user to easily edit the options that are shown when the send-to menu option is chosen, such as for example removing or adding items to it. Another problem in the prior art (for example in Windows XP) is that reducing the resolution and/or increasing the system font size can cause the window that asks if to keep the new resolution to appear outside of the desktop (i.e. become invisible) and/or cause the text in various system message windows to appear truncated. This is preferably automatically prevented, and for this preferably the system automatically calculates the new size and ratios and thus makes sure that all the message windows appear in a visible area and that the text size in them fits the message window, and if not then preferably the message window's size is automatically adjusted as needed and/or the font size in the message window is automatically reduced as needed and/or for example scroll bars are added to it as needed. Although Microsoft recently announced that the new Longhorn version of Windows will contain smooth scaling (a feature which exists already in Macintosh OS X), there is no indication that the above described features regarding the desktop will be included, and the smooth scaling is apparently relevant mainly to flicker free animation and to DPI scaling or window scaling instead of only window resizing, i.e. the ability to automatically change the size of text and images through the graphics card, so the some of the above described features will be easier to implement (but without the above features, changing for example the scaling of the desktop can lead to exactly the problems that some of the above features are intended to solve). Also, preferably the ability so increase or decrease for example the size of the text and/or of the images and/or icons for example in web pages or in other windows as described above is preferably independent of the size of the window, since scaling the size of the text and images automatically by the window size is more relevant for special animation effects involving the windows (such as for example juggling or rotating windows around the screen), but when the user wants to work on the window typically he/she would want to be able to choose the most desirable size of fonts and/or images regardless of the size of the window (This means that for these purposes the resizing is preferably done by reformatting the page, like in the above described Netscape feature, and not by some purely graphic effect performed by the graphics card). Another possible variation is that for example if the user changes the screen resolution, the fonts and/or icons on the desktop and/or in other places or applications (which means of course also for example menus, the taskbar, and/or anything else in the user interface, preferably the entire user interface) by default remain more or less the same size (unless for example the user explicitly requests to change them, which can preferably be done independently of any change in screen resolution), preferably by using for example the smooth scaling to automatically correct for the changes caused by the changed resolution, so that if the user increases the resolution, the fonts and/or icons and/or images (and/or anything else in the user interface) can be automatically increased in size to compensate for this and if the user decreases the resolution the fonts and/or icons and/or images can be automatically reduced in size to compensate for this. So if the user for example switches from a resolution of 1024×768 to a resolution of 1280×1024, the fonts and/or icons are preferably automatically increased in size by the appropriate factor (in this example preferably they are increased in width by 25% and increased by height by 33%, and/or the aspect ratio is maintained by default so that the width and height are for example both increased by the higher value or by the lower value or for example by some average value. This means that preferably for example even the mouse's movements are automatically compensated accordingly, so that for example if the resolution for increases and so the number of pixels the mouse has to travel is larger, preferably the speed of the mouse's movement remains the same, so that the same distance of mouse travel on the desk is still needed for traveling for example from one edge of the screen to the other edge (preferably unless the user changes this explicitly, which is preferably again independent of the resolution). Even if for example for any reason the OS still needs for example a reboot in order to apply these changes throughout the system, then preferably while the user is changing for example the resolution for example to a higher resolution (which according to the above should preferably actually mean only that the text and images become sharper and/or with more derail, but the user interface does not become automatically smaller) or the user is changing the size of the user interface independently of the resolution (which means that for example preferably everything in the user interface or at least the main elements in the user interface grow or shrink (for example except some automatic adjustments, such as the taskbar for example always automatically filling the full width of the screen, etc.), preferably the OS automatically displays to the user these changes in real time as a preview, so that preferably the user can for example move one lever for example left or right and see preferably a smoothly changing preview of the effects of changing the resolution as he/she is moving the lever, and preferably similarly moving for example a separate lever which changes the user interface size is preferably accompanied by a preferably smooth preview of the changed size of the user interface (for example the size of the icons on the desktop and the area occupied by them, the size of the taskbar, menus, fonts, etc). This preview is preferably done at least by emulation, so that the OS preferably displays it at least while the user is for example moving the lever. Another problem is that for example icons that have not been designed for higher resolution might appear a little zigzaggy at the higher resolution, So this is preferably solved so that if for example the new resolution is for example close to twice the original resolution then preferably each pixel is automatically duplicated, and if the ratio is not a direct multiple, then preferably for example the missing pixels are interpolated heuristically, for example by using different colors and/or brightness and/or contrast and/or saturation for the added pixels, for example in a way similar to the way that the resolution of fonts is increased in the Cleartype method. Another possible variation is to use for example similar automatic interpolation when increasing images in web pages—especially for example in cases of diagonal lines and/or graphic bitmap images of fonts (since in this type of images the zigzags upon enlarging are much more conspicuous than for example when enlarging photos), so preferably diagonal lines and/or graphic images of fonts and/or the zigzags themselves (for example compared to the situation before the enlargement) are preferably automatically detected (for example by any known OCR methods) and are preferably automatically corrected as explained above. Another possible variation is that for example such graphic letters and/or images are preferably automatically converted by the browser for example to preferably high-resolution vectors before the enlarging, for example based on various heuristics. Another possible variation is that the user can for example increase or reduce the size of the icons and/or of their text by zooming in or out on the desktop itself for example by pressing control and moving the mouse wheel, in a way similar to increasing or reducing for example the text and images in web pages (so that preferably for example if there is not sufficient room for example the gaps between the icons are automatically reduced or for example, as explained elsewhere is this application, a scroll bar is added when needed for example sideways and/or up-down so that the user can reach also icons which become out of the screen and can move them back manually). If for example the default is the average, this has the advantage that by default the minimum change in icon shapes will be perceived. However since, as explained above, the desktop preferably remains the same size, preferably by default at least the distances between the icons are corrected in each direction by its appropriate ratio of change, i.e. in the above example preferably 25% in width and 33% in height, with or without similar change in the aspect ratio of the icon. Preferably the user can choose among these options). Of course various combinations of the above and other variations can also be used. Another possible variation is that if the user for example wants to copy more than one application at the same time for example from the “all programs” pop-up list which is activated through the Start button, for example to the desktop, then preferably he/she can mark more than one item at a time (for example by dragging the mouse to darken a group of them and/or for example by marking a group with CTRL or Shift pressed) and/or the list remains open even after dragging an item (unlike the prior art, where immediately after dragging the first item to the desktop the list disappears and has to be opened again from the Start button, unlike for example a window created through Explore). Another possible variation is that preferably the user can drag a shortcut also for example from normal open applications on the taskbar (for example by dragging the square on the taskbar that represents the application) and/or for example by dragging something for example from the top and/or other parts of an open window (for example by clicking on the right mouse button, for example onto the desktop), and/or for example from the file name as it appears in a DOS or cmd window. If for example the desktop is not visible due to full open windows, preferably the user can for example hover the dragged item near or over for example the “show desktop” icon and then preferably the desktop shows and lets the user take the item to wherever he/she wants and preferably after dropping the item there the windows preferably automatically return to the state they were in before the dragging of the item. Another possible variation is that the user can for example drag for example onto the desktop also menu items within the user interface (for example within the options in the menus of the taskbar or within the menus that show when the user clicks on the Start button, so that the dragged menu option becomes a separate icon on the desktop that can then be activated directly from the desktop, and in this case preferably the icon becomes automatically for example with the shape and text of the menu option that was dragged there and of course the user can preferably change the icon and/or the text to whatever he/se wants. So for example the user can preferably drag to the desktop this way for example the Screen Saver (from the Display Properties menu), the “Create a Restore Point” (From MSCONFIG −> Launch System Restore menu), Another possible variation is that for exampling when going over programs or program folders within the Start menu (for example after choosing “All Programs”) preferably the user can also mark multiple programs and drag them together to the desktop (for example when reaching the Office folder in the “All Programs” menu), Device Manager, Task manager, etc. Another possible variation is that for example in Windows Vista the internal search of the Start menu and/or for example the general desktop search (for example the Google desktop search) can preferably also search for example within menu options of at least the OS's user interface (for example by automatically following the available menu options after the user goes through them at least one time or by indexing it directly for example from one or more elements in the user interface files), so that if the user for example searches for the words “create restore point” or “restore point” the system can preferably automatically display the menu option of creating a restore point eventhough it is an option within the system restore, and for example if the user types “device manager” preferably that menu option is automatically shown. Another possible variation is that preferably various applications or at least one or more of the more complex ones—such as for example Word, preferably enable the user for example also to search for various functions in a search menu instead of having to find them in various pull-down menus or in the new ribbon of office 12 (later renamed Office 2007), so that for example preferably the top of the word processor window contains a search window for entering a word or words which the user searches for in the user interface, so that for example if the user types the word footnotes preferably an automatic menu shows up with commands related to footnotes (for example in a pull-down menu or for example in the ribbon) or for example if the user types the word translate or dictionary for example the menu items related to the dictionary automatically become visible and/or for example the dictionary window is automatically opened, or for example typing the word paragraph in the menu search box will display a menu of all the commands that are related to paragraphs or for example have the word paragraph as part of the menu option, and/or for example typing the search word can automatically select the most appropriate option within the ribbon (or other menu system) as if the user reached it in the normal way, or for example typing the word “ruler” will automatically enable the user to add the normal ruler on the top of the page with the slide-able triangles which users are used to in previous versions of word but does not show by default in Word 2007. Preferably when the menu is shown the searched-for option is also pre-selected, so that for example simply hitting the Enter key can choose the option (however the user of course preferably can also click on it with the mouse). Another possible variation is that for example any typing by the user on the area of the top menus or on the ribbon achieves this result without having to type directly within the search box or even without a search box. Preferably the above search works instantly like the Google desktop search so that the response is instantaneous as the user types characters, without having to press Enter at the end. In addition, preferably when clicking again on the internal search window (after doing something else) or for example on the normal desktop search window, or for example on the search window within the start menu, preferably before the user types the first character preferably the search engine preferably instantly displays as default the results of the last search that was conducted, and only then it is preferably changed or removed if the user starts typing an character that is incompatible with the previous results. Another possible variation is that if the user decides to enter the “Help” file, the commands that he/she finds there are also clickable and preferably when clicked upon bring the user directly to the correct menu option or for example ribbon configuration as it would look if the user had reached it the normal way through the menus or through the tab handles of the ribbon. Another possible variation is that preferably the word processor can use also for example the descriptions in the help file related to each command for adding them automatically to the above described searchable command/menu options index, so that the user can find a command or menu option also if he/she does not remember its name but only for example something which describes it. In addition, preferably the internal command search uses also the thesaurus, since the user mighty for example use some different wording than the actual name or description of the searched command. Another possible variation is that for example the desktop search (such as for example the Google desktop search) can automatically for example follow the menu items for example in the ribbon or pull down menus (for example by letting the user define the relevant screen area or more preferably by following though heuristics the relevant typically squared areas on top of the screen) and generate for example automatically an index for finding these commands, but this is much less preferable since it is much more reliable and powerful to build this from inside the application. Another problem for example with Word 2007 is that it forces the users to work only with the new interface without an ability to go back to the old interface, which means that for some things which the user knows instantly how to access on previous versions (for example Word 2000 or Word 2003) the user might have to spend a long time to learn how to reach them in the new ribbon interface, which can be annoying and frustrating even with the above internal commands/menu search variation (since the user still has to type the search string instead of clicking directly on something which he could do instantly in the old interface and the user still has to remember the new way to reach it even if the search result also includes automatically configuring the ribbon to the same state it would be if the user choose it through the appropriate tab handle /or submenu option, as explained above). So preferably another improvement is that preferably, at least as an option, the user can choose for example to have the old menu available at the top of the page in addition to the ribbon (and/or for example to temporarily hide the ribbon in this case, to save even more space), which is very easy since at the top above the ribbon there is sufficient room to add the normal classic menu of File, Edit, View, etc, with the normal pull-down menus (which are preferably updated to include also the new features of Word 2007). Another possible variation is that if the user for example prefers to use the above menus without hiding the ribbon, preferably for example when choosing anything on the top menus or with pull-down menus, preferably the ribbon automatically, preferably instantly, changes also to the appropriate configuration, so that the user can also instantly see how to reach the same command through the ribbon tab-handles and sub-menus. For this preferably the Word processor has, preferably for example in the same index used for the above described internal command search feature, also for example a link for each entry to the menu steps needed in order to reach it for example through the ribbon, so that after reaching the command (for example either through the old classic menu system or through the instant search) the system can preferably instantly show also the correct ribbon/menu configuration for reaching it. Of course, the above described internal command search and/or for example the desktop search or for example the search within the start menu can preferably also be activated by voice commands, and preferably the system knows to which type of search the voice command refers for example by looking at where the mouse is currently hovering, or by the user adding for example a selector keyword at the beginning of the voice command. Preferably in case of voice commands or when typing the search string in the internal command search preferably the user does not have to go through the normal menus but can preferably access any menu option directly, but if there are more than one likely result then preferably all the relevant results are automatically shown for example listed one below the other, preferably with some context identification so that the user can understand what each command is, and the user can preferably move with the errors and choose any command, in a way similar to choosing applications for example in the results of the Google desktop search. (However as explained above, preferably in addition to this list, the most likely top result or the result chosen by the user is preferably also indicated automatically in the ribbon or menu system configuration so that the user can also see how to reach it the normal way). Another possible variation is that preferably the user can for example copy any item from the ribbon or preferably from any other menu option for example to the area above the ribbon so that for example the commands which the user uses most frequently become available for instant direct clicking, and/or for example the word processor can do it automatically for the user by identifying the commands which he/she most frequently uses in general or for example in the last N minutes or the last N commands (where N is any a reasonable periods or a reasonable number of commands). If for example the word processor also enables tabs as an alternative to opening additional windows, then preferably the tabs handled of these tabs are above the tab handles of the ribbon. But preferably below any to-level menu if for example the user request to enable also the classic to menus, as explained above. Another problem is that the ribbon increases the control area at the top of the page at the expense of the visible area of the document, which can be inconvenient for example to uses of Word 200 or 2003 who are used to and prefer to have a bigger visible text window. So preferably this is improved for example by enabling the user for example to drag upwards the border at the bottom of the ribbon (and/or for example borders above the ribbon, but preferably dragging the bottom of the ribbon is sufficient to affect also items above the ribbon), which preferably causes the height of the ribbon and/or of the parts that are above it to shrink in height automatically preferably proportionally but preferably in a smart manner, so that for example the ribbon tab handles can preferably become shorter by reducing unnecessary spaces below and above the tab handle names preferably without the letters themselves shrinking in height, and/or for example similarly the top header line which contains the file name can preferably shrink in height similarly preferably without the letters themselves shrinking in height, and/or for example similar principles can be used for shrinking the height of the ribbon itself, and/or this automatic shrinking is for example done by default by the word processor (and/or the user can pull the bottom border of the ribbon and/or other borders for example above it down if so desired). Another possible variation is that for example clicking on various links in the relevant help file can also automatically display the relevant menus for example in the word processor and make the user jump do that option. Another problem is that for example the Opera browser enables the user to mark a text (or for example use ˆA to mark the entire web page) and then right-click on it with the mouse and choose “speak” to hear the text through synthesized voice. However this is still not useful enough for example for people who are visually impaired because they might have a problem with choosing the speak option or clicking on the text. So preferably this is improved so that this works preferably in combination with voice commands, and for example when “speaking” the text preferably the browser states when it is a link and lest the user for example to request going into the currently spoken or the last mentioned link or to request for example “Go to previous link” or “Go to previous kinks” and then preferably the browser for example reads only the text of the previous links and asks the user through voice communication which one of them to go to. Another problem is that both the Microsoft desktop search and the Google desktop search ignore for example file extensions when the user is searching for something. So preferably this is improved so that if the user for example types also the file extension for example after a dot or separated from a string within the file name for example by a space or spaces or by wildcards (for example the user types in the search box “*epiph*.avi” or “epiph*avi” or “epiph avi”), preferably files that contain the word in their name and also contain the desired extension are displayed in the results before files that don't have that extension, or for example files without that extension are not displayed, but the first variation is better because the user might make a mistake in the extension, so preferably he/she can see it the following results. Also, preferably files that contain the desired string closer to the beginning of the file name are preferably displayed before files that contain it at the middle or end of the name, but preferably, as explained above, files with the desired extension preferably appear earlier. (Preferably the user can this way for example also look for all the video files of one or more types, etc.). Another possible variation is that for example the desktop search can monitor which application or applications the user is currently using and take this into account as context for the search, so that for example if the user has just opened for example the PowerDVD program (especially for example if the user has an open browse window in that application) and then goes to the desktop search preferably the desktop search shows first results that are related to video files even if the user did not indicate it, since it is most likely that the user will be looking for such files in this case. Another possible variation is that for example the application itself (for example PowerDVD) can preferably interface with the desktop search for example though a standard common interface and for example look automatically for all the files of certain types and thus add them for example automatically to an automatically generated play list or for example open an internal search box which searches for example only for video files and preferably gives instant results as the user types the letters, but preferably gets its results from the indexes generated by the desktop search, preferably by communicating directly with the desktop search application. Another possible variation is that preferably the user can also use for example regular expressions in the search string ion the desktop search. Similarly preferably including for example “/” signs before and/or after and/or within the string preferably indicate searching for directories so that preferably the desktop search shows at higher positions results which fit the desired path. Similarly, if the user for example wants to uninstall more than one program at the same time (for example in the control panel), preferably the user can mark multiple programs (for example with the convention of shift or control pressed while selecting items) and then preferably all the marked programs are uninstalled automatically (preferably one after the other). Another problem is that for example in Windows XP if there is some problem restoring the system to an earlier state then the system merely states that the system cannot be restored to the requested restore point but does not give any additional data. So preferably his is improved so that in such cases the system also displays preferably the exact problem or problems that prevented the restore and preferably also offers the user various solutions, such as or example fixing the problematic element from a different restore point, which is preferably recommended automatically by the system, and/or for example the system can preferably check automatically if the same problem exists in other near restore points and can then for example recommend to the user the closest next restore point or points which can be used without the problem. Another possible variation is that if the user for example requests to restore the system to a specific restore point and the changes his/her mind even after the restore process has already started, preferably he/she can press some abort key or for example click on some abort icon or menu option, which preferably causes the system to instantly stop the restore process and copy back the relevant system files from the copy of their state before the restore operation was started, and preferably without any reboot. This is much better than the prior art, in which the user would have to wait until the entire restore has completed, which includes also a reboot in the process, and the user could only then undo it or request a different restore point. Another possible variation is that preferably the system enables the user for example to correct or add to the description of restore points which were already created—for example if the user discovers later that he/she made some error in the description or forgot to add something.
10. Another problem is that for example in MS Word (all versions) if the user is within the header field and clicks on some position on the normal text of the document the user cannot continue to work on the position he/she clicked on in the normal text unless he/she clicks again or clicks on the close button, and when then the user is returned to the previous position where the cursor was before entering the header and not to the position which the user clicked upon, and similarly the same occurs when the user tries to enter the header field after working on the normal text of the document (so actually the user has to click THREE times in order to get where he/she wants in the other field, which is very inconsistent with the normal experience of simply clicking anywhere the user wants to go in the document. So preferably this is improved so that a single click can let the user jump between the header and normal text or vice versa, and preferably directly to the position on which he/she clicked (preferably of course when the user is in the header, the header indeed becomes more alive and the normal text more gray to indicate that it is a different field, as is done in the prior art, but that the hassle of having to click 3 times in order to get anywhere when moving between these fields is preferably avoided by the above improvement. Similarly, for example in Word 2007 it appears very inefficient that the user has to click on the menu tab handles above the ribbon in order to see the related items on the ribbon instead of being able to simply hover over it with the mouse. So preferably this is improved so that merely hovering with the mouse over the tab handle automatically shows the related items on the ribbon without actually having to click on the handle, and preferably this is done instantly, without for example having to wait for example 2 seconds over the first tab handle or having to click on one of the tab handles in order to get started in this mode (and/or for example the user can choose if it will work based on hover or he/she needs to click on the tab handle) Preferably the related items that belong to the tab handle over which the user hovers remain visible as long as the user does not hover over another tab handle, and this means that after the related items appear on the ribbon, if the user wants to click on one of these items on the ribbon the user preferably has to move the mouse through then bottom of the current handle and thus enter the ribbon and start moving over it to the desired item. (Although in the 2^{nd} Technical Refresh of Word 2007 of Mar. 13 2006 Microsoft added the ability to use the mouse wheel in order to scroll through the tabs handles, this is much less efficient since it is harder to stop exactly on the tab handle which the user might have in mind. In addition this is problematic because the scrolling ends when the user reaches one of the two ends, so the user has to change direction each time. So preferably this is improved so that the scrolling becomes cyclical, so that after the last tab is reached on the right preferably the next tab is again at the extreme left tab, and vice versa when reaching the extreme left tab handle when going in the other direction). Another problem is clear lack of consistency in various items within the ribbon itself, so that for example in some of them hovering over them will show a direct temporary effect on the current paragraph and on others the user has to click. For example when hovering over the style samples the preview works but when hovering over the 4 alignment icons (The vertical stripes that represent Align left, align right, align center, or align both ways) nothing happened and the user has to click on them. So this is preferably improved so that the same rules apply for example for all the features or at least all the similar features (for example all the changes that can instantly be displayed visually, such as for example changing the alignment), and preferably all the visible effects due to hovering on some option become available instantly. In addition, preferably the explanation bubbles which appear when the user hovers over some menu options preferably appear instantly and not after 2 seconds and/or at least the user can preferably easily change these time definitions. Similarly, preferably any submenus are opened automatically when hovering with the mouse over the options that open them instead of having to click on them (and preferably this is done instantly without having to wait 2 seconds), so that for example when hovering for example over the “Change style” option in the ribbon that associated with the “Write” tab handle, preferably the submenu of the options appears preferably immediately without having to click on it for the submenu to show, preferably together with the explanation bubble, which preferably becomes integrated for example at the top of the sub-menu that opens, and for example hovering over the “Switch windows” option within the ribbon associated with the “View” tab handle preferably immediately shows the menu of open Word windows, or for example hovering over the “Columns” option in the ribbon associated with “Page layout” preferably shows immediately the pull-down menu that open, instead of having to click on it in order to see the submenu, and then for example hovering over options in this submenu preferably instantly shows their effect preferably on the section with is currently visible on the screen, and for example hovering over the option of “Chart” or “Table” in the ribbon associated with the “Insert” tab handle preferably instantly temporarily adds a preferably small chart or table at the current cursor position as a preview, and at the same time preferably also shows the submenu of available table or charts, and then preferably hovering over any of them (for example in the “Quick Tables” sub-menu) preferably instantly changes the preview table or chart into that option, and since this is just a preview, of course when moving to another option on the ribbon the temporary preview table or chart is preferably automatically removed if the user hasn't actually chosen anything by clicking on it. Another problem is that for example when clicking in Word 2007 on the “WordArt” option and thus creating for example 3d colorful fonts with shadows on the marked section, these special fonts become an image and are not further editable directly at text, so that in order to further make changes in this text the user has to right-click on the image and enter a special window that enables the user to edit this text, which is inconsistent with normal editing regardless of font shape or size or color. So preferably this is improved so that the cursor can be moved to any position within this text by normally clicking on it an then preferably the user can edit this text normally in place like any other text (such as for example deleting or adding characters at the position the cursor is on. (This is preferably done by creating instead of a joint image for the entire marked text, a separate image for each character (or for example 2-3 characters if the shadow for example effects also for example the next 1 or 2 character on the right), and preferably updating only the affected characters on the fly as the user types, so that the other characters after that are merely shifted in position and do not have to be redrawn. And preferably, like the above examples, preferably the available styles of the “WordArt” option on the ribbon are preferably shown instantly when the user hovers with the mouse over this option, and then preferably hovering over any of the actual styles in there is preferably instantly shown as a preview over the currently marked section of the document (if no section is marked then preferably for example only the current word or line is affected). Similarly preferably for example when hovering over the various watermarks available preferably a preview of the watermark on the viewable text is preferably instantly shown without having to click on it, and in addition preferably the user can also choose for example the color of the watermark. Similarly, preferably for example hovering over the Italic or boldface or underline icon preferably automatically shows a preview of that style for example on the current marked section or for example on the current word or current paragraph, etc. Another possible variation is that for example if no specific section is marked then preferably all or most of the preview effects the entire section that is currently visible on the screen (preferably until the new formatting fills the screen—for example if the fonts become bigger). Another problem is that since the ribbon can change fast and there are many submenu options, the user might at first forget how he/she reached some options that he/she already found. So preferably the user can for example click on an icon or top menu option which opens some command history which preferably opens in a pull-down menu and preferably shows the user automatically the most recent commands that he/she used, preferably sorted automatically by recency and/or by frequency of use (which is also good of example simply for faster access even of the user does remember how to reach these commands). Another problem is that for example Word 2007 allows the user to save documents as pdf files, but when reopening such saved files or other pdf files the user cannot edit them anymore. So this is preferably improved so that preferably pdf files that are opened by Word are preferably automatically converted to a normal doc format which can be edited, and/or for example when saving a Word documents in pdf format preferably additional information is automatically saved which complements any additional data that might be needed for editing the file (for example within hidden comments within the pdf file and/or for example though separated linked files).
11. Another problem is that for example when creating an automatic table of contents in Word the user can only create one such table since there is no way of marking headers for a separate table, so for example the user cannot generate this way also an automatic list of all the tables and/or figures separately from the normal table of contents if the user wants also the table of contents. So preferably this is improved so that the user can create automatically more than one table. This is preferably done for example by letting the user use a different header style for example for items that go to the separate list of tables or figures and thus these items will not show up in the normal automatically generated table of contents. Another possible variation is that the list of tables or figures can preferably be generated automatically by the word processor itself without the need for the user to use a special header style for those entries. This is preferably done by simple heuristics so that for example any fully underlined paragraph which starts with the word “Table” or “Figure” or “Fig.” and especially if it consists of a single sentence and/or is center-aligned and/or is followed by an image is preferably automatically picked up when the user requests to generate or refresh the automatic list of tables/figures (preferably also with automatic page numbers) and preferably the user can for example go over this list and remove any items which were added there by mistake which the user does not want where or for example right-click explicitly on some line in the normal text of the document which should have been added to the list and for some reason was not picked up automatically and for example choose an option from a menu to add it to the list of tables/figures, and then the word processor preferably remembers these additions or deletions an keeps the list accordingly also when next refreshed. Preferably there is a default list of default rules, such as for example starting with the words “Table” or “Figure” or “Fig.” and being at least underlined or for example also having to be center-aligned, and preferably the user can go over the list and for example mark or unmark each of these rules or add additional rules or change the catch words instead of “Table” or “Figure” etc. (In case of a bilingual word processor, such as for example Word in the English-Hebrew version, preferably the parallel Hebrew words are also pre-selected there and the user can also change them if needed). Another possible variation is that normal automatic table of contents can also be generated automatically by using similar heuristics without the user having to format any lines in advance as headers, for example by the word processor picking up automatically all 1-sentence paragraphs that are underlined from their start, and/or only lines which start with digits and/or single letters separated by dots. Since the menu hierarchy is typically reflected already in these letters and digits at the start of such lines preferably the hierarchy of the table of contents is also created automatically from this, and if there are any mistakes the user can preferably correct it easily for example by dragging an item in the automatically generated table of contents left or right in order to represent its proper level in the hierarchy, and then preferably the word processor remembers this automatically and keeps it at the moved items at the correct level in the hierarchy the next time the table of contents is refreshed, unless the user changes it again explicitly or for example changes the letters or digits at the beginning of the relevant line in the actual text. Another possible variation is that an automatic index with page numbers, for example for the end of books, can be also similarly automatically generated without having to mark any specific words for it. For this preferably the word processor has a pre-defined list of Ignore-words (such as for example “a”, “the”, “I”, “you”, “he”, “him”, “her”, etc. and other common expressions which should not normally be in an index, and when the user requests the automatic index, preferably all the words which are not in the Ignore-list are automatically indexed with page numbers. The user can then preferably go over the index and delete any undesired words or for example go over the pre-defined list of Ignore words and add or remove words from it, and preferably when the user removes words form the index they are preferably added to a specific Ignore list of that particular document (but preferably not the general Ignore list which will be used for other documents unless the user for example requests that explicitly or requests to make the local list global) and thus are not picked up again when the user requests to refresh the automatic index. This is much more efficient than the current prior art, where the user has to manually explicitly mark words which he/she wants to include in the index, and the index generated by the above methods is much more complete and useful. Another possible variation is that for example this index of words with page numbers can be automatically generated for documents for example by activating for example the Google desktop search or a similar application on the document and requesting an automatic index with pages, and/or for example the desktop search automatically keeps also page numbers for words found when indexing documents. Another problem is that for some reason for example in word 2003 the user cannot change the left and/or right margins of the table of contents without screwing it up or change for example the line spacing within the table of contents (for example 1.5 line-spacing instead of single spacing) without being reset the next time the user refreshes the table. So preferably this is improved so that the user can change these parameters for the table of contents and they are preferably remembered so that the next refresh keeps the new margins and line spacing until the user changes them again (preferably this change is automatically corrected to keep the original ratio of the line spaces in the table of contents, so that for example if there is an additional line space for example between entries that are on the highest level of the hierarchy then preferably these spaces are automatically increased by the appropriate factor. Another possible variation is that the user can for example enter a command which enlarges or reduces the fonts in the table of contents by a given factor (for example by 10%, 20%, or other ratios) while preferably keeping the hierarchy of larger and/or otherwise more conspicuous fonts for higher levels in the hierarchy. For this preferably the word processor automatically picks for each level in the hierarchy the nearest font type and/or style (for example bold or not bold, etc.) and/or size in order to keep as close as possible to the appropriate ratios. Another possible variation is that the user can for example specify, preferably globally for the entire document, for example the exact font type and/or size and/or style for each level in the hierarchy, which preferably changes automatically all the relevant entries in the table of contents itself and all the relevant lines in the document itself. Another possible variation is that for example even without the automatic table generation preferably the user can mark relevant lines much faster than having to mark the whole line and then choose a style for it—for example by merely right-clicking anywhere on the line and choosing for example “add to table of contents” or “add to list of figures” from the menu that appears and then preferably the entire (preferably underlined) line or 1-sentence paragraph is chosen. In addition, preferably the word processor keeps track of what the user is doing and it for example the user is jumping over the document and marking lines for the table of contents then obviously the user is trying to focus on building the table and therefore preferably the word processor offers these options for example on the top of a menu that preferably appears for example when right-clicking on the line and/or for example the menu becomes positioned so that the most likely option or options (for example according to the last few choices of the user) becomes automatically aligned near the clicked line, so that the user only needs the minimum mouse movement in order to choose that option (preferably this is done by shifting the menu itself up or down to appear so that the most likely option is closest to the line, but preferably without changing the order of the options within the menu, since the user might remember the original order in which the options usually show in that menu and thus changing the order itself might be confusing)(This can be done also for example with the normal prior art marking of headers, but as explained above the above variations are better and more efficient). Another possible variation is that the user can for example first generate a single table of contents normally and then for example mark multiple entries there (for example by pressing Shift for clicking with the mouse on a range or pressing Ctrl for clicking on single additional entries, and thus the user can for example mark all the entries that should be removed to the other automatic content—for example the list of tables and for example choose a menu option that moves them, and then preferably the word processor creates the other list and moves the marked entries there and remembers this so that when the user activated the next refresh the moved entries remain in the other list unless for example the user moves them back again. In addition, preferably when the user hovers with the mouse within the normal text of the document over a line which belongs for example to the table of contents or to the list of tables & figures, preferably a small bubble or other visual indication shows up which indicates that it belongs there, or for example all such lines are all the time automatically visually marked with an indication that they belong to some table of contents (such as for example automatically surrounding them, with some rectangle or color or other preferably conspicuous visual indication. Of course various combinations of the above and other variations can also be used. Another possible variation is that preferably the user does not have to manually update for example the table of contents every once in while but instead it is preferably updated automatically. In order to do this efficiently preferably the word processor updates it for example whenever the user jumps to the area of the table of contents in the document and/or when he/she requests to print the file or to save it (unless of course there were no relevant changes since the last saving or printing) or for example whenever there are changes in page numbers which make any of the lines that belong to the table of contents move near the page borders (for example by tracking their position) or whenever the user changes any of these lines themselves. Since the update usually takes only about 2-3 seconds, even if the user has for example just jumped to the area of the table of contents, by the time the user starts actually reading it the table can be already updated. Another possible variation is that for example when the user right-clicks within the word processor for example on an image that was inserted from a file preferably one of the available options in the menu is to show the path and name of the file from which the image was inserted. Another problem is that for example when the user splits the word processor into two windows of the same open file, for example in Word, the split can only be done vertically, so that one window is at the top of the screen and one at the bottom, which gives only limited view. So preferably this is improved so that preferably by default (or as a choose-able option) the split can be created into a separate tab or separate window (which has the additional advantage that preferably even more than one additional window or tab can be opened of the same file) and the user can preferably switch between them for example by the normal Alt-tab or Ctrl-tab instead of having to click each time on the other. In this case preferably the tabs or windows which are split views of the same document are preferably specially marked as belonging to the same document, such as for example a separate color and/or other identifier compared to the other windows or tabs. Another problem is that for example when using ˆZ or ˆY in one of the split views after doing something at the other, the position jumps to the other split view, and also some changes fn the first view can shift the position in the second view, which makes it hard to keep track of the desired position. So preferably this is improved so that preferably any changes in one of the views do not change the position in the other view unless for example the text visible in second view itself becomes for example deleted or changed, and preferably there is a separate undo and redo buffer for each split view, so that preferably they behave like two independent windows or tabs, except that changes in any of them are preferably updated simultaneously also in the other view. This is of course even more natural in combination with the above variation of making the split into as separate window or tab.
12. Another problem is that for example in Windows XP when the “all programs” pop-up list which is activated through the Start menu becomes full, additional programs are just out of the screen and are not shown at all, which can be very annoying and/or confusing. Although the user can ask to sort the programs alphabetically instead of by order of appearance, this does not help if the newly added programs start for example with a letter too far away in the alphabet, and anyway, this is not a real solution since either way some programs will still remain out of view. Another possible variation, as mentioned elsewhere in this application is for example to enable the user to sort the programs for example by descending order of recency so that the most newly added programs appear first, and/or for example to choose this as the default order also for the programs that will be later added, however this again still does not solve the problem of having at least some programs become invisible (Similarly, when choosing for example alphabetic order preferably new items are afterwards automatically added according to this sorting order without the user having to request to sort again alphabetically after they are added, unlike the current XP, in which even after sorting them alphabetically new programs are still added at the end). So preferably this is solved for example by creating in such cases automatically for example a horizontal bar which moves to scroll the list of programs sideways, and/or for example if the user moves the mouse for example to the right edge of the screen the list scrolls automatically to show what is next on the right, and preferably there is an indication in advance that the list extends beyond the edge of the screen. Another possible variation is than the system can for example automatically enable adding more programs for example by automatically reducing the width of each column for example in advance or on a need basis (for example by automatically folding long names into two or more lines and/or showing only part of them (and in such cases for example when the mouse hovers over them preferably the whole name for example is preferably instantly shown for example in a pop-up bubble), and/or for example making the letters at least in the long names automatically thinner and/or smaller, and/or for example automatically reducing the distance between the lines of text in the list of programs. Of course various combinations of the above and other variations are also possible.
13. Preferably the user can logically disable or change the function that pressing various keyboard keys has on the OS and/or on any programs that are running, such as for example the “Windows” key, since if the user is working for example in text mode in a DOS window, pressing for example by mistake the “windows” key causes the display to switch and can be very aggravating. Similarly, if the user buys for example a new keyboard and some keys (such as for example the ESC key or the CTRL key) are not in the place that he is used to, preferably the user can simply redefine these keys, for example by marking the changes on some virtual keyboard that the system displays, so that for example these keys will switch places, and then the user only has to switch physically for example the external plastic caps of the keys that he changed logically (or for example glue new labels on them), and then the change is complete (This means that preferably the keyboard keys are mapped though the inner conversion table). Another problem is that for example in portable computers some keyboard keys do not exist, such as for example the side keypad, which can be very inconvenient to users that are used to it, and also for example in some text editors the side ‘*’ is the Undo button and for example the side ‘-’ key copies and deletes a line, but the normal ‘* and ‘-’ keys don't have this function. So preferably the user can also redefine for example some keys for example on the right to become for example the keypad keys—but for example on condition—for example when another key is pressed or some switch is moved, and/or for example the keyboard in the portable computer is defined like this in advance and preferably the relevant keys have also the additional keypad marks on them, or for example the original ‘*’ and ‘-’ automatically become the keypad keys when the other key or switch is pressed. Another possible variation is that the user can for example add to the portable computer (for example when it is used on a desk) for example a mini-keyboard which completes for example the side keypad and/or any other keys—for example using the normal plug that enables adding a keyboard to the portable computer, except that preferably the complementary keyboard for example sends a special code or for example has a somewhat different configuration of the connector, that tells the portable computer not to regard it as a replacement keyboard that disables the portable's built-in keyboard but regard it as adding certain keys to the internal keyboard. This can be more convenient and space-saving than adding a full keyboard that is used INSTEAD of the portable's built-in keyboard.
14. Preferably the dynamic linking possibilities are improved so that the user can call and use any Windows DLL from a DOS program (preferably in an extended DOS environment) and/or vice versa, so that preferably the two environments are integrated seamlessly in memory, so that Windows modules and DOS modules can preferably transfer data between them without having to use for example intermediary file storage. This way, for example a program that needs to use the TWAIN interface to work with various scanners can for example have one or more modules that run in the Windows environment and can for example connect to the TWAIN DLLs and for example have also one or more modules that run in DOS mode (preferably extended DOS) and can thus have backward compatibility for example with absolute memory addresses or other functions that are available only in DOS mode. This can be done for example by defining appropriate stubs and/or API interfaces that bridge between the two types, including for example any necessary conversions that are needed for compatibility, and/or using for example various sockets and/or client/server connections within the same computer.
15. Another preferable improvement is that for example when Faxes are received directly into the computer by a fax card, preferably the Fax program and/or the OS is improved so that if for example a fax-transmission has been cut-off because of some error and the sender wants to send again only the remaining pages, preferably the program and/or the OS can automatically identify this (for example by identifying that this is from the same source and within a short time after the previous fax), and then preferably the continuation fax is appended to the end of the previous fax and/or the program at least groups them together and/or notifies the user that two or more faxes appear to be a continuation of the same fax from the same source. Another possible variation is that the receiving fax card can for example automatically return to the user (preferably by improving the communication protocol so that this feedback can be received without having to call back the user) a unique return code that preferably includes a time and date stamp and a serial number of the communication (as described also in U.S. patent application Ser. No. 10/756,839 by the present inventor), and preferably the user can add this code on the continuation of the fax, for example preferably digitally (if the fax is sent from another fax card, or for example as an additional code at the end of the dialed phone number if the protocol is improved to enable this), or for example as a printed number at the top of the first continuation page, together with a code that indicates that this is a continuation (in which case preferably OCR is used to identify this). Another possible improvement is that if the user for example sends by mistake in a normal fax or for example a combined fax-scanner-printer a page that is with the printed side facing away from the side that is scanned (unless for example if it is a double-side fax that can read both sides of the page simultaneously), preferably the system automatically warns the user that the page is empty on the scanned side (preferably the system determines this for example according to some threshold values). Another possible variation is that the user can for example choose an option on the fax menu which automatically also prints a photocopy of each fax page while it is being sent (or for example keeps it in memory and prints it for example immediately after the page is sent or for example after the entire fax is sent, or for example sends a copy of the faxed pages to the user's computer so that the user can for example view them on the screen and only then decide if he/she also wants to print them and/or for example keep the copy in an archive) and thus the user can immediately see exactly how the page was scanned and for example see immediately if there were any scanning problems. Another possible improvement is that if the user has for example a combined fax-scanner-printer connected to the computer preferably the OS is able to send faxes also directly through the attached fax-printer by sending it the data and telling it send is as fax instead of printing it. That is preferably done together with an appropriate enhancement in the attached fax-printer (preferably this is done by a simple change in the firmware of the all-in-one scanner/fax/printer and/or by adding the appropriate software to the computer). The pages can be converted to a fax image in this case for example by software in the OS or by the fax-printer itself. This has the advantage of better quality than scanning a printed page, and is useful for example if the computer does not have a modem/fax card installed in it or if the external fax/printer is faster than the fax/modem card. Another possible variation is that the user can for example use the combined fax/printer/scanner and/or for example even a normal scanner to send faxes directly through the Internet, preferably through the computer's Internet connection. This is preferably done, again, by a change in the device's firmware and/or by adding the appropriate software to the computer. This has the important advantage that the user can preferably send faxes directly and instantly the same as he/she would be sending them through a normal phone line, except that preferably the fax is sent through the Internet and is preferably sent to the receiving fax either directly also through the Internet (If the other fax is also connected to the Internet), or for example through a local gateway that converts it to a normal Fax transmission through a local phone-call, or for example it is received directly into a computer on the other side. (Of course, if the file exists for example as a Word document on the user's computer then using the scanner or combined scanned/fax/printer is not needed, however the main reason that people send a Fax instead of an email is typically to send a document that contains a signature or a document which does not exist on their computer). Preferably the user can for example add some special prefix to the phone number, which indicates to the sending fax that the call should be routed through the user's computer, and then for example, instead of really dialing, the image is sent to the computer for example through the USB or other connection that exists between them. Another possible variation is that the user can for example use a fax card or for example a combined fax-scanner-printer which is connected to the computer in order to send one or more pseudo fax images which are actually digital data (such as for example one or more pdf files or other convenient formats). This can be done for example by a special software that runs on the computer and/or for example by some firmware change for example in the all-in-one fax-scanner-printer, so that the computer can send to the fax-scanner-printer for example the special digital file or files for example alone or together with real images or scanned images (for example if some scanned cover forms or other scanned images are also needed), and when it is transmitted by Fax the sending device preferably uses a special code to tell the receiving device that one or more pseudo page images are actually a digital file, and preferably the receiving fax is either a computer with a fax/modem card or for example a combined fax-scanner-printer which is also connected to a computer and thus can transmit the digital file to the computer as a digital file, and preferably if a normal fax machine that can't handle such files responds then the sending device knows that the transfer of digital files is not possible and preferably issues some error code and aborts or automatically sends instead also the digital file as normal fax images. This can be used for example for sending applications or other documents to patent offices by Fax (which can enable for example user identity confirmation by the telephone's caller ID, without having to deal with digital signatures, etc.), while allowing high speed transfer almost at the same speeds of sending email, Even if the file contains for example a 100 pages, whereas a normal fax of such size might take even half an hour or more and involves the risk of for example some lines not being scanned properly without the sender even knowing this, and of course it also saves wasting of time on OCR recognition at the receiving side. Preferably this is accompanied by transferring also one or more CRC codes and/or other integrity data, so that preferably the connected computer on the receiver side (and/or for example the CPU of the receiving device itself) checks if the CRC and/or other integrity data fits the actual file that was received, and, if not, preferably tells the receiving device to return an error code so that the sending device can try to resend it. Another possible variation is that the sending device can for example automatically split the digital file or files to multiple sections if for example the file is too large for the desired size of each pseudo page-image. Another possible variation is that the two devices can automatically recognize each other, preferably already during the handshake, as having more than Fax communication capabilities, and thus for example can automatically (preferably at least when it is more suitable) switch to some other electronic file transfer protocol between them which is preferably more directly oriented to exchanging digital files. Another possible variation is that for example the fax logs automatically indicate near each communication for example also the resolution that was used in the transmission (for example standard, fine, super-fine, photo, etc.) and/or for example if the fax was in B/W or in color. Of course, various combinations of the above and other variations can also be used. Of course, like other features of this invention, these features can be used also independently of any other features of this invention. Another possible variation is that when sending a Fax the sending Fax machine can preferably enter automatically into the sent page (and/or also display to the sender) the local time and date of the receiving Fax (for example by reading it from the receiving fax or for example by reading it automatically from the phone company or for example from the Internet, for example according to the called number). Another preferable improvement is that preferably the receiving fax machine (for example a normal fax or for example all-in one devices that contain a fax) is programmed by default (and/or at least the user can choose this option) to respond with fax sounds only if fax sounds are heard in the incoming phone call. This is very important since when the user needs the same line for fax and voice, if the user does not answer fast enough (for example if the fax is set to answer at the 5th ring and the user did not reach the phone fast enough) the Fax machine on the same line will interfere even in voice calls. Although the normal Fax protocol has been that the calling fax is supposed to wait for fax sounds from the receiver side of the phone call before making its own fax sounds, modern fax machines make these sounds when calling even if there is no fax sound on the receiving side, so, if the user chooses this option or this is the default, the only price is that some old stupid fax machines might not be able to send faxes to the receiving fax when the receiving fax is set in this mode, but it solves the problem of the user's fax interfering with incoming voice phone calls. Another possible variation is that the receiving fax is improved so that it is preferably able to automatically identify voice calls and thus avoids making fax sounds if it identifies for example human voice and/or stops immediately and gets off the line even if it started making fax sounds, as soon as it identifies the human voice. Another possible variation is that for example if the fax and/or the computer or other computerized device can also record voice messages, preferably the user can define routing of phone calls to separate virtual boxes according to the incoming phone number or numbers (for example according a list or lists of specific numbers, and/or according to ranges of numbers or even patterns with partial wild cards), and/or for example also according to voice patterns (such a for example pitch or other heuristic patterns that differentiate best between individuals), so that for example calls from a specific person can be automatically routed to a different area even if he/she hides his caller id. Of course, like other features of this invention, these features can be used also independently of any other features. Another preferable variation is that preferably the ability of the scanner/copier to overcome wrinkles in papers or for example overcome the black stripe that appears when scanning or photocopying books when the user can't press the book down strongly enough—is improved, preferably by adding at least one more light source in the scanner, so that shadows are automatically reduced. Another possible variation is that for example when using previous applications as basis for a new application for example in the EPOline software, preferably all the original data (including for example the details of the applicants and/or inventors, address for service and/or agent, and/or even for example priority data and/or the attachments, so that preferably the user can change or remove things if needed but can preferably use as much as he/she needs from the previous application, since in the prior art EPOline software the user has actually to refill everything from scratch even when “reusing” the pervious application as basis for the new application.
16. Another problem is that when the user searches for programs in the “Start menu” the installed programs are typically sorted by the order they were installed, and so in order to find a specific program the user might have to scroll over a large list if there are many installed programs. Although the user can for example request the System to automatically sort the list of installed programs in the start menu for example by alphabetic order, preferably the user has also additional options, such as for example to jump automatically to a given program in the list for example by typing the first letters of its name, and/or for example the user can enter a search string and the system looks for example for names that are at least similar to the desired name (in which case preferably all the similar names are displayed, preferably sorted by descending similarity to the search string), and/or for example the user can request to sort the programs there according to reversed date of installation, so that the latest installed software appears first, etc. Another possible variation is that there is for example a special log of installations of programs according to the order in which they were installed, which for example the OS or the security system can keep automatically, even if for example the program has not added itself to the list of programs of the start menu or to the desktop, which has the advantage that the user can easily find programs also in this case and or find out for example about installations that occurred without his/her knowledge (this of course can work very well also with the rollback possibilities discussed elsewhere in this application. Another possible variation is that the user can for example request automatic sorting of the programs according to types, such as for example programs that deal with DVDs, programs that deal with music, Internet application, editors, etc., for example in the list of installed programs and/or on the desktop, which can be done for example by adopting a convention where each program contains such meta data about its main function and/or for example the system finds this info automatically for example according to the program's name in one or more Internet Databases. Another possible variation is that the user can for example move or copy for example functions that are available when clicking the left mouse button for example over the start menu (such as for example “explore”) to be available (in addition or instead, but preferably in addition) also when clicking with the right mouse button, or vice versa. This is important because sometimes the user does not remember if a certain option is available for example with the right click or with the left click or prefers for example that at least certain functions will be available for example by both clicks. Another possible variation is that for example when the user uses the explore window he/she can preferably for example add for example on the top line for example the name of a file name with wild cards (for example f:\commnet\bet*) and then the explorer window preferably shows only the files who's names fit the pattern, for example like in the file open or save dialogue box. Similarly, preferably the user can use this typing for example on the desktop, and then preferably the system for example displays the list of closest names as explained above and/or for example automatically indicates the most relevant icons, for example by making them brighter and/or making them move or flash and/or drawing visually attention to them by any other means. For example in Windows XP if the user types a letter on the desktop the system jumps to an icon beginning with that letter but when the user types the next letter the system jumps again to an icon beginning with the newly typed letter (and if the user repeats the same letter then the system jumps to additional icons which begin with that letter), instead of jumping according to a sequence multiple letters, so that if the user for example wants to repeat a search preferably another command is used. Also, preferably the chosen icons are conspicuously marked (for example by stronger light and/or flashing), since just darkening the icon a little bit like Windows XP does is not conspicuous enough so it takes time for the user even to notice what next icon is marked. Another possible variation is that for example the OS and/or for example some other software) can for example automatically change the color (and/or other attributes) of the text near the icons on the desktop, preferably for example in a way that creates maximum contrast according to the colors of the background at that specific location (For example the Azul background of Windows XP has some areas which are too bright for white letters and some areas which are too dark for black letters, but in Windows XP the text of the icons is always white). This can be done for example by choosing automatically black or white and/or other colors according to which has the better contrast with the local background and/or for example using some automatic XOR function. This can be done for example automatically for every pixel or group of pixels in the text and/or for example per letter or per word and/or for example all the text of the same icon has the same color, which means that in this case preferably for example the average background is taken into account and the average best contrast color is chosen for example for the letter or the word or the entire icon text, etc. Although Windows XP partially solves this by using some slight darker shadow below the white letters, which helps see it also on whiter parts, this can still cause fatigue to the eyes and make it harder to see since for example black on white is usually easier to recognize cognitively than white on black, and also the duplicity of the shadow can create some inconvenient feeling of lack of focus, and also but the user cannot choose a different color or for example sets of more than one colors. Although there are some utilities that allow the user to change the text color, as far as I know the choice is just one color for all the text. Therefore, another possible variation is that for example the user and/or for example the OS (and/or other software) can for example choose also to display text in different sets of more than one color for example by letting the user choose which color to use for the text and for example which for a shadow (or for example other effects) and/or for example the OS can choose two such colors automatically, for example according to any of the above methods. Another possible variation is that the user can for example change the color of the taskbar and/or for example choose between various skins for example with different patterns for example for the taskbar and/or for example for other elements on the desktop, such as for example the start menu. Another possible variation is that for example when Stereo display becomes available, for example the text of the icon and/or the icons themselves can be made to look as if they are for example protruding from the desktop, and/or for example such protrusion can be used as one of the options for emphasizing text for example in word processors and/or Internet browsers. Another possible variation is that the user can also change for example the color of the text that shows for example on taskbar items, so that for example the user can choose black instead of the normal white, which is easier on the eye (preferably this is made available for example as one of the menu options for example when right-clicking on the taskbar). Another possible variation is that for example a stereo view web camera (preferably with at least 2 lenses—right & left) or pair of cameras (or more than 2) can be used to automatically generate a 3d model of the user's body for example for avatar representation in various virtual meetings and/or for example for measuring clothes for online shopping of clothes. Of course the user can preferably use also an application which enables various fine tuning of the body features, but preferably the general image is automatically generated this way.
17. Another possible variation is that for example the user can preferably enable or disable for example Cleartype separately for various uses or contexts, so that for example the user might want to activate it for example for Word documents and/or web pages but not for some other applications, or for example activate it for everything except for example the text near the icons on the desktop, since that text already comes with a shadow and the Cleartype makes the shadow even more conspicuous, which some people may find annoying, and/or for example when Cleartype is used preferably the OS automatically corrects for example by making the shadow thinner or otherwise less conspicuous, and/or for example the user can define, preferably in general or for example for each type of application or section or context, for example not only if to use Cleartype or not but also for example to what extent to use it, so that there are for example a few possible levels of it (for example with varying degrees of making the fonts fuller or thicker). For choosing these separate settings preferably these different options are added for example to the normal menu in which the user chooses between standard fonts or Cleartype, and/or for example by right-clicking on the text of an icon on the desktop or for example in other applications the user can for example change the Cleartype setting for example only for text of desktop icons or for application of the same type, and or the user can preferably toggle between Cleartype to standard fonts instantly without going through a menu, for example by pressing control-R or some other character, and then preferably the chosen mode becomes the default for example for other windows of the same application and/or for similar windows. Another possible variation is that the user can for example change for example the brightness and/or contrast and/or saturation and/or color and/or for example gamma correction (and/or other color and/or brightness parameters) for example separately for different elements in the user interface, which is very important since in many monitors for example the desktop looks best with a certain amount of color and/or contrast and/or saturation and/or gamma correction, but for example text windows such as for example Word documents or web pages, which contain mainly black text on a white background, typically need a lower brightness or contrast and/or lower gamma value than for example images in order to avoid eye strain, and/or for example images for example within web pages and/or in other applications need for example higher brightness and/or contrast and/or higher gamma value, and/or for example DOS or cmd windows look better with a different brightness or contrast. So preferably the user can for example set a separate brightness and/or contrast and/or saturation for example to the taskbar, separate to the desktop, separate to Word and/or web documents, separate to images, separate to dos or cmd windows, etc. (Preferably this is done for example by adding such options to the display setting menu, and/or for example by right-clicking on each such element these settings can be changed separately for it and preferably automatically also for similar elements). This means of course that the definition preferably goes logically with the appropriate element, so that for example if the user increases or reduces the size of the taskbar then preferably its color and/or brightness and/or contrast and/or gamma and/or saturation definitions automatically carry on to any new space it occupies. The implementation itself of such different settings for different elements can be done for example by the display card driver or by improved drivers of display cards which can add such parameters separately to different parts or areas or pixels of the screen and/or for example by passing all the display through an intermediate underlying layer (for example in the OS or in the display card's driver) that adds the appropriate correction for each element, for example by choosing automatically for each pixel or each area of pixels (for example rectangles, etc), a different color or color correction which approximates the effects of the desired logical parameters (this can be for example the same underlying layer that is used in vista for the vector graphics rendering of everything and which can be used for example also for the resolution Independent User Interface), and/or for example by improved hardware and/or firmware in the monitor itself which enables receiving different instructions for different pixels or for different areas on the screen (preferably after the underlying layer has translated the logical areas into actual physical areas) and/or for example by the OS changing directly some of the relevant elements to fit the requested parameters, such as for example the bottom task bar. Another possible variation is that for example the browser itself preferably adds the desired gamma correction automatically to the images that it embeds within the displayed web page, preferably while keeping the gamma correction of the text areas lower, however this can be easily done for example by the OS itself since the OS can easily identify text areas separately from image areas (since writing text is usually based on calling the relevant OS services). This is much better than the prior art, in which the user can change such settings only once for everything (or for example there a separate setting available only for Video overlay), because normally there is no single definition of these parameters that is good for all of these categories, the shared settings of the prior art means necessarily that the user has to compromise on many elements and thus views them in a sub-optimal way. In terms of productivity this seem much more important than for example using Cleartype or a normal font, since full strong black letters with a background that does not blind the user can lead to much more productivity than grey letters and a background that is too bright and thus blinds the user. In fact, it actually helps getting much more out of Cleartype fonts, because being able to set the parameters of text separately in an optimal way (for example with lower brightness and lower gamma value) enables seeing the fonts as solid black eventhough in reality the Cleartype uses various shades to fill the gaps in the contours of the fonts. For example when browsing on the Internet there is typically a mixing of images and text on most web pages, so these different settings can enable the user to see both the text and the images at optimal levels. Another possible variation is that for example when there is a different setting for video overlay, preferably at least by default until the user changes it, the saturation and/or brightens and/or contrast and/or gamma level etc, of the video overly controls are preferably automatically applied also for example also to photographs or web images, since typically there should be no difference if the images are stationary or moving. This can for example help the user make the most even of old monitors in which there is less flexibility to change such parameters when changed globally for the entire screen, and help the user achieve even better results on better monitors, thus being able to reach the optimum on each category without the normal necessary trade-off. Another possible variation is that for example the word processor and/or for example the browser preferably allow the user to choose for example the color of their normal white background to become for example different less dazzling shades of white, for example from a set of pre-selected options and/or for example by creating additional options by clicking anywhere on a 2-dimensional color map of the type used for example in various painting programs. In the browser this means that preferably whenever the browser displays a web page which has a white background or has a background which was defined in a color sufficiently close to the color that the user chose to represent white, the white parts of the page are preferably automatically converted to the chosen shade that the user has chosen. Another possible variation is that similarly fonts that appear grey for example beyond a certain threshold are automatically converted to black by the browser and/or the word processor (in this case there is no need for the user to choose the desired shade of black since clearly the blacker the font the easier it is for the eyes to see). Anther possible variation is that web fonts that are too thin and appear grayish (not all thin fonts do) are automatically converted by the browser into larger fonts or into a more appropriate font type which thus becomes automatically easier to read and/or automatically converted to boldface. Another possible variation of the implementation is that for example whenever the user opens for example a sufficiently large word processor window or full window or for example a web page which contains mainly text on a white background, the OS or for example the screen driver (or for example the application itself—for example Word or the browser, or some other application) preferably automatically lowers the brightness and/or lowers the gamma value (and/or whenever the user is viewing a sufficiently large image the opposite is automatically done)—even if it is done for the entire screen (However this is preferably done, as explained above, in combination with letting the user choose the separate parameters for each of these modes, and/or for example choosing as default for images, at least initially, the same parameters which the user specified for video overlay). Preferably the change is done together with corresponding automatic correction for example in the task bar so that it preferably remains approximately the same (for example by automatically switching to brighter colors to compensate for the general darkening for example when the Word window covers most of the screen), and thus the user can have a very good approximation of the optimal experience without having to change the brightness manually for example when switching between work on Word to other activities.
18. Another problem is that for example in Windows Vista the OS can automatically decide to disable various features according to the hardware support available, such as for example the AERO glass transparency or for example the flip-3D or the animations of windows growing out of the taskbar squares or shrinking back into them without giving the user an indication about what features have been disabled or a direct choice about it, which can be very annoying. So preferably this is improved so that the OS reports to the user automatically what features have been limited or disabled and preferably also allows the user, preferably form a central convenient menu (preferably in the same window that displays the disabled features) preferably to enable again any such features, even if it causes a cost in performance. For example, at least the transparency and/or for example the animation of growing or shrinking windows can be done quite efficiently even on display cards that don't support it directly by hardware, as can be proven for example by games like Roadrash, which show amazing fast 3d graphics even on very old systems—for example even on a Celeron 400 MHz without any special display card. In addition, preferably the user can define for example if the desired features will for example work a little slower than in a fully hardware supported system or for example will be done at the same speed as in hardware supported system, for example at the expense of slowing down other applications for a preferably very short period during the displaying of the animation or other special effect (preferably except for example time critical applications if such applications are running in the user's computer) or for example of automatically reducing the resolution of the special effect. Another problem is the lack of consistency in these animations of growing and/or shrinking windows, since for example in Vista build 5270 when clicking on icons on the desktop (such as for example cmd) the windows appear to grow out of an arbitrary point on the desktop instead of from the position of the icon—so preferably the animation is improved so that when activated from the icon on the desktop it starts in this case from the position of the icon. Another problem is that when windows for example shrink into the taskbar the small window actually disappears when it is relatively small but still not close enough to the relevant desktop item. So preferably this is improved so that the smaller windows keeps showing consistently until is has completely merged with the relevant item on the taskbar. Another problem is that when moving in Vista (build 5270) between full-size windows to part-size windows there is no gradual animated transfer, but an instant abrupt jump between the 2 states, like in Windows 98 and XP, which creates a lack of consistency with the smooth animation of growing or shrinking windows when the window is minimized or expended from the minimized state. So preferably this is changed, so that a preferably smooth animation is automatically displayed also when moving from the part-size state to the full-size window and/or vice versa, but preferably the user can also choose for example from a menu if to enable for example this additional animation or not and/or similarly for other animation affects and/or other special effects. Another possible variation is that preferably the user can also for example determine the speed and/or length of each animation, since for example when opening the power saving window from the screen saver window in Windows Vista the animation for opening this small window takes too long and so can be annoying after a while. Another problem is that in for example in Windows Vista when the user activates the flip-3d all the windows become automatically minimized and the desktop becomes darker, and also the user can exit the flip-3d only by clicking on one of the windows in the flip-3d or by pressing Esc, which is inconsistent with other application. So preferably this is improved so that the desktop remains with the normal colors and preferably if the flip-3d is activated while one or more windows are in view preferably they are not minimized automatically (i.e. the 3d deck of windows can appear on the background of other currently open windows and not necessarily on the background of the desktop itself), and also preferably the user can exit the flip-3d also for example by clicking anywhere on the desktop and/or on the taskbar and/or by clicking on any other item on the desktop or on the taskbar or for example by clicking on the “show desktop” icon, and/or even for example by clicking again on the icon which activates the flip-3d. After I registered this in a previous version of this application this Microsoft indeed added to Vista build 5308 the ability to click on anything items outside the Flip-3d in order to go out of it, but the user is returned to the original Window in which he/she was before activating the Flip-3d, regardless of where the user clicks now, which is very inconsistent and confusing. In the above variation the intention was of course that clicking on anything else while the Flip-3d is open preferably closes the flip-3d but indeed brings the user to where he/she clicked (for example another item from the taskbar, an icon on the desktop, the Start button, the desktop, etc, and not back to the previous window the user was in. Another problem with flip-3d is that if there are too many open windows (for example a few dozen) then the flip 3d side shows as if there are fewer windows than the real number (apparently it shows only 10), which can be confusing to the user, and also they can be very dense sideways with no ability to see any details on the side of the windows. So preferably this is improved so that the user can preferably easily define the sideways spread of the flip 3d (for example by defining the minimum and/or maximum sideways shift and/or the vertical shift between each two adjacent windows and/or by determining the total size that the flip-3d set of windows will occupy sideways and/or for example defining the angle or angles of the window decks, for example the 3d depth angle), and/or preferably the correct number of windows is shown, unless for example the size had already increased to the full width of the screen, and/or for example if the size of the set reaches the full width of the screen then for example preferably only then the sideways gaps between the windows are automatically decreased. Another problem with flip-3d is that for example windows that are smaller then other windows (for example cmd windows) appear smaller on the 3d deck of windows, which can be confusing since it distorts the 3d perspective. So preferably this is improved so that preferably, at least as one of the choices, the user can choose a mode in which all the windows in the 3d deck appears of the same original size (preferably regardless or their size and regardless if they are full windows or partial windows), and thus get smaller consistently only according to their depth in the 3d deck (but preferably this is the default). Similarly, preferably the size of the preview windows (for example on the taskbar) is preferably equal and not smaller if the window is smaller, since again making it smaller according to the size of the window this is more distracting than helpful. In addition, in the prior art (for example Vista beta builds 5270 and 5308) this is clearly inconsistent since for example the taskbar preview window looks taller than full-windows, such as for example Word, eventhough the taskbar window is never full-screen. Another possible variation is that for example a grouped item can appear in the flip 3d as a single “card” which is preferably for example divided internally into preview windows which can be clicked to go to them and/or for example a separate “flip-3d” can be generated for each group of items of the same application or type, for example if they are a grouped item and/or for example even if they are ungrouped (for example all the open browser windows in one flip-3d deck, all the open Word documents in another flip-3d deck, etc.). Another problem is that in Windows Vista (build 5270) although the user can change the color of the taskbar, not all colors are really available, since the user for example cannot change the taskbar to appear the same level of blue as the typical blue taskbar of Windows XP. So this is preferably improved for example by any of the above solutions, such as for example letting the user change independently the color and/or brightness and/or contrast and/or saturation of any section or element on the screen as described above. Another problem in this Vista version is that the user can only change together the color of the taskbar and the color of the top head line of each window. So preferably this is changed so that the user can change each of them (for example color, brightness contrast and/or saturation) independently, as is implied again also by the above solution. Another possible variation is that for example movie player applications and/or image viewing application can for example find automatically the best saturation for example by identifying elements for which the correct saturation is known—such as for example water, the sky, green plants and human faces, and in case of video, preferably this value is averaged over time as the movie progresses and thus becomes more reliable (assuming that the saturation does not change in the middle, unless for example there is strong evidence from similar later elements where the correct level is clear, that the saturation level has indeed changed). Another possible variation is that for example the gamma value is automatically corrected, for example by checking which gamma level adds most details (preferably measured as variation) in black areas, and preferably, again, the gamma value is calculated over time and thus is preferably calculated as an average. Another possible variation is for example that the automatic gamma correction is applied only to the black areas, thus not affecting the rest of the image. Another problem in this build is that when a full-size window is opened the color of the taskbar becomes automatically again the default black and returns to the user-chosen color only after the window is minimized or changed to part-size. So this is preferably improved so that the taskbar color does not change according to the size of any windows. Another problem is that various windows are non-expandable to full-size eventhough many times the window is not big enough to show easily the information it contains, such as for example the window that shows the list of startup programs or for example the window of the task manager. So preferably this is improved so that the OS automatically enables the user for example to enlarge preferably any window to full size even if it does not originally contain such an option, and/or for example the OS automatically allows the user to search for any string within such windows or for example print its content or for example save it to a file. In addition, preferably the OS automatically allows the user also to print and/or save the contents of any window even if it was not designed for this. Another problem is that for example even in normal windows, which are designed in advance to be enlarged or reduced or converted to full size, when not in full size typically the user can enlarge or reduce them only by dragging the bottom right corner. So preferably this in improved so that preferably for example also the left bottom corner and/or for example any other corner can also be used for reducing or enlarging the window. This way, preferably for example the top header line of the window is preferably still user for moving the window, but dragging one of its two corners is preferably user for enlarging or reducing the window. Another possible variation is that for example the lists of programs and/or application that are shown in the task manager are preferably improved to include also the full path from which they were loaded and preferably also a link or other info which shows for example what program or process activated each of the existing programs or processes and preferably also when is the first time they showed up on the task manager (for example 3 hours ago during the current Windows session, or even beyond sessions—for example a certain process entered the task manager for the first time 3 days ago, etc). Another possible variation is that when the task manager displays the sorted list of processes with the percent of CPU time taken by each of them, preferably—at least if the percent of CPU time taken by System Idle or other global system category is beyond a certain threshold—preferably the Task manager automatically displays more detailed information about the relevant system process or drivers, so that for example if a specific driver suddenly starts to take up unusual system resources the user can know exactly which driver it is. Another possible variation is that for example when displaying preview windows of files for example in directories for example when the user works with the Windows explorer, preferably files that are video clips or movies are preferably automatically displayed in the preview image for example not as a still image but as a moving image, for example by starting to run the video automatically only within preview images which are currently in view. In this case preferably these videos are for example automatically stopped when the preview image grows out of view and automatically restarted when they go back into view (for example as the user scrolls through the displayed directory contents) and/or for example the are run in a loop for example only within the first 1-2 minutes (or any other duration), and/or for example they are reset and start to run from the beginning again every time the preview window was outside of the visible user's view and then returns again into the visible user's view. Another problem with Windows Vista (build 5270) is that the when the mouse hovers over items on the taskbar it takes about 2 seconds till the first preview window shows up and only then when the user moves to the next item the next preview window shows up instantly, so preferably this is improved so that even the first preview window (or windows, since as explained elsewhere in this application preferably multiple preview windows or all of them show up at the same time) shows up preferably instantly without this delay (and/or for example the user can preferably easily set this delay for example between 0 to a certain amount of seconds). Another problem is that for example in Windows Vista if the user moves the mouse too fast over taskbar items the preview window does not show at all. So preferably this is improved so that the preview windows are preferably prepared in advance and preferably almost no time is needed to display them, so that preferably they can show preferably even at the highest speed which the user can move the mouse for example over the taskbar or over the tab handles line for example in the browser (of course this problem does not exist if for example all the preview windows show up automatically at the same time for example when the mouse is anywhere over the taskbar or for example tab handles line for example in the browser). Another problem is that for example when an application contains more than one window—for example Winamp—the preview window shown near the taskbar item shows only the Winamp itself even if for example it is currently playing a Video file. So preferably this is improved so that in this case preferably the OS for example automatically identifies the most relevant or most informative Window (for example based on various heuristics—for example that a window that displays video is more informative than a still or relatively still window), and/or for example a convention is defined which allows application that have multiple windows to define the window that should be chosen for preview, and/or for example in this case the OS can show more than one preview window over the same taskbar item—for example one above the other. Another possible variation is that for example computer games are improved so that for example the game can automatically assess the performance of the user (for example according to his/her scores and/or according to the time it takes him/her to reach a certain goal or goals) and can then for example automatically recommend to the user when it's time to move on to the next level.
19. Another preferable improvement is that when the user searches for files on the computer preferably the “find files” window allows him/her to enter also more than one file name at the same time (for example separated by commas or one below the other, etc.), since if the user wants to search for more than one file this is better than having to search consecutively and it is also more efficient since this way all the requested files can be searched for during the same disk access.
20. Another possible variation is that preferably the installation disk (for example CD or DVD or for example through fast network connection) of the OS (for example in the new version of Windows) contains also one or more typical usable disk images, so that the system can be instantly installed from the most appropriate image, and then the system preferably automatically determines the actual computer's configuration and simply corrects and/or adds appropriate device drivers and/or makes other necessary adjustments, as if the system was already installed on that computer and the hardware was later changed. This can save a lot of time on the installation process, so that most of the time will be focused only on correcting the configuration.
21. Another problem is that, for example in Tablet PC's and/or similar devices and/or other devices that accept direct input by handwriting, when the user enters text in handwriting, it is problematic to use scrolling since the user would have the quite unnatural feeling that for example written text to the left of the current position of the pen is automatically slipping away to the left (or to the right, if the writing is from right to left). This means that if the user for example enters text by handwriting in a search box (for example when searching with the Internet browser in Google) and there is not enough room for the full search string, then there is a problem how to accommodate the additional text. This can be solved for example by letting the user continue his/her writing even beyond the edge of the input box, and then preferably the Operating System and/or for example the browser preferably automatically knows from the continuity of the written text (and/or from the continuity in time) that this is the continuation of the same text, and therefore interprets it correctly as if it is still in the input box even if its spills out for example to the right and/or to the bottom or up, and or even the user for example continues immediate to enter text for example on a second line below the input box (preferably unless there is another input box there). Another possible variation is that if the user runs out of space in the input box, the System and/or the browser and/or other relevant application automatically extends the box for example to the right (or other relevant direction). This can be done for example by automatically extending the box for example to the right in a new layer that partially covers for example whatever is to the right of the input box so that the user has more space (for example this layer is indicated by a shadow effect as if it is a few millimeters above the screen), and/or for example the extended part and/or the handwriting on it are automatically made at least partially transparent so that whatever is below it can still be seen, and/or for example what is below the extended part and/or below the handwriting is made temporarily faded (for example gray), and/or for example whatever is to the right of the input box (however, preferably only at the vertical position of the input box) is also automatically shifted to the right (this means that things at the right edges of the screen can automatically scroll away and temporarily disappear at the right of the screen if needed, and/or the system uses this scrolling only if there is sufficient free room in the needed direction and uses one of the other options if there isn't sufficient room for this), and/or for example the area where the user is writing can automatically be zoomed in (however this preferably automatic zoom preferably does not effect the user's hand writing itself, so that the handwriting preferably remains at the same size and position). Another possible variation is that at least the part of the handwriting that spills out of the input box is visible only when the user hovers or positions the pen and/or cursor and/or mouse near it. Similarly, if the user for example is entering text by handwriting in some open text window (for example a word processor or notepad) and his/her handwriting exceeds the edge of the window, preferably the System automatically recognizes (for example by the continuity of the hand writing and/or of the temporal sequence) that this belongs to the same text and thus the system keeps the focus in the current application even if the user for example spills some letters on another nearby window of another application. Another possible variation that can increase the natural feeling for example when reading large files or digital books in tablet PCs (or for example in devices dedicate to reading digital books) is that the user can for example move the page (for example up or down or sideways) for example by dragging his finger or fingers on it in the desired direction (which means that preferably the screen can identify that this is the user's finger instead of the pen for example by the size of contact or for example by the electronic resistance, and can then respond accordingly), and/or the user can for example cause pages to flip over for example by touching with his finger a corner or edge of the displayed page or for example some relevant icon there. Of course various combinations of the above and other variation can also be used. Another preferable variation is to supply the user with an electronic pen which can preferably write on normal paper and preferably at the same time both writes with visible ink on the paper and transmits the writing sequence to the computer, so that preferably the user can write normally while also obtaining an automatic copy on the computer (which preferably immediately becomes characters through automatic recognition). This can be done for example by using a double tip, so that one part senses the movements and the other actually writes on the paper, or for example use some electronic eye which views the ink sequence as it is created on the paper and transmits that into the computer. This is also more convenient since the user can much more easily write this way when he/she sees normally the output on the paper as if it is normal writing. Another preferable variation for example in tablet PC's and/or for example in digital book readers and/or for example in programs such as for example Winamp or other software media players and/or for example in other gadgets for playing songs or films, preferably the software and/or the device is able to measure automatically preferably not only which songs or films or books (or other media) are more or less liked by the user, but preferably also for example which parts or sections in them are for example the best and/or which parts are less good or for example problematic. This can be very useful for helping improve for example those books or films or songs and/or for being able to write better ones the next time. This can be done for example by automatically noting if there are any sections which the user for example likes to hear or read or view again and again and/or for example the device or software asks the users explicitly which sections they most like and/or for example in digital books noting automatically for example which sections the user marks and/or adds comments to, and then preferably anonymous statistics are sent automatically for example over the internet for example the next time that the user connects to download for example additional songs or films or books. Another possible variation is that for example in such devices and/or software for playing for example songs or films preferably the player can automatically adjust the sound level not to exceed a certain desired limit and/or not to be too low below a certain limit. This can be done for example by automatically adjusting the level when the limit is reached or exceeded, and/or for example the software or gadget can preferably run ahead quickly in advance over the song or film and determine the maximums and minimums, however that would be much less efficient, and also the local adjustment is even better since preferably a separate optimization is done for each section. Another possible variation is that for example song-playing software, such as for example Winamp, can automatically update their songs list, for example by adding automatically all the relevant files that are found automatically during the updating of the local search index (for example by taking it from the results of the Google desktop search or the Microsoft desktop search), or for example by remembering the list of directories from which the playlist was generated and checking automatically these specific directories (for example every few minutes or any other convenient interval) and if additional relevant files (for example of the relevant file types) have been added then the software preferably adds them automatically to the playlist, and preferably the playlist is for example automatically sorted with an index, for example alphabetically, so when adding songs preferably the index is automatically kept updated at the relevant order. However this is preferably done on a playlist that contains one or more full directories, and the user can preferably also define additional partial playlists, which are not automatically expanded like this. Another possible variation is that for example in Winamp (or in similar programs that can work with a playlist) when the user for example uses “J” (jump) or other convention to pick a list of songs by typing a string of letters, preferably the user does not have to chose a single results but can for example mark multiple results and then for example press play or Enter or otherwise activate them, and then preferably the player marks them automatically as a sub-list within the normal play list and preferably starts playing the marked songs preferably one after the other (preferably jumping each time to the next marked song) preferably until the marked sub-list is finished.
22. Another problem is that for example in Windows XP when the user opens for example multiple browser or word processor windows, typically they automatically become like an internal division within one window on the taskbar, so that the browser or word processor appears in the taskbar only once and the other open windows of that application are listed within it (although at least alt-tab properly jumps between the windows as if they were normally marked as multiple instances of the application on the task bar). Since this can be inconvenient or confusing for example for users who are used to all the windows of the same application appearing in the task bar, preferably the OS allows the user to activate a command which can for example automatically toggle between this mode to the mode where each window appears separately on the task bar. Another possible variation is that the user can also for example activate a command which can toggle between such grouped items (and/or separate items on the task bar) to tabs representation and/or vice versa (so that for example all the windows of the same browser become a single united window with all their tabs together, and preferably the user can for example activate this as a global command that affects for example all the open applications, or for example affects only the windows of the specific application which the user clicked upon). Another possible variation is that the user can for example group or ungroup the windows of a specific application for example by clicking on the grouped icon or on one of the icons of the application on the task bar (for example if they are not grouped) and then for example clicking the right mouse button and for example choosing from a menu, and preferably this remains the default for the specific application (for example the Opera browser) even after the user closes it and reopens it, until the user changes it again (This is better than the prior art, in which the user can choose group or ungroup only globally—i.e. either for all the applications or for none). This can be done for example by just simulating graphically the other representations (even though typically tabs are actually threads and other open windows of the same application are typically actual processes (preferably with some indication that for example the converted new tab is not really a normal tab or a converted separate window is actually a tab), and/or for example also in this case for example each tab which is converted into a separate window (or item in a group) is actually closed and a new tab automatically opened for it instead, and/or for example when the vice versa conversion is used each such tab is closed and an actual window is opened instead (for example of the same file or Internet URL, etc.). Another possible variation is that if for example a browser window becomes crowded with too many tabs the user can for example click with the mouse on a certain point on the tabs handle line and then for example choose as one of the menu options splitting the browser window into two or more separate windows so that for example all the tabs to the left of the clicked position remain in the original browser window and all the tabs to the right of the clicked position automatically move into the a new browser window, and/or for example the user can activate a command which also chooses automatically the split-up position, which can be done for example by choosing automatically the middle position or for example choosing automatically for the new window all the tabs that belong to the domain in the tabs most recently visited by the user or for example all the tabs most recently visited by the user, or other criteria. Another possible variation is that the user can for example activate a command which causes all the most recently visited tab handles to become automatically larger and/or otherwise more conspicuous and/or for example this is the default. Another possible variation is that one of the options available to the user (for example when right-clicking on the tab handles areas, for example in addition to “close all tabs” or “close all but active tabs”) is for example to close for example all the less recently accessed tabs or for example all the least accessed tabs or for example all the tabs that have already been visited, or some other criterion or criteria which automatically select only some of the tabs for closing. Another possible variation is that preferably the user can for example minimize a tab for example by clicking again on its tab handle while it is open (similarly to clicking again on an item on the taskbar) or for example by clicking for example on a minimize icon (for example in the shape of a minus sign, for example below or near the X in the tab handle or for example on the corner, for example the top right corner, of the tab itself), thus enabling the user to jump back to the last tab without having to click on ctrl-tab. Another possible variation is that the user can for example activate a command which causes all the tabs to be ordered automatically for example so that each time a tab is closed or minimized the user automatically jumps to the next tab (for example to the right or to the left) even if that is not the order of last activation. Another possible variation is that for opening new tabs and/or new windows the user can preferably tell the browser for example if to start new tabs or new windows in general for example with the user-define default home page or for example with the current page from which the new tab or window is being opened, and/or for example there are at least two separate commands for opening new tabs (or windows) wherein one type creates a copy of the current window or tab and the other uses the user defined default start page (preferably the default is creating a new tab with the default home page, since that is typically the most useful option). Another possible variation is that the user can for example define more than one default home page and can preferably also specify if each of them will be for example in a tab in the same window or for example in a new window and preferably also specify for example which of them will be the active tab (for example the user might specify that the default home page set is for example 3 open tabs, for example one a Google web search page, one a stock market page, and one a Google news search page, for example, and for example specify that the Google web search page will be the default active tab (and in the case of multiple default home pages preferably this active tab will also be the default page which is opened when the user opens a new tab, and/or for example the user can specify that separately). Preferably this can be either specified for example at the preferences menu where the user defines the home page, and/or for example the user can open the relevant tabs in the desired order and with the desired active tab and then for example press some control or for example click or some icon or for example choose some menu option which sets this as the default set of home pages. Another possible variation is that the user can for example mark this set of tabs or for example specific individual tabs for example from the currently set of open tabs to be always opened together with the last automatically saved session of tabs, so that even if some of them were closed for example in the last session, when the browser reopens preferably these tabs will be opened automatically in addition to the automatic reopening of the tabs of the last session (but preferably these tabs are not added twice, i.e., if they already exist in the last saved session). Preferably when the user closes all the tabs in the browser these default tabs are preferably left open, or the user is for example asked for example if he/she wants to close all the tabs or all but the default start tabs or all but the active tab or all but the default tabs and the active tab, or all but the active tab. Another problem with browsers that can automatically save the last session and reopen automatically with the tabs that were opened the last time (for example Opera, and Firfox with the Save Sessions extension) is that they behave unreliably on reopen when multiple windows are closed, so that for example if more than a few seconds pass between the closing of the multiple windows, on reopen only the last window will be restored. So preferably this is increased to a considerably longer thresholds—for example a minute or a few minutes (since if a user closed another window for example more than a minute ago and then closes the current window that it is much more likely that he/she intended the previous window to remain closed, whereas a few seconds don't mean anything since for example the user might close the current window that he/she is working on and not even notice immediately that there are additional open windows for example of the browser), and preferably the user can change this time from the default. Another possible variation is that, since indeed the user might not notice that there was another open window of the browser for example even after a longer time and only then closes it too and later reopens the browser (which prevent the automatic restore of the current window), preferably the browser (or other application) also takes into account for example how much time the user spent on each window and/or how many tabs were open in that window when it was closed, and can assume for example that it is more likely that the user will want to reopen a window that had much more tabs and/or the window on which he/she was spending most of the time in the last session. Anyway, this problem is reduced by the ability to undo also the closing of windows (which is described further below this application) and/or saving automatically also a list of previous sessions (including open tabs and/or windows), as described further below. Preferably the browser saves automatically also the history of each window separately, since the user might for example want to restore windows that were open more or less at the same time into a different state in the individual history of different windows (this doesn't take much space since the browser can simply save for example just the links, and if used recently the relevant pages will probably still be in the user's local cache. If for example multiple histories are saved and certain links repeat themselves, for example a pointer to links that are already in the browser history can be used for example instead of the full link). Another problem is that for example in the Opera browser if the browser was unable to reach a url and is closed, when reopened the tabs with such url become blank tabs without the address. Firefox with the save sessions extension does remember the url but only if it had sufficient time to try reaching the page and displays an error message page. So preferably this is improved so that the url address is automatically saved even if the browser was closed before it displayed an error message for such urls, so that when reopened the user can try again to reach those urls. Another problem is that for example sometimes one (or more) tabs is causing a problem and when the browser reopens the save-sessions automatically restores also the problematic tab or tabs. Although for example in Firefox the save-sessions extension offers the user in such a case to ignore the saved session, preferably this is improved so that the save-session feature can also offer the user in such cases for example to automatically remove only the problematic tab or tabs so that the browser can be reopened for example with all the other tabs intact and the problematic tab does not show or for example its handle exists but when the user clicks on it for example only the url is shown with a message that it has caused the problem the last time. So preferably if the browser has crashed and/or for example continues to crash at least 1 more time on the next re-open, preferably the browser can automatically reopen the next time automatically without the tab or tabs that were responsible for the crash (for example as default and/or with request for user confirmation for disabling the problematic tab or tabs, preferably by displaying at least the url and/or title of each such problematic tab), so that preferably it reopens the next time without that tab or tabs or for example shows their url and/or title but displays for example, instead of displaying their content, a message that the tab has been disabled due to causing a crash the last time (and/or for example this message enables the user for example to try again anyway to reload the problematic tab, for example by pressing a link or button in the displayed message and/or for example by pressing the normal reload button). Preferably the above behavior is displayed for example both in case the user himself/herself reopens the browser and in case the browser is configured to reopen automatically after a crash. Preferably the browser also indicates automatically the cause of the crash and/or estimated cause, and preferably the browser knows which tab or tabs caused the crash for example by a fault protection trap for example in the browser's software which is for example activated whenever there is a problem in some thread, so that preferably the browser can document the problem and the identity of the relevant tab before closing, and/or for example each tab or thread preferably automatically keeps some log, so that the crash and the casing tab or tabs can be identified automatically when the browser examines the logs the next time. Another possible variation is that preferably for example the above described trap can be used for example in order to prevent the browser form crashing in all cases or at least in some of the cases where a tab encounters a run time error, so that preferably the browser can automatically close or disable the problematic tab or tabs and/or request user confirmation before trying to reopen it, as described above, preferably without the browser itself crashing, so that the other tabs remain open. Another possible variation is that similar methods are preferably used to prevent cases where for example a run time error in one of the open windows of the browser causes other open windows of the browser to close—so that preferably in this case there is at least one process of the browser which catches run time errors which could cause other open windows to crash, and/or for example when disabling tabs and/or warning the user on reopen preferably both the relevant tab(s) and/or relevant window(s) are indicated. Another problem is that if there are many tabs open (for example 20 or 30 or more) and the user closes the browser and then reopens it, it can take quite some time till all the tabs are restored and during this time the user cannot use these tabs or even a new tab productively since the multiple downloads of all the tabs are slowing everything down. So preferably this is improved so that upon reload the browser preferably gives higher priority in download and/or in cache allocation to the tabs which the use most recently viewed before closing the browser the last time (preferably for this the browser can use for example the heuristics that the tabs at the right edge are typically the tabs most recently viewed, but more preferably the browser preferably saves automatically for each tab for example a tag with the last time the user viewed it or clicked on it), and/or for example if the user after reopening the browser clicks on a certain tab handle (or for example also if he/she merely hovers over it) preferably the browser immediately gives download priority to that tab, and if for example the user opens a new tab preferably that tabs gets the highest priory, so that preferably each time the tab or tabs that are at the focus of the user work preferably at the highest possible speed and the other tabs preferably continue to download at the background with lower priority and/or lower speed until the reload is complete. Another possible variation is that for example a session with the current open tabs, preferably including the history of each of them, can be saved for example in a standard format that can allow easy porting between different browsers, for example by using a simple html page (or for example XML format), and if for example the browser allows marking a set of links and opening them at once or for example clicking on an icon or menu option that opens automatically all the links of a page (preferably by default into multiple tabs) then the effect of reconstructing the session can be easily achieved. Another problem for example with Firefox is that extensions are limited to the current version so when a new version of the browser comes out, extensions that have not been updated for the new version don't work. So Preferably this is improved so that for example as long as commands have not been deleted in the new version of the browser or its scripting language, preferably the browser can automatically update the extension to work on it ignore the specified version. Another possible variation is that when the browser shows the list of extensions preferably the list indicates also near each extension the url from which it was installed. Another possible variation is that whenever the user installs an extension preferably a copy of it (for example the XPI file in case of Firefox extensions) is also automatically downloaded (for example to the user's default download directory), so that for example if there are later problems the user has automatically the source of the extension available on his/her computer even if the extension is for example later removed form the url where he/she downloaded it, or for example the browser can automatically export to a file the source code of any installed extension upon request for example by extracting it from the installed extension. Another possible variation is that the browser enables the user to easily sent the list of extensions to someone else by email, for example by choosing a menu option that says for example “Send extensions”, for example in a way similar to “send page” in Netscape, except that what is sent is the list of extension (and preferably, as explained above, each entry on the list indicates also the url form which the extension was downloaded), and so the receiver can for example know exactly where to get any of the extensions that he/she wants, or for example the browser allows the receiver to automatically get any of the extensions which he/she for example marks in the received list, preferably from the indicated urls. (however the list of extensions is preferably sent in a simple html or even more preferably simple text format, in order to protect against attempt to deceive the receiver with a phony list that actually does something else, so preferably the user can see the list in plain text (for example for each extension the name of the extension and the url from which it was downloaded and preferably also a short description of what it does—preferably generated for example automatically by the sending browser for example by automatically extracting it from the original page at the time the original user installs it) and preferably when the user opens such a text file with the receiving browser preferably the receiving browser preferably automatically generates from it a list of sent extensions in which the user can mark what he/she wants and send the browser to get it (In addition preferably the browser automatically requests the user's authorization even for marked extensions if they are not from one of the already authorized sites, such as for example the Mozilla site, since the user might mark extensions without noticing the url). Another possible variation is that, like for example in the “Noscript” extension, the user can for example define a white list of domains or even specific urls in which to enable for example Javasrcipt and/or active-x or other active content, but preferably in sites which the user has not whitelisted yet preferably the user is explicitly prompted for active content, since in the “Noscript” solution in such sites the browser simply user a small mark at the bottom to indicate that Javascript has been blocked but the user might not even notice it and the user simply sees an empty or improper page. Another possible variation is that for example various extensions or plug-ins that speed up internet surfing by pre-loading links that the user has not yet clicked on (and/or for example the browser enforces this automatically) automatically disable any active content on the pre-fetched links and can enable it for example only if and when the user actually chooses to open the link. This is very important since otherwise the user can really be exposed to unnecessary risks since the pre-fetching of links would expose the user to active content or possible exploits on links which the user would not normally click on. (The risk is reduced if the pre-fetching for example only saves a cache of links without any attempt to interpret them before the user actually clicks on the link, but for safety reasons it is better even to avoid caching the code of pages that contain exploits, so another possible variation is that for example sections of the page that contain active content (for example Javascript or active-x subroutines) are automatically not saved during the re-fetch and instead the pre-fetcher preferably saves there only for example a special link or indication which is used for getting the actual missing part of or parts the page only if the user decides to actually click on the link). Another possible variation is that preferably for example the TCP/IP protocol (and/or other protocols that might exist or that might replace it in the future) are preferably improved so that for example at least the text parts in web pages are automatically compressed by the http server (for example by zip or other standard compression format)(this is less relevant for images since typically their format is already compressed more or less close to the possible optimum) preferably before sending to the browsers or other client programs that request them (actually if this becomes the standard then preferably the pages are saved on the server already in their compressed format so that the server does not have to compress them again on the fly each time they are requested, which is much more efficient, even if for example a local cache for recently compressed requested pages is used or the server), and preferably the browser (or other client program) automatically uncompresses the data automatically on the fly as it is being received. However, since browsers preferably can start displaying a page even before it is fully received, preferably the compression format a preferably modified format that enables decompressing parts of the compressed file as they arrive without having to wait for the entire file for starting the decompression. This is preferably done for example by including for example at the beginning of the file all the information needed to decompress what comes next, even in independent sub-units, or even more preferably for example by using a format which contains for example independent units of data, each with its own decompression information (for example in a way similar to base frames in streaming video), so that for example preferably the browser can decompress parts even if the beginning of the file arrives later than other packets. Preferably if for example CRC (or similar data) is used for checking integrity of the compressed data, preferably this data is kept independently for each sub-section, so that there is no need to wait for example for the end of the file to verify its integrity. In other words, the automatic pre-compression of pages preferably does not reduce the flexibility or ability of browsers to display information even before it is completely received. Since text data can typically be compresses by even 70-90%, compressing for example the html or xml parts of the page (preferably including of course the control commands for example within the ‘<’ ‘>’ marks), can significantly boost speed. Of course, packets can be for example instead compressed on the packet level, but that is less efficient since it would mean compressing also for example images or video data which cannot be efficiently further compressed anyway, and also wasting time on compression on the fly while it can be done more efficiently in advance based on knowledge of the text parts which can be most efficiently compressed. However, for compatibility issues for example with older browser who might not support this, preferably the http server keeps preferably for each page for example both a normal copy and compressed copy and preferably the new browsers that support this preferably tell the server through an appropriate code during identification that they support compressed text format of pages and then the server knows it can send them automatically the pre-compressed pages instead of normal pages. By using preferably the pre-compression of the saved files on the server in advance (so that they do not need to be compressed again on the fly each time they are requested), as explained above, and since usually the decompression is considerably faster than compression, and since typically bandwidth bottleneck problems are much more common than the user's CPU reaching its limit, the small extra time needed for the decompression by the user's browser and/or for example ftp client (or other client programs) can typically be much less than the transfer time saved. In addition, preferably the text or html editors on the server and/or similar client editors on the user's PC can preferably support the compressed files in a transparent way, so that for example html and/or xml files and/or other supported types are preferably automatically compressed into the special compressed format when saved and automatically decompressed when displayed for editing. Another possible variation is that, since it is very rare today that users request browsers to ignore images or use text-based browsers without images, and since in the normal http protocol the browser first requests the page and then requests its images according to the image-embedding code it finds in the page, preferably the protocol is improved so that the browser (and/or other internet applications) can preferably also give the server for example a url and request the server to send already in advance also all the related images and/or for example other embedded files and not only the page itself, thus saving on the unnecessary traffic of requesting for example each additional image separately, and preferably all of these are sent together in a single packet or at least combined into a small number of packets. Preferably by using for example an additional code for this when requesting the page, preferably backward compatibility is saved for older browsers or other applications that don't support this and continue to request pages normally. Another possible variation is the protocol is improved so that preferably the server can automatically send in advance all the information about embedded images and/or other data (preferably together with information about the size of each) at the beginning of the communication preferably before sending the page itself, so that the browser (and/or other application) can request them or decide if to request each of them or all of them in one bunch in advance even before parsing the page itself (this is preferably done by saving this data in advance on the server together with the page, for example in some automatically generated tag preferably at the beginning of the page or for example in a linked file preferably at the beginning of the page, so that the server preferably does not have to do this on the fly each time the page is requested. Preferably this tag is for example automatically generated improved html editors, and/or for example automatically added to the file for example by the http server if it is not there, for example automatically for example the first time that the server accesses the file). If this variation is used then preferably this also is preferably done by requesting the url with a special code, however if it is done for example by an automatically generated tag at the beginning of the page this is not necessary since the tag can be designed so that older applications which don't know what to do with it will simply ignore it. In addition, preferably in the above variations the page is preferably sent as a single large packet or at least as small a number of packets as possible, thus even further reducing the load on the routers (for example In Internet 2 the advantages of this will be even more automatic since the packets there can be considerably bigger anyway, and so saving unnecessary back and forth communication for fetching the embedded images and/or other files and thus enabling sending the whole page together with the embedded parts preferably in one large packet or a few large packets will be even more natural). Of course, various combinations of the above and other variations can also be used. Of course, like other features of this invention, these features can be used also independently of any other features of this invention. In addition, preferably the user can for example define or change which controls will do various things such as for example save a bookmark or open a new tab or open a new window, since for example in Firefox ˆD saves a bookmark and ˆT opens a new tab and ˆN opens a new window, whereas for example in Opera ˆT saves a bookmark and ˆN opens a new tab, so users who switch for example between brows might feel uncomfortable or confused with a different set of such controls. So preferably the browser allows the user to open for example a table that shows the current control characters and what they do and the user can for example change the controls for each action and preferably can for example define even multiple controls that can do the same thing, such as for example both ˆD and ˆT for saving a bookmark. Another possible variation is that the user can for example copy a group of or the entire set of tab handles from one open browser windows and reopen it in a another window of the same browser or even of a different browser (which can be done for example if the OS and/or some other application keeps track of the open tabs or at least of their url addresses or if this multi-tabs-copy and/or paste function is available in both browsers) Another possible variation is to enable for example also tabs for example in word processing applications and/or other applications, such as for example other Office programs (these tabs can be for example threads of the same window or for example normal additional windows of the same application, except that they have an interface like tabs in a browser). Another possible variation is that for example if the tabs become too many (and thus too small), the browser (or other application) can for example automatically and/or by user request enlarge the line of tab handles for example to two or more lines instead of one (for example like the taskbar can be increased to more than one line). Another possible variation is that for example the other windows of the same group can be shown for example in another task bar, for example at the top of the screen (but preferably visible only when the user is viewing at least one of the windows of the group), and/or for example within the typically blue top of the main open window of the group and/or for example at least the user can toggle into this mode. Another possible variation is for example to improve the AERO interface for example in Windows Vista, so that for example when the user clicks on the icon of the group for example in the lower taskbar (for example Word or an Internet browser), preferably instead of a list of names in lines below each other, the group can for example automatically expand for example to preferably small images of the relevant Windows, and preferably the size of the images is preferably automatically determined by the number of windows, so that if for example there are 4 windows then each preferably occupies more or less a quarter of the screen or for example a little less, and preferably for example by clicking on any of these preview images the user preferably immediately jumps into it. AERO apparently only shows a small image of each icon on the bottom task bar when the mouse is over it, and I am not aware of treating grouped windows in the way described above. In addition, according to the EARO demo video available from Microsoft at http://channel9.msdn.com/Showpost.aspx→postid=114694 (new_kam_vedbrat _aero_{—}2005.wmv), published Sep. 13, 2005, apparently when the mouse is on top of an icon in the bottom task bar the image shown has the same width as the icon. So this could be of course a problem if the icon is smaller due to having too many icons on the task bar. So preferably this is improved so that, at least if the icon is below a certain minimal width, preferably the image is automatically made wider than the icon—preferably with a minimal size which is preferably defined by default by the system, and preferably this definition can also be changed by the user. Another possible variation is that if the user automatically changes the desired size of these preview windows—for example by resizing such a window, preferably the other preview windows will also become automatically of the new size defined by the user, for example until he/she resizes it again, and/or at least as long as it is above some minimum size defined by the system. For example, the user might even enlarge the preview window for example to the size of a full screen or almost full screen (of course preferably without covering the other items in the task bar—like normal windows that are at full size), and/or the system might even for example choose this as default, which means that preferably by simply moving the mouse button over an item (for example an item on the taskbar or a tab handle in the browser) the item (i.e. the relevant tab or window) preferably instantly springs into view, which enables seeing much more easily than for example a small window of a few centimeters, and then when the mouse moves over the next item, the next item for example springs into full view instead. Another possible variation is that the user can achieve the same effect for example by hovering with the mouse over the task bar or for example over the area of the tab handles in the browser and rolling the mouse wheel, and, preferably this works in a circular way, so that after reaching the most extreme tab at the right the next tab becomes the most extreme left tab, and vice versa when reaching the extreme tab at the left in when going in the other direction. This is still much faster than the prior art, where the user would have to click on each item to view its contents. Another possible variation is that for example as the user moves the mouse vertically up or down over the list of names in grouped items (wherein this list appears for example only after clicking on the group item, as is done in current XP, and/or for example even after merely putting the mouse over the group icon), preferably a preview image of the window which the mouse is currently over its name preferably appears for example sideways near the item and/or near the list. Another possible variation is that for example when the user moves the mouse over the items for example in the taskbar (or items in grouped windows, or tabs) preferably the preview image springs into view for more than one of them (for example also for the previous and the next item or for example for even more items, for example automatically according to the current size of the preview window, so that preferably the images fill the space for example sideways for example for at least one such line of images), or for all the items. Preferably the user can choose the number of preview windows that will be displayed at the same time and/or how many rows of preview windows will be displayed and/or for example if he/she wishes that the preview windows of all the tabs (or windows, etc.) will all show up at the same time for example when the mouse is over the bottom task bar or for example over the browsers top tab handles bar, etc. Preferably if a tab contains for example streaming video, the streaming video continues also in the relevant preview window of the tab. Another possible variation is that for example when the user moves the mouse over these items they increase in size gradually around the current item, for example like the virtual magnifying glass features in maps, so that for example the squares on the taskbar or the squares representing the tabs (tab handles) become preferably gradually larger with more details (thus preferably containing more text in order to help the user to quickly identify it), so that the current item (the tab handle or the square in the taskbar over which the mouse is directly) is the largest, and/or the preview images similarly grow in size accordingly (preferably the change in size as the mouse moves is also gradual in order to keep the smoothness, or for example the change is in discrete jumps), or for example only one tab handle or square on the taskbar becomes bigger, preferably instantly when the mouse hovers over it. The increase in size can be for example vertical or horizontal or both, thus for example compressing automatically other tabs squares or taskbar items on the side for example or for example partially covering some of them or for example the expanded tab handle or handles or taskbar item become semi-transparent so that the tab handles or taskbar items behind it are still visible at least partially, or for example the extended tab handle or handles or taskbar items show for example in a second raw, preferably with some visual line connecting them to the original item or tab handle (and are preferably of course clickable also by themselves) or for example only a bubble or other structure with preferably only the text appears near the tab or taskbar item, but preferably instantly, and this bubble for example appears only for the current tab or taskbar item or for example also for one or more items on each side of it. If more than one preview window or bubble show up at the same time then preferably there is for example an automatic line or other visual connection which connects between the preview window or bubble to the item and/or preferably the user can also click directly on the bubble in order to enter the item, similarly to the ability to click on the preview window. Another possible variation is that for example the preview windows are for example a few centimeters in size, but for example if the user puts the mouse over the preview window itself (for example immediately or after a short time which the user can preferably change) it grows into a larger size even if the user does not click on it (again, similar to the virtual magnifying glass) and/or for example if the user leaves the mouse for more than a small time (for example 1 or 2 second or more) over a certain section of the preview window and/or moves the mouse slowly over a certain section in the preview window for example as if trying to read it, the system can for example automatically show that section in enlarged form (for example like in a magnifying glass area or for example by opening an enlarged version of that section in a larger additional preview window which is focused on that section or for example the entire preview window is further increased automatically with that section preferably remaining at the same current position of the mouse) (This automatic enlarging of the preview windows and/or of parts of them is preferably done for example by the system saving in advance each preview window in more than one size or for example saving a larger size and reducing it on a need basis or even for example using some feature in the graphic display card which can for example do the reduction or enlarging automatically, and this automatic enlarging can preferably be applied for example to any type of preview window for example in the various described variations where preview windows are used). Another possible variation is that if for example the user clicks on the preview window for example after having kept or slowly moved the mouse over a certain section of it (for example text or image), the actual page is opened with that section of text or image at the center of the screen or more preferably for example at the current mouse position, so that the mouse is preferably still found pointing at the same section when the user jumps to the actual page, and/or for example the mouse is automatically moved to the position of that section when the user jumps to actual page (however, that is less preferable since making the mouse position suddenly jump without the user actually moving the mouse can be confusing and/or annoying). Another possible variation is that the user can also for example move the preview window or windows into a certain position, so that for example the preview window or windows will show in the specific user-selected area. Another possible variation is that preferably the scroll wheel that exists in many mice between the two buttons preferably can also be tilted at least slightly to the right or to the left, which can preferably be used for scrolling sideways. This is preferably accompanied by some additional freedom for this sideways movement, for example by making the wheel a little thinner than in normal mice and/or the gap around it a little wider, so that for example it can be tilted 1-3 mm to each side. The tilting itself can preferably be sensed for example by a potentiometer which is changed when wheel is tilted or for example mechanical sensors or optical sensors or induction sensors or electromagnetic sensors. Another possible variation is that for example the title and/or url and/or for example file name is also displayed for example automatically, for example above the top edge of the preview window, preferably in normal text size that can be easily read, and/or even without the preview window and/or for example the user can toggle between various types of display (for example only text, only preview windows, or both) (Although in current XP and Windows 98 for example the url or file name is displayed in a small elongated square after some time if the mouse button is kept for some time over the item in the task bar, this is very different since it is so slow that it is quicker to simply click on the item in order to see what it is, so preferably this switched very fast for example as soon as the mouse is on the item—preferably at the same speed the preview images appear for example in the AERO interface). Although for example in Vista beta build 5270 there are titles which appear above the preview windows of the taskbar items, the title appears only after the user hovers with the mouse over the preview window for about 2 seconds, which is much less efficient than the above solution, in which both the preview window and the title or additional textual description preferably both appear instantaneously. Another possible variation is that for example when the user puts the mouse over an icon on the desktop or on the list of quick launch icons the system (preferably immediately, without the 1-2 second delay) displays additional info about it (preferably for example the file name and path) and/or the user can for example preferably easily control the length of this time threshold. Another possible variation is that when the user hovers with the mouse over an icon on the typically bottom task bar preferably the information that is preferably instantly displayed (without the 1-2 second delay), with or without preview windows and/or example at the top of the preview windows, preferably includes also the path and file name. Another possible variation is that for example whenever a message window is displayed on the screen the user can see for example the path and file name of the program or process that generated the message, for example by hovering with the mouse for example over the header of the message window or for example by right clicking on it and getting a menu, and/or for example the user can choose an options that for example makes the OS (or for example the security system or some other application) display this information automatically for example somewhere on the message window. Another possible variation is that preferably this information and/or for example preview windows are also displayed automatically for example for items that show up in the list of active programs and/or task manager that shows for example when the user presses Control-Alt-Delete. Another possible variation is that for example if the preview window is too small (for example only a few centimeters) and/or contains for example only or mainly text without images, the system can for example automatically decide to display for example only the title and/or first few lines and/or first few images in the windows, since otherwise, for example if these windows or tabs are for example Word documents or for example a list of Google search results, the user might not be able to distinguish between them if he/she is shown only a small preview window which only shows small text (in other words, preferably the system automatically analyses each window or tab, preferably already before the mouse is over it, and decides what type of preview would be most informative—for example a small image of the entire window if it is sufficiently graphic and/or if it is sufficiently different in general visually from the other or neighboring windows or tabs, and for example a few lines of text, preferably of the current position on the text, if it is for example a Word document with little or no graphics at the current page and/or for example the list of search keywords if it is a Google results page (preferably the browser uses various heuristics for finding that this is a search results page and for finding the search keywords, for example by finding that it is a search page for example according the url (for example Google, etc.) and according the typical regular repeating structure in which search results are typically displayed and/or finding the search words for example as parameters in the url and/or in the search box)(this text of the for example relevant Word lines or for example Google search keywords can be displayed for example in the preview window itself or for example above it, for example between the file name and the preview window)), and/or for example the user can define some preferences about what part or parts of the window to show in the preview. Another possible variation is that if for example there are multiple open word-processor windows and/or tabs of documents with similar names, preferably the system automatically highlights the sections that are different when displaying the file names, for example by giving these sections automatically a different color and/or showing the file names so that these different sections appear at the center. Another possible variation is that for example if some of the tabs are for example Google search results (or are for example related to the same site and/or have for example clearly something else in common—for example are Word documents or pdf files or were for example opened from each other, so that the sequence of opened tabs becomes one group, and this way for example if the user stars 3 different searches for example from 3 Google tabs, the other tabs automatically belong to the search subject from which they were opened), then for example when putting the mouse over one of these tabs (which means that the user is probably trying to find for example one of those Google search results tabs or for example Word documents or for example pdf files), preferably the system for example automatically displays for example only the preview windows of for example Google search results tabs (or windows) or for example Word tabs (or windows) or for example pdf tabs (or windows), for example next to each other in a line below the line of tab handles and/or for example automatically increases the size of the tab handles of these related tabs (for example on the same line of tabs, for example by making them simply longer and/or for example by making them protrude onwards and/or downwards for example like a 3d expanding ray of light, for example together with some shadow and/or color effects and/or animations, and/or for example in a new line of tabs below the current line). If these are for example Google search results tabs and also if for example within each such preview window what is most clearly visible is the search words as in the above variation (or for example the search words appear as text for example near the preview window, for example above it, for example between the title to the preview window), then the user can find the desired window or tab almost instantly, and then can for example preferably click on the desired preview window or on the tab handle (or taskbar square) in order to jump instantly into it (of course in any of the variations where preview windows are shown preferably clicking on the window instantly jumps into it and preferably before that preferably just hovering over it preferably further increases its size automatically, and preferably for example clicking anywhere on the active tab or window, for example between the preview windows, removes them and jumps back to the active tab or window). Another possible variation is that the user can for example manually drag or mark one or more tabs for example into a certain group, thus creating manually the groups, and/or for example even in this case preferably new tabs are by default added automatically to group of tabs from which they were opened. Another possible variation is that the user can for example type a string of letters or keywords and search automatically for example within all the open tabs of the browser (or for example in all the open windows for example of the browser and/or of another application or for example of all the open windows and the desktop) and so preferably for example all the tabs (or windows) where the searched text (and/or for example closely similar text) is found are preferably marked or and/or for example preview windows spring up for these tabs (and/or windows), for example as normal reduced size preview windows and/or preferably with the view of the area of the desired text, and then the user can preferably click on the desired preview window and preferably jump instantly into the relevant tab or window (the user can for example identify Google tabs or for example Words file tabs or for example pdf file tabs according to the first letter or symbol which is for example a typical shaped G in case of Google, which is usually visible even if the tab handles become very small). Another possible variation is that the user can for example search for text in the url (and/or in the contents of the tabs or windows), so that for example typing “Goog” or “google” will for example preferably instantly show all the preview windows of tabs (and/or windows) from Google, or for example typing microsoft will show all the tabs and/or preview windows from Microsoft, and/or if the user types for example “checkout” or “shopping cart” the preview windows of tabs or windows that currently show a shopping cart will be shown. The relevant tabs can be shown for example in an additional line of tabs below the original, and/or for example a pull-down list of only the relevant tabs is preferably instantly opened for example below the tab over which the mouse is hovering, which means that for example if there are for example 5 such tabs, the user can either click directly on one of them to jump directly into that specific tab, or (for example if they are already too small to see details and the user does not remember which of them is which) can hover with the mouse over any one of them and then immediately see a pull down list which shows for example at least one line for each of the relevant tabs of that category, and then by clicking on the line the user preferably jumps directly into the desired tab, and preferably each such line contains at the side, for example the right end, for example an X for closing that tab if the user wished to close it, and preferably the user can also for example mark with the mouse a group of tabs and then close them together at once, and/or for example the relevant tab handles on the normal tab handles line become for example preferably instantly wider and all the other (non-selected) tab handles become for example preferably thinner, so that the user can instantly pick only the relevant ones. This last option can be most relevant for example if the user searches for example in multiple goggle searches for example for various Altec Lansing speaker models and then for example decides that the most interesting results are about model ATP3 and then wants for example to go back and look only at the tabs that deal with this model. Another possible variation is that the user can also for example automatically close all the unselected tabs or for example automatically move them temporarily into some hidden buffer or line of tab handles which can later be retuned to (for example by going there directly or by returning to the original tab handles line or by selecting a new search within the open tabs) which don't currently clog the tab handles line, or for example this is what happens by default. Another possible variation is that for example the browser window can automatically become split for example into two windows, so that for example the current window has all the relevant tabs and all the other tabs are preferably automatically moved to the other window. Another possible variation is that the system or browser takes into account also the differentiating value of the word or words that the user typed, so that for example if the word google or microsoft appears for example in 20 out of 50 tabs but for example only in 8 of the tabs this word appears in the url or in the title of the page then preferably only the 8 most relevant tabs are shown (or for example all the 30 are shown but those in which the word is in the url or title are preferably shown for example in a more emphasized section at the top), but if for example the words “shopping cart” appear only in 3 tabs within the page itself these are shown even though it is not in the title or url. Another possible variation is that if for example there are too menu preview windows to fit on one screen, instead of adding a side bar for scrolling up or down, the browser (or other application) can for example automatically cascade the preview windows or cut each preview window so that for example only the top half or top third of the preview window is seen, and/or for example the user can for example choose the desired vertical cutting point of the preview windows (for example show the whole window, only the top half, only the top third, etc.) and/ore for example apply this even when there is sufficient room, since for example viewing only the top half of the window can actually save time since it can be less distracting and the browser preferably shows anyway the title and/or url on the top of the preview window. Another possible variation is that the user can for example mark one or more of the tabs to become more conspicuous so that he/she can instantly identify them even when there are many other tabs, so that for example clicking with the right mouse key on the tab handle enables this as one of the options, and then the marked tab handle becomes for example larger or higher or with some frame around it, or other visual mark. Another possible variation is that if for example the browser is allowed to wrap the tab handles line into more than one line if it becomes too dense, preferably the user can define for example the maximum number of tabs allowed per line or for example the minimum width of a tab handle. Another problem is that many sites don't have a predefined icon, which makes it more difficult to distinguish between them and other tabs when the tab handles become too small, so preferably in the tabs from such domains the browser preferably automatically generates an icon for the domain to put at the left end of the tab handle. This can be done for example by using automatically the first image that appears for example on the beginning of the page if it appears in all or most of the pages from that domain (and then use it preferably for all the tabs from that domain, or for example finding the first image that does seem to repeat in most them) and for example automatically reducing that image to the appropriate size and using it as the icon at the beginning of the tab handle, or for example taking the first letter of the domain name and adding to it automatically a certain color and/or style which is preferably made different for example for each domain or category of tabs (if the domain name for example starts with “the”, the word “the” can for example be ignored, especially for example if at least one other tabs is from a domain that also starts with “the”, or for example the “T” is used). Although there is for example an extension for Firefox called HashColouredTabs which helps when the domain does not have a predefined icon, it only adds a colored square, which is much less differentiating than the above variation. Another possible variation is to use a similar mechanism also for example for items on the bottom task bar, so that for example the open windows of the same application are not grouped, but when they become too small to see details for example (for example all the windows of Word or all the windows of Firefox or all the windows of MSIE) the user can simply hover with the mouse over any one of the relevant icons on the taskbar and then see the pull up list of textual choices and/or preview windows of the relevant group and then click on the desired line or preview window). Another possible variation is that similarly for the grouped items preferably each line contains also for example an X which the user can click on to close that window (and preferably the user can for example mark with the mouse a group of the windows and then close them together at once), and preferably closing a window does not make the menu of windows disappear (which is much more convenient than the prior art in which for example in Windows XP the user has to click on the right mouse button and then chose close form a menu that opens, and in addition to that the pull-up menu disappears after each such action and the user has to click again on the group icon, which is very tedious, unless of course the user wants to close the entire group at once). Another possible variation is that for example each square on the task bar contains for example an X (or some other mark or icon), for example on the right or on the left side of it, for quick closing for the window, instead of having to right-click with the mouse, wait for the menu to appear and then choose the 'close’ option (however, for compatibility reasons preferably this menu also continues to be supported so that the user can user either of these methods to close the window). Another problem for example in tabs is that for example in the Opera browser when the tab handles become smaller (for example already when there are around 13 tabs in the same browser window) the X at the right of the tab handles for closing the tab disappears and shows again only after the user clicks on the tab handle, which is inefficient since now the user has to click twice for closing a tab instead of only once, and also there is a problem that when the tab handles become even smaller (when there are around 30 tabs in the windows), when the X shows it fills up almost all of the space of the tab handle. (In the Firefox browser for example when the Firefox is used with the “Tab X” extension, when the tab handles become too small the X becomes partially hidden until it almost disappears altogether). So preferably this is improved so that the “X” (or other letter or icon for closing) shows always, without having to click once before seeing it, and preferably the X (or other letter or icon for closing) becomes automatically smaller when the tab handles becomes smaller (however it preferably becomes only thinner and not smaller in height since reducing the height will not gain anything), preferably without parts of it becoming hidden, so that preferably it is still not more than a certain percent of the tab handle's space (and/or at least until the X reaches a certain minimal size), which is no problem since users can be quite exact with the mouse movements. Preferably a similar solution is used if for example such an “X” (or other letter or mark or icon for closing) is added for example to the squares (or similar shapes) which represent items on the taskbar (However, since the user might click on the X by mistake, preferably this is combined with the variation in which the user can for example press ˆz or some other key in order to reopen any window if it was for example closed by mistake, as explained elsewhere is this application). Another possible variation is that for example if the user is clicking consecutively (for example at or beyond some minimum threshold speed) on the “X” for closing tabs even when not closing each time the most extreme tab on the right, preferably the browser automatically makes the X of the next tab handle jump into the same position (for example by dealing differently with the width of the tab handles to the right and to the left of the position where the user is clicking on the X and/or by changing the position of the X within the tab handle that is currently at the clicking area), so that preferably the X remains at the same position after each deletion, and then preferably for example after a second or more after the user stops closing tabs preferably the tabs handles regain the correct width. Another possible variation is that as the tab handles (or for example the squares on the taskbar) become smaller preferably the text of the tab handles (or squares on the taskbar) becomes automatically thinner (preferably without reducing the height), thus enabling the user to still see more information, however this automatic thinning is preferably limited till a certain threshold (for example text gets thinner until it becomes 70% of the original width or some other reasonable threshold, preferably changeable by the user), since becoming too thin might make it too much effort to read conveniently. Another possible variation is that similarly the original icon of the site (or the icon automatically generating by the browser), which is typically shown at the left of the tab handle (or the icon of the application on the taskbar, at the left of the square) also become similarly automatically thinner as the tab handles (or squares of the taskbar) become smaller. Another possible variation is that preferably as more tab handles (and/or for example boxes on the task bar) are added and become more crowded preferably the borders between the tabs handles (and/or for example boxes on the task bar) preferably become automatically thinner relative to the size of the tab handles themselves and/or for example the wasted spaces on the right and on the left of the icon/text of the tab handle (or box on the task bar) preferably become automatically smaller relative to the space occupied by the icon and/or text—so as to maximize the available space for displaying the actual informative part. Of course, various combinations of he above and other variations can also be used. Another possible variation is that for example if more than one version of the same application is open at the same time (for example Word 2003 together with Word 2007), preferably the OS for example automatically adds differentiating information to their icon at the left of their square on the taskbar (and/or for example when showing them when pressing Alt-tab), for example by adding automatically the words 2003 and 2007 respectively for example at the bottom of the icon). Another possible variation is that preferably the user can automatically convert for example any proportional fonts into fixed space fonts and/or vice versa, thus creating preferably a new additional font which preferably has the same name as the original font, preferably plus preferably an extension which preferably says if its proportional or fixed and/or if it is original or automatically converted font. This conversion is preferably done for example by automatically thinning or widening characters as needed and/or for adding or removing empty pixel columns on their sides. These additional new fonts can then preferably be used for example in the word processor and/or in other applications or for example as various OS related fonts. Another possible variation is that for example the user can request the OS to create this conversion for example automatically to all the installed fonts. Another possible variation in that the user can for example perform the conversion for example on the current fonts for example in a specific document and/or for example if the converted fonts already exist, for example instantly replace each font with the equivalent fixed font or with the equivalent proportional spacing font, and preferably this is also is one of the changes which can be previewed for example in Office 2007 before clicking and actually making the change, Another possible variation is that the “X” (or other icon) for closing windows is also added for example to the decks of Windows that show in the flip 3d and/or to the icons and/or preview windows that show when the user clicks Alt-Tab or for example to the items in the pull-down menu that can preferably show all the tabs in the browser (preferably in addition to the normal tab handles). Another possible variation is that preferably the user can define for example the smallest size that a tab handle or a square (or other shape) on the taskbar can become and/or the maximum number of squares or tab handles per line, because for example in the prior art Windows XP the OS automatically decides when to start using and additional line or lines with a scroll bar without asking the user, eventhough the user might prefer for example more smaller tabs without resorting to the scrolling between additional lines, at least until there are more tabs on the normal line (or lines) without scrolling. Another possible variation is that the user can for example use the mouse to reduce the size of the section devoted to the Start button, so that for example the Start button can become as small or as thin as the user wants, thus gaining more space for the squares on the taskbar. Another possible variation is that for example after a certain amount of squares is reached on the taskbar and/or the squares become smaller than a certain threshold, for example one or more additional lines of squares can be automatically added for example by making the square lines (for example automatically and/or as a default which the user can enable or disable) shorter in height. This is no problem since in the normal taskbar for example in Windows XP there is clearly a wasted area at the top and bottom margins of each square. In this case preferably the icons that typically show at the left of squares in the taskbar preferably become automatically shorter in height and/or for example the top and bottom margins become closer to them. (A similar variation can also be used for example with tab handle lines for example if more than one tab-handles line is needed, for example in the web browser. Another possible variation is that for example if additional taskbar lines have to be added they are for example added automatically on a need basis without resorting to scrolling between taskbar lines so that one or more lines can become invisible (and preferably the user can define the maximum number of lines that can thus be added automatically and/or if scrolling should be disabled or enabled). If for example more taskbar lines are added and for example the taskbar begins to cover some icons at the bottom part of the desktop then for example these icons are preferably automatically moved up if there is room or for example the entire desktop above the taskbar (for example in Windows Vista) can for example automatically become slightly compressed in height to fit the new reduced height of the desktop, preferably while keeping everything in proportions or for example just the vertical spaces between icons are automatically reduced while the icons remain at the same size, and when the taskbar becomes again shorter in height (for example because of closing open windows) then preferably this is also automatically returned to the way it was before (unless for example the user indicates that he/she wants to keep the desktop view this way even after the taskbar becomes smaller again (for example by entering some menu for this or clicking on something). Another possible variation is that for example the “>>” arrow at the right of the quick launch area can be on top of the dividing border that separates between this section and the central section of the taskbar, and/or similarly for example the area that enables enlarging or reducing the size of the system tray, thus increasing further the free space left for normal squares (or other shapes) on the taskbar. Another possible variation is that the user can for example define various general rules or conditions for displaying or hiding items in the system tray, for example according to certain events. Similarly, there is a problem that if the user for example installs the Microsoft desktop search on Windows XP, it installs a search window which occupies a whole section in the taskbar and does not allow the user to reduce that section to less than about 5.5 centimeters, So preferably this is improved so that the user can reduce it to any size he/she wants, which is no problem since anyway automatic horizontal scrolling is used if the text is longer than the size of the search windows. (Of course, like in other places, various combinations of the above variations can also be used). Another possible variation is that preferably the square on the taskbar that represents an open DOS or cmd window preferably shows also the drive letter and the path of the open window, instead of showing for example always the letter and path “c:\” as is done for example in Windows XP (and/or preferably the path is also displayed for example on the top line of the open window). Similarly, preferably the path (including drive letter) is also displayed for example in the relevant square in the taskbar for example for open word processor documents and/or other applications and/or for example on the top line of the open window which shows the file name, since in the prior art if the user for example opens for example in Word two similar or identical file names in two different directories, it is very difficult to know which is which. Another possible variation is that preferably the DOS or cmd window keeps more consistency with normal windows, so that for example the user can click or double click on a file name in order to run it and preferably the mark and/or copy and/or paste work also the same way they work in normal windows (for example by dragging the mouse with the left mouse button clicked and pressing ˆC or ˆV), without having to right-click with the mouse on the cmd window and choosing mark or paste from a menu. Another problem is that for example in Windows XP pasting into a CMD window works much slower than for example normal paste in Windows or for example pasting into a DOS windows in Windows 98. This slowness might be useful for example in some applications which might expect the input to be slower, but this is very rare so normally this is just annoying and inefficient. So preferably this is improved so that pasting into a CMD windows is preferably done at the normal fast speed and for example if there is a specific problem with some application then preferably the user can use for example a separate command (for example other than ˆV or the normal paste command) which works in the lower paste speed (and/or preferably the user can for example set the speed itself on the low-speed command so as to be able to optimize it to the maximum that can still work OK). Another possible variation in that preferably this is accompanied for example with a sufficiently large input buffer of for example at least a few Megabytes or more so that for example the buffer can keep the patched data for applications that are slower but are able to signal when they are unable to read the input fast enough. Another possible variation is that for example when deleting a file from a DOS or CMD window it is also added automatically to the recycle bin, like when deleting a file for example through the Windows explorer, and can then preferably be undeleted for example by dragging it back from the recycle bin (for example through the Windows explorer) or for example by copying it back from there for example within the DOS or CMD window. Another problem for example in Windows XP is that for example Hebrew fonts in file names that can be seen in Hebrew for example in the Save or Open dialogue box may be displayed for example as questions marks in a cmd window. So this is preferably improved so that the fonts in the cmd windows are displayed the same way and in the explore or dialogue box. Another possible variation is that for example if the OS does not know how display some fonts it will always use at least some meaningful character set and preferably allow the user to easily change the set, but will preferably never display just question marks. Similarly, for example in Windows Vista preferably the OS enables the user also to run programs from a cmd window in elevated mode, for example by adding this as one of the options in the menu for example when right-clicking on the item with the mouse, and/or for example when double clicking or single-clinking on an item (for example with the left or the right mouse button or either of them) (for example both in cmd windows and in normal windows or on the desktop) preferably a menu appears which lets the user choose between Run normal and Run elevated. Another possible variation is that for example the user can activate programs on the desktop by clicking only once on the icon for example with the left mouse button (as is done for example with quick-launch items on the taskbar) instead of having to click twice. (In Windows Vista this is preferably combined with the above options of Run elevated, so that for example after clicking once on a desktop icon the menu which allows choosing Run normal or Run elevated shows up (preferably with normal run pre-selected, and then for example if the user clicks again on run normal or even just clicks again on the icon then preferably normal run is activated and only if the user explicitly clicks on the option of run elevated then that option is activated). Another possible variation is that for example hovering with the mouse on any item in the tab handles line opens for example a pull down list of all the open tabs (preferably for example together with the symbol or icon of the site or domain for example to the left of the text in each line), or for example the list shows all the tabs but those from the relevant category (for example from Google if the user hovers over a tab of a page from Google) show up in a top section of the list and/or more emphasized), and/or for example all the preview windows of the tabs are shown but those from the relevant category appear on the top and/or emphasized. Of course, like in the other places, various combinations of these variations can also be used. Another possible variation is that for example when the user clicks on the group icon for example with the right mouse button, one of the options (in addition to “close group”) is for example “minimize group, which minimizes all the windows of the group without minimizing other windows (which would happen if the user for example pressed the “show desktop” icon). Like with the preview windows, preferably the number of open tabs in each window is preferably indicated also in each line of the pull-up menu and/or for example in the relevant square on the task bar, for example if it is not a grouped window. Another possible variation is that for example the desktop search is modified to preferably automatically search also for example the currently open browser tabs and/or windows (currently Google desktop search and the Microsoft desktop search don't do this). In this case preferably results from open windows and/or tabs (and/or other currently open files) are preferably displayed in a separate category (since they are by definition the most recent)—for example on top of the list of results and/or for example on a separate category, and preferably these results and/or other types of results are shown together with a preview window for example next to them. The desktop search can access the browser's open tabs for example by monitoring which urls are being opened (for example though the firewall) and/or for example by becoming defined also as a browser helper or plug-in (and/or installing for example also a related browser helper or plug-in, which can for example show as a search box for example at the bottom of the browser window) and/or for example by searching the most recent cached urls in the browser's area of temporary files, and/or for example by other preferably standard communication with the browser. If the user wants to search for example only for text in the currently open tabs then this can be entered for example by typing the search string or keywords while the mouse is for example anywhere in one of the open web pages (but not in a form field), in which case preferably the browser or for example desktop search application preferably automatically identifies it as searching for text in open tabs (and/for example also other windows for example of the browser), or for example the user can type it only when the mouse hovers over or near the tab handles line or for example above it, or the user can for example type it in the special search box for example at the bottom or top of the browser window, or for example typing it anywhere on the page as explained above also automatically causes the text to jump into the relevant bottom search box (or for example if a voice recognition application is installed and running together with a microphone, the user can preferably also for example say the words, for example “google” or “shopping cart”, for example while the mouse is for example anywhere on the web page preferably outside of form fields, and then preferably the search in the open tabs is performed as explained above). If the search in the open tabs or windows is done for example as part of the desktop search and is for example displayed as a special category, preferably at the top of the search results, as explained above, then the user can for example type it in the normal search box of the desktop search. Another possible variation is that when installing the desktop search preferably it automatically indexes first the most recent files and/or directories, since most likely the user will search for more recent things, and thus the desktop search can become useful even after it has only indexed a small part of the files. Another possible variation is that for example the desktop search line contains by default the last search word or words or string which the user searched for and preferably if the user wants to change it he/she can for example move over it for example with the arrows or mouse and change or add characters and preferably if he/she starts typing something new from the start then preferably the previous search string automatically disappears. Another possible variation is that when displaying search results for example from multiple open tabs and/or windows the cursor and/or display jumps into the relevant text and then jumps again when the users jumps to the next found occurrence of the text, and when the last occurrence is found in the current tab or window then the next jump is automatically to the occurrence of the text in the next tab or window where it occurs, etc. Another possible variation is that the user can for example define the level of priority for various criteria for example for displaying the desktop search results, such as for example define how much weight to give to recency versus relevance. Another possible variation is that when the user is shown the desktop search results (for example form the Google desktop search) preferably for example he/she can drag a result to the desktop to create an icon for it. Preferably the results from the indexing of the open tabs or windows are also kept for example in the desktop database even after the tabs are closed so that if for example the user later searches for these keywords preferably the results can include also for example bookmarks or histories which contain links to the pages where these words appeared (this is better than searching for example over bookmarks to find some site which the user wants to return to, since sometimes the words that the user remembers appear not in the title or url but somewhere within the page at the URL). Another possible variation is that the user can for example tell the desktop search to index for example also the existing bookmarks and/or history lists that were already existing for example at the time the desktop search was installed, in which case preferably the desktop search can for example open all the relevant URLs (for example through the browser and/or preferably while taking advantage of the local cache of at least recently visited web pages) and index them automatically in the background. Another possible variation (for example if the user uses for example the Google desktop search) is that preferably the search application for example just sends for example to one or more of the Google databases the list of relevant urls and gets the relevant indexing preferably instantly for example from the Google databases (since these web pages are constantly indexed anyway on the web), and/or for example when the user searches for something locally or on the web the Google search application can for example search automatically also in the list of bookmarks or historically saved urls (automatic history list) if the desired keywords appear in them and then for example can display them for example in a special results category (and/or for example the desktop search and/or the browser can for example check for each search result if it already exists for example in the bookmarks and/or in the history list or lists and/or for example display those results for example with a special mark that indicates that the user already visited them). Another possible variation is that for example when the user is browsing the net and suddenly for example one or more of the tabs or windows begins for example to play a sound or video file, preferably the relevant tab and/or window is automatically marked for example with an appropriate icon or other preferably visually conspicuous mark, for example above it (and/or for example the relevant preview window is specially marked), so that the user can immediately identify the relevant tab or tabs or window or windows and for example directly jump into the relevant tab or window or for example close it if the sound is annoying (in other words the mark is preferably on the square of the relevant application on the taskbar and/or on the tab handle of the relevant tab). This is very important since otherwise it can be for example very annoying if the user has for example 20 or more open tabs for example in the browser and suddenly for example one of or more of them begin to play a sound file and the user has to start searching for it one by one. Another possible variation is that for example the browser can automatically group together tabs that are related to the same url (for example all Google search results pages) for example by placing them near each other or for example by creating a group icon for the related tabs, for example in a way similar to grouped windows on the desktop task bar. All of these solutions can be applied also for example for tabs for example in the browser or for grouped windows (the use of this with tabs in a browser can be one of the most important uses since typically there can be much more open tabs within a browser than open windows on the desktop). Another possible variation is that for example when putting the mouse over the bottom taskbar or over the tab handles line on the browser, for example the mouse's scroll wheel (alone or for example in combination with some other key) can cause the tab handles (or squares if it's the desktop bottom taskbar) and/or the preview windows to automatically grow or shrink in size, preferably for example by automatically reducing or increasing the number of lines used for the tab handles or squares or and/or for the multiple preview windows. Another possible variation is that the for example the bottom task bar and/or or for example the browser's line of tab handles is for example one or 2 lines but when the user puts the mouse over it, it automatically expands to more lines (this way multiple lines can be used when the user intends to click on something there but they don't interfere with reading web pages when the user is not dealing with the tab handles line), however that can be problematic because it can be confusing if the user intends to click for example on a certain tab but then the automatic expansion moves the desired tab to a different position, so preferably, if such automatic expansion is used, preferably the automatic expansion is done in a smart way so that the current tab (or for example the current box on the bottom task bar) over which the mouse is held (or for example also the other nearest tabs) preferably is automatically kept at the same place even after the expansion. Another possible variation is that for example when the user puts the mouse on the tab handles line preferably the tab line automatically expands for example into a tree structure (for example instead of the original tab line or for example the original tab line remains as it is and the tree expands below it) and/or for example the preview windows are shown in a tree structure. This tree structure can be for example constructed automatically according to the order in which the user reached these tabs, so that for example the roots are tabs which started at the user's default home page and/or for example Google search pages and the branches continue according to the order of clicking on links that opened the following tabs, or for example the trees are constructed automatically for example according to domain and for example the path length in each domains, but that is less preferable since that would be less relevant to the user. Another possible variation is the user can for example choose or toggle between various options, such as for example showing the tree structures (and according to which rules) or for example showing only the preview windows of the relevant category, such as for example the preview windows of Google search results pages for example when the mouse stands on one of the Google tabs, as explained above, and/or using for example automatically grouped tabs on the tabs handles line. Another possible variation is that for example when the user searches for some web page for example in the bookmarks or history, preferably preview windows are also shown there (for example to the side of the url). This can be done for example by the browser automatically bringing the relevant pages and reducing them to preview images for example directly from the web when the links are displayed, and/or for example from the local cache on the user's computer if available, and/or for example the preview windows are saved in advance automatically somewhere on the user's computer for example at least for the most recently visited pages. Another possible variation is that the web servers are improved to automatically create in advance preview images of pages (for example each time after they are created or changed)(for example the size of 1:10 of the normal first screen of the page) and preferably submit them directly as preview images upon request (for example by adding a specific convention to the http protocol for requesting them) so that for example the preview image can be requested even without the page (for example by requesting any url with an addition of a code that indicates that only the preview image is requested) or for example the web server adds it automatically as an added data for the page. Another possible variation is that for example the tabs can automatically become grouped, so that for example all the Google search results become automatically represented for example by one Google tab and when the user puts the mouse over it and/or when he/she clicks on it, it expands for example into multiple tabs (for example on a second tab handles lines) and/or the relevant preview windows, and/or for example the grouped tabs are generated according to the above described tree roots or for example like in any of the other variations described above. Another possible variation is that the user can for example push for example with the mouse for example some of the tabs (or for example squares in the bottom task bar) sideways, so that for example the tab handles (or for example squares on the taskbar) from the mouse position up to the left end become smaller and more compressed and so the tab handles (or for example squares on the taskbar) to the right of it become bigger and more clearly visible, or vice versa. (Since dragging a tab handle with the mouse for example in Opera moves only the attached tab, thus changing the order between tab handles, preferably for compressing a group tabs there are for example vertical thin rods that go up between tab handles, so that for example the user can drag with the mouse the appropriate rod to the right or to the left, or similar arrangements). Another possible variation is that the user can for example use a control or menu choice which closes for example all the tabs for example to the left of the current tab (or for example to the right, but to the left is much more useful since it normally means closing all the previous tabs). Another problem is how to display for example preview windows of windows that themselves contain multiple tabs, for example on the bottom task bar, such as for example the preview window of the browser itself, or for example a preview window of a grouped icon. So preferably the preview window of for example a browser window with multiple open tabs can be for example the preview window of the currently active tab, and preferably next to it (for example above it, for example between the title and the preview windows), for example an indication is given of how many tabs are open in that window, and/or for example the preview window in this can be for example some symbolic preview window for example with a number of small squares that represent the number of open tabs, or for example with automatically generated squares that represent the tabs themselves (for example extra small preview windows of the tabs within the preview window of the browser window, which at least give the feel of the general color of the tabs, or for example a copy of the actual tab handles or whatever part can be made available within the space of the preview window). Similarly, for example if textual choice lines (for example the typical pull up list) are used when clicking on a grouped icon and for example some of the individual windows contain tabs, preferably the number of tabs is indicated near each of them. For example the preview window of a grouped icon can be for example a preview window of the menu of choices that will spring up when the user clicks on it (for example in reduced size on in the normal size, and if the user clicks on one of the options there preferably he/she can enter the desired choice even without having clicked on the grouped icon). Another problem with grouped icons (for example of browser windows or for example word processor windows), is that whenever the user moves for example from the browser window to some other application and then clicks on the grouped icon to go back to the browser, the system automatically displays the choice menu of the grouped icon even though the user would most likely want to return to the same browser window that he/she was previously in, in which case the user has to search again in the list of choices to find this last window, which is unnecessary and inefficient and can be very annoying. So preferably this is improved so the user does not have to search again if he/she wants to return to the last used window of the group and/or preferably also does not have to click more than once for this. So when returning to the grouped icon the system preferably for example moves the user back to the last window of that grouped icon that was in the forefront (for example the last browser windows which the user was looking at before jumping to the other application or applications), and for example only then if the user clicks again on the grouped icon then preferably the choice menu is displayed. Another possible variation is that when the user clicks on the grouped icon the system preferably moves the user preferably instantly back to the last open window of the group in which he/she was, as above, but preferably the choice menu (for example textual, for example line below line as usual, and/or for example by preview windows, and preferably the preview windows also contain for example at their top the title and/or url or other textual information) is also shown for example for a certain short time period (for example a few seconds and/or until the user clicks for example on the window or for example on another window, however preferably the choice menu and/or preview windows don't go away if the mouse remains over any of them), and so if the user intended to go to another of the windows of the group he/she can simply click on the desired choice, otherwise he/she can continue immediately working in the last window. Another possible variation is that for example when the user puts the mouse over the grouped icon the choice menu (textual and/or for example preview windows) appears (preferably instantly—without any delay) without the user having to click on the icon, and then if the user clicks on the grouped icon preferably he/she is moved preferably instantly into the last window, and if he/she wants to go into another window he/she can click on the desired choice (for example the relevant preview window and/or relevant text choice option), and thus the user still gets to the desired window with one click and does not have to search again if he/she just meant to get back to the last window. Another possible variation is that when the user licks on the grouped icon the choice menu (textual and/or preview windows) appears and preferably the last windows in which the user was in is already marked and/or pre-selected in the textual choice menu and/or preview windows so that the user does not have to search for it again and preferably just clicking again on the mouse button will bring the user to the last window (so in other words, quickly clicking twice on the grouped icons can bring the user back to the last window, or for example the user has to move the mouse in order to click on the marked and/or pre-selected choice if he/she wants to enter the last window, which is even less preferable, since it involves additional movement with the mouse), however this is less preferable since the user has to click twice in this variation instead of only once in the other variations. Another possible variation is that for example when the user clicks on the grouped item, the last window of the grouped item in which the user was in preferably appears automatically as the lowest option (and preferably appears pre-selected as and marked as pre-selected as described above), which means that the user has the least distance to move if he/she wants to click on that option. Another possible variation is that this pre-selected option actually appears on top of the square of the grouped item, for example by partially or fully covering it and/or it appears for example at least partially transparent so that the taskbar and the square of the grouped item still shows below it, which means that if the user clicks quickly twice on the grouped item he/she will again automatically return to the last item in which he/she was in that group. Another possible variation is that the user can for example enlarge sideways the lengths of the lines which show in the grouped item menu so that more information can be visible in them (so that preferably this becomes the new default until the user changes it again) and/or for example the OS can enlarge it automatically as needed (for example according to the longest title and/or according to the average length of the titles, etc.). Of course various combinations of the above variations can also be used. Another possible variation is that if for example the user is interacting with one application and then for example clicks directly inside an open window of another application (for example Word or a browser or other application), preferably the first click is not removed from the buffer of clicks, so that for example the user can preferably for example mark directly an area in the other application without having to click again. (In the prior art Window the user would have to click again since after transferring focus to the ₂nd application the first click that was used for the transfer becomes lost). Another possible variation is that for example even if the user chooses not to group multiple windows of the same application into a single grouped icon on the task bar, preferably when closing one of the windows for example from its icon on the taskbar preferably one of the options displayed in the pull-down or pull-up menu is for example “close all open windows of this application” (which is preferably all the windows that would have been automatically grouped together if the automatic grouping was On). Similarly preferably one of the options in the browser is for example to request to automatically close all tabs of the same category (for example from the same domain), for example by clicking with the right mouse button on one of the tabs of that category and choosing from a menu, instead of the normal clicking for example on an X at the side of the tab handle to close just that tab (or for example to close the grouped tab if it is a handle of a group of tabs). Another possible variation is that for example in the Google News (or similar sites) preferably news items are accompanied by a preview window of the item for example in addition to the pictures that accompany some of them or for example for each item that is not accompanied by a picture, the preview window is automatically added instead. Another possible variation is that the screen resolution is preferably automatically raised preferably for example to the maximum available at the areas of the preview windows. This can be done for example by improving the hardware and/or firmware of the monitors (at least for example in LCD and/or SED and/or Plasma monitors), preferably by enabling individual areas of the screen to behave differently in a dynamic way, and/or the hardware and/or firmware of the display adapters and/or their drivers in order to enable setting different resolutions at different areas of the screen, and/or for example the OS preferably automatically chooses or enables the user to choose for example the highest available resolution (for example 1600×1200 or for example 1900×1400), and then the OS emulates the lower resolution which the user normally uses (for example 1024×768) preferably by software and/or for example through the driver, and/or for example the hardware and/or firmware of the display card does it, and so the real resolution is for example the highest but the user sees it for example only in the preview windows and/or for example when playing DVD movies and/or in other specific activities, etc. However, if the system for example enables anyway changing the resolution in a truly independent way that can leave the fonts and/or icons and/or every thing else that is relevant (for example menus, the taskbar and/or anything else in the user interface) unchanged (and alternatively allows changing them, if so desired, independently of the resolution), as described elsewhere in this application, then the user can for example work all the time with the highest resolution for everything (as long as for example the refresh rate and/or performance for example is still high enough) without having to suffer too small fonts or icons because of that). If for example there is a performance or refresh rate issue when working all the time in the highest resolution, another possible variation is that for example the entire resolution of the screen can change preferably instantly to a higher resolution for the time period that the preview windows are shown and then instantly change back to lower resolution, preferably without any noticeable jump or delay that the user can perceive, except for example the lower refresh rate for a brief period. Another possible variation is that preferably the user can activate a command which automatically jumps each time to the next window (for example in the normal task bar on in the internal group of open windows that belong to the same application or for example between open tabs in the same application—for example in the Internet browser), so that preferably each time the user moves to the next window systematically. This is much more convenient than the prior art, where the user has to press alt-tab or control-tab but each time just moves manually to a specific window instead or has to use the mouse manually each time to get to the desired window, instead of being able to systematically traverse the relevant open windows one after the other. Another possible variation is that for example when the user presses alt-tab to move between windows (and/or for example when he/she presses control-tab to move between tabs)(or other similar keys for jumping between open windows or applications or tabs) preferably items in the group of items shown (which can be for example icons and/or preview windows—in other words the preview windows are preferably displayed together next to each other (for example in a few lines and columns) at the same time instead of or in addition to the normal icons, so that for example if icons are also used then for example each preview windows has also the relevant icon, for example above it, preferably together with the title, so that the preview window (and/or icon) and the title preferably show up together as one unit, so that the user does not have to look at two separate places) can also be accessed for example by clicking with the mouse on any of them, instead of the prior art in which only the tab button can move between them and only serially. In addition, if there are too many icons or preview windows that show in the alt-tab to fit in one screen, preferably a bar handle is added for scrolling the group of shown items up or down. Another possible variation is that this shown group can for example be made to remain visible (and preferably also selectable from) also after the user releases for example the shift or control key (for example by clicking for a longer time, or for example by using a separate key other than control or tab or in addition to it, but more preferably for example if the user moves the mouse into the area of the shown items and/or for example uses the arrows and/or some other key after they are shown, preferably they remain shown for example until he/she clicks on one of them or for example clicks with the mouse outside the area of the shown group, or for example uses some other key to close the shown group). Another possible variation is that at least there is a command which for example allows moving only between the windows of the same group, unlike for example to example alt-tab, which moves also between the other open windows, and for example control-tab which moves only between tabs of the same window. On the other hand, for example when opening additional pages in the browser as additional tabs within the same window (for example in Netscape or in Opera) there is a problem that for example closing a page with Alt-F4 closes the entire browser window with all the open pages (tabs) instead of just the current page, and for example the normal Alt-Tab does not switch between the tabs. Although typically CTRL-F4 and CTRL-Tab work on the tabs instead, this is less convenient since many users might prefer the same standard controls, so that tabs don't get a different status from normal open windows, and so that the user does not have to remember for each open page that he/she is viewing if it is for example an internal tab or a normal browser window, and if he/she makes a mistake he/she might close all the open pages that he/she is working with. In addition, in the prior art, if the user has some pages open as tabs and some as another browser windows, this means that switching between the pages requires using both Alt-Tab and CTRL-Tab, which can be very confusing and inconvenient. So preferably this is improved, preferably in the browser itself and/or by the OS, so that preferably for example Alt-F4 (or any other similar accepted convention) closes only the current page (tab) and preferably for example Alt-Tab switches also between the tabs (On the other hand, since some users have gotten used to the CTRL variation, preferably both the Alt and the CTRL variations work the same for the tabs, and/or for example the user can choose what effect the CTRL and the Alt variation will have, and/or at least for example when closing a tab page by Alt-F4 the browser or the OS preferably warns the user or asks if he/she wants to close just that page or the entire browser window with all the open tabs). Another possible variation is that the OS itself automatically enables this, which can be easily done for example if the command of opening internal tabs within a window becomes an automatic service offered by the OS, so that application programmers simply call this service when allowing the creation of tabs within the application Window. Another possible variation is that if the user for example closes a browser window or tab or for example a word processing file window or for example other applications (for example with Alt-F4) he/she can still press some undo button or menu option or key which automatically reopens the last closed window or tab or file. For example, the user might close by mistake a window or tab of an important web page before he/she added a bookmark to it, and might want to instantly restore it as soon as he/she realizes the mistake. This is preferably done by the relevant applications and/or the OS creating automatically a temporary backup of the open window or file for example when the user closes it and/or for example when it is first opened, and/or for example automatically at certain intervals and/or in other events (preferably for example the links (urls) and/or the actual data is saved), and/or for example the OS preferably keeps the information about the application and window in the swap file for at least a few seconds or at least a few minutes (or another reasonable time or until there is no longer room to keep it there) so that for example if the user realizes after a few seconds that he/she closed a window by mistake, preferably the restoration form the swap file is as fast as if the window had never been closed. Another possible variation is that preferably the user can request to automatically reopen the entire set of windows and/or tabs that was opened last time when reopening the browser after previously closing it, even when it is closed normally by the user. This is better than the prior art since for example the browser Opera allows the user to return to the previous set of open tabs only if the browser was not normally closed previously. Another possible variation is that even after the user for example tells the browser (and/or for example other internet application where this feature is used) to start from the beginning or for example closes the various windows or tabs, preferably the user can for example enter some history list which preferably the browser keeps automatically, which preferably saves the previous states of multiple browser windows and/or tabs (preferably by saving only the links in this case), and thus the user can for example preferably scroll back to any desired set of tabs and/or windows that were previously open together and can preferably for example with a click of the mouse go back to that same state of multiple open windows and/or tabs (preferably the entries in this list are kept least for a certain time and/or at least until the list reaches for example some maximum size, and then the oldest entries can preferably be deleted automatically if the space is needed, however if only the links are kept then the list can be kept even without any automatic deletion, unless for example the user requests this explicitly, since very little space is needed for this). Another possible variation is that for example the browser or OS or other application preferably allows the user for example to reopen closed tabs and/or undo other changes in the tabs even after for example the browser itself is closed an reopened, preferably by saving automatically also the history of changes in the tabs for Undo, so that for example using for example ˆz (or other convenient command) will undo closing of tabs, moving of tabs, etc., even if the whole browser window has been closed and then reopened with these tabs, and preferably redo also works here, preferably including multiple branches in the redo when needed. (Although the Opera Browser for example allows the user to press ˆz to reopen closed tabs, this does not work for reopening closed windows or for reopening closed tabs if the browser is closed while these tabs are closed and is then reopened. In addition, in Opera if the user is in an email-message-composing tab, the ˆz works on undoing typing or deletion within that tab instead of restoring other tabs, so this is preferably improved so that undoing the typing in the composition tab uses a different control, or for example the user has to hover with the mouse outside the typing area in the composing tab on order for the ˆz to restore closed tabs instead of undoing typing in the composition window). Another possible variation is that the last search string or history of recent search strings (and/or multiple search strings if separate search strings can exist for example in separate tabs at the same time) is preferably also saved automatically preferably together with the tabs, so that when the window is reopened after being closed preferably the search string or strings are also preferably automatically available from at least the previous session. Another possible variation is that for example fields in which the user entered data, such as for example in forms or for example data that the user enters when composing an email message, are also automatically saved (for example every few seconds and/or after an amount of small change, for example after every N characters or words, and/or upon closing) and are preferably automatically available again when the user reopens the browser. Another possible variation is that the user can for example mark for example with the mouse multiple tabs (for example by marking their top handles, for example by pressing shift and clicking on the start and end tab of the desired group) and then can for example close the entire marked group for example with a single click or key. Another possible variation is that the user can for example use a command such as “refresh-all” or “reload-all” (preferably for example by clicking on such an icon or menu item), which causes refresh for all the currently open tabs. Another possible variation is that preferably when the user saves a file under a different name, for example in the word processor, preferably the user has also an option to request to automatically keep open also another window with the original file. This can be very useful for example in case the user wants to work for example on one copy with marked changes and a second copy where the changes have been accepted. Of course the user can do this manually by first saving the file under a different name and then reopening the original file name in another window, but it is more efficient to add such an automatic option to the application so that the application can do this automatically for the user. Another problem is that for example when trying to delete a directory through a command prompt window in windows XP the OS only asks “are you sure” without even letting the user know that this is a directory. This is very dangerous since the user might this way inadvertently remove even a huge directory tree. So preferably this is improved so that instead the OS tells the user that it is a directory and preferably tells him/her also the number of subdirectories and/or the total number of files in that directory tree and/or the total size. Preferably the OS also lets the user choose as one of the options a controlled deletion so that for example the user will be automatically asked to make the same choice for each sub-directory of the chosen directory and/or for example asked to verify the deletion of each file. In addition, preferably especially when deleting directories, preferably the system automatically keeps a backup of the directory structure and/or a rollback log, so that if the user made a mistake the directory tree can preferably be instantly restored. This is very important since eventhough there are for example various programs that enable searching for deleted files and restoring them, restoring a full directory tree without automatically saving first a copy can be much more complicated and less reliable. Another possible variation in that the user can preferably request to copy with automatic individual file conformation for example 1 or more directories (for example from a DOS or CMD windows or for example from an explorer window), which means that preferably the user is asked to confirm if he/she wants to actually copy each file one by one (regardless of whether the file already exists in the target destination or not), and/or for example request to copy only files which were created for example be and/or after certain dates. Of course, various combinations of the above and other variations can also be used. Of course, like other features of this invention, these features can be used also independently of any other features.
23. Another problem for example with SED monitors is that they have a brightness of only half or less of a comparable CRT monitor, probably because in the way that they are normally built increasing the voltage further could cause an uncontrolled discharge for example sideways. Therefore this is preferably solved for example by adding borders between adjacent pixels, preferably for example by surrounding each pixel by preferably thin walls that preferably go at least part of the way or even almost all the way till the front glass (and the walls can preferably for example also contain some preferably thin internal metal coating), which can be a small added cost since such monitors are typically manufactured by printing in a way similar to an inkjet. Such walls thus preferably serve as wave guides for the electron beams and, apart from preferably enabling using higher voltage and increasing the brightness, they can have the additional advantage of increasing the precision of the direction (and thus the exact position) in which the electrons hit the phosphor, and thus reduce even further the need for using a shadow mask, so that preferably only a very thin mask is used or even no mask at all, or for example elongated slots like in Trinitron monitors are used but in a way that the borders between the slots are even thinner than in a Trinitron monitor. This can thus further improve the brightness and/or the color rendering so that the SED can preferably give better brightness and/or better color rendering than even Trinitron monitors. Another possible variation is that for example every once in a while (for example every few centimeters, for example some of the walls or for example small spikes at the ends of some of them can preferably reach all the way to the front glass, thus increasing the stability of supporting the flat front glass eventhough there is typically a vacuum between the back part and the front glass. Another possible variation is that the are for example small holes at the back of the cells that generate the electrons in the SED monitor or at least in some of said cells, so that for example the vacuum can be created by sucking the air out of a layer at the back of the cells. Another possible variation is that preferably the monitor's control can be done for example with a preferably single moving element, for example similar to the rotate-able button on the front of Mag monitors, except that preferably instead of a rotating button there is preferably an element that can be moved freely for example in all directions with a certain frame of possible movements, thus giving the user an ability to choose anything on the screen or on a certain area of it without being limited to a circular menu like in Mag monitors. This moving element can be for example a moveable piece of plastic attached for example at the end of a needle which for example goes into the depth of the bottom front panel of the screen, which can be moved in any direction for example within a square frame border, so that for example its position can be sensed by the angle of the needle. Another possible variation is to add for example in portable computers preferably (instead of the square which is typically used as a mouse substitute) for example a small ball or other small handle which the user moves on an area for example with the same size of the typical square or even bigger. This is important because many users feel uncomfortable with having to drag their finger on the square. This ball or handle can be connected for example in a way similar to the above described moving Monitor control button—for example by attaching it to the end of a needle, or for example it is connected magnetically to a magnetic plate and preferably moves a parallel magnetic element on the inside which is sensed, or for example the movements of the external element are sensed directly for example electromagnetically or for example through induction. Another problem with Mag monitors is that in order to switch from the normal monitor's menu to the hidden menu which has more options and can change factory settings (This menu is hidden because users who are not technicians might easily screw up these settings) the user must keep the round navigation button pressed while turning the monitor off and on again, and then again turning it off in order to return to the normal menu, which is very unhealthy for the monitor. So preferably this is improved so that for example for switching to the factory settings menu preferably the user has to keep the navigation button pressed for example for 10 seconds or more (or other reasonable time limit), preferably while it is pointing for example to a specific menu option (preferably any normal option which is used normally for something else) or to one of a few specific menu options (so that it does not happen by accident), and for returning to the normal menu preferably the hidden menu has for example a normal exit option which the user can simply choose through the navigation button. Another possible variation is adding for example a hidden small switch for example on the bottom side, for example somewhere below the round navigation button, but this is less preferable because is means adding additional electronics, while the above solution is much cheaper and more efficient. Another possible variation is that preferably these OSD (On-Screen Display) Menus are transparent or can be made more or less transparent for example by an additional option within them, so that the user can more easily see what is on the actual computer display even while the OSD menu is on. Another possible variation is that preferably the various menu items in the monitor have an undo function so that preferably the user can click on an option that resets them for example individually or as a group to the previous value before the last change.
24. Another improvement in Windows Vista is that the OS automatically identifies the applications which the user most typically uses and loads part of them automatically in advance during the boot. However, this can still be inefficient since it can slow down the boot process itself. So this is preferably improved for example by combination with saving the image of a correctly booted system and using it for the next instant boot or reset. So preferably the OS adds to this image also these most commonly used applications, so that they can be loaded instantly together with the image of the OS and other start-up programs. However, since the user might not really want to activate these programs each time, preferably they are loaded into memory with a flag that causes them to be actually inactive, so that preferably they become active only after the user actually tries to open them.
25. Another improvement in Windows Vista is that the user can view virtual folders, which unite together for example “all pictures and videos” etc. However, since these are only logical and not actual folders the user for example cannot copy additional files directly into such folders, which creates a consistency problem compared to normal folders and can therefore be annoying or confusing or inconvenient. So in order to improve this preferably the system allows the user also to copy files (and/or other directories) also into such virtual folders. Preferably this is done for example by intelligent decisions which real folder to use in association with this. For example the OS can decide that the new files will be copied to the largest relevant real folder (for example the folder which currently contains the largest number of files of the relevant type, for example photos or video or music files, etc.) (which can be easily determined for example from the local desktop search database) and/or for example when the user copies files to the virtual directory the system for example automatically show the user a selection of actual directories that are recommended and the user can for example click on the desired one and then the copy will actually proceed into there. Another possible variation is that for example for each such virtual folder an actual folder is also created automatically (for example with the same name) so that preferably any subsequent files copied to the virtual folder will be simply copied to the physical folder that is associated with the virtual folder of that name, and for example when viewing the virtual folder, both the virtual contents and the actual contents of it are shown together or for example in separate categories. Another possible variation is that for example the system can preferably display, preferably instantly upon request, (for example with the help of the indexed desktop search), for example a descending list of the largest files and/or directories and/or subdirectories and/or for example mark especially those files that also have not been used for a long time and/or are rarely used, so that the user can for example most efficiently get rid of unnecessary junk on the hard disk or disks. This can preferably be done also across partitions and/or across physical disks, if there is more than one disk (although there is a program called TreeSize which does something similar, that program works only within each partition, and also Treesize only displays the sorted order of directories and subdirectories but des not sort by size the files in the directory itself). Another problem in Windows Vista is that the security feature that requests user confirmation too often causes people to start ignoring it after a while and click on “Allow” almost automatically. So preferably this is improved so that the system takes into account if the user or an application initiated the action (as explained for example in other applications which deal with computer security by the present inventor), and this is preferably applied at least to OS functions, so that if for example the user himself/herself for example clicks on a menu item which activates some system function, preferably the OS does not ask the user for confirmation. Another problem is that in the new Vista Beta 5365 of Apr. 22, 2006 when the OS requests this permission the entire screen becomes dark except the authorization dialogue box—in order to freeze other applications until the user answers so that they cannot interfere with this. Again, a much better solution is described in the above security applications by the present inventor—so that preferably other processes don't have to be frozen until the user replies but the OS and/or Security system prevent other applications or drivers etc. from interfering in the dialogue so that they cannot for example change the message or falsify the user responses, and preferably similarly for example the OS and/or the security system (or for example other application or service which is in charge of this) preferably prevents other applications or drivers for example from displaying a misleading message for example on top of the message displayed by the OS or by the security system (thus for example changing the question or the positions of the Yes and No, etc.).
26. Another problem is that for example various programs or drivers refuse to install on various betas of Windows Vista because they don't recognize the OS version. So in order to solve this preferably the OS enables the user to specify for example what name or and/or other codes the SO will identify itself by to various applications, so that for example the user can preferably tell for example Windows Vista to identify itself (for example in general and/or for example to a specific list of applications for example as Windows XP). Another problem is that for example in windows XP the cmd window does not show anymore also the short 8-letter names of files with names longer than 8 characters, unlike Windows 98. But this is problematic if the user wants for example to open such a file for example with a DOS application that sees only 8 letters because then the user does not know the correct DOS name that the DOS application will see (typically a few letters and then a ‘˜’ and then 1 or 2 letters). So preferably the user has for example a choice if to let the cmd window display also the short DOS names for file names, and/or for example if the user activates the DOS program with the long file name then preferably the system automatically converts the file name parameter to the correct short name before transferring it to the DOS program (in the prior art in such a case only the first 8 letters are transferred and then the DOS program cannot open the correct file if the name is longer than 8 characters because it does not get the correct name with the ‘˜’).
27. Preferably file sharing programs which download files from multiple other users are preferably improved so that when the same file is available from multiple sources, they preferably download from each available source sections in preferably random order (so that for example from one source the end parts are downloaded, from another source middle parts, from another source parts at the beginning, etc.). This can prevent the phenomenon that, since certain files become no longer available during the process, typically the downloading becomes progressively slower near the end of the file.
28. Another preferably improvement is that when more than one OS is installed on the same computer the user can preferably easily switch the default OS to whichever option he/she wants and/or for example change the order of the options (where typically the first option becomes the default). This can be done for example by letting the user drag an option line with the mouse to a different position in the screen that asks which system to boot or for example press some key or key combination. This is very important, since in the prior art if the user for example installs Windows XP over a system of Windows 98 (so XP automatically becomes the default) and then prefers to use for example Windows 98, it can be very frustrating to have to change the choice each time when booting, and this is also important especially for example if there is a power failure and the computer reboots automatically. Although XP for example allows changing this by performing a few steps after the XP has finished booting, which most users don't even know how to do, it would be much more intuitive to let the user for example move the option lines with the mouse in the screen that asks which system to boot, as explained above. This means that preferably basic or standard mouse support is preferably activated at least partially already at this stage eventhough no particular system has been activated yet. Another possible variation is that the system automatically remembers the boot option that was last chosen and makes it automatically the default for the next boot until the user changes it. (Another possible variation is that this option also automatically becomes the first choice on the boot menu on the next boot, but that is less preferable since it might confuse the user if he/she is used to a certain order of the boot options and did not choose explicitly to change it). Another possible variation is that if the user for example chooses some option in the boot menu and then regrets it and the system for example has already started to boot according to the chosen option, (for example choosing Windows 98 in a boot menu that has both Windows XP and Windows 98) preferably the user can for example press some button which can preferably return the user preferably instantly or almost instantly to the boot menu preferably without having to reboot the computer. This can be done for example by saving automatically an image of the state of the computer when the boot menu is reached, so that preferably this state can be preferably instantly loaded again from that image for example when a return to the boot menu is requested. Another possible variation is that if there is for example more than one bootable hard disk (or for example other forms of non-volatile memory which function as hard disk replacements) (which can be reached for example by pressing F8) and this disk is not covered by the normal OS-generated boot selector, preferably the BIOS can sense this automatically and can create automatically—and/or for example the user can choose this from a menu in the BIOS—an additional pre-boot selector, which preferably shows up automatically when booting without having to press F8 and lets the user choose between the two or more bootable hard disks (or other non-volatile memory options), and preferably in this boot selector also the user can preferably for example move one or more of the options to be before the others and/or for example the BIOS remembers automatically the last choice and uses it as the defaults the next times until the user chooses again differently, and preferably after for example 5-30 seconds (which preferably the user can change through the BIOS) the last default options is automatically chosen. Another possible variation is that the user can for example though the BIOS or through the OS, preferably without needing any additional installations, for example preferably easily add this additional boot option or options to the normal boot selector that was generated by the OS, if such a boot selector already exists (for example by simply adding one or more lines to the Menu during the Boot or in the Bios or from the OS and adding the drive letter of the additional option and some name or description of the additional boot option or options), and thus preferably there is only one united boot selector instead of having to wait twice or choose twice. Another possible variation is that preferably the BIOS enables 32 bit transfer by default, preferably for each hard disk that is detected and/or is capable of supporting it.
29. Another problem is that for example in wireless networks (for example in homes or offices) the only method of protection against stealing data and/or illegal tapping into communications is encryption, which has already proved not reliable enough. Therefore another possible variation is that in order to improve the security of wireless networks preferably the network computers use also for example automatic triangulation of the source of transmissions (preferably by using for example all or some of the known devices in the network to compare the strength of the signal that they receive), so that for example the coordinates of the allowed space are entered into the system and/or for example only specific locations of known devices are white-listed, and so for example any intruder from an outside position cannot pretend to be an authorized user even if he succeeds in finding a vulnerability in the encryption. (Although this still does not prevent passively listening-in, preventing any other form of interaction can be very effective, since for exploiting various vulnerabilities typically at least some interaction as needed, so this together with encryption can be very effective).
30. Another problem is that for example Microsoft is now trying to market in low-income countries such as for example China and India a considerably cheaper version of Windows XP, however this version has some serious limitations that make it much less attractive to users, and one of the most severe limitations is that for example only a very small number of programs can be run at the same time. This can make the OS much less useful, so very few people will be willing to use it, even at a half price or less, and thus the main purpose (reducing piracy in those countries) can be completely defeated. Therefore, a much better solution is to let users buy the OS at such countries at such a low price preferably with few limitations or no limitations or at least no limitations that result in reduced functionality to the user, and preferably prevent loss of profit in other countries where the OS can be sold in normal prices—by limiting the use of the discounted version in the other countries. This can be done for example by at least one of the following means:
   a. Limiting these cheap versions so that at least part of the interface and/or some important applications work only in languages that are not useful to most people outside the cheap countries (for example only Indian languages or Chinese languages).
   b. Displaying a warning for example whenever the OS is started that it is illegal to use this version of the OS in any either countries than the list of qualifying countries, unless for example the user has a citizenship of one of these countries and/or is resident there, etc.
   c. The OS can Check for example automatically when the user connects to the internet if his/her IP address is in one of the qualified countries and, if not, require for example some certification to be filed (if it hasn't been filed yet) which proves that the user is entitled to use that version of the OS outside of those countries. Preferably in these cases the OS can automatically stop working or start working with only limited functionality after a certain time period (for example one month) if said certification has not been filed.
31. Another problem is that for example in Windows XP if the system is unable to read a CD then the entire system can get stuck without any explanation to the user, since the OS apparently tries again and again incessantly to read the CD. Preferably this is solved by automatically aborting any attempts to read a problematic CD preferably after a short time and preferably indicating to the user the nature of the problem and letting him/her decide what to do, and/or for example allowing the user to press some key or otherwise request immediate aborting of the attempts to read the CD (this is preferably done for example by some element below the OS which does not get stuck even if the OS gets stuck, and/or for example the OS automatically interrupt the attempts to read the device at short intervals (for example at least once a second or more) and then checks for example if any commands have been entered by the user.
32. Another possible variation is that preferably the user can tell the OS for example not to enter sleep mode until a specific application has finished running, for example by clicking on the application's window or for example on the square that represents it in the task bar and marking the relevant option in a menu (preferably this can be done for example for a specific currently running Window of the application or defined in general for that application, so that for example every time automatically the OS will not enter sleep mode if that application is running and has not finished yet). Another possible variation is that the user can for example tell programs that play media, such as for example songs, for example Winamp, to stop working automatically after a certain preset time period (for example 30 minutes or any other convenient time period) or for example after a certain number of repetitions of the current playlist (for example there are 5 songs in the playlist and the user marks that the program should go for example though 3 cycles of playing the songs before stopping automatically), which can be very useful for example if the user wants to fall asleep with music in the background but without the music continuing all night. Another possible variation is that for example the user can simply indicate or mark to the OS a set or range of hours in which the computer will automatically go into sleep mode (hibernate) at a certain set of hours, for example during night hours (preferably unless of course someone is working on it). Another possible variation is that for example all-in one printer-faxes, such as for example by HP, which once in a few hours automatically calibrate themselves, thus making noises, are preferably automatically configured to avoid doing that, at least for example during night hours, since it can be quite annoying if someone is woken up by these noises (This can be done for example by using a light sensor and/or according to the local time settings, and/or preferably the user can of course define the desired quiet hours). Another possible variation is that for example, when needed, the calibration is done for example only after the user clicks on the keyboard and/or for example moves the mouse (this gives it sufficient time to do the calibration before the actual printing, so that the user does not have to wait when printing, but ensures that the calibration will not occur for example when the user is asleep). Another possible variation is that preferably the calibration is done automatically immediately after printing if needed, however this could still create a problem if for example a fax is received at night. Another possible variation is that for example during night hours (as determined for example by light sensor or sensors and/or by the local time setting), preferably faxes are automatically only stored in memory (for example unless the memory becomes full) and are automatically printed for example only after a certain time in the morning and/or a time which the user can set as default. Preferably the system allows the user example to enable or disable the feature of quiet operation during night time and/or define the relevant time limits. Similarly, another problem is that for example typical firewalls (such as for example Zone Alarm) are programmed to close the connection to the web automatically for example when the screen saver activates, which is usually quite useful, however sometimes the user for example might want the firewall to keep the connection open for example until one or more download operations are completed. For this preferably the user can also similarly preferably indicate for example that the firewall should not close the web and/or for example the screen saver should not be activated until the application has finished performing some operation. Another possible variation is that for example whenever the user updates the fireweall (for example zonealarm), which typically requires shutting down the current working version of the firewall during the installation, preferably the firewall and/or the system automatically closes any internet connections and/or for example activates some other process which temporarily for example makes sure that all Internet activities are frozen, until after the new firewall is installed and starts to work, otherwise the computer can be dangerously exposed during the installation. Another possible variation is that for example the modem can receive a command for example from the firewall or from the OS to shut itself down (which can preferably be done automatically for example when the firewall is updated or when the OS goes to standby or reboots), however if this is enabled then preferably the modem can then be automatically powered on again only if it has not been powered off manually by the user (otherwise this would create a security risk of being able to power on the modem even after the user physically powered it off). Another possible variation is that for example any installation of a new program and/or any uninstallation automatically triggers creating of at least one restore point by the system (but preferably two—one before and one after the action) and preferably the System and/or the security system (or for example another application which takes care of it) preferably automatically adds to each such automatic restore point also a description of the situation when it was done, such as for example “before uninstalling zonealarm 6.0” after uninstalling zonealarm 6.0 or “before installing opera 9” and “after installing opera 9”, or for example automatically any time the registry is about to be changed (for example by detecting automatically that the install shield has been activated or for example by hooking or monitoring the relevant system functions). Another possible variation is that the screen saver menu available for example at the windows desktop preferably enables the user also an option of for example displaying a simply preferably fully black screen (or almost fully black, with an additional preferably small preferably dim preferably slowly moving indication that the screen is still turned on) after a certain time instead of or in addition to the option of turning off the monitor (which means instant return from a seemingly turned off monitor), so that for example the user can choose for example activating the normal or first screen saver after for example 15 minutes (or any other convenient time) of no user activity and activating the fully black or almost fully black screen (and/or for example any other screen saver chosen as 2^{nd} step screen saver) for example after 25 minutes (or any other convenient time) and turning off the screen for example never or after some other period). Another possible variation is that for example for every given screen saver (or at least for example some of them) the user can preferably easily change the color of the foreground and/or background and or for example move some bar or other control or command which changes the brightness level of the screen saver for example from fully lit to very dim, which is preferably taken care of by the OS or by some other application. In addition, since sometimes the screen saver can become turned off for example by mistake, preferably in such cases the system can warn the user about it (at least for example if the screen is a CRT or SED or Plasma or other screen which can suffer from burnout), for example by indicating to the user the next time that he/she comes back after a certain period of inactivity that the screen has been fully active add/or stationary without any need for example for the last N hours and recommending the activation of one of the screen savers, and/or for example with such screens the system does not allow the user to define no screen saver and in such a case or for example if the time the user chooses for activation is too long (for example activate only after 1 hour or more of inactivity) the system for example automatically enforces at least some minimal screen saver rules (this means that preferably the auto-detection of monitor brand and model preferably includes also an indication of the monitor type). Another possible variation is that if a screen saver includes parts that don't move for example for more than a certain period (for example a waterfall screen saver where only part of the scenery moves and part remains stationary) preferably the system detects this automatically and can for example generate the movement or change automatically, for example by starting to shift the entire image randomly and/or for example creating automatically various ripple effects and/or for example automatically shrinking the size of the image and moving it around a preferably black screen. Another possible variation is that for example if the system senses that the screen saver is too bright at least in general or in parts of it the system can for example automatically dim it further, for example after a longer period of inactivity has passed, thus creating for example an automatic 2^{nd} stage lower activity period (and/or the user can at least within certain limits choose the time till this 2^{nd} stage will be automatically activated). In addition, preferably the OS checks and makes sure that the screen saver has indeed been activated after the appropriate time, because sometimes a malfunction can cause it not to start even though it is defined as enabled, or for example some program displays on the screen a message which stops the screen saver and/or any program stops the screen saver in another way, and if for example this happens (i.e. for example the message or something else stops the screen saver wile running or prevents it from even starting) then preferably the OS (or some other application, which can be for example a separate application or for example at least part of the Screen saver itself) preferably takes over and for example re-activates the screen saver automatically after a certain time if there is no user activity (for example after a few minutes or less) or even for example immediately or temporarily suppresses the message until the user types something on the keyboard or moves the mouse, since there is no point in displaying the message anyway if there in no user around, or for example the screen saver or the OS lets the message reappear every once in a while, for example every 15 minutes for 1 minute, or other reasonable time, and/or for example the screensaver or the OS causes the message itself to start floating around for example together with the normal moving part of the screen saver or instead of it). (Of course if the message is for example some security warning then this means that preferably the suspect activity remains blocked until the user returns). For this preferably the screen saver or at least some part of it and/or for example the monitoring element is preferably installed at the kernel level and preferably at least lower than most other applications and drivers. Preferably similar principles can be applied for example when the system is supposed to enter for example sleep mode and/or hibernate after a certain period. However, another problem is that for example while the user is working normally for example the taskbar typically remains at the same position all the time, so the area of the taskbar or parts of it can become burned-in anyway since it remains with the same image for many hour each day. So preferably in order to prevent this the OS (or some other application) preferably for example automatically for example moves the entire display or at least the relevant area (for example the area of the taskbar or for example parts of it or for example the icons in it) for example 1-2 or up to a few pixels up, down, right and/or left automatically for example every 10 minutes or every hour (or other convenient interval), preferably without deviation for example more than 2-3 pixels from the user's current settings in each direction and preferably in each jump the jump (of preferably the entire screen) is only a step of 1 pixel in the new direction, so that the user will almost never even notice this. Another possible variation is that for example the OS automatically keeps a record of the screen areas that haven't changed for a long time and then for example when the screen saver is activated for example automatically displays at least for certain intervals the reverse image on those areas, so that for example in the area of the taskbar a color-negative of the taskbar is displayed for example at least part of the time while the screen saver is running, in order to correct for some of the effects. Another possible variation is that preferably the OS for example always makes sure that the CPU does not exceed a certain temperature threshold) (which can preferably be easily changed by the user) and preferably alerts the user if the threshold is exceeded, since for example some users don't install a temperature probe or sometimes eventhough it is installed it becomes de-activated by mistake or because of some runtime error. This is preferably done by the OS or a relevant application or driver which checks the CPU's temperature, and preferably the OS automatically ensures all the time or at least at short intervals that this is functioning properly and indeed reads the temperature from the CPU. Another possible variation is that preferably when the user asks Windows to create a restoration point, the user has a choice of indicating if he/she wants a normal restoration point or also creating a full snapshot of the main system and registry files and/or the user for example can define in general if and/or when snapshot or normal restoration point will be generated when the system automatically creates them (for example every certain periods and/or for example depending on the amount of accumulated changes) and/or for example the system automatically creates the snapshot files whenever it is about to make highly significant changes for example in the system. In addition, preferably rollback info is saved automatically in more than one place, preferably together with a copy of a sufficient reference base-point, so that the system has a much better chance of restoring it even if for example the registry becomes seriously damaged. In addition, preferably the registry entries are made independent of each other so that even if part of the registry is damaged it will not effect anything else, and preferably the system uses transaction sequences in the registry and/or for example other important system files like in a normal database with automatic rollback in case the transaction has not been completed, so that if for example the system gets stuck while trying to update the registry and/or for example other important system files or the for example the FAT, etc., then when discovering this or for example even in the next boot (if the system for example crashed and had to be rebooted), preferably first of all at least some process comes into action which automatically finds out transactions that do not have the mark that they were completed and thus preferably activates automatic rollback to the previous state before the unfinished transaction or transactions begun. (And, as explained above, preferably the rollback info is saved in more than one places). Preferably this process or at least part of it is below the OS, since some aborted changes might for example make the OS unable to function properly until the rollback is done. In addition, if for example there was still some damage beyond repair and the system needs for example to load a previous snapshot of the registry and/or other critical system files, preferably during boot the user is advised of the situation and can automatically view for example a list of the most recent snapshots and/or otherwise possible restoration points (preferably including dates and/or other comments or information) and can simply choose the most preferred ones to attempt and then the system preferably restores it automatically and continues to boot (instead of the prior art where for example in windows XP if the registry is damaged the system sometimes cannot boot at and all the user might have to boot from a special CD and restore manually the snapshot files from their hidden directory—which is quite a cumbersome process to perform manually). Another possible variation is that preferably at least the registry (and preferably also other files that are needed for snapshots) are always automatically kept in at least two copies so that if for example one copy becomes unusable (for example as a result of crashing or reboot in the middle of updating the registry) there is always an immediate backup of the most up to date version (for example in a way similar to the way that there are always two copies of the FAT). Of course automatic rollback info can preferably be saved also for much larger changes including for example any changes to the disk, as explained elsewhere in this application. Another possible variation is that for example during preferably every boot (which is typically a time when the user has to stair at an almost blank screen for at least 20-30 seconds), preferably the system uses this time to display important information to the user, such as for example details about the number of safe restoration points and/or snapshots that currently exist (and preferably also their dates) and/or for example various indicators of the health of the system and/or for example the current automatic back-up policy that exists and/or for example the amount of remaining free space on the disk and/or for example the percent of disk fragmentation, etc. Of course, various combinations of the above and other variations can also be used. Of course, like other features of this invention, these features can be used also independently of any other features of this invention.
33. Another possible variation is that for example if the user does not find a certain file name, the OS automatically checks for similar names and asks the user for example “did you mean . . .” —for example in a way similar to the way that Google offers users to correct typing errors in the search keywords, and/or for example the OS shows the user the list of closest file names and/or paths available, sorted by closeness (for example in the dialogue box for opening files and/or for example in cmd or DOS windows). For improving the efficiency and the hit rate of the closest names offered preferably information about the recency and/or frequency of the user's accessing file names and/or directory names is preferably automatically kept, and preferably automatically taken into account when offering the most likely names which the user probably intended.
34. Another preferable improvement is that if there are more than one CD and/or DVD installed on the same computer they can be connected to a common audio connector for example in parallel or with some multiplexor (so that for example the same audio cable can lead from more than one drive to the sound card), or for example cables from more than one drive can lead to a common connector or multiplexor near or at the sound card. Preferably if more than one drive is playing for example a CD or a movie at the same time then either all the sounds are automatically routed to the speakers (this is no problem since normally the user would not play both drives simultaneously) or for example the correct drive can be chosen by software. This is better than the prior art where the user can typically connect only one of the drives to the sound card and thus can for example hear CDs or watch DVDs with sound only through that drive. Another possible variation is that no direct connection to the sound card is needed from any of the drives, and for example each CD or DVD that contains sound is simply played by activating the sound card directly through the software that plays the data, for example in the same way that the sound is played from an avi file on the hard disk.
35. Another preferable improvement is that preferably the user can for example define for example drives and/or directories to become shared for example only when connected by cross-linked Ethernet cable between two computers so that preferably for example they become automatically not shared when connected by normal cable to the internet. Another preferable improvement is that preferably the user can for example create a copy of the OS on another partition (for example on the same disk and/or even for example on a different physical disk in the same computer) preferably with a single automatic command, and then preferably the system with all the installed programs is automatically copied to the new partition (preferably by using automatically the registry to locate all installed applications and/or drivers and/or other relevant components) and preferably all the drive letter references in the new installation are automatically updated to refer to the new drive letter, and preferably the choice of the new partition is preferably automatically added to a boot selector. In this and/or in other variations preferably the user can also change the name of a boot option and/or add comments to itpreferably also while booting, for example by right clicking on the desired line and then choosing from a menu and/or editing it. This can be very useful if the user for example wants to create a backup of the installed OS on more than one partition, so that for example if the OS becomes corrupted or unstable, the user can in the meantime boot and work normally from the other partition. Preferably the user can do this also for additional partitions, and preferably the user can also use an update or synchronize command, which for example automatically updates any differences between two or more such OS-installed partitions, so that for example the user can update the other partition according to additional changes made in the original partitions, and/or for example the opposite—automatically correct the original partition according to one of the backup partitions, etc. Preferably the user can also request automatic undo of such updates, for example if anything goes wrong (for this preferably the system automatically keeps a backup of at least the registry and other important system files and/or a preferably more complete rollback log). Another possible variation is that preferably the user can, preferably easily, change the delay time which the system waits in the boot selector before activating the default boot choice, so that for example the system waits only 10 seconds instead of 30 (preferably the user can change this for example from the boot menu itself (for example by clicking on the right mouse button and opening a menu) or for example from within one or more of the OS's, for example through the control panel. Another possible variation is that even the new partition itself can be automatically created by the special copy command, if needed, for example in a way similar to the way that the Partition Magic software created new partitions, so that the user does not even need to have a new partition ready before requesting the special OS-copy command. Of course this can work for example in combination with systems like Intel's Vanderpool, so that for example the other installations can automatically be configured to run in parallel at the same time. As described for example in U.S. applications Ser. Nos. 10/301,575 and 10/644,841 by the present inventor, another possible variation is that multiple instances of the OS are preferably managed by Copy-on-Write. Another possible variation is the user can for example mark only one or more specific installed programs and/or drivers and/or other parts to be automatically copied to the other partition, instead of for example automatic full copy of all the installed elements into the other partition. Another possible variation is that the user can preferably automatically backup one or more installed programs to a back-up media, so that preferably automatically the relevant registry entry is copied to the backup media and preferably all the relevant components are automatically copied preferably through the relevant registry information. Another preferable variation is that preferably when activating for example a command like SFC (which checks the integrity of installed system files and/or compares them to their source on the installation CD and restores them when needed), preferably this or similar commands can be used also from another OS or another installation of the OS on another partition and/or for example from the installation CD or DVD itself. This is much better than the prior art, since in the prior art it is possible to run SFC only after booting into the OS whose files need to be checked, whereas OS might be too damaged to boot into, which is like catch 22. Running such commands while booting from another partition should be no problem since the application that performs it preferably merely has to know on which partition and/or basic directory to run the checks, and preferably can use any information from there to know which files to look for and where. Another possible variation is that for example if the OS gets stuck during or after the boot, preferably the system can automatically sense it for example after a short time and preferably for example automatically identify the driver or application that caused it to get stuck (and/or for example any other source of the problem, such as for example bad change in the registry or other critical files) and preferably can automatically roll-back to the state it was in before the problematic driver or application was loaded and/or before the registry change or other relevant change and preferably can automatically continue without the problematic driver or application and/or can for example automatically search for a replacement driver or application and/or automatically instruct the user what to do in order to fix the problem. This is preferably done by at least part of the OS which preferably runs below the normal OS and which preferably contains also a preferably large knowledge base about preferably almost any known problem that can occur, preferably with instructions on how to solve it. In addition, preferably the OS or part of it and/or for example this part below the OS preferably automatically tries to follow those self-repairing instructions whenever possible and preferably involves the user only if for some reason it is unable to perform whatever is necessary (for example because the installation CD is not in the drive).
36. Another problem which exists for example in windows XP is that for example if the user changes motherboards, the OS, unlike for example windows 98, is many times unable to overcome it and has to be reinstalled. So preferably this is solved by allowing at least part of the kernel and/or part of the OS, which is preferably hardware independent, to always boot properly even if there are a lot of hardware changes, so that preferably any adjustment problems can then be fixed after this initial boot, preferably automatically.
37. Another problem is that sometimes for example the OS does not allow the user to access a file because it is locked by another process (for example if Word previously crashed while working on a file and the user restarts Word and tries to access the file), but the user cannot do anything except open the file for example only for reading, since the OS does not even tell him/her what the problem is. So preferably when this happens (in such cases and/or in other cases of resource clashing) preferably the OS also lets the user know the identity of the clashing process and preferably the clashed resource and preferably any other needed info, and preferably allows the user also options such as for example terminating the clashing process or for example freezing it temporarily for example until the user releases again the problematic resource.
38. Another preferable improvement is that when there is more than one physical hard disk on the same computer and more than one partition on at least some of these disks, preferably the OS automatically adds some mark to each drive name that indicates to which physical hard disk it belongs (for example an additional letter and/or number and/or icon which indicates the physical disk), since otherwise the automatic letters given to the various partitions can be confusing and the user might loose track of which partition belongs to which physical disk. Another possible variation is that for example there can be more partitions than there are letters and/or for example partitions can be identified also by names longer than 1 letter, so that for example if the user wants to name a partition for example “c2:” or “d2:” or “dnew:” for example instead of “d:” then these longer names can preferably be used in the same ways that 1-letter name partitions can be used (such as for example “copy f:\comment\test.doc dnew:\backup\”). Another possible variation is that the user can for example define multiple synonymous names for the same partition, so that for example the same partition can be accessed by more than 1 name.
39. Another preferable variation is that when using for example a system for predicting the next channel or channels that a user is most likely to jump to next for example in digital TV broadcasts (for example cable or satellite) and/or using multiple tuners to cover a large range of channels (so that for example the last 2 seconds in the predicted or covered channels are kept in at least one buffer) so that the zapping can be instant instead of typically having to wait for up to 2 seconds for the next base frame, as covered for example in U.S. application Ser. No. 10/905,038 of Dec. 13, 2005 by the present inventor, preferably additional improvements are added to solve the problems of the decryption time and of channel mixing. The channel mixing problem is that because some channels can be statistically much more bandwidth consuming than other channels (for example action movie channels, where there are significant changes between the frames, vs. for example an interviews channel, where people sit in front of the camera with typically little change from frame to frame), typically the cable or satellite providers try to optimize statistically the allocation of digital channels on each data-stream (frequency), so that for example there are 10 frequencies with 15 digital channels carried on each frequency, but consecutive channels are many times scattered between different frequencies because of statistical considerations. Therefore, since typically the most common zapping is consecutive going up or down in the channel number, preferably the solution is avoiding the scattering, so that the channels are grouped together consecutively in the frequencies, and solving the statistical bandwidth problem by changing the number of digital channels in each frequency as needed, so that for example if the first channels contain typically movie channels, which are by nature more bandwidth consuming, then preferably the first frequency contains less channels, as needed (for example only 7 channels instead of the normal 15), and other frequencies contain a smaller or bigger number of channels depending on the overall fatness or thin-ness of the channels that are grouped into them (in terms of the average bandwidth needed by them). This may be a little less efficient than optimization by scattering (since for example putting 7 fat men in one elevator can waste a little more space than putting people of different weights in the same elevator, since with the fat people there is less flexibility for example in the last gap if you avoid bringing in a thinner channel for the last gap if it is not the next consecutive channel), but keeping the consecutive order is much more efficient for the instant zapping. (Another possible variation is for example to keep the order as explained above but use flexibly for the last gap even 1 or more non-consecutive channels, but that is less preferable). The decryption time problem is that since it takes some time to decrypt each channel from the base-frame, in order to decrypt in advance the predicted and/or covered channels which the user can next zap into (preferably into the at least one buffer), the system has to either use some table which knows in advance which channels the user is allowed to view (in most systems the user typically has only a basic subscription and pays in advance for a set of additional non-basic channels), or the system checks if the user is allowed to view a given channel only after the user has already jumped into it. The problem is that if such a table is used (which means that the set-top box finds in advance which cannels the user is allowed to view and puts this information into some table in memory), then such a table in memory makes it much more easy to hack into the system and for example change this table or bypass it. On the other hand, if the set-top box is designed to check if the user is allowed to view the channel only after the user has jumped to it (thus avoiding the security risk of such a table), then enabling the instant zapping means that the system might have to allow the user to view the first 2 seconds even before checking if the user is allowed to view this channel. One possible solution is to indeed allow the user to view for example the first two seconds (or other relevant time slice) before checking his/her permission to view the channel and then blocking the channel if needed. This is still OK since the user would normally not gain much by constantly zapping for example between two channels that he/she hasn't paid for and seeing each time for example only 2 seconds or less (except if someone for example connects 2 such set-top boxes with an automatic channel switching and automatic multiplexing into the same TV). However, it should take much less than 2 second to determine if the user has a right to view that channel, so even if the system checks the permissions only after the user jumps to the channel, the data stream can preferably be blocked automatically even sooner than the for example 2 seconds and/or for example a message can be displayed on the screen for a certain minimal time period (for example for a 100 milliseconds or less) and/or for example the message covers only part of the screen so that the data stream can only be partially viewed, thus avoiding any artificial delays even if the user immediately continues to zap. Of course, if a user can hack into the system to try to steal the permissions table he might also try to steal for example the pre-captured data streams of the covered and/or predicted channels, so another possible variation is that these streams for example remain encrypted (or are re-encrypted) at the set-top box itself, but since the set-top box already has the base frames for each of them and each current frame, when the user jumps to the channel the decrypted data stream can preferably be viewed instantly (assuming instant checking of the permission) or it is decrypted automatically so the user can view it until the result of the permission check is known. Another possible solution is that for example in the covered and/or predicted channels the system automatically detects for each such channel if it is allowed or not even before the user jumps into it, and preferably does not save this info anywhere else. Another possible variation is that for example the set-top box does determine in advance which channels are allowed for the user but preferably this is not saved in a normal table but preferably for example in some scattered and encrypted manner in memory, so that preferably even the location in memory of the different cells of this table preferably changes all the time. Another possible variation is that similarly the decrypted data of the covered or predicted channels is scattered in memory in a way that makes it very hard to hack into it, but the set-top box itself can preferably still extract the stream instantly or almost instantly. In case the set-top box can for example work also (in addition or instead) with streaming data from the Internet (for example IP set-top-box) of course the same principles apply, however there are some different problems, since for example there is typically no constant data sent to all subscribers automatically at the same time, which means that requesting the predicted next channel or channels while the user is viewing a given channel actually can put more load on the system (eventhough preferably identical packets going to the same general area are preferably sent with a single copy to each general area and are preferably replicated into multiple copies locally, as explained in other applications by the present inventor). In order to solve this, preferably the system can use additional heuristics for improving the efficiency, such as for example activating the pre-loading of the predicted next channel or channels for example only when the user holds the remote control in his/her hand, which is much more efficient, since for example if the user is watching a specific movie or program and does not hold the remote in his/her hand then obviously no zapping is occurring and thus the data from the next predicted channel or channels is not needed, and on the other hand if the user picks up the remote, typically it will take him/her more than 2 seconds since first touching it until actually starting to zap, so that this should be quite sufficient for the system to start getting the streams of the predicted next channel or channels only then. For this preferably the remote control has for example galvanic response sensors and/or other preferably biometric sensors so that preferably the instant the remote is touched it preferably sends automatically a command to the set-top-box to start retrieving the predicted next channel or channels (for example the full resolution data stream and/or for example initially a lower resolution steam or steams with preferably more frequent base frames). If the lower resolution stream is based for example on a few streams with different pixels and a phase shift in the temporal position of the base frame, these can be for example separate low resolution streams or for example different data sections in the same low resolution stream,. If for example the user watches for example a TV station or for example some other form of multiple channel broadcast on the internet directly on his/her computer without a set-top box, similar heuristics can be applied for example to the mouse, so that for example the systems preferably starts fetching data for the predicted next channel or channels (for example the full-resolution stream and/or for example initially one or more streams of lower resolution with shorter-interval base frames) only when the user starts moving the mouse, since typically, again, if the user is not touching the mouse, no zapping is occurring, and if the user starts moving the mouse, typically it will take him/her more than 2 seconds till he/she actually clicks for example on some menu option in order to request for example the next channel or the previous channel or for example some other channel. Another possible variation (which can be used both in normal and in internet set-top boxes) for further improving the likelihood of correct guessing of the next channel is that for example the remote control can preferably also sense for example the position of the user's fingers before he/she actually presses a button—so for example by adding galvanic skin sensors and/or other touch sensors also to the buttons, for example if the remote senses that the user's finger is on or near the plus part of the main zapping button the chance is much higher that the user will next zap to the next channel and for example if the user's finger is on or near the minus part of the main zapping button then the highest chance is that the user will next zap to the previous channel and/or for example putting the finger on or near digit buttons can predict specific channels (for example in combination with that user's statistics and/or typical sequences). (Of course these methods can be used for example with streaming video and/or with streaming audio, such as for example with a digital satellite radio or for example with an application that connects for example to a large number of Internet radio stations, and/or for example with palm devices or cellular phones which can receive for example TV and/or radio broadcasts for example through the Internet or for example other cellular broadcasts). In addition, preferably the set-top box comes with extra memory fro time-slices buffer of buffers, so that if for example, as explained above, identical packets going to the same general area are preferably sent with a single copy to each general area and are preferably replicated into multiple copies locally, for example when requesting streaming data from the internet or for example when ordering programs or films in VOD (for example through the Internet or directly from the cable or satellite company)—preferably the extra-memory can work like in a computer, so that if for example a 100 users in the same general area request a certain program or movie at about the same time, preferably for example requests that are made within a small threshold (for example within the same 20 seconds window or any other reasonable threshold) are preferably grouped together and the data is sent to them at the same time so that these people view it at the same real time, and for example if the threshold is bigger —for example up to another 20 seconds a few minutes or more (or other reasonable threshold) preferably the first dozens of seconds or few minutes are sent separately (or also as united packets but for a smaller group) to the people that joined later and the rest preferably is sent to them together with the earlier group or groups, and so, provided that the set-to-box has enough buffer memory for the additional slice of the show, the next group of people can after a short delay of for example 10 or 20 seconds) start viewing the same show without further delaying the previous people, while still getting the data for most of the program together with the previous group or groups. Thus if for example a 100 people request the same show within the first for example 20 seconds window and then for example another 80 people in the same general area request the same show for example within the next 20 seconds, and assuming that for example it takes about 10 seconds to send the 20 seconds slice of the requested program or movie, then preferably the set-top-box's buffer starts receiving at the same time for example both the missing first 20 seconds (preferably together with the other 79 people of the 2^{nd} group in this example) and at the same time also the streaming data which the previous group of 100 people is receiving in our example, and then the set-top box for example after these 10 seconds (with the aid of the buffer which keeps that for example 20 seconds slice of the program or movie on with a constant shift of 10 seconds from the first group of 100, with these example parameters. Another possible variation, in addition or instead, is to use for example a local area cache or proxy—for example in the connection box in the neighborhood that typically serves for example 2000 people in Cable TV networks. However, since this local cache typically has only limited space and might not have sufficient memory for holding whole programs or movies, especially if more example many different programs or movies are being requested on VOD at the same time, preferably the local cache can for example hold slices, which can be utilized for example by methods similar to those described above. Another possible variation is that when the user downloads for example Streaming Video from the internet (such as for example movie trailers or other types of video date) preferably instead of asking the user about the speed of his/her connection (which can be unreliable since the user can reply wrongly or for example the actual bandwidth can be for example lower than the official definition which the user has), preferably for example the site and/or the user's browser measures automatically the actual speed (for example by automatically downloading packets of various sizes and measuring automatically the speed) and so preferably the optimal resolution and/or for example frame rate is preferably automatically determined according to these measurements, and this way for example if the streaming data is available for download at various resolutions and/or frame rates preferably the best mode is automatically chosen if the user wants to view it not instantly (if the user can and prefers to download it for later viewing then of course preferably the user himself chooses the desired resolution and/or frame rate preferably from the available choices). Another possible variation is that for example, in addition to or instead of predicting in advance the channels that the user is most likely next going to zap to, the system can for example request and get from the supplier (or for example web site in case of IPTV) a special base frame which represents the current position in time, and a special set of changes that lead to the next normal base frame, or for example a complete set of base frames up to the point of the next normal base frame, however this solution has efficiency problems and might be relevant only when the Internet and the service's computers become more powerful. Another possible variation is that for example real-time automatic rating data are transmitted to users'homes for example from the cable or satellite content provider together with the programs, preferably for each channel and program for which this information is available, so that for example pressing some key on the remote control preferably shows this data for example on some corner of the screen, for example near the channel Logo (which is typically on the top right or top left corner). Another possible variation is that for example automatic rating measurements can be made by simply improving for example the remote control and/or the set-top-box, so that for example the set-top box senses automatically if the TV is on of off (for example by sensing the electromagnetic radiation from the TV (since almost always the set-top box is on top of the TV or at least very close to it), and thus it can return automatic preferably anonymous data about the current channel being watched. This way for example the cable or satellite company can have real-time rating data from almost all of the subscribers instead of having to rely on a small selected group of volunteers (who typically also get paid for this) who have to use a special “people-meter” device. But since many times the rating measurers are also interested in knowing which family members are watching each show, preferably the remote control is improved to include for example automatic biometric measurements which can automatically identify the family member which last held it—without having to press a special button as is done with “people-meters”, which is a bother to the volunteers and is also unreliable in case they forget or are too lazy to activate it. This biometric detection can be done for example by optical sensors which can identify fingerprint and/or for example galvanic skein resistance detectors, however such methods are preferably used only with volunteers who agree to have the special remote control and who identify the age and sex and/or other data about each family member. Another possible variation is that for example a special camera is added to the set-top box which transmits data preferably to the set-top box's normal CPU or for example special additional CPU or DSP which can preferably automatically identify for example the age and/or sex of the people seating in front of it (preferably by using for example various heuristics, such as for example the height of the person as the age indicator and the hair style and/or cloths as the sex indicator), and preferably no data is transferred to the suppliers except anonymous data about the sex and/or age and/or number of people watching and which channel they are watching. This computerized camera is preferably used, again, only in a selected group of volunteers, but as explained above it can be much more reliable than having to rely on the volunteers to press some button every time the watch something. Another possible variation is that for example the methods of digital compression are improved so that a base frame can be efficiently sent more often and/or each given frame is less dependent on the base frame, and/or for example the base frame is simply sent more often even at the expense of some more bandwidth, and/or for example the sound is sent independently at the same time so that it can be played almost immediately (for example by using uncompressed sound or sound with more frequent base frames), and/or for example a lower resolution stream with more frequent base frames is similarly sent independently at the same time for example in parallel to the normal stream and can be used before the normal stream base frame becomes available. Another possible variation of this is that for example the data is split into several lower resolution streams which complement each other—for example each 1 of 4 (or another convenient number of) pixels is sent in a different stream and the base frames of each stream are preferably sent at a time shift compared to the other streams (for example ¼ seconds apart instead of for example 1 seconds apart between base frames in a normal data stream), so that a base frame for one of the streams arrives for example in ¼ of the time and then the data can be used already to create first an image in which only for example 1 in 4 pixels is known—i.e. an image of 4 times lower-than-normal resolution which can be shown 4 times sooner, and then for example as the base frame of the 2^{nd} stream comes in the resolution jumps to half, and then for example ¾ and then full resolution after the base frame of the last stream comes in and then the image remains in full resolution by combining the for example 4 sources of pixels in each image. However, of course this variation is less preferable since it means a less clear image for example for about a second, whereas the solutions based on predicting the newly zapped-into channels and pre-storing their streams can give instantly the full-resolution data stream when the user presses the button. Of course various combinations of the above and other variations can also be used.
40. Another preferable improvement is that computer cases are improved so that the same case can be used either in desktop position (lying in a horizontal orientation) or as normal tower (vertical orientation), thus giving the user much more flexibility in choosing the most convenient orientation without having to buy different cases. This is preferably done by making the case strong enough to support even a large screen on top of it when used in the desktop orientation, and preferably at least the area that supports the external CD and/or DVD drives, is preferably rotate-able between two positions, preferably in 90 degrees (preferably only back and forth between the two positions—to avoid excess bending of the cables), so that preferably the user can easily choose one of these two positions, at least by screwing the part when the case is open, but even more preferably the user can for example press one or more levers or buttons and then rotate the part even when the case is closed. An example of the case with the rotating element is shown in FIG. 7.
41. Another problem is that due to standard debug features in motherboard bridges, actually any computers that are connected to the internet, for example through a modem card or through an Ethernet card or USB, can be compromised by a hardware-based attack even below the OS, so that for example the Ethernet card can tell the north bridge and/or the south bridge to report to it any data that passes from the hard disk and/or even send directly commands to the hard disk through the bridge. Such activities can therefore bypass any software-based security system. In order to prevent this preferably at least one of the following is done:
   a. Preferably the motherboard chipset is changed so that such debug features and/or for example direct communications for example between hardware cards and the hard disk are preferably enabled only if some hardware element allows it, such as for example a jumper or a switch which has to be manually enabled by the user, and preferably the default mode is the disabled state, or for example it is not available at all. In addition, preferably the configuration can be set for example to enable such a debug feature only for example for one or more specific preferably special slots and/or one or more specific devices, and/or enforce other limitations.
   b. Another possible variation is that the user can for example add a card to one of the PCI slots and/or for example add another external device (such as for example a USB device, a PCI express device, and/or other type of connection device) which preferably keeps sending, preferably constantly, commands to the bridges which can preferably for example over-ride any attempt by other devices to tell the bridge to sniff on data or to communicate directly with the hard drive and/or for example the communication channels (for example the Ethernet card and/or USB devices and/or wireless devices).
   c. Another possible variation is that preferably the OS and/or a software Security System is preferably able, preferably through the OS kernel or even below it (for example by running within the hypervisor in systems that support it), to take complete control of the bridge and give it instructions that override any undesired attempts by hardware elements to sniff data and/or access directly for example the hard disk and/or for example the communication channels (for example the Ethernet card and/or USB devices and/or wireless devices). This is, again, preferably done by also changing the chipset accordingly.
   d. If for example some devices need to be able to exchange data with the hard disk directly, preferably at least any command sent from the device to the hard disk can preferably be monitored and filtered for example by the OS and/or by a security system installed on the OS or below the OS for example through the hypervisor that runs below the OS's in systems that support it, so that for example the data transfer itself is not slowed down, but for example the OS and/or the security system and/or the hypervisor can control preferably what files and/or directories and/or partitions and or physical disks can be accessed directly from the device and preferably what commands can be transmitted to the hard disk. This is, again, preferably done by also changing the chipset.

Of course, various combinations of the above variations can also be used. Of course the same principles can apply also to other non-volatile storage devices, as explained also in the clarification and glossary section.

Other improvements can be done for example in statistical packages, such as for example SPSS, so that for example when correlations (or other types of output) are displayed (for example on the screen and/or in printed form) for a large number of variables, preferably the user can for example instruct the system to automatically mark for him/her the most significant correlations (for example according to the significance value and/or for example according to the strength of the correlation), for example by automatically encircling them and/or for example using some special icons and/or fonts and/or colors (in other words preferably for example the font itself and/or its background is in a special color) and/or other marks (preferably they are surrounded for example by a background with the color, so that they are clearly visible also on monochrome laser printers, for example with a gray square), and/or putting them for example in a different section. (For example the other marks can also be for example 3d fonts that appear to jump out of the text or other visually conspicuous marks). The criteria for which correlations are sufficiently significant can be for example some default criteria defined by the user and/or automatically by the system, such as for example only correlations above 0.2 (or other significant cutting point or points defined for example by the user and/or by the system), and/or for example only correlations where the significance is 0.005 or less (or other reasonable cutting points defined for example by the user and/or by the system), etc., or for example the cutting points automatically and/or by user definition can preferably change dynamically according to the results, so that for example they can be automatically determined according to the number of correlations (for example if there are much more correlations in the results than preferably the cutting points become more demanding), or for example the cutting point is in addition or instead based on relative percent, so that for example the top 5% best correlations (or any other desired percentage, definable for example by the user and/or automatically by the system) are automatically marked, and/or for example some combination is used, so that for example only the top ×% correlations that are also beyond a certain absolute cutting point (for example of correlation values and/or of significance) are automatically marked. In addition, since some correlations can be much less meaningful than others—for example various Pearson Corr or other correlation commands can create automatically also correlations of variables with themselves, preferably these are marked differently and/or ignored, and/or taken into account differently so that they do not distort the statistics. Another possible variation is that the user can mark for example one or more sections of the correlations results (for example with the mouse) so that these automatic marking or statistics will be run only on parts of the results (since for example some of the correlations might be known by the user to be more or less meaningful than others). Preferably, apart from marking the most important and/or meaningful correlations, the system can, in addition or instead, also report various meta-statistics, such as for example what percent of the correlations are beyond certain cutpoints (for example according to the correlation value and/or the significance), and preferably this can be for example reported for example as a combination of such cut points and/or for example for each cut point or criterion separately, and the system can preferably also report for example what is the significance of these meta-results, i.e. for example what is the chance that for example in these specific results 12.7% of the correlations have significance for example below 0.01 (or any other value), preferably while taking into consideration issues such as for example the total number of correlations, the number of cases upon which they are based, and preferably automatically ignoring all the correlations of variables with themselves and preferably also for example any other correlations that the user marked as less meaningful and/or that the system can for example automatically determine as being less meaningful. (For example variables that are defined in an overlapping way, for example because they are based on computation involving other variables, will create correlations that may be interesting but should preferably not be confused with other statistics since part of their correlation is artificial, and there should be no problem for the system to automatically identify the problematic correlations for example according to the “compute” commands that were used). Preferably these statistics can of course relate also for example directly to the marked results, so that for example the system can report what number of results was marked out of what total, what percent it is, and/or what is the chance of having such a meta-results by chance, however these meta-statistics preferably show also additional values. Another possible variation is that the system can automatically and/or by user request generate also various graphs for visually displaying these meta-statistics. Although it is possible in the prior art to run for example a cluster analysis or an Addtree or Extree analysis on a set of output correlations, this is a very specific analysis that takes as its input a matrix of correlations and uses them as distance data to derive an analysis of the way these variables are clustered as a group. In contrast, the above suggested meta-statistics can be much more general and much more flexible, and thus can deal for example also with correlations that are not in the form of a matrix of correlations of N×N variables, and preferably can analyze for example the value of the correlations themselves, as explained in the above examples, whereas for example cluster analysis or Addtree or Extree take the correlations as input without analyzing the value or significance or meaningfulness of the correlations themselves. In addition, for example analysis such as Cluster analysis, Addtree or Extree are not a substitute for looking also at the correlations themselves, and the above described markings and/or meta-statistics can help the user analyze or evaluate also the correlations themselves. Another possible variation is to improve the Extree or Addtree display of the resulting tree for example by automatic coloring of different clusters and/or sub-clusters with different colors and/or sub-colors and/or for example automatically encircling the groups (preferably the system knows the clusters and sub-clusters in the resulting tree already since the tree is typically created from the bottom up, and/or they can be identified automatically according the length of the branches). This coloring can help the user grasp the results visually faster. Preferably the user can also manually change colors or change their borders for example by dragging the border, since for example the user might decide that one or more borderline items actually belong for example to the near cluster. Another possible variation is that for example in cluster analysis (which typically shows the results for example in a two-dimensional scatter plot) clusters and/or sub-clusters are preferably automatically colored by colors and/or sub-colors). Another possible variation is that the system can for example use more than one type of mark, so that for example 2 or more levels of significance (for example according to the significance value itself and/or for example according to the strength of the correlation) are marked differently, for example more conspicuously and/or with different colors. Another possible variation is that the system can for example automatically sort the results for example according to their value and/or importance and/or significance, so that for example in the case of correlations, for example the highest correlations and/or the correlations with the highest significance values and/or some combination of the above are displayed first. (Preferably the user can request for example if to display the correlations normally or in a sorted way, and if so, sorted by which criteria or combinations of criteria, and/or the user can for example also request some combination, so that for example the results are displayed according to certain structures and the sorting is for example only within the structures). Another possible variation is that for example instead of marking correlations, for example only the relevant correlations (or other results) that fit the criteria (and/or would have been marked) are printed, thus saving paper and time. However in that case of course preferably this is accompanied by meta-statistics that refer also to the non-printed results. These automatic markings and/or meta-statistics can be applied for example for each statistical procedure or command separately or for example to the entire set of procedures or commands, for example on the same Run. Another possible variation is that the system can for example automatically correct the significance scores of the correlations, for example according to the Bonferroni correction formula, so that the significances themselves are already displayed corrected, however that is less desirable, since it means that the significance can change all the time depending on the number of tests in the same run (or set of runs), thus making it confusing and not consistent when someone wants to compare various results. Another problem for example with Pearson correlations is that 1 or more extreme values away from a main cluster of values can sometimes distort the correlation. This is preferably solved for example by allowing the user to request automatically running the tests also on preferably automatic randomly divided sub-samples, and preferably the number and/or size of the sub-samples is determined by the user and/or automatically by the system (for example according to the number of cases and/or according to the variance and/or according to other parameters). Another possible variation is that this test is run automatically by default (for example unless the user explicitly requests to suppress it) and preferably the correlations (or other statistics results) can also be for example marked differently and/or displayed in a different section if they are more stable across these sub-sample tests, and/or the results of these stability or strength tests can be for example displayed each near the corresponding correlation (for example as a number indicating the stability value). Although for example SPSS has recently added to their most recent version (Ver. 12) the ability to request tests on sub-samples (a new feature called Complex Samples which uses CSPLAN to define the sampling parameters), the CSPLAN design specification is used only by specific procedures that are defined within the Complex Samples Option, whereas according to the above suggested solution automatic analysis by random sampling is preferably automatically available and automatically activated for any statistical procedure, and as explained above, the results of this analysis can preferably be used automatically for example to mark the most important results. So preferably either the sub-sampling is done randomly and automatically by the system by using preferably automatic defaults and/or automatic rules that are preferably used to decide the most desirable sampling strategies according to various parameters of the actual data, and/or for example the user can define in addition or instead more specific parameters, for example by the above CSPLAN procedure, but preferably these definitions can then be applied automatically for example to any of the normal statistical procedures that are used for that run, and this is preferably used also for marking the best results, as explained above (and/or is taken into account for example for the sorting, so that for example correlations are sorted both by their size and/or significance and by their stability and/or for example within a certain level of strength the results are internally sorted by stability). Preferably the user can choose for example if the correlations will be sorted by absolute correlation, with negative correlations mixed with positive correlations, or for example the negative correlations appear separately, and/or for example the user can request that this sorting be done for example separately automatically for each variable, so that for example the variables appear for example in alphabetic order or by order of appearance, and for each variable the correlations are automatically sorted so that preferably the largest correlations appear first. So preferably the user can for example enter a simple list of variables, and then request for example to run a correlation of all by all, and display the results for example by automatic sorting across all variables, or for example by automatic sorting only within each variable, and/or for example by some combination, so that for example there is a sorting within each variable, but the variables themselves are automatically sorted so that for example the variables that have the highest correlations in general (for example on average or have the highest peaks) appear first. The automatic rules defined by the system can for example take into account the original sample size, and for example determine the size of sub-samples by the minimum desired absolute size of the sub-sample and/or by the minimum desired size in percentages, and/or for example by the number of correlations that are tested, etc. For example the best automatic choice might simply be to create just a division of 2, but for example create this multiple times (for example 10 times or any other desired number) with a different random cut and compare the results for stability across all random attempts. Preferably there is for example one most preferred default, and if the user is not satisfied with this he can for example choose from a few other suggested defaults or sets of rules, and if the user still does not like any of them he can add his own rules in addition or instead. Of course, a list of correlation results is just an example, and similar principles can be applied for example to other types of statistical results where multiples results are presented together. This is much more convenient than the prior art, where the user typically had to print the results and mark manually the most significant ones. Another possible variation is that the user can for example request to run various procedures (such as for example FREQUENCIES or PEARSON) also on lists of variables defined by exclusion (such as for example “ALL EXCEPT AGE”). Of course, various combinations of the above and other variations can also be used. Of course, like other features of this invention, these features can be used also independently of any other features of this invention. Another possible variation is that preferably the user can tell the SPSS (or other statistical packages) for example how many digits to show after the dots in various statistical results, such as for example in Pearson correlations frequencies, significance level, etc., preferably either globally or for example for each specific procedure.

In addition, preferably various statistical programs that allow backwards checking, such as for example the search engine of http://search.wallstreet.com/wsc2/prosearch.html are preferably improved to allow the user much more flexibility in defining the backwards checks. For example, the Wallstreetcity.com search engine allows the user to test various investment strategies retroactively up to one year, in order to see which performed best. However, the user is thus limited to only a very small test period, which can be very unreliable, since if for example during 2003 the market came up from a multi-year low, strategies that work best at such periods might for example work very differently in other periods. So instead of this, preferably the user is allowed to use the retroactive test on much longer periods (such as for example up to 10 years backwards), and in addition, preferably the user can for example divide it to one or more sub-periods and see the performance for example on each sub-period, and the user can preferably define for example the exact starting point and/or ending point of each period or sub-period. In addition, in the prior art search engine the user has no control on the way the tested strategy is applied retroactively—for example are the N stocks that most fit the test criteria simply bought at the beginning of the retroactive test period (for example 12 months ago) and just held for the entire period, or for example every month the stocks are replaced if there are other stocks that now fit the criteria better, etc. So this is preferably improved so that the user can define for example exactly on which times or after every what period the stocks are again updated according to the strategy (for example every week or every month or other convenient period) and/or for example the stocks can be updated automatically (for example even once a day or even any time) when there are one or more stocks that become better according to the criteria beyond a certain minimal margin of difference. For example if there are 8 stocks that were chosen according to the strategy, anytime that one or more new stocks become for example 5% or 10% more (or any other convenient margin) better than at least one of the for example 10 or 20 original stocks (according to the chosen criteria), then the appropriate stock or stocks can be automatically switched for example anytime during the retroactive test. Preferably all of these stock swappings take into account also at least minimal required commissions, so that the end result of the simulation preferably reflects correctly the performance that would have been made after having also paid the necessary commissions in order to apply the strategy (in addition, preferably the user can specify the commission level that most correctly reflects what he would have to pay in reality if he did these swappings). Another problem is that this prior art search engine allows the user to define the past performance of the stock (which is one of the possible criteria) only in terms of performance over a defined period (for example the last 3 years or the last 5 years), which thus unnecessarily limits the user. So this is preferably improved to allow the user to define in addition or instead for example criteria such as for example choose the 10 or 20 (or any other convenient number of) stocks that performed in a certain way from the last peak (and the peak itself can be for example specified specifically by the user as for example as an exact date or for example automatically found by the system). This is important, since if for example a NASDAQ stock was at its peak in April 2000, and was for example much lower in January 1999 and in January 2001, it might be much more informative to take as a criterion for choosing stocks their performance since the last sufficiently large peak, or for example since the highest peak that existed over the chosen period (where the peak is automatically found for example in the last 3 years or 5 years or any other desired period) instead of taking as the criterion automatically the performance since the beginning of the specified period. Of course, various combinations of the above and other variations can also be used. Of course, like other features of this invention, these features can be used also independently of any other features of this invention.

Other improvements can be done for example with Internet browsers and/or other programs that access the Internet, so that for example preferably the browser can request from the server also just a part of an Internet page, such as for example a certain line or for example the value near certain words or areas or fields in the page, etc. This can save a lot of time and traffic, since for example programs that want to update data from various pages and/or run for example various statistics with data from a large number of pages might need just a small part of the data in each page, and thus this can be much more efficient than having to request the whole page and then look for the desired data in it. Although there exists already a format called RSS, which allows getting only a specific area from a web page, this is an XML format that requires specific definitions in advance in the desired web page in order to enable this. On the other hand, according the above improvement, specific requests can preferably referred to web servers regarding any pages, so that for example the browser (and/or for example other programs that accesses the Internet) can request from the server for example just a certain line or lines or words or words in the page, for example defined by position (such as for example lines 20-22), and/or for example defined by content (such as for example, Bring me only lines that contain a certain search string), etc. This is very important since most web pages today are much less structured than XML pages. The server can provide this information for example by simple string search on the web page, and then sending to the browser just the relevant data instead of the desired page. This can be done for example by the server itself or for example by additional software that runs preferably together with the server, preferably on the same computer or at least on the same site or location. Another important improvement is that when uploading a file—for example when submitting a form or in any other way, preferably the browser specifically warns the user about the file name that is about to be uploaded and preferably also its path and/or its size, so that the user can know exactly what is going on, instead of the prior art in which for example when submitting a form Netscape just warns the user that data is about to be submitted, since the prior art warning is activated any time the user presses the submit button in a form and thus the user does not pay any attention to it if he/she indeed is submitting a form, and so the user can be easily fooled for example by malicious web pages if the form looks OK but a file is downloaded from the user's computer for example as a hidden variable or in any other way that the user does not notice that it is included in the form (for example invisible font color and/or size, etc.). In other words, the warning is preferably more specific about such files, instead of or in addition to the normal warning about submitting any form. (Preferably the general warning about submitting forms is not needed and the browser automatically avoids submitting anything unless the user really pressed a submit button. However this preferably includes a lexical and/or grammatical and/or semantic analysis of what is written in submit buttons, for example in normal form buttons and/or in Javascript buttons, and/or for example the browser automatically indicates to the user near each button what action pressing the button will lead to, preferably at least when the mouse is near it, before the user even presses it, or even all the time, for example near the button or superimposed on it, for example by showing the button at least partially transparent, in order to reduce the chance of the user being fooled by a misleading button). Another possible improvement (which is similar to some of the variations of the solutions to the focus grabbing problem discussed elsewhere in this application) for example in browsers is that preferably when the user types text for entering for example in some field in a form, preferably the browser and/or the OS can keep it automatically in some buffer, so that if the user starts to type before the actual form field is reached—for example in pages where on loading the page the focus goes automatically to a search line even if the user does not click on it, such as for example in various search engines, for example if the user starts typing before the page completes loading, the typing is not lost but is preferably added automatically for example by the browser or by the OS to the beginning of the input line. Another preferable improvement for example in other email sending programs (such as for example Pegasus) is that when the user tries to send for example multiple emails and some of them get for example a TCP/IP error or some other kind of error when trying to connect to the mail server, preferably the email sending program automatically saves these messages separately and can preferably automatically try to resend them for example after some time or by user request (preferably only if they are non-permanent errors) or for example can automatically display them one after the other so that the user can try to correct whatever is wrong when possible, and then for example pressing some key automatically tries to resend the same message. Another preferable improvement is that for example if the user changes the language from English to Hebrew while filling a form in a browser, preferably the user can also indicate if the change is intended only for that specific browser window, or for example the change is by default automatically only for the specific site involved until the user changes it again (which means that preferably this information is saved for example in a cookie file), or for example the change is automatically only for similar types of forms, etc. Another possible variation is that the browser automatically takes into account the language of the text near each form field and automatically accepts by default the input in the appropriate language. Of course the browser does not have to positively identify the language but at least the relevant character set and then preferably use the same character set by default for the near input field or fields.

Another improvement in Internet browsers is that preferably the user can for example mark a group of links (for example in the history list and/or in the bookmarks list of the browser, and/or for example in any web page displayed by the browser that contains links) (for example in a way similar to marking more than one object in a scroll list and/or by simply marking the area where the desired links are), so that after the user for example marks the desired group or groups of links, preferably pressing for example some button causes the browser to automatically open multiple windows (or tabs) so that preferably each window or tab accesses automatically one of the marked links. This means of course that preferably similarly choosing for example “save as” after marking the links causes the browser to automatically save the targets of all the marked links (for example other web pages and/or files, etc.). In this case preferably they are saved by default with their original names, or for example the user can define a group name which is preferably incremented automatically to differentiate between the files in the group, and/or for example the system can automatically read the title in each of the files or web pages and use that as the name, and/or for example the user can automatically save the group of pages one after the other in the same cumulative file (in this case preferably the browser adds automatically separators between the original pages and/or the url before each page starts in the combined file. Similarly, preferably the user can also for example perform other commands on the group of marked links, such as for example automatically print the group, etc. Another possible variation is that preferably the user can for example mark multiple email addresses (for example when some email has to be sent to a number of people with cc) and then for example by using cut & paste into the recipient's field when composing a new mail message, preferably the browser (or for example other email program) automatically pastes the first email as the first recipient and the other emails as the copy recipients (for example in Netscape by automatically adding them line after line, as is done in Netscape, and in Opera by automatically adding the copy recipients all together in the second line with commas inserted between them, as is done in opera). Another possible variation is that the browser preferably allows the user for example after jumping to some bookmarked page, for example to move consecutively forward or backwards for example to the next or previous bookmarked pages consecutively (for example by clicking on some arrow or icon or for example pressing some key. This can allow the user for example to go over some recently marked bookmarks faster than having to click on them one after the other without having to open multiple tabs or windows of them at the same time.

Another possible variation is that the user can for example perform commands that affect a group of open windows (preferably of the same application—for example browser windows, and/or for example tabs)—so that the user can for example enter a command that prints all of them or that saves all of them or that bookmarks all of them—for example by entering the global command in one of the open windows of the same application, or for example by marking multiple boxes in the task bar or in the tabs handles bar (for example by clicking with the mouse while the shift or control keys are pressed) and then entering the command, such as for example ˆS for saving all of the marked windows (and/or tabs), ˆD for bookmarking them, and ˆP for printing them. Another possible variation is that the user can for example automatically change together the size of all the open windows and/or tabs (or make for example other format changes that affect automatically all of them) of the same application, so that for example if the user activates the cascade command, which reduces automatically all the open windows of the same application, he/she can preferably also restore all of them automatically to full screen with one command. Another possible variation is that if the user for example wants to print an article and does not notice that there is a link for a printer friendly version, preferably the browser looks for this link automatically in the page and preferably can ask the user automatically (for example when the user tries to print the page) if he/she wants indeed to print the page as is or to use the printer friendly link, and if the user replies positively then preferably the browser automatically goes to the printer friendly link and preferably reactivates automatically the print command for that page. For this the browser preferably goes over the links in the page and preferably looks for the most common expressions that are usually used for such links, such as for example “print”, “print version”, “printer friendly” “printer friendly version”, etc., and/or for example finds it according the html content of the link, such as for example “javascript:window.print( )”. Another possible variation is that in this mode the user can for example choose automatic carrying out of the global command or for example to be prompted for each of the windows for example with the option to choose yes or no in each case. Similarly, for example when the user wants to print an original patent image file in the EPO and/or for example print the drawings of a patent in the USPTO, in the prior art he/she usually has to request and print each page separately, which can be quite cumbersome and lengthy. So preferably these databases are of course improved so that the user can for example press an icon which allows printing for example the entire images pages or for example a range of pages. Another possible variation is that even without improving the available options in the site itself, preferably the browser itself can allow the user to define a set of steps to be performed automatically, such as for example pressing the icon or link that leads to the next page and then printing it, so that for example after pressing for example once or twice the “next page” link and printing it, preferably the user can activate a command that tells the browser for example to repeat the last N actions for example an additional M times and/or for example until it is no longer possible (for example after reaching the last page the next page icon is no longer active). Another possible variation is that the user can for example preferably easily give the browser for example a list of parameters and then let it preferably automatically repeat the same action on each element of the list—for example give the browser a name of a file with application numbers and tell it to search them one after the other for example at the USPTO PAIR portal, and preferably also for example the user can tell the browser for example do print or for example add to a file specific fields in the results page. For this again the user preferably for example shows the browser an example of the desired action or sequence of actions and then for example activates a command that tells the browser to repeat the same last action or sequence of actions on the entire list of parameters. Another possible variation is that the user can tell the browser for example to repeat this run with the multiple parameters for example every day (or other convenient interval) and preferably save the relevant results each time and for example issue an automatic alert when anything has changed (for example by running automatic compare between the new results and the saved results) and then preferably for example the browser (or other application) indicates to the user the changes since the last run. Similarly preferably the report can also for example search the private PAIR and for example generate automatically the list of expected next examination reports, for example sorted by application number or name or sorted by time till examination, Another possible variation is that preferably when pressing for example a Javascript button which designates a link with the right mouse key, preferably the same options are available as when pressing for example the right mouse button over normal links, such as for example Open in a new Window instead of in the current window, or Save the link target instead of opening it, etc. (in the prior art buttons that designate links can only be opened normally by clicking on the left mouse button). Similarly, preferably the browser shows the action defined by the button at least when the user's mouse is near the button or above it (or even all the time), for example by showing the button with a semi-transparent color that lets the user to see text under it, so that the user can know in advance what to expect, and if for example pressing the button activates some Javascript function then preferably at least the function name is shown. Another possible variation is that when typing for example one or more words or part of a url address in the location window of the browser, preferably the browser does not attempt to go automatically to the “.com” address, but can for example check also, preferably simultaneously, if the address can be resolved also to other TLDs (Top Level Domains) or other domain extensions, such as for example “.net”, “org”, “info”, “.co.uk”, etc., and then preferably the browser opens for example a scroll Window of the existing addresses and lets the user choose the desired one. Another possible variation is that in such cases the browser can also for example check automatically in the background, for example on a search engine like Google, which of these possibilities shows up higher (i.e. for example has more links pointing to it) and then preferably sort the options by this popularity index (for example number of links pointing to it) or even for example choose automatically the most popular option, so that if for example aol.net has a higher score than aol.com then for example typing in the location window the word aol will automatically lead by default to aol.net instead of aol.com. In addition preferably if the browser for example does not find a domain with “www.” at its beginning it preferably tries automatically also without the “www.” and vice versa. Another possible variation is that preferably the browser is improved so that for example if a certain given URL (for example from a link which the user clicks on or for example if the user types it himself/herself in the location window) is not found, preferably the browser can automatically check in a search engine (for example Google) for similar urls and display for example a sorted list of closest most likely alternatives. However, this is preferably done differently for example if it was a link which the user clicked on than if the user typed it in directly, since for example when the user types the url directly there is much more chance for typing errors, so preferably various heuristics are used in this case for checking for typing errors, for example according to close characters on the keyboard and typical errors. (Although Netscape for example goes automatically to a search page if a domain name is not found, in the prior art if a url within a domain is not found then the browser displays an error message of the server in that domain, and also apparently netscape searches for the words as keywords instead of trying to check for example for mistyped very similar urls). Another possible variation is that web servers are improved so that if a page is not found the server itself for example offers such a preferably sorted list according to similar pages (preferably according to the path and file name) in the same directory and/or for example in similar directories. Another possible variation is that preferably for example the Internet browser or some other application or for example some external service on the web can for example monitor automatically a list of one or more specified domains or urls preferably at short intervals (for example every few minutes or any other reasonable period) and can preferably automatically notify the user (for example by email or SMS or visual and/or auditory message on the screen) if and when the server is down or the domain or url is unreachable for any other reason. In addition, preferably the user can tell for example the OS and/or the browser and/or for example the service that the user acquired domain names from, to automatically perform all the actions necessary to renew one or more specific domains on time even if the user forgets to do it (for example the browser can automatically login to the site and perform the necessary actions for renewal, or for example the service is instructed to renew it automatically like a subscription if the user does not cancel the automatic renewal until the automatic renewal time, etc.). (This is very important since even huge companies sometimes forget to renew on time important domain names eventhough they get automatic reminders from the domain name service). Another possible variation is that for example the OS and/or the browser can automatically sense the width or size of the screen and/or the resolution and/or number of fonts available, so that for example if a table does not fit in the page and necessitates creating automatically for example a horizontal scroll bar, preferably the browser and/or the OS can for example decide automatically to reduce the font size accordingly so that the scroll bar is not needed (this is preferably done for example only if the automatic reduction is of a limited size, for example up to 20% or any other reasonable ratio, preferably so that the font does not become too small to read). Another possible variation is that the browser can similarly also decide automatically for example to reduce only the width of the fonts, so that the fonts become thinner, which can be easier and more convenient to read than a font that is also smaller in height. This can save a lot of time and increase surfing efficiency. Another possible variation is that for example both a color printer (for example inkjet) and a non-color printer (for example laser) can be connected together to the same computer and for example when printing pages the system can for example automatically decide to send for example print jobs and/or even for example parts of them—for example individual pages to either of the two printers, for example according to the amount of color in them, so that for example pages with color beyond a certain threshold can automatically be routed to the color printer. Of course, various combinations of the above and other variations can also be used. Of course, like other features of this invention, these features can be used also independently of any other features of this invention.

Another preferable improvement is that preferably the user is warned automatically for example by the browser and/or by the email client if an http link (for example in a web site or in an email message) is trying to deceive him/her. For example there are email messages that pretend to come from PayPal or Ebay or various banks and tell the user that someone unauthorized has accessed his/her data and invite him/her to click on a link in order to check or update his/her data, and the visible link says for example https://www.paypal.com but the real link within the href is somewhere else, so that the user is lured onto a phony site and into revealing secret information, such as for example his/her credit card number, account number, passwords, etc. (This kind of fraud attempts has increased dramatically in the last year and is commonly called phishing, and a large number of users are indeed fooled by it into revealing their data). So in such cases preferably for example the browser or the email client (and/or other application) automatically indicates to the user preferably in a conspicuous manner (for example by flashing the real link within the href and/or displaying a warning for example that the entire page or email is suspect, for example with a recommendation not to click on the link) that the real href is different and thus the link is phony, and/or for example warns the user about this when he/she clicks on the link and gives him/her a chance to cancel before actually going to the linked site and/or for example blocks altogether access to that link and/or for example goes instead to the visible link which the user thought he/she was going to instead of the phony link inside the href. For example preferably immediately when displaying the email or web page or before displaying it the system can flash a conspicuous warning that the entire html page or email message that contains the phony link is therefore most likely a phishing attempt and therefore should be ignored (this flashing of the warning can be done for example together with displaying the page or email message or even before displaying it, so that for example unless the user explicitly requests to view it anyway it is not displayed at all). Of course, like in other places, various combinations can also be used, such as for example both warning the user about the misfit phony link and about the fakeness of the page or email message altogether, and then if the user still allows going to he link, going only to the visible link instead of the phony link, since for example the user might press by mistake or without noticing the wrong answer. (In this case if the user for example still wants to go to the phony address (for example for research or law enforcement purposes) preferably for example he/she has to manually cut and paste the phony url). Of course, in such clear cases of misleading hrefs (for example Email messages that contain clearly misleading hrefs where the visible link does not fit the real link) the email message can also for example be automatically blocked for example by spam filters (with or without notifying the user about this blocking) for example on the user's own computer or for example on a corporate firewall or ISP's firewall or mail server, thus not reaching the user at all (for example unless the user is also notified about it and for example requests explicitly to view it anyway). (Preferably normal spam filters are also improved to identify automatically for example typical patterns of mixing digits and/or other non-letter characters with letters in a way that tries to bypass word filters). However, the visible link might just say in this example for example “Paypal” without the full url, in which case it is more difficult to be sure of the attempt to mislead the user, or for example might simply say something like “click here to activate your account”, etc., so another possible variation is that preferably for example the browser or email client automatically indicates to the user also the real url that is within the href (preferably in the normal display of the page—for example next to the link or superimposed on it, preferably even when the mouse is not near it, and not just in a line at the bottom of the window when the mouse is standing on the link, as is done in the prior art, since many times the user clicks quickly without even noticing it, and preferably the browser (or other application) of course makes sure that this is clearly visible, thus preferably ignoring for example any font size and/or font color command which might hide it and/or for example making it automatically even more conspicuous than the normal text). This is important because eventhough the user might discover the deception after clicking on the link, this is still dangerous, because the link might for example point to a site that contains a hostile code that takes advantage of some vulnerability for example in the browser or in some plug-in and thus can compromise the user's computer and for example steal or destroy information or plant a Trojan horse on the user's computer (This is also why these smart phishing protection methods, and/or checking against known black lists, are preferably done BEFORE the user has a chance to click on the link, since identifying a phishing site after the user has already entered it is much more dangerous since it already exposes the user to possible exploitation of various vulnerabilities even if he/she discovers the deception after reading the web page itself and/or does not eventually enter personal data there). Another possible variation is that for example the browser and/or for example the OS and/or for example the security system (and/or for example another software, such as for example the email client or the spam filter) can for example automatically conduct at least some keyword analysis and/or grammatical and/or semantic analysis of the message and identify for example a typical scam which requests the user to verify data and/or can preferably identify the name of the institute which is referred to (for example according to the wording of the message and/or according to the domain name of the purported sender, which is in those cases almost always a forged email sender address which pretends to be from the domain of the relevant institution, for example Paypal, Ebay or some bank) and can for example warn the user automatically (for example about the specific links and/or about the likely fakeness of the entire page or email message) if the name of the institution appears as a file name or directory name in the real url of the href or does not appear at all or appears for example in a section before a dot before the real domain name, and/or for example in such cases can for example automatically look up the url for example in one or more whois database and for example warn the user immediately if the domain or IP address is not registered as belonging to the purported organization and/or for example appears to have been registered only a short time ago (such as for example a few days or weeks or months or any other reasonable period). Of course, a generic security system such as for example described in PCT application WO0192981 and U.S. applications Ser. Nos. 10/301,575 and 10/644,841 by the present inventor provides ample protection against any such threats, however it is still a wise policy to warn the user in advance about such attempts to mislead him/her. Also, there have been attempts for example to use unreadable characters in the url that appears in the location window (for example http://www.microsoft.com[special character].hackersdomain. com), so that for example Internet Explorer will display the url only up to that character, and thus the user might not discover the deception even after clicking on the link. Although Microsoft has fixed this specific bug, other ways to display a phony url in the location window might be discovered later. So, in addition, preferably the browser automatically makes sure that the url in the location window (and/or in the display of real url which is shown even before the user clicks on the link) is indeed displayed exactly like the actual url that it connects to, and if there are for example unprintable characters then preferably they are marked with some sign and do not effect the printing of the rest of the url, and if there is for example any attempt by Javasrcipt or for example Active-X or for example some other portable code (or for example by any other program on the user's computer), to put for example other data on top of the location Window (for example by fitting another small window and/or text and/or image that appears on top of the location Window), then this is preferably automatically prevented for example by the browser and/or the OS and/or the computer's Security System, for example by automatically monitoring and preventing other programs or portable code from putting any windows in front of the browser window unless the user explicitly transfers the focus to them, and/or for example by automatically intercepting windows and/or text and/or images that have a suspect size and/or shape and/or location or that otherwise have suspicious or unusual qualities. Another possible variation is that such sites that allow the user to make monetary transactions preferably have additional precautions that prevent the thieves from doing real damage even when they succeed in luring users to divulge their secret data. These additional precautions can be for example that for any transaction or for example for transactions above some minimum amount, or for example at least during login in those sites, the user gets an automatic message directed to his/her known address (for example email or Instant Message, with a special code) which preferably contains a unique one-time use generated code, and the user has to respond to it before he/she can go on with the login or the transaction, and/or for example the user has to login from certain known IP addresses or range of addresses or address parts and cannot login at all from other places (and/or the login must be from a certain geographical positions, for example a certain range of GPS coordinates, for example when geographic IP addresses are used), or for example the challenge email is sent only if the login is from another location and/or not from the allowed IP addresses, and/or for example the user's identity is verified by a biometric method and/or by a physical identification hardware that only the user has, and/or these same methods are used for verifying attempts to use the credit card, etc. Of course, the system preferably prevents forgery of IP addresses, for example by any of the methods described for example in my Canadian application 10/756,839 of Jan. 11, 2004 and U.S. provisional application 60/561,160 of Apr. 9, 2004. This way even stealing for example the users'account numbers and/or passwords and/or credit card numbers, still severely limits the thieves'ability to use them. Similarly, preferably irregular credit card payments (preferably even for example when a physical card is presented, for example outside the Internet) and/or for example drawing money from ATM machines, are preferably instantly reported to the owner (for example by SMS to his/her cellular phone and/or normal phone and/or internet phone and/or other type of automatic voice message or instant message and/or email) and/or back-confirmation is required, for example depending on the extent of the irregularity. For example since Sep. 2003 some banks have started experimenting with sending automatically an SMS to clients whenever a payment is made with their credit card. However, that is a bit problematic since this way eventually one way or the other the credit card companies will transfer the cost to the clients for sending an SMS for each payment, and also this might become an annoying routine and thus users would pay less attention to such messages or decide it is too much of a hassle and thus request to cancel this service. Therefore, it is much more preferable to send such an instant message automatically only when there is an irregularity. Although the idea of sending an SMS if the transaction is of a high amount has been around since Dec. 2003, this is too extreme on the other end, since a thief might for example make multiple transactions, all with a value smaller then the threshold. Therefore, preferably the automatic messages are generated for any type of irregularity, such as for example if the transaction is made in another city or country in which the user does not usually make transactions and/or for example in a shop in which the user has not yet made transactions (or has rarely made them) and/or for example the transaction involves an item which the user has not bought before, etc. (If the type of items bought is also taken into account then this means that preferably this information is preferably transmitted automatically for example from automatic cash registers to the credit card company's computer for example at the same time that the credit cards company's computer is contacted, so this is preferably done by transmitting for example the bar codes of the items, but this might be problematic since it requires changes in many places and also some users might be concerned about the reduced privacy if this is done). When money is taken from automatic teller machines, preferably the instant message is sent every time an unusual amount is extracted (this does not have to be an unusually large amount but can preferably be for example an amount the user has never or rarely extracted before—for example $35 if the user almost always extracts for example $20 or $50) or for example every time the money is drawn from a machine which the user has never used before (or for example rarely used)(since a normal user usually pulls money from a small set of machines and, a thief who for example duplicated or stole the card would most likely use a different machine). Another possible variation is to similarly preferably highlight (for example by underline and/or boldface and/or special color and/or for example special icons or other preferably conspicuous visual indicators) such unusual credit card transactions and/or for example ATM or check withdrawals and/or for example any unusual activity, for example in bank reports and/or credit card reports which are for example sent to the customer once in a while (for example the credit card monthly report), since otherwise the user might for example not notice this, for example if the thefts are for not big amounts and only one in a while (as explained above this is preferably done automatically based on automatic analysis of the user's usage statistics). Another possible variation is that for example the bank sends the user automatically once in a while a list of all the ATM withdrawals together with an indication of the address of the ATM machine where the money was drawn (this is preferably not available by request for example at the ATM machine since otherwise the thief could also request this report), and thus for example the user can identify immediately when an amount has been withdrawn at a place where he/she never withdraws money (In normal prior art reports that list only the amounts and dates many users might not remember if they indeed withdrew that amount on that day, especially for example if the report is sent for example after a month). Another possible variation is that preferably the credit card is based on a smart card or other thin computerized gadget which looks like a credit card in size and shape but creates the magnetic flux dynamically instead of a normal magnetic stripe, and preferably the credit card works only when another device which the user carries (for example some special key added to his/her keys bundle in his/her pocket) is sufficiently close (for example up to a few meters), preferably based for example on RFID communication between the two devices, and if for example the user wants to allow someone else to use the card, preferably the user can for example punch a secret code for example through a small keyboard on the card, and then preferably the card can also be used away from the user, for example for the next N minutes and/or for example for up to X transactions and/or up to Y amount (preferably settable by the user). Of course various combinations of the above and other variations can also be used.

Another possible variation is that when the browser enters a site (i.e. this is preferably done when the user presses the link, preferably before actually transferring any content to the user, however it can be done for example also while displaying the data to the user, however that is more dangerous, or it can be done for example while displaying the data but for example no active-x or scripting for that site is allowed until the user explicitly permits it, at least for example if the browser and/or for example the OS and/or for example the security system decides that the site is suspicious) and/or for example even before the user presses the link, for example when the mouse is near it, the browser preferably automatically checks also one or more relevant WHOIS databases and displays to the user automatically also the for example name under which that domain is registered and/or for example the country and/or other details that can easily indicate to the user if a site is phony, such as for example the length of time this domain has existed. Another possible variation is that if the system (for example the browser and/or the OS and/or the security system and/or other software) for example also checks in one or more databases for known phishing sites, preferably it also identifies suspect servers which were known to host such sites before, and/or for example also checks for example in whois records if the domain seems to be related in one or more ways to previously known phishing domains, such as for example being registered to the same people, having the same email of the technical contact or billing contact, etc. In addition, preferably there is also one or more database on the Internet which collects typical word combinations and/or other typical patterns of phishing email messages, for example from messages which have been identified by humans and/or by any of the above methods, which the browser and/or other application can preferably consult automatically for example for getting the typical patterns and/or for example the browser and/or other internet application accumulates the typical wording patterns itself automatically for example when it identifies a phishing email by any of the above methods), and thus preferably the browser or other application can for example warn the user automatically of any email that seems like a typical phishing attempt even for example by typical word combinations. Another possible variation is for example keeping a list of at least the most common organization names used in typical phishing attempts (such as for example Paypal, Ebay, Citybank, etc.), so that for example the browser (or other application) gathers this lists for example by itself (for example when it identifies a phishing email by any of the above methods) and/or gets it for example from one or more online database, and then for example warning the user automatically about urls which contain the name of the organization in suspicious places, as explained above. Another possible variation is that for example the browser (or for example other internet application) also warns the user if for example the whois record has various missing data and/or for example has suspicious fields, such as for example a phone number with a number 999-9999-9999 or some other suspicious patterns, since this can also be a clear sign of a bogus or falsified data of the domain owner). Another possible variation is that for example when a browser (or other Internet application) that was patched for some exploit (or for example a firewall that was updated to catch the exploit) for example see that a website attempted to use that exploit, preferably they immediately email the site's url preferably automatically, preferably with an appropriate automatically generated message, to the appropriate database or databases to be blacklisted, so that even systems that are still unpatched will at least be able to automatically avoid the url by checking for example in the database of suspect or blacklisted urls, and/or for example special spiders are used for finding such url's or for example this is added as an extra feature to spiders that already constantly spider the web anyway, such as for example the Google spiders. Another problem is that is Vista Microsoft added to Internet Explorer protection against misuse of domain names with international characters in phishing scams, but this protection is based on. Of course various combinations of the above and other variations can also be used.

Another even much more dangerous kind of attack, typically coined “DNS poisoning” or “pharming”, is based on changing data in DNS servers, so that various domain names point to malicious IP addresses instead of the real IP addresses. This is even much more dangerous, since no action is required on the part of the user, and all the users that reach the infected DNS are automatically affected by the phony IP address. In order to solve this, preferably at least one of the following is done: 1. Internet Browsers and/or other internet applications which need to access domains preferably automatically query multiple DNS servers, preferably in different locations (for example at least 3 or more), and if there is a mismatch between the IP address reported by them for the same domain then preferably the browser (or other application) preferably checks in preferably many additional DNS servers and preferably chooses the one that appears in most places, and preferably also warns immediately the user (preferably before going to the site) that there might still be a risk due to the mismatch (preferably with statistics on the percent of DNS servers pointing to each IP address), and/or the browser (or other Internet application) preferably checks in one or more domain name registrars to see for example if the IP address given to the domain is compatible with the DNS servers that are associated with the domain's records, etc. Preferably the warning about the phony IP address or addresses is preferably immediately automatically also sent for example to one or more relevant authorities and preferably also to the valid site owners (for example according to the correct IP address and/or according to the emails of the contacts in the registry records). Another possible variation, preferably in addition, is that preferably the browser (or other Internet application) preferably keeps historical data of IP addresses of domains that the user has accessed and preferably whenever there is suddenly a change preferably performs, preferably immediately and automatically (preferably before letting the user access the site), various checks, such as for example any of the checks described above, for example in multiple DNS servers and/or registrars. Another possible variation, preferably in addition, is that preferably the DNS servers themselves preferably perform automatically similar checks to those described above, such as for example keeping historical data and checking with multiple sources immediately when there is a change, and/or checking with multiple sources whenever new data arrives, etc. Another possible variation is using for example long encryption keys (for example PKI) preferably for any communication between DNS servers. Another possible variation is that preferably the DNS automatically identifies for example “birthday attacks” (statistical bombardment with guessed session Ids in order to find the correct session Id) or other statistical based attacks (preferably by keeping track of multiple communication attempts with false session Ids purportedly coming from the same server) and then preferably automatically ignores any packets from the spoofed other DNS and preferably automatically switches for example to other DNSs at least for a certain time. Another possible variation is that the browser (or other Internet application) and/or DNS server automatically checks back any IP address (for example whenever giving it in a reply or for example when it changes) also in preferably multiple reversed databases which find the domain name from an IP address. Another possible variation is that preferably the browser (or other Internet application) and/or NDS servers also check for example how long the IP address has been associated with the domain for example according to registrar records and for example if it has been associated for a short time below a certain threshold preferably performs various checks (such as for example any of the checks described above) and/or warns the user. Another possible variation is that (preferably together with keeping historical data) for example when an IP address changes, the browser (or other Internet application) and/or DNS server checks in one or more reversed Databases (which give the domain name from the IP address) if the original IP address now indeed point to a different domain, and if it is still pointing to the original domain then preferably this is immediately perceived as indication of possible DNS poisoning and preferably appropriate action is immediately taken, as described above. Of course various combinations of the above and other variations can also be used.

Another preferable variation is that when the OS and/or various applications support 3D objects, preferably the objects can be resized or moved in various directions in a way similar to the current processing of 2d objects, so that for example by clicking on the appropriate corner the object can be easily resized in that direction, and in this case preferably size parameters are automatically updated and preferably displayed, for example in CAD (Computer Aided Design) programs. Preferably a large taxonomy of object prototypes is available to choose from, such as for example planets, plants, trees, flowers, animals, people, vehicles, etc., and preferably these objects or prototype objects can be dragged into position and then preferably can be for example changed on the spot for example by fast scrolling over a preferably large number of objects of that prototype or sub-prototype, etc., so that preferably the object changes immediately in view, preferably while the mouse drags for example a scroll bar next to it. Another possible variation is that this scrolling can be done for example also for modular elements of the objects, such as for example leaves, branches, flowers in the plants category, car elements in the vehicles category, etc. Another possible variation is that various elements can be for example reshaped dynamically, for example in a way similar to the Goo program, except that preferably when pulling for example on a part (for example a nose in a face), preferably only that part is reshaped without affecting the parts next to it. Another problem is that for example in services such as the Google 3D Earth, which allows uses to access over the internet interactive maps which typically combine satellite images with street maps (either with the browser or with a special client program which the user downloads), when the resolution is close enough to see buildings, although the user may rotate the images in any 3D direction, since the photographs are really only 2D, many distortions can occur, so that for example the direction of viewing can be not compatible with the shown side of the buildings and/or the whole scene can become flat. Preferably this is solved by at least one of the following: a. Improving the program so that the 2D images are preferably processed in advance to create extrapolated 3D representations according to relevant visual cues, and/or for example by making the photographs in advance with two or more lenses or 2 or more cameras. b. Adding, for example at least in popular public places, multiple photographs from multiple angles, preferably from helicopters and/or balloons, which are preferably automatically combined into the processed 3D representations and/or at least become automatically integrated when the rotation and/or angle is appropriate. Another preferable improvement is adding, preferably at least in popular public places, one or more local streaming video cameras which broadcast preferably real time streaming data, so that preferably when the location and/or angle is appropriate the real time streaming data is automatically integrated. Preferably the displayed normal images contain special marks which indicate to user “hotspots” where addition 3D images are available and/or more details are available and/or live streaming data is available, and preferably the user can also ask the program to automatically take him/her to such spots for example automatically, for example each time the user enters a command to jump to the next nearest hotspot and/or for example clicks on one of the marked hotspots. Another problem is that when the user for example wanders sideways, typically it takes time for the application to fetch the more detailed images for the new area which the user moved to each time, thus creating an annoying wait for the data. So preferably this is improved so that the program automatically guesses for example from the pattern and/or direction and/or speed of the user's movement where he/she is most likely to continue next and so preferably the details for next area or areas are downloaded in advance before the user goes there, thus preferably reducing significantly the waiting experience. Preferably this is applied also for example in the cases when for example the user can move a virtual magnifying glass, used by the competing Microsoft application (‘Virtual Earth’), since there also the waiting experience needs to be reduced by the above advanced predictions of the next movements. Another problem is that when the user zooms in on an area, many times the exact point which the user was interested in can move out of the frame unless the user is careful to move it again to the center each time before continuing with the next zoom. So preferably this is improved so that for example if the user clicks on the point he/she is interested in and then continues with the zoom, preferably the spot that was clicked upon is preferably automatically moved by the application to the center so that is remains in focus, for example unless the user deliberately moves the area or for example clicks on a different spot. Similarly, preferably the system can automatically predict for example the zooming sequence of the user, so that for example if a user is apparently trying to zoom into the marked spot, preferably the system tries in advance to get each time the additional details at least one step before the user requests it. Similarly, preferably for example the pill such as by Given Imaging, which can photograph the human digestive system internally, is preferably improved so that it contains at least one more miniature video camera or other sensor also on the other side of the pill, and preferably each such camera can cover at least around 180 degrees, so that preferably both can cover almost all directions at the same time. This is much more efficient than the normal Given Imaging pill, since in the normal elongated pill the camera is only on one side, which means that at each given moment only the section randomly pointed to by the camera can be photographed. Another problem is that many times when filling various forms or questionnaires, the user might have to check or uncheck multiple checkboxes, as shown for example in FIG. 6. So preferably the browser is improved so that the user can for example darken with the mouse a group of checkboxes (for example by clicking the right button and dragging the mouse over the area while it is clicked) and then with one command for example mark or unmark the entire group, and/or for example dragging the mouse over a group of checkboxes with the left button pressed immediately marks each box on the way and dragging it with the other button pressed unmarks each checkbox on the way, or for example vice versa, etc., and/or for example pressing the Shift key (or some other key) and marking or unmarking 2 checkboxes preferably also marks or unmarks for example all the checkboxes in between. Another possible variation is that the user can for example also unmark a radio button (for example by clicking on it again or for example using another mouse key) since in the prior art once a radio button is marked it can not be unmarked except by marking another radio button which belongs to the same set.

Another possible variation is that for example when a computer becomes compromised by a Trojan and becomes for example a spam-relay station, preferably there are special sites or for example routers which identify the attacking computers and can preferably send the users who's compromised computers have participated in the attack (for example by identifying identical or sufficiently similar multiple messages from these multiple origins) for example automatic warning messages, for example directly to their IP address or to their email (However, using the email is much more preferable since on many such computers there is no normal way of sending messages to this IP address which the user will see). Preferably this can be accomplished automatically, even if the Trojan for example uses forged email addresses and/or forged IP addresses, for example by any of the methods described in the present inventor's U.S. application Ser. No. 10/756,839 of Jan. 11, 2004 and Provisional application 60/561,160 of Apr. 9, 2004. For translating the user's real IP into his/her email, preferably the system works in cooperation with the immediate ISP of the inflicted computer and/or for example there are on the internet databases which automatically link email addresses or other identity indictors with the current IP of the user, which are preferably automatically updated each time the user connects or disconnects from the Internet, as described for example in U.S. applications Ser. Nos. 10/756,839 and 10/905,664 by the present inventor, and preferably these databases preferably automatically allow also efficient searching according to the IP, for example by creating automatically in real time also indexes according to the IP addresses. Another possible variation is to identify for example when the user's normal Internet Browser accesses web pages from the real IP address of the inflicted IP and then for example various routers on the way or relay stations or special sites can Send the warning to the user for example when the browser tries to access a normal web page. Another possible variation is that for example the IP addresses of inflicted computers are automatically updated in one or more special URLs in real time and for example the OS and/or the browser automatically checks regularly in one of these official sources and sees if the IP address fits the real current IP address of the current user's computer and then warns the user. However, in these variation, preferably IP addresses are removed automatically when there is an indication for example automatically from the ISP that a different computer or phone number is now using that IP address, for example by the nearest ISP node automatically identifying the user's phone number, for example when a normal model or ADSL modem is used and/or some other hardware fingerprint of the computer, since otherwise the wrong user will be warned. However, this is preferably needed only if the user has an insufficiently protected firewall or for example if the user inadvertently gave the Trojan horse permission to access the web. For example the generic security system such as for example described in PCT application WO0192981 and U.S. applications Ser. Nos. 10/301,575 and 10/644,841 by the present inventor describes among other things firewalls that even prevent Trojan horses from bypassing the firewall (for example by installing a driver that accesses directly the communications card or its driver), while normal firewalls can become completely ineffective when this happens. That patent also covers improved firewalls that protect for example additional communication devices in addition to or apart from the network card or modem. Another possible variation is that for example even when the user supposedly allowed such a device to be accessed, preferably the user is given also a real time indication that the device is working. For example, if the user inadvertently allows a Trojan horse or spyware to activate silently the webcam, which then can for example start to photograph and/or record what happens in the room, preferably the security system and/or the OS and/or some other software and/or for example the webcam itself will for example continuously flash some light and/or otherwise indicate to the user clearly that the webcam is for example currently filming and/or recording what is happening in the room. Preferably similar warnings are preferably generated for example if some device has been connected to the USB and data is continuously being downloaded to it or for example some wireless device is continuously broadcasting data, even if the user apparently allowed it when the firewall asked him/her. Another possible variation is that for example when the user is asked to authorize Macro commands to run for example in Word, preferably he/she also has a choice of for example allowing only macros which do not access files beyond the present document, or for example the user allows the macro to run but is automatically warned and asked for authorization whenever the Macro tries to access external files (This interception and warning can be done for example by the word processor and/or by the computer's security system and/or for example by the OS). Another possible variation is that when the word processor opens a file that contains Macros and asks the user if to enable them or not preferably for example the menu that asks this includes also for example an option of viewing the Macros before deciding.

In addition, preferably when searching for example for MIDI files on the Internet preferably the search engines are improved to enable for example automatically choosing the best MIDI files, for example by displaying first the most popular files. For example, in the current prior art the MIDI search engine http://www.musicrobot.com/(which is perhaps the best MIDI search engine) Enables users to find MIDI files according to song names and shows first a list of all the song names that contain the search string, so that if for example the user searches for the song “yesterday once more” but uses as search string the words “yesterday once”, the results are displayed for example as shown in FIG. 4 below. As can be seen, the results are ordered not by the most popular entry (i.e. the file name that appears on most sites) but by being closest to the search string. In this prior art search engine, if the user then chooses to click for example on the most popular file (entry 4), he/she then gets a second division—according to the file length of the files with the same name (in increasing order), so that for example the list of results shows that a file named yesterdayoncemore.mid (with the length of 8,430 bytes) is available from 4 URLs (for which the user is given the links), a file with the same name and length of 24,601 bytes is available from 7 URLs (for which the user is given the links), etc. However, in reality, the file that appears in most URLs is usually the best MIDI version of the desired song, so this means that the user has to manually look for the file size that is available from the largest number of links, and sometimes there are a large number of results (especially for more popular songs) so this is cumbersome. So in order to improve this, preferably in the first stage, after choosing the set of results that are sufficiently close to the search string, preferably the search engine automatically sorts the song names by the most popular in descending order (and/or for example the similarity to the search string is also taken into account, however if the original set was chosen properly this should not be necessary since at least most of the results in the set should be relevant, and the most popular names will probably include the song that the user is actually looking for). Secondly, after choosing the desired file name, preferably the 2^{nd} stage is also sorted by the number of links available for each file size (instead of the sorting by the file size in the prior art engine), and so the user can preferably typically with just 2 clicks of the mouse reach immediately the desired MIDI file that has the best chance of being a good version of the desired song. Preferably similar principles are used also for example when searching for recorded songs on the internet—for example in legal shops which sell online songs (for example in mp3 format), so that for example the user can use a meta-search over a number of such stores and can preferably use the same stages described above like in the midi file search. (This is another improvement in Internet search technology as defined for example in the present inventor's Canadian patent applications 2,443,036 of Sep. 14, 2003 and 2,444,774 of Sep. 29, 2003). Such a search or meta-search engine can for example work on a server on the Internet and/or can for example be at least partially implemented on the user's computer, for example as part of the OS (so that for example at least some of the processing of the results is done on the user's computer). Of course, MIDI files are just an example and similar principles can be used also for other types of searches, such as for example in Shopping metasearch engines, so that for example if the user is looking for example for a combined Fax-Scanner-Printer, the system preferably helps him/her choose the specific manufacturer and model for example by sorting the models by descending order of popularity. Another preferable improvement for example in such shopping metasearch is that preferably the metasearch engine can show not only a current price range but also for example a table or graph of previous prices (for example during the last few months or weeks) for example for changes in the price range and/or for example for any specific shop which has the item, which later shows up in the detailed results (so that not only the current price for that item in that shop is shown but also a graph of recent price history for that item in that shop). Another possible variation is to take into account for example also some ranking factor of the sources, so that for example Online stores that are much bigger or more important can be given higher weight. Another possible variation is that for example in shopping meta-search preferably the meta-search engine automatically deduces the user's country according to his/her IP (and/or for example asks the user about the country where he/she wants the goods shipped to) and preferably by default (or at least if the user requests it) preferably the engine automatically marks near each shop alternative if it has shipments to the user's country and/or for example puts such shops in a separate group, preferably at the beginning (and/or for example can exclude shops that don't ship to the user's county if the user requests that, but that is less preferably since the user might prefer to know all the prices in comparison even in shops that don't ship directly to his/her country). Similarly, preferably the user can for example request to sort the results for example according to countries and/or cities and/or states and/or other areas and/or for example show only shops which are in certain countries and/or cities and/or areas, and/or for example the shopping metasearch engine can automatically indicate in the list of results near each shop the city and/or state and/or area and/or country in which it is located, instead of the prior art where the user has to click on the shop to find out more about it, such as its location. This can be very useful for example if the user wants to pick up the item or items himself/herself in a certain city or area. Another improvement is such meta search features is that for example when displaying automatically generated news the user can preferably define the desired time span to cover (for example only the last N hours or N days, etc.), and/or for example the user can mark certain news items or clusters or sub-clusters as no longer interesting. This is very important since otherwise for example automatically generated news items such as for example in the Sci/Tech section in the Google News, can remain almost the same for many hours or even a few days, and thus the user misses other items (of course, as explained in the above applications, preferably the user can continue to browse for additional automatically generated news clusters, preferably until the clusters become too small, but still this can save unnecessary distractions by skipping clusters which the user has already seen and is not interested to continue seeing new items about them). Another possible variation is that the user is notified automatically (for example by email or instant message or SMS, etc.) when a sufficient number of new clusters has become available and/or when a sufficient number of new items has become available in existing clusters which the user has not requested to remove, etc. Another possible variation is that for example when sorting automatically generated news clusters the number of items in each cluster is normalized by the time factor, since clusters that have existed for a longer time (for example a few days) would normally have more items than a newer cluster (which has exited for example for 1 hour), even if the new cluster is more important, etc. Another possible variation is that preferably the user can also, preferably easily, review also historically the automatically generated items that were on the automatic newspaper (for example in the Science/Tech section or any other section) for example a few hours ago, a few days ago, a few weeks ago, or more. Preferably the user can specify for example the time in hours and/or days to jump back (or for example once the jump size has been defined each next jump is automatically of the same size), or the user specifies for example a specific date and/or time which he/she wishes to view, and/or for example the user can press some link which automatically takes him/her back at each step for example automatically for a variable time period—determined for example automatically according the amount of change (for example the amount of change in clusters and/or within them). For this preferably the MetaNews service preferably automatically keeps a history of the links for example with certain time jumps (such as for example every hour, or any other reasonable time gap) and/or for example every time a sufficient number of items have changed within clusters and/or clusters have changed, etc. Another possible variation is that, for example when displaying the automatically generated newspaper or the results of a new search, the results can preferably be displayed also for example by a combined sort that combines for example relevance or importance with time, so that for example the clusters and/or sub-clusters and/or items are sorted by a score which is based on a formula that is affected both by time and by relevance and/or importance. Another possible variation is that for example in normal web searches and/or for example in searching the dictionary and/or the thesaurus for example in the word processor the user can search for example for synonyms of words with a specific pattern or length, or for the word itself when partial data exists (which can be very useful for example for solving cross-word-puzzles), so that for example the user can use for example question marks (or any other convenient designation) to designate unknown characters. So for example if the user is looking for a Greek island which is 6 letters long and starts with “ba”, he/she can for example search for ‘ba???? Greek island’, or for example if the user searches for example for a synonym of the word satisfaction with 11 letters he/she can for example type ‘synonym(satisfaction) ???????????’ or for example ‘synonym(satisfaction, 11)’, and/or for example some other convenient notation. Another possible variation is that the user can for example use wild cards in domain names, for example in the location window of the browser or in the search engine's search line, so that for example the user can type in the search line ‘http://coca* annual sales’ in order to get results only from world-wide sites that belong to coca-cola, or for example ‘population growth statistics http://*.gov’ to get results only from official government sites, etc. Another possible variation is that the user can for example use various pattern marks when looking for general information, so that the user can for example type in the search engine (On the Internet and/or for example on the local desktop search), “distance from [1] earth to [1] moon is % N % Kilometers”, which means that for example up to 1 word (or any other desired number of words) can be between the words “from” and “earth” and between the words “to” and “moon” and a number is expected before the word kilometers, etc. (Of course this is just an example and many other notations can be used for the number of allowed words in between). (Preferably similar search patterns, for example with a numeral of the words in between or for example with a NEAR operator, and/or for example suggesting automatically also synonyms, are enabled also for example in the word processor, since the user might for example want to find some subject and only remembers that certain words should be close to each other). Another possible variation for example in the web search or in the word processor search is that the user can specify for example that the two words have to be in the same sentence or for example in the same paragraph. Another possible variation is that for example if the user searches for two or more words next to each other and no results or few results are found (for example in the web search or in the word processor search, preferably the search engine or for example Word processor can automatically offer to the user to perform a “near” search, and/or display already how many results will be shown in that case (in this case preferably the maximum distance between words is set automatically for example according to some default or defaults which the user can preferably also change, or for example the search engine or the word processor automatically can suggest, preferably according to the actual number of results available, in one or more incremental steps for example at one or one after the other, increasing word distances, while preferably showing the number of expected results in each case (The number of expected results is preferably shown for example by performing the actual additional search automatically in advance, or for example by heuristics based for example on various statistics). Another possible variation is that for example when the user searches for a combination of words in the word processor preferably the word processor can also for example automatically regard for example “-” like a space or vice versa, at least in case no results are found, but preferably as additional suggestions even when the results are found. (Although Altavista for example allows using the NEAR qualifier, it is more preferable to allow the user to limit the exact number of in-between words allowed). (Although for example Google already allows the user to achieve a similar effect by including a range of numbers, for example 2 . . . 40, in the search line, preferably the user can also enter a general number indicator without having to waste time thinking of an appropriate range). Another possible variation is that the user can add for example a tag that causes the results to be sorted according to this number (or numbers, if more than one number pattern is specified) (so for example the search string can be: DVD “Koi Mil Gaya” $ % N %<lowest> cart) (or for example indicate this by any other way), so that for example all the sites that contain the desired keywords and the number are automatically sorted in the search results by this number in descending or ascending order, as determined by the user, or for example the sorting is only among sites which are sufficiently highly ranking according to other criteria (preferably this is also determined by the user, but sorting on the entire set of appropriate results is more preferable since it can give better answers). This is somewhat similar to using shopping metasearch, except that this gives the user much more flexibility in using such sorting for almost anything, so it can cover much more possibilities than normal shopping metasearch. Another possible variation is that the user can for example tell the search engine to search for words that belong to the same item instead of just appearing together on the same page, so that for example when the users types ‘<group> all in one color laser printer fax scanner’ (or with any other suitable code or notation) the search engine preferably returns only pages where these words appear near a single item (for example identified by being in the same paragraph or by smart heuristics that identify items or for example simply by being within the same sentence or for example group of 1-4 sentences, etc.). In a way this is similar to the use of the ‘NEAR’ code word, except that it applies to a group of words and preferably smarter heuristics are used as explained above and not just distance in words. Another possible variation is that instead of using ‘or’ and brackets the user can for example use ‘/’ do designate ‘or’ for a single word, which is much faster and more intuitive, so that the user can for example type at the end of the above query Kilometers/miles. This can work even better for example if synonyms are also automatically activated or offered (for example in the form ‘did you mean “Morning after pill”?’ if the user searched for “day after pill”, or by automatically including also the results with at least the close synonyms), as explained for example in other applications by the present inventor. Preferably the search engine can know synonyms for example at least from various thesauruses and preferably also through automatic learning, for example based on various patterns and/or statistics (such as for example similar patterns or word combinations that appear in pages that are close on the recursive clustering analysis, wherein the clustering is based for example on keyword analysis and/or at least partial semantic analysis and/or incoming and/or outgoing links analysis. For example there are 1940 pages with the words “day after pill” and 128,000 pages with the words “morning after pill” and even 1150 pages which contain both phrases, so even without the 1150 pages the search engine can preferably understand that these two phrases are used very similarly on pages which are close on the recursive clustering and therefore are probably synonym phrases, eventhough “day” and “morning” are not normally defined as synonyms) and/or semantic understanding of pages where relevant definitions or connections are used (for example at least in some of the 1150 pages where both phrases are used it is clearly indicated that these two phrases designate the same thing). (For example when searching for various devices or components in electronics even professional users many times have trouble finding the desired items because they are referred to by different names or different terms in different places, so preferably the search engine can for example automatically deduce the connection between the different names while spidering the web, for example based on various patterns or statistics or for example by semantically understanding references or definitions that directly link two or more names at some of the pages, etc.). This means that the search engine preferably also for example checks and preferably offers for example alternatives such as for example replacing the word ‘a’ with ‘the’ or vice versa for example when the user searches for exact strings for example within quotation marks (for example offering the combination). Another possible variation is that for example when requesting News alerts, instead of being able to request only by specific keywords (as it is for example in prior art Google News), preferably the user can for example mark a cluster or a specific sub-cluster, so that he/she is notified automatically on any new items that belong to that cluster (as explained above), or for example the user can use semantic qualifiers or for example mark words in brackets, so that for example he/she will be notified also about items that contain synonyms of these words, etc. Another possible variation is that meta-news sites such as for example Google News are expanded so that the meta-search engine can also search or example for keywords in news broadcasts (for example by obtaining sub-titles digitally from these news sources, which is the most preferred method, or for example by automatic OCR of sub-titles or for example by automatic speech analysis). Another possible variation is for example a search engine or meta-search engine that conducts searches also for example in online TV program guides and/or radio program guides for TV or radio broadcast (for example in cable TV, satellite or broadcasts over the Internet) so that the user can for example request to receive automatic notifications when certain keywords appear in the name and/or description of current broadcasting guides or reviews or time tables, so that for example the user can enter for example the words “black hole” and can then be notified automatically for example whenever a new broadcast is scheduled which contains these words for example in the title or in the description of the show or broadcast (which can be for example a movie, a TV series episode, a documentary, etc.). Preferably the search engine works for example by using a technology similar to the Google News, so that for example the engine scans automatically periodically (for example every hour or other reasonable interval) a list of pre-collected urls of web pages of the main cable TV, satellite TV, IP TV stations and/or other relevant content providers, and notifies the user according the requested keywords (this list can be created for example automatically and/or manually and/or semi-automatically by the search engine operators). For filtering broadcasts that were already broadcast preferably the search engine links directly to pages that list only broadcast times that have not finished already and/or for example uses also some time and date filter, and/or for example the search engine enables also searching for past broadcasts, but preferably in this case as a separate category. Preferably the user can request for example to be notified about the desired keywords for example from all the scanned sources without limitations, or for example only broadcasts in a certain country or countries and/or for example only in a certain language or languages and/or for example only from a specific list of providers, so that for example the search engine can show the user a list of all the covered content providers (preferably with additional details on them) and the user can for example select all or unselect all or select or unselect groups of providers or individual providers. This search engine can be implemented for example from a web site similar to the Google News preferably with email and/or for example SMS notifications, or for example from a Tivo or similar device which can preferably connect automatically to the Internet, or for example by a local application on the user's PC which performs the search or meta-search Online. Another possible variation is that for example the search engine can preferably also offer users or subscribers for example automatic notifications about when a certain url changes, and preferably the url can point for example to a normal web page or to a specific search result from internal search on some web page, such as for example the pair record of U.S. patent application or for example other important databases. This can also include special services, such as for example allowing the user to add a list of parameters (for example allowing a large office of patent attorneys to load a large list of all the patent applications it wants automatically monitored) so that preferably the service automatically monitors all of them and for example automatically sends the subscribers for example every morning (or other desired time or interval) the most current update of the relevant urls or for example only specific areas within the relevant web page and/or for example the report can be set to include only changes from the previous report of from some base report (for example by automatically activating a file comparison with the previous record). This can also work great for example in combination with the feature described elsewhere in this application—of improving web serves and/or browsers so that the browser (and/or for example other programs that accesses the Internet) can request from the server for example just a certain line or lines or words or words in the page, for example defined by position (such as for example lines 20-22), and/or for example defined by content (such as for example, Bring me only lines that contain a certain search string). Another possible variation is that preferably the search engine or some other service can automatically alert the user (for example through SMS, email or Instant Message) if a certain site (or one of a list of sites provided in advance by the subscriber) becomes offline (for this preferably the service checks for example once every few minutes (or other defined interval) if the relevant urls respond properly, and preferably of course this is done with local caches or proxies disabled in order to avoid getting a response from the proxy while the site is really offline. Another possible variation is that for example in the ordinary web search and/or for example in the meta-news search the user can for example use some code or mark in a menu in order to request for example only results from a certain country or countries and/or for example only results in which the page contains at least one or a few words in a specific language or languages, and then preferably the search engine accomplishes this for example by showing only search results in which the domain name ending is of the desired country or of one of the desired countries and/or for example the owners of the domain for example according to Whois records have an email with a domain ending from the desired country or countries and/or for example the DNS records point to a server which is located in the desired county or countries and/or for example the url contains at least some text in the language of the desired country. Another problem with search engines such as for example Google is that since the engine typically automatically tries first “and” relations and then also “or”, many time the user tries to further narrow the search by adding words, but instead the number of result actually increases because the search engine also adds more “or” results, which can be confusing to the user. So preferably this is improved so that instead of giving only the number of total results preferably the engines gives also the number of results with only “and”, preferably showing these two statistics next to each other. Another problem is that for example when the user searches for a string of two or more words together (typically designated by using quotation marks, Google apparently disregards the full stop at the end of sentences, eventhough if the two words are each on the other side of the full stop at the end of a sentence they are almost never the combination that the user had in mind. So preferably this is improved so that when the user searches for a combination of words which have to be next to each other and in the given order, preferably cases where there is a full stop between them are preferably ignored or for example automatically ranked lower then cases where they appear together without a full stop between them. Another problem is that for example Google and MSN search ignore completely upper case, so that for example searching for “word”, “Word” or “WORD” returns the same results, which is a s waste of important information, since many times the user's choice of upper case can give important additional information about what he/she actually has in mind. So preferably this is improved so that this information is taken into account and thus pages which contain the word in the correct case preferably appear higher in the results. So for example if the user types “Word” instead of “word” then preferably sites that deal for example with MS Word preferably appear higher in the results than sites which simply have the word “word” in various places, and for example if the user types “LED”, results which deal with LED Lights appear before results that deal for example with Led Zeppelin. Another possible variation is that when the search engine for example displays advertisements in addition to search results, based on the keywords which the user used, preferably the choice of appropriate advertisements takes into account not just the keywords themselves but also semantic and/or context related information. This can be done for example by taking into account the order of the keywords which the user used on the search and looking for example for qualifiers, such as for example “all”, “not”, “most”etc. However such words are rarely used in keyword searches so this would be useful only sometimes. A better variation is to determine the semantic meaning and/or the context based on the search results which the user clicks on (which is especially useful if the results themselves are automatically displayed in the form of recursive clustering), so that for example the advertisements are updated accordingly when the user requests the next page of results or repeats the search with similar keywords. Of course displaying the results in the form of recursive clustering has the further advantage that much more than 20 or 30 results can be displayed for each search, since the recursive clustering can be easily applied for example to the top 100-1000 results (or other reasonable number), since as explained by other application by the present inventor (for example U.S. application Ser. No. 10/939,454) the recursive sub-clustering is preferably sorted recursively by the page ranking algorithm which is used for example in the prior art Google for displaying linearly a small number of results (or similar ranking algorithm), so the user can very quickly tune in for example to the top N results in the sub-cluster that most interests him/her. Since the number of individual results in each cluster and/or sub-cluster is preferably shown next to its heading or next to the exemplary specific results (which is preferably for example the top-ranking web page of that sub-cluster) preferably at any point in the recursive structure the user can preferably either request to view at once all of the results for example at that level of the tree (which will in that case preferably be displayed for example linearly, preferably sorted by the normal ranking algorithm), or for example press on a sub-cluster, which will bring the user to the next place in the tree, preferably with the same options again. Another possible variation is that the advertisements can be dynamically updated also on the same results page which the user already has, so that for example while the user opens new windows for some of the links and explores them, the original page is already updated based on the links which the user clicked on, for example by automatically setting automatic refresh to every 30 seconds (or any other convenient time). Another possible variation is that preferably the search engine can automatically identify the user's country or area (for example based on his/her IP address) and/or the browser preferably can tell the search engine for example at least the sex and/or age of the user (preferably the user for example is requested to enter these when installing the browser and the age is then preferably automatically updated as the time passes), and this way preferably the search engine can for example offer different advertisement based on these parameters and/or for example automatic ratings of sites can include breaking down by these parameters. Another possible variation is that for example the page rank (or other search engine ranking) of each result in the search pages is preferably automatically displayed for example as a numerical absolute value or for example as a percentage, preferably for example next to the url or title. Another possible variation is that in order to save bandwidth for example the html protocol is changed so that it is possible to define for example “refresh on a need basis”which means that the refresh command is initiated automatically by the site when there is any change in the preferably dynamic page (so that the browser can get a refresh even if it didn't ask for it), or for example the browser asks for refresh more often (for example every 20 seconds or even less), but if nothing has changed then the browser gets just for example a code that tells it to keep the current page or window as is. The first of these two variations is more preferable since it saves also the waste of bandwidth by unnecessary refresh requests by the browsers. In addition, when the refresh is sent, preferably it can be a smart refresh, which tells the browser preferably only what to change on the page instead of having to send the entire page again. Another possible variation is to implement this “refresh on need” for example by active X and/or Java and/or Javascript and/or some plug-in or other dynamic code that is updated only when there is a need for it. Another possible variation is for example to keep the page or part of it open like a streaming audio or video so that the browser always waits for new input but preferably knows how to use the new input for updating the page without having to get the whole page again and preferably doesn't have to do anything until the new input arrives. Another possible variation is to create for example a search engine or meta search engine which searches over a database or databases of for example DVD sub-titles and/or for example TV broadcasts subtitles and/or subtitles of other types of movies and/or media, so that for example the user may be able to locate any DVDs and/or broadcasts and/or movies for example according to text in the sub-titles. This could be a great complement for example to the Google Print project which allows to search over text of printed books. Another possible variation is that for example when the DVD is accessible (or for example the relevant video file is on the hard disk or other instantly available storage media) the user can preferably for example jump directly into a desired scene by searching for the relevant keywords for example in the subtitles and for example clicking the desired result. Another possible variation is that instead of just being able to set a single speed for DVD (or other video file) playback (for example ×1, ×1.5, ×2, ×3, ×4, etc.) the user can preferably tell the DVD player or other media player for example to use a separate speed for example for normal section and a different speed for example for sections which contain talking and/or subtitles, because if the user for example wants to watch the DVD or other video file at higher-than-normal speed, usually sections without subtitles can be watched faster than sections with subtitles (for practical purposes preferably the talking sections are simply identified according to the sections with subtitles). Another possible variation is that the user can even tell the playback program for example to automatically adjust the speed (at least for example in the sections without talking or subtitles) for example according to the amount of action or change, so that for example if almost nothing happens then the playback can automatically move faster and if for example fast action begins then the playback can automatically slow down again for example up to normal speed of xl. This can be easily done because the mpeg encoding itself automatically indicates the amount of change between each two frames. Another possible variation is that preferably, at least as one of the options which the user can choose, the media player can automatically detect in advance sections where speech is too fast or faster then usual and for example automatically slow down the playback in these sections for example even below the normal playback speed, which can be very useful for example if there are no subtitles and the viewer is not a native speaker of the spoken language. The fast-speech detection can be done for example by detecting speech sections according to heuristics of checking the shapes and patterns of the sound wave (and/or for example by looking at the sections where there are subtitles, if there are subtitles) and then detecting for example the density of the fluctuation at the section of the speech. Another possible variation is that preferably programs that play for example songs and/or video can preferably remember automatically for example the sound level and/or the speed and/or bass level and/or treble level which the user used to play back each file and preferably use these as the default speed and/or volume for the next playback of the same song or video (preferably by saving automatically for each file the code for these 2 and/or additional settings). Preferably the volume settings are relative to each other between the songs, so that for example if the user lowers or increases for example the general volume control this does not change it. Another possible variation is that the music player or video player can automatically measure the level of the bass and/or treble for each file or song or movie and can preferably automatically boost them as needed and/or later remember these values accordingly for the file. For identifying the needed levels the system preferably analyses the average sound level for example on the bass range and on the treble range and/or in general, for example for the entire file or movie or song for example for the next few coming minutes (or other reasonable time window) after the current position and preferably corrects the bass and/or the treble and/or the general volume level to reach a higher level if it is for example below a certain minimal pre-defined or user-defined threshold. More preferably the look ahead is for the entire song or movie in order to get the global averages, otherwise it might distort the internal relations. Another possible variation is that since for example the relationship between the midrange and the treble is not linear, so that at lower volumes the treble sounds weaker compared to the midrange than, preferably this is automatically compensated for by the player application, so that preferably at lower volumes the treble is automatically increased to compensate for this non-linearity. Another possible variation is to similarly compensate automatically for example for the non-linearity of the basses. Preferably the user can turn on or off these automatic compensations and preferably changing the treble or bass volume directly has a general effect independently of this. Another possible variation is that for example the codecs and/or the encoding program are improved so that the encoders that create for example the MP3 files or Mpeg2 or Mpeg4 files or other formats preferably calculate these values automatically during the encoding (for example by sections and/or globally) and preferably add them as parameters to the encoded files so that the player applications can read those values directly without having to look ahead. Another possible variation is that for example when playing MIDI files the system can for example use the MIDI file in combination with a related lyrics file to synthesize singing of the words in tune with the music. This is preferably done by a combination of standard speech synthesis algorithms together with various heuristics about good singing, such as for example adding vibrations (waves) to the voice when singing high notes, especially for example long high notes. In addition, preferably this is done in combination with a dictionary or semantic trees which include information about the emotional significance of at least the most common emotional words in songs, so that preferably various emotions can be added to the sound accordingly. Another problem with DVD subtitles for example in PowerDVD is that when the user changes for example from pan & scan of 1.85:1 to 2.35:1 in many DVDs the subtitles exceed the bottom of the screen, and thus the user can read only part of them and so if he/she wants to be able to read them the user might be stuck with the lower pan & scan and thus might have for example to watch the whole DVD with black stripes at the bottom and top). So this is preferably improved so that the user can for example move a control which changes the position of the subtitles and/or their size and/or for example the application automatically recomputes the position of the subtitles while taking into account the new pan & scan mode so that the subtitles remain in their correct poison and/or can automatically also reduce their size or for example make them thinner if they also exceed the right or left borders of the screen, and/or for example the application simply uses a separate function to put the subtitles at the same size and position on the screen each time independently regardless of the pan & scan value. The above variations have also an additional advantage since computing the position and/or size of the subtitles independently of the video displays size can help improves the translation into actual fonts, whereas letting the subtitles grow together with the video display as is done in the prior art PowerDVD causes the subtitles to become granular for example with zig-zags on the diagonal lines. Another possible variation is that preferably the user can request for example automatic volume normalization for example during recording and/or during playback, in which case preferably the system reads ahead in advance and for example automatically reduces any sounds that exceed the threshold. Another possible variation is that preferably for example the media player or OS or other application preferably enables the user to extract sections for example from DVD files and/or mpeg 4 and/or divx or other compressed video or audio formats without having to extract and then recompress them, preferably by letting the user mark one or more sections (for example by viewing them and marking for example the start and end points or the start point and length in time) and the preferably selecting automatically each time the nearest base frames, preferably a little before the beginning of the section and a little after the end of the section, and preferably the system or application then copies the desired section or sections as is and preferably merely adds any wrapper information that might be needed for the new file (preferably if various parameters are needed from the original file or files they are preferably read from the wrapper information of that file or files). Another possible variation is that the user can instruct the program for example to locate automatically the beginning and ends of movies or songs or other sections and extract them automatically to individual files (for example by using various heuristics such as for example identifying song labels at the beginning and end of a song like for example in VH1 or MTV, identifying silence periods or drastic change in sound, identifying fade in and fade out, and/or identifying automatically for example places where the user activated or stopped the recording, if the file is for example a recording from TV, or finding automatically digital marks of programs or songs if they exist). Another possible variation is that the user can instruct for example an application that records for example from TV or Cable TV or satellite to automatically save recorded data in advance in separate files, for example according to one or more of the above criteria. On the other hand, in this case the system might for example create also splits which the user does not want (for example if the user pauses a recording during a commercial and then continues), so preferably the user can also concatenate separate sections together for example by marking them or entering their names or numbers and requesting to concatenate them into a single file, and this is preferably similarly done without decoding and encoding again—preferably by concatenating directly with the appropriate base frames. Another possible variation is that for example the control or remote control or the relevant user interface of a VCR that records for example digitally in mpeg or divx or other compressed format or for example a TV capture and compression card connected to the PC—enables the user for example to start recording with at least two separate controls—one for recording in a new file and one for recording as a continuation of the last file. In addition preferably even after starting a recording (for example if the user made a mistake or changes his/her mind later) the user can for example, preferably even while the recording is going on, for example click or press an option which requests the system to split the newly started recording from the previous file or add it to it, in which case preferably the device for example makes the split or concatenation on the fly and continues to record, or for example marks the request and makes the final division or concatenation for example the next time the user stops the recording. If there is any problem with some formats that makes it difficult to split or concatenate for example sequences that start and end with a base frame and then adding the appropriate file wrapper, then preferably these formats are improved to enable this, since there should be no problem to do this in formats that used base frames after each set of frames that are represented by changes. Another possible variation is that for example when recording song video clips for example from VH1 or MTV or similar channels the system can for example automatically use OCR to recognize the name of the song when it appears in the label at the beginning and/or end of the video clip and thus can save it automatically for example in a file of that name. Another possible variation is that for example if the user enters a cached page for example in Google and sees that the keyword combination that he/she searched for appeared only in a linking page, preferably the link to that linking page is given automatically by the search engine so that the user can jump to that page and see the relevant href. Another possible variation is that this link links directly to the relevant href, which can be done for example by jumping to the appropriate place in a cached copy of that linking page. Another possible variation is that preferably for example the href command is improved and/or for example additional commands are available so that so that when linking to any web page for example the link can contain a reference for example to a certain string and/or for example to a certain line number in the page and the when the user clicks on such a link preferably the browser can jump directly to the desired position in the page even if there is no relevant anchor in advance in the relevant web page, which can be done for example by the browser finding the correct position when fetching the page data, and or for example the http servers are improved for example to indicate the position automatically according to the requested parameter or parameters (for example according to requested line number, search string, or other indicators), for example by dynamically adding a location mark or anchor when sending the page. Of course, various combinations of the above and other variations can also be used. Of course, like other features of this invention, these features can be used also independently of any other features of this invention.

In addition, preferably dating sites are for example improved so that for example instead of paying or with preferably lower or much lower fees (compared to normal dating sites), users are preferably exposed to advertisements which are preferably tailored automatically for example to their background and/or interests, so that for example the age, education, sex, location, fields of interest and/or any other relevant information which the users fill anyway on the web site can be used for distributing automatically advertisements much more effectively to the appropriate people. For maximum effectiveness preferably these advertisements show at the place users of the dating site typically spend most of the time—the pages that display results of potential dates and/or for example pages that display data and/or photos of specific members which the user looks up. Preferably the advertisements are textual and short, in a way similar to the Google adwords, and/or for example they are accompanied by a small image which is preferably the same size of typical photos of the potential dates, so that for example the ad preferably looks visually similar to normal results. These advertisements can be for example generated by the dating site though direct deals with advertiser or for example though a deal with a big search engine such as for example Google, in a way similar to adsense, except that for example ti dating site and/or the search engine are able to use for example the background data and/or interests of the users or the better relevance advertising. Another possible variation is that since the dating site preferably works together with an external Instant Messaging client or installs such a client (with the user's permission) for example as a standalone program on the user's computer or for example as a browser plug-in, so that the user is considered to be online whenever the user in surfing the Internet regardless of whether he/she has a currently open window or tab at the dating site (as explained in other applications about dating by the present inventor), preferably this can be used also for example in combination with search engines for example like Google, so that for example by joining the dating site for free or at the reduced fees the users agree that at least some information such as for example background information and/or interests are preferably conveyed automatically for example to the search engine when these users search it, so that for example the Google advertisements become automatically more oriented to the user's background and real interests, and so preferably the dating sites gets revenues for example also from the search engine for enabling it to improve the efficiency and relevance of the advertisements to the benefit of both the users and the advertisers. (Preferably this is done for example by passing automatically and preferably anonymously the relevant data to the search engine when the user is performing the actual search, preferably for example through a browser cookie). Of course, if the dating site is for example run by the search engine itself, this can be done even more easily with automatic seamless integration. In addition, this arrangement preferably enables the advertisers to pay less per advertisement since it is more directed and thus the same advertising space can be divided more efficiently between various advertisers. Another possible variation is that this or similar data is also used automatically with rating plug-ins such as for example Alexa or similar application, so that the automatic ratings of web sites arte preferably automatically broken down according to for example sex, age, education, location, etc. Another problem for example with the Google adwords is that there have been many cases where a company bought words which violated a trademark of another company, thus misdirecting traffic of people who were actually looking for the other company. So preferably this is improved so that for example the Search engine creates a copy of the list of trademarks and their owners for example from the USPTO and so preferably the search engine can automatically find cases where a third party tries to buy a word which is a trademark that belongs to some other company and in these cases for example an automatic alert is sent to a moderator which then checks it and/or an automatic warning is for example sent to the trademark owner. Another possible variation is that for example trademark owners can register in a service which automatically searches for example once in a while (for example every hour or every day or other convenient interval) for example in Google for their trademarks and notifies them automatically for example if some paid (or even unpaid) misleading results are shown for their trademark. Another possible variation is that preferably the search engine can identify click fraud automatically for example by keeping automatically track of the IP addresses of the clicking computers or users, so that for example not only repeated clicks from the same IP can be identified, but also for example patterns across multiple computers, so that if for example the click fraud is conducted by compromising multiple computers and using them as zombies or robots, preferably the search engine can also identify repeated patterns, for example if the same set of computers are involved again and again in clicking on apparently different ads. Another possible variation is that preferably the dating site uses for example mail boxes in order to manage for the users all the dating related messages in a convenient way, and preferably the messages are also automatically forwarded to the user's real email but preferably for example only part of the message is copied directly to the real email and in order to read the full message preferably the user has to click on a link which brings him/her to the mailbox in the dating site (which helps bring people back to the site and helps for example managing the longs and/or statistics). Another possible variation is that for example when sending a message to another user or when receiving a message form another user, preferably the copy of the outgoing message and/or the incoming message at the user's mailbox has preferably an icon or other indication next to each message which preferably automatically indicates for example if the other person has already read the message (in case of an outgoing message), and preferably a copy of the indication if the other user is currently online is indicated there also (apart from being preferably indicated also near the other person in the search results and in his/her profile, as explained in the above applications, but this way the user can also see it directly near incoming or outgoing massages that relate to the other users. Another possible variation is that the dating site preferably shows at least two types of indications about whether other users are currently online or not—one for being online in general on the Internet (which means that an IM connection can be established with that user), and one for being currently engaged in activity in the site itself, which means that the other user can now for example be reading messages in the site, etc. In addition if the site enables users also to upload for example video files and/or voice files, preferably the site indicates clearly near each user if the user has uploaded such files and/or how many and/or shows directly their icons (for example with a preview image in case of video), since for example in MySpace the user has to click on the video icon and only then a new page opens and tells him/her if there even exists a video files for that profile, which is very inefficient since most user don't upload videos about themselves so people learn to stop even checking and thus miss the cases where there is a video. In addition, when the user writes messages for example though the web browser with the site's mail box system, preferably an error correction service is automatically performed on the message, preferably by using an error checking application on the dating site. Another possible variation is that preferably in order to enable users to gets instant results on the one hand and also create a valuable database and service on the other hand, preferably the sire is based on gradually encouraging new users to add more details, so that for example at the beginning the users can search profiles even without registering at all, afterwards in order to view additional data about other user profiles and/or contact them the new users has at least to register some basic data about himself/herself, and afterwards, preferably for example according to the system automatically monitoring the user'progress, preferably especially when it is clear for example that the user is getting too many results in his/her searches (for example a few hundred or thousands and starts going manually over long lists or results and/or profiles, preferably the system encourages the user to fill a longer and/or full questionnaire and preferably get reciprocal scores in the next searches, thus creating much more efficient utilization of the database. In addition if a user for example does not respond to a message sent to him/her by another user or for example to an instant message sent by another user for example after more than a certain time, preferably the system automatically encourages that user to at least mark the reason from a set of given categories and/or for example enables him/her to give the reason in open free text, so that the sender can preferably understand why he/she did not received the reply (for example: Don't like the other user's photo, too much age difference, etc.), and this way preferably people can help each other also understand how to correct various problems which stand in their way. Of course, various combinations of the above and other variations can also be used. Of course, like other features of this invention, these features can be used also independently of any other features of this invention.

Another possible variation is that preferably the search engine can also use preferably various heuristics for determining the information value of the search results, which can be used for example for improving the ranking of web pages according to their information value and/or for example indicating near each link its information value (for example as a single score and/or as a list of scores and/or sub-scores). The information value scores can be defined for example according to authoritativeness (for example a scientific journal article versus a blog page), truthfulness, objectivity, expertice, reliability, accuracy, etc. Preferably the search engine can determine for example if a web page is probably more scientific (for example has higher information value according to one or more of the above criteria of information value) for example according to for example diagnosing automatically whether it contains references and/or how many references and/or how scientific are the sources that are included there, and/or for example by lexical and/or semantic analysis of the details about the author if such details exist, such as for example if he/she has a PhD. title and/or has a background relevant to the field that the article deals with (for example the writer has a degree in nutrition in an article about the dangers of eating Soy products), and/or for example link structure (incoming and/or outgoing) that indicate that the page (and/or the site in general, i.e. for example the entire domain or for example subdirectories in it) has links to and/or from other pages (and/or sites or for example subdirectories in them) which are considered more scientific (or of higher information value) by the system (for example in terms of percent of scientific incoming and/or outgoing links and/or in terms of absolute scientific incoming and/or outgoing links), and/or for example if the site is for example on a university or for example in a government institute (for example according to the top level domain—for example “.edu”“.ac.<country code>”, “.gov”, etc.). (However, a university site can contain for example also student pages, and government sites can carry for example tendentious or biased information sometimes, so preferably the search engine takes into account for example also how high the page is in the subdirectory structure of the domain—for example student pages will typically be in a lower directory, many times for example with a name that contains a‘˜’ on the path, and for example if a page in a government site appears to deal with a scientific subject preferably the search engine can assume that there is less chance for bias than if the subject is political for example). This can be done for example preferably in a way similar to the way that Google uses recursively the number of incoming and outgoing links to determine the authoritativeness of pages and/or sites (where authoritativeness is actually defined by popularity), except that in this case preferably the recursion uses as criteria also for example various indications about the scientific value (or information value) of the pages and/or sites and/or sub-areas in the sites, etc. Determining the initial indications can be for example according to various heuristics based on the content of the pages (for example as in the above examples), and/or for example additional indicators, such as for example starting out with known scientifically accredited sources, etc. (However, these indicators are preferably reassessed automatically again for each page and/or domain and/or directory tree or sub-tree, in order to avoid degradation of the information value score or scores as the recursion continues). Preferably the taking into account of the information value can be for example applied automatically as an improvement of the results ranking algorithm and/or for example the user can indicate that he/she prefers to take this into account, for example by marking default preferences (which are preferably saved for the next time he/she uses the search engine, for example in cookies) and/or for example by adding some special keyword or mark to the search string, and/or for example the search engine has a few search windows, so that one or more are defined in advance for searches for more official and/or authoritative and/or scientific information, etc., and/or for example the search engine can preferably decide automatically how much weight to give to the information value of the results according to the search string itself, so that for example if the user enters a search string such as ‘blond huge boobs’ then he/she is probably not looking for scientific articles in this search. However, since it is obviously difficult to know if the user is for example searching for articles about cars or sites that sell cars (for example with a search string like ‘best price performance cars’), the above described solutions of using semantic qualifiers, such as for example ‘best price performance cars (shops that sell)’ when looking for shops and for example ‘best price performance cars (articles/reviews)’ is more preferable, and preferably the search engine can use any of the above methods for responding to such a query (such as for example synonyms, semantic trees and/or taxonomies, semantic tags, etc.). Of course for example in the variations where the user chooses in advance more official and/or authoritative and/or scientific information, etc. (for example by adding an indication or choosing the appropriate search window, as described above), preferably the search engine can for example automatically ignore sources or results (for example pages and/or sites in general, i.e. for example the entire domain or for example subdirectories in it) which have an information value below a certain threshold, or for example mark or indicate the threshold (for example by a clear borderline or in a separate window), so that for example results below the threshold are displayed in a separate section or window. Preferably this procedure is done both for normal web pages and for internal search databases (the deep web), which is hundreds of times larger than the normal web. In this case it is even easier to reuse the indicators to avoid degradation, since internal search databases typically have a consistent nature and typically have clear indicators about their scientific or information value, such as for example what organizations stand behind the database, what type of sources are included in it, etc. Preferably the search engine can also automatically include in the search results also replies from various internal search databases, preferably by analyzing automatically the search keywords and/or semantic qualifiers, so that for example a semantic qualifier such as “(articles/reviews)” preferably prompts the search engine to try to bring some results also for example from relevant internal databases. Another possible variation is that for example when searching for academic results and/or for example in normal web searches, the user can for example request the search engine to show only results from articles (and/or for example normal web pages which were last updated) for example from a certain date onward or for example before a certain date or for example within one or more range of dates. However, some pages include for example an automatic visitors counter and so the counter is automatically updated even if the page does not change for years, so preferably the search engine uses its historical data to estimate if the amount of change and/or the type of change justifies regarding the page as recently updated (for example addition of new paragraphs or significant changes in existing paragraphs, as compared to merely updating a few numbers). (Another possible variation is that for example the web server sends also data about the last time the page was updated in the local directory, but that is much less preferable since page owners can easily write a program that will update the file's date regularly even if there is no real change). Another possible variation is that the search engine can for example use the historical data to answer for example queries such as when is the first time that a certain combination of words appeared together in the same web page (preferably the user can for example ask this directly or for example requests the results to be sorted by date). Of course, various combinations of the above and other variations can also be used. Of course, like other features of this invention, these features can be used also independently of any other features of this invention.

Another preferable variation is that for example the system includes a firewall which allows giving specific applications differently rights for downloading and/or uploading information for example to or from the Internet (and/or for example through all available communication channels or through specific communication channels, such as for example network cards, USB, wireless, modem, etc), in contrast to prior art firewalls which only allow users for example to let applications access the Internet, but the user has no knowledge or control for example if an application that has been allowed to access the Internet is uploading or downloading information, etc. This is very important since for example the user might want to allow a program such as Winamp to access the internet for example in order to play streaming data but does not want Winamp to be able for example to upload information, or for example the user might want Word or for example some other word processor to be able to access web pages but does not want the word processor to be able to upload document files (for example even if they are in its own directory and/or even if it is the current file which the user is working on), so that for example if an application is actually a Trojan horse that tries to steal data or for example the application is compromised for example by some buffer overflow, it will not be allowed to steal data and send it out. This can be done for example by automatically showing the user the statistics of sending/receiving information near each application that has been allowed to access the Internet (for example in some table, preferably in the same normal table of authorizations) and/or for example defining a maximum ratio between upstream and downstream for each application (which is then preferably enforced automatically for example by automatically blocking excess uploading and/or warning the user and/or asking for his/her authorization) and/or for example defining a maximum absolute amount of information that can be sent out per time (which can be for example enforced similarly). However, such definitions are limited in effectiveness, since a sophisticated hostile application can for example slowly steal important data over time even within the limitation and/or for example various applications might cease to function properly because of these limitation. For example, enforcing such separation between uploading and downloading is not easy since even programs that download data typically have to also send some information in order to establish the communication, however allowing for example automatically a reasonable required ratio between the two directions can solve this problem and this can be quite effective for detecting theft of data, since if a program for example is allowed to upload only for example ¼ or 1/10 or less of what it downloads then trying to steal for example a large file will also require the application to download even more data and the user can easily see for example that the application had no reason for downloading it (and this is only if the Trojan knows for example about the limitation and tries to cheat its way out of it by downloading extra data, otherwise it will simply be blocked because it would try to send much more data than it receives). Another possible variation is for example monitoring the data in the incoming and/or outgoing packets, but even this can be limited in value since for example a hostile application might encrypt the data and/or for example disguise one protocol within a seemingly different protocol, etc. Another possible variation is that for example programs that the user wants to allow only to download data but not upload data are automatically prevented from any real access to the web and for example the OS and/or the firewall and/or the security system intercept any attempt that these application make to contact the web and send the requests instead, and so for example only valid normal protocol requests for example for accessing web pages and/or for downloading data, etc., which are recognized by the firewall or other intermediate agent are allowed to go through (this means of course that the firewall or other agent preferably has in this case to monitor the entire incoming and outgoing protocol of that application in order to be able to understand fully what is going on and interfere when needed). Anther possible variation is that for example the firewall and/or security system can display also for example upon user request for example a sorted list or table of the programs that are currently downloading the biggest amount of data and preferably separately the list of programs that are currently uploading the biggest amount of information and preferably also the file names and/or directories (preferably by monitoring the files which these applications read or write and/or the packets that they are transmitting and/or receiving. Preferably the firewall or other agent for example can also notice other suspect behaviors, such as for example requesting a web page with an unreasonably large parameters line for example after a “?” in a url (for example ‘http://abc.com/test?asdo+32892323+8238023803+wqwqdpq? ideeww . . .’), since such addresses can also be used for example for connecting to a hacker's site (phoning ‘home’) and stealing the data in disguise of the url's parameters, or for example frequent repeated similar connections for example with shorter parameter lines that keep changing (in case the data theft is in smaller stages, etc.). Similarly, for example the TCP/IP protocol itself might be changed so that for example sockets can be opened for both sending and receiving data or only for sending or only for receiving. In addition, preferably the firewall (and/or for example the Security system and/or the OS or other software) for example can also indicate to the user automatically when some application (for example that has been allowed to access the web) is trying to download a file (so that for example the user can be alerted if such activity is happening without his/her requesting it—preferably together with indication of the full path and the file name that is being downloaded), or for example the user is warned for example only if an apparently executable file is being downloaded. Preferably the firewall (or other agent) can determine if it is an executable for example not only by its extension but also by automatic inspection of its contents, since a hostile application might for example use a seemingly innocent extension and then for example rename it, etc. This can be very useful for example in cases of various browser exploits which cause the browser to download hostile executable code without the knowledge of the user. Another possible variation is that the user is for example warned automatically for example every time a program modifies and/or erases and/or creates an executable file on the disk (This is something that should normally happen only if the user compiles a program or if he/she downloads an executable file). Another preferable improvement is that for example the firewall allows the user to change the permissions of multiple applications at the same time for example in the firewall's table, for example by marking entire columns or other areas and then changing automatically for example all the permissions in the marked areas, such as for example to allow/deny or ask, etc. Another possible variation, which can help the user notice for example inadvertently given permissions, is that for example whenever a program that has been given the rights to act as a server becomes active or activates the server preferably for example the firewall notifies the user that the server is now running and accepting connections from the internet and/or for example very time the user is shown the browser's table of permissions the active servers are preferably marked preferably very conspicuously. Another problem with personal firewalls, such as for example Zone Alarm, is that there is usually a large number of d11's and/or other components which are used by applications that are allowed to access the web, and some hostile application (for example a virus or Trojan horse) can easily change one or more of these components and thus actually for example create a huge hole in the firewall. For example Zone alarm does not notice any such changes and simply asks the user to allow only components which he/she trusts, but of course it is unreasonable to expect the user to now which components to trust or not. So preferably at least one of the following things are done to protect against such tempering: 1. One possible variation is that Preferably the firewall and/or security system can automatically check for example in some Internet database or databases (preferably only in specific certified sites) the correct CRC (or other fingerprint or fingerprints) of the various known components and thus determine automatically if some component is suspiciously with a wrong fingerprint (this is especially useful for example fore components that were on the computer before the firewall was installed). Preferably the database checking includes also a lookup for example in some preferably encrypted database or databases of the OS, in order to check that relevant OS components have not changed, and/or this check is also conducted for example on the Internet database or databases. 2. Another possible variation is that preferably when such a component is changed the firewall and/or security system warns the user about it and preferably is also able to tell the user which application changed it and when, for example by automatically monitoring all the components that are used by the programs that have been allowed access to the web and warning the user for example when they are changed and/or for example the next time the relevant application that uses the changed component tries to access the web, and then preferably the user has again to decide if to allow the application which uses the changed component or components to access the web. However, it is much more preferable that the firewall and/or security system actually intercepts the change at the moment that an application is trying to make it and asks the user if to allow it before the component is allowed to be changed, and, since the firewall preferably tells the user which program is trying to change the component, the user has a much better chance of being able to distinguish between a legitimate change (for example because he is installing a new application) and a change attempted for example by a virus or Trojan horse. Another possible variation is that for example the firewall and/or the security system can be set to require user permission for example the first time a program (and/or for example dll or driver) tries to access each file type (for example “.exe” files, “.doc” files, “.vob” files), and preferably for each file type the user can for example decide if to allow the program read rights and/or write rights in such files (and/or for example execution rights separately, and/or for example creation rights and modification rights separately, and this can be done for example in addition to or instead of requesting permission according to directories). However, in this case preferably the system automatically differentiates between access to shared OS directories and files (which preferably by default are handled automatically by copy-on-write of files or sub-file parts, as described for example in U.S. applications Ser. Nos. 10/301,575, 10/644,841 and 10/968,022 by the present inventor), and attempts to access other directories or files which were added by the user or by other programs. In this case preferably the user can view for example in the table of authorizations which applications (and/or for example drivers or for example d11s) were allowed such rights (for example in addition to showing internet access rights). Another possible variation is that the user can for example also view for example a table which shows for example according to file type and/or for example according to directory and/or for example according to other resources (for example according to various peripheral devices) which programs and/or drivers and/or environments and/or guest OSs are currently allowed access it and/or with what type of access). Another possible variation is that the security system can for example enforce segregation of the computer into two or more virtual machines or virtual environments for example based on the user marking one or more specific directories or for example one or more specific partitions (or other areas) as protected, but preferably the user does not have to jump between the machines, so that the protected directories and/or partitions are actually preferably enforced by a virtual machine with copy-on-write (preferably on a level even lower then complete files), but access to the protected areas for example in order to copy a file into there is preferably based on determining if the user or the application initiated the access, as explained in the above applications, or for example the user has to enter a special mode in order to move or copy files within the environments. So in this variation preferably if the user for example clicks on Word on the desktop and then for example opens a file in the protected area or areas (or if the user for example clicks on the word document directly if the document is in the protected area or areas), preferably this automatically activates instead a separate copy of Word which is associated with the protected area (preferably based on copy-on-write), since otherwise it could be very dangerous since for example a Trojan in the unprotected area might compromise Word in the unprotected area and then if the user opened the protected file with that copy of word anything could happen. (This problem does not exist if automatic segregation with an unlimited number of virtual environments is used, as explained for example in the above applications, since in that case Word is also protected automatically from Trojans). So if for example a Trojan horse compromises for example Word, if the Trojan is executed outside of the protected areas it is preferably able to affect only the Word of that environment (preferably by enforcing copy on write), and if the user wants to make changes for example in the version of Word that is used in the protected area or areas, he/she has to run for example the program that updates Word from one of the protected areas (preferably the user can define of course for example if the protected areas will have a shared virtual environment or each an environment of its own). This is better than the solutions where the user has to jump between two or more virtual machines since this way there is much less change from the normal user experience, and also there is less chance that the user will make errors and for example think by mistake that he/she is in the a protected environment while he/she is not or vice versa. Another possible variation is that for example the user jumps between the environments but for example copying files between them is based at least partially on at whether the user initiated the command, so that the copying between the environments becomes easier for the user. Another possible variation is that for example when looking at the authorizations table of the firewall preferably the user is shown also for example which programs have been given temporary access rights to the communication channels, and preferably also for example how long ago the temporary or non-temporary permission was given, and/or how much data that program has already sent out and/or for example received, as explained above, etc. This is different from the prior art, in which for example the very popular ZoneAlarm firewall shows near each program an ‘X’ if it is not allowed to access the Internet, a ‘V’ if it is allowed, and a ‘?’ if it needs to ask permission (i.e. the user has not asked to remember his last reply), so if the user gives a program a temporary permission, the authorization table still shows a ‘?’ near that program and the user cannot know if the program has or doesn't have temporary access rights at present. This is dangerous since the user might inadvertently answer a prompt from the firewall without paying attention and thus give a program for example temporary access right without intention, but when looking at the authorizations table the user has no indication of this. Another possible variation is that the firewall for example includes also a preferably instant undo and/or redo function which can preferably also show the user for example all the recent permissions or changes he/she has made in the firewall (since preferably the security system and or firewall keeps automatically a log of all the questions that the Security System and/or firewall asked the user and his replies, as explained in other applications by the present inventor) (for example by answering a question that the firewall posed or for example by clicking on the table of authorizations) and the user can for example instantly undo the last action or actions for example by changing the reply and acting accordingly. Preferably the user can either simply recall the last question and answer it differently, or for example enter the log which shows his/her recent answers and then choose for example the last answer and change it. Another possible variation is the preferably for example the OS and/or the dialer and/or the security system and/or firewall (and/or any other program) preferably keeps also a history of previous Internet connection sessions (for example unlimited or for example for a certain time limit or till certain list size and/or for example until the user explicitly deletes some earlier history), which can include for example start time and end time of the connection, duration, how much data was sent out, how much data was received, and/or for example how the sent-out and/or received data was divided between the various programs, so that for example for each session or time period requested the user can be shown for example a sorted table of the programs that sent most data out and a preferably separate sorted table of the programs that downloaded the most data, preferably with the name and path of each program and the amount of data downloaded or uploaded (and preferably also for example the list of files associated with these downloads or uploads, preferably according to which program uploaded or downloaded them).

Another possible variation is better precautions are taken against buffer overflows, for example as follows: Although Microsoft has added the prevention of data execution, both by software and/or by hardware to the recent XP service pack 2 in the 2^{nd} half of 2004, however the problem still remains that even with this improvement, according to http://www.microsoft.com/technet/prodtechnol/winxppro/maintain/sp2mempr.mspx, typically attempts to execute code from the data area may still cause the process to terminate and/or even cause the system to fail with Bugcheck. This indicates also a deeper problem, which is that even just data crashing can be dangerous, such as for example in case of changing the return address, or for example if various data that may include for example information about file names or disk segments or web addresses or user permissions is crashed, etc. Therefore, in addition to the above, preferably the security is improved so that even data crashing becomes automatically impossible or at least much more difficult to do. This can be done for example by improving the compilers to perform much better automatic checks and preferably automatically add (for example preferably for every type of reading data for example from a user interface or from a file) additional code that automatically cuts off any data that exceeds the size of the input buffer, for example in a way similar to the way that Pascal compilers automatically add code that cuts the data that can be read into a string when it reaches the size of the string, except that this is preferably done for example also in C compilers and preferably for every possible type of data input an not just strings. Another possible variation is that the security system and/or the OS can for example analyze executable files that have already been compiled or for example were written is assembler and preferably identify automatically problem areas where for example buffer overflow may occur and preferably automatically add code that can prevent it and/or at least for example issue an automatic warning about such vulnerabilities, and/or for example at least the data stack is better protected by any of the above methods and/or for example by automatically keeping return addresses at a separate place from the data (and if in some cases executable code is also kept in the stack then preferably these executable codes are also preferably automatically kept in a separate place from the data). Of course keeping the return addresses at a separate place from the data for example in stacks can be most easily done for example by changing the compiler to work this way, but preferably this can be done also for example by a program that goes automatically over executable code and can preferably identify for example the commands that add the return address to the stack and can preferably automatically change the code so that this is kept and handled separately. Of course, various combinations of the above and other variations can also be used. Of course, like other features of this invention, these features can be used also independently of any other features of this invention.

Another preferable improvement is that the user can have for example two or more Operating systems running at the same time (for example Windows Me and windows XP or XP and Longhorn), so that the user can for example jump between them preferably instantly or almost instantly, for example by pressing some key or key combination or clicking on some icon, instead of having to shut down Windows and reboot. This is preferably done for example by keeping a mirror image of the loaded and running OS (for example like in sleep mode, which means that while the user is in one OS the other OS is dormant or simply the user can switch between the OS's after entering sleep mode), or for example by having preferably separate swap files so that both Operating systems can be actually running at the same time—which means that preferably one or more additional OS elements are operating below the two (or more) Operating Systems and are in charge of the resource sharing between them. As explained above, this is preferably done together with copy-on write so that only the changes between various instances of the same OS are saved, and of course it can be done more efficiently with a processor that is especially designed to support it, such as Intel's Vanderpool, but using such special element or elements bellow the running Operating Systems can work also with a normal processor. Vanderpool uses an additional more privileged ring below ring 0 for the control system below the OSs, however this was described for example in U.S. applications Ser Nos. 10/301,575 and 10/644,841 by the present inventor a long time before Intel started to talk about this (first priority was on Apr. 2 and Apr. 8, 2002). In addition, as explained in those applications, there can be a special more privileged area or areas within ring 0 or for example below ring 0. In other words, there can be even one or more additional higher privileged areas or rings or sub-rings with even higher privileges, for example in addition to ring −1. For example (instead of one control system, for example in ring −1, which for example can take care of both running for example 2 or more OSs or virtual machines which the user can switch between and the security for each OS or virtual machine and/or also the security within each OS or virtual machine, such as for example enforcing automatic segregation between programs within that OS), there can be for example a separate control system for each OS (which for example runs below the OS, for example in ring −1, and for example takes care of the security within that OS, such as for example enforcing automatic segregation between programs within that OS, and/or for example takes care of any other desired control system below that OS), and for example an even more privileged control system, for example in ring −2, which for example takes care of the context switching and/or security between the OSs. However, since typically the user might want to enable at least some file and/or directory sharing between the various OSs, it is more preferable that the same control system and/or security system indeed handles both the security between the OSs or virtual machines and within them, since otherwise a security system which runs below the OS but is not aware of the context switching between OSs might for example become confused or even for example might misbehave for example by assuming that some change (made for example by another OS) was created by hardware malfunction or unknown type of attack and for example might restore it automatically (for example if it guards changes in some files or directories with redundancy), or for example another OS might for example damage a special file system run by the security system of a separate OS or for example confuse the user for example by showing him special files and/or directories which are used by the security system of the other OS but for example are not normally visible to the user. Another possible variation is that for example various protocols are defined for better cooperation between the OSs and/or their security systems so that for example there are standard mechanisms for letting each guest OS and/or its security system know that it is being used in a multi-OS environment and/or for example which directories and/or resources can be accessed by other OSs and in what type of access. Another possible variation is that the security systems ask the user before making such automatic restores and so the user can easily know for example which changes he/she made from another OS wants to keep. Another possible variation is that in this mode for example certain functions are automatically disabled or are available to only one OS (for example by choice of the user and/or by automatic choices), for example when there are problems of allowing two or more separate processes to access the same hardware at the same time. Although there are for example systems that allow the user to run a window of another OS by emulation, this is much more efficient. Another possible variation is that for example if the graphics card can support two or more monitors at the same time and the user connects two or more monitors, preferably the user can for example tell the control system which is in charge of switching between the OSs, preferably as one of the available options, for example to run on each monitor a separate OS at the same time. Another problem is that in Windows for example if there are two monitors connected or one monitor connected only to the 2^{nd} monitor socket of the display card and the user for example installs a new OS or a new display driver while using the monitor that is connected to the second socket, on the first reboot the system forgets this and tries to start working only with the first socket (eventhough the 1^{st} socket might be for example not connected or connected to a monitor that is turned off), and then the user has to connect the monitor to that socket in order to fix this. So preferably this is improved so that the new driver or OS remembers which was the active monitor and thus preferably keeps using the same monitor after rebooting unless the user changes it himself/herself afterwards. Another possible variation is that for example when there are multiple OS's running which are for example switched-between by a hypervisor for example in ring −1 or lower, if one of the OS's needs to reboot, preferably for example the hypervisor can keep for the OS's a buffer or buffers of various states of various hardware devices, so that preferably it can simulate for the rebooting OS a situation with the appropriate values that would be returned from these devices if they had really been reset by a boot but preferably without having to actually reboot, so that preferably the others OS's can keep running undisturbed at the same time (for example by monitoring and saving these parameters during the real boot and then repeating those conditions in the virtual reboot). Another possible variation is that for example if new devices are added for example without rebooting, for example by connecting the to the USB, and/or for example new device drivers are added which need to be recognized by already running applications, preferably the relevant OS can for example identify automatically only the affected running applications and then preferably for example save their current state and then close and reload them automatically without rebooting and without affecting other running applications. In addition, since Microsoft are adding for example in Vista a restart manager, which can also prevent at least some reboots when they are not really necessary, preferably if an installing program tells the user that he/she needs to reboot, preferably the OS itself can for example interfere when the reboot is not really needed and for example display to the user a message to ignore the reboot suggested by the installing software since it is not really necessary, or for example the OS can automatically cause the message that tells the user to reboot for example to become invisible. This can be done for example by preferably monitoring automatically what the installing program changed (and then preferably doing what is needed in order to enable the change without the need for reboot, when possible) and monitoring the messages that the installing program tries to display to the user and intercepting the message if appropriate). Another possible variation is that for example in such multi-OS environments when the user activates hibernate or standby or even shutdown from one of the OS's, preferably the hypervisor simulates this only for the relevant OS, and for example real standby or hibernate or full restart or real shutdown has to be activated from the level of the hypervisor. Another possible variation is that for example until the Vanderpool and/or the similar AMD Pacifica or other similar technologies become available, preferably the user can for example switch between two or more operating systems by jumping between hibernate states instead of having to boot from scratch. For this preferably the system allows the user after entering hybernate for example to press some control which shows a menu of the available current bootable OS options, and preferably shows also if any of them can be entered through resume form hibernate or a real boot is needed (because the user did not leave that OS on hibernate the last time he/she exited from it), and then preferably clicking on the desired choice lets the user resume from hibernate in the chosen OS if such a state currently exits. Another possible variation (for example especially if there is for example sufficient free RAM or for example flash memory) is that the user can switch even faster to the other OS for example by clicking on some control or menu item while still working in the current OS and thus entering the menu, and in this case if the user clicks on restore from hibernate on the Other OS then preferably the resume from hibernate in the newly entered OS can occur even before the current OS image is saved for hibernate or during the same time (and this can be even faster if the hibernate image of the newly entered OS is for example still available at least partially also in RAM. (However, in order to enable this at least some process preferably runs below both OS's and takes care of finishing the saving of the image of the OS which the user just left while the user in entering the new chosen OSS. Another possible variation is to add to the computer various sensors that can automatically monitor the condition of the user, for example by various biometrics, such as for example sensing the user's heartbeat and/or respiration (for example by a special remote microphone), skin temperature (for example through sensors in the keyboard and/or mouse) etc., so that for example if the system senses a serious problem preferably the OS or a special application can for example warn the user and/or for example call directly one or more emergency numbers and request assistance for the user, for example through synthesized speech or SMS or for example use Instant Messaging. Another possible variation is that this sensing is not limited to when the user is sitting near the computer, so that for example there are various additional sensors for example in the room or in the house or for example some sensors which are worn by the user (for example if the user is at known risk) and preferably connect automatically to the computer for example by UWB or Bluetooth or other short range wireless connection. Similar systems can be very useful for example with various special sensors for example in trains or in cars, since for example if the train's driver has a heart attack and does not press the breaks before collapsing it can cause a dangerous accident. So preferably the driver's cabinet contains various biometric sensors which can work for example as described above, and/or for example additional sensors such as for example sensors in the seat or on various elements which the driver is supposed to interact with, and preferably the train's computer has also sensors (such as for example radar and/or ultrasound and/or video cameras) which can sense for example if the train is moving too fast toward a too near obstacle and then for example can preferably apply the brakes automatically and/or sound a warning. Although there are for example some trains which contain a ‘dead man switch’ which means that for example every 30-60 seconds the system indicates a sound and/or light and the driver has to press some switch to show that he/she is still alive and if he fails to press it a stronger warning is indicated and if he still fails to press it the train automatically stops, an automatic sensing system as described above is better since it can be much more convenient to the driver and it can preferably sense problems immediately without having to wait for the next activation. Another possible variation is that the system includes for example also one or more video cameras that constantly monitor the driver's cart and for example the computer's system can automatically analyze for example un-normal positions of the driver and/or for example the image is broadcast automatically for example every few seconds to various ground stations. Similar sensors can be used for example in cars, so that for example if the computerized system senses that something is wrong with the driver (for example the driver has fallen asleep or is not feeling well, which in the case of a car can also be based for example on sensing erratic behavior of controlling the car—for example erratic movements which seem to ignore the track) it can for example try to alert the driver by sound and/or for example jolting or rocking the driver's seat, and/or for example can apply an automatic system which can preferably sense the contours of the road and/or the white lines and/or the position on the road and/or the surrounding vehicles and/or other objects and can preferably automatically slow down and move the car sideways and come to a safe automatic stop on the margins of the road and/or for example issue an automatic call to emergency services. In addition, for example in cars that have various sensors against collisions (for example radar, visual, ultrasound, etc.), preferably the car has also sensors between the front and back wheels, so that the car can also preferably instantly warn the driver and/or automatically take over for example in case an object, for example a kid, gets between the two sets of wheels. Another possible variation is that for example the car's sensors of impending collisions can be left active at least partially (preferably with low energy consumption) even for example when the car is parking (for example by activating some radar and/or other signals and/or sensors for example every second or other convenient interval at least for short range), so that if the car senses for example an impending collision preferably it can for example automatically broadcast a warning for example by automatically sounding the horn and/or for example by automatically flashing lights (and/or for example automatic wireless communication). Another possible variation is that is such cases the car can also automatically activate for example one or more video and/or still cameras and thus can for example keep photos for example if another car hits the parking car, so that the hitting car can preferably later be identified with proof.

Another possible variation is to add for example preferably automatic preferably smart temperature and/or light permeability control to cars, for example while they are parking and/or while people are in the car, preferably by computerized control. Preferably for example during parking preferably the car's computer system (and/or for example an additional preferably computerized system, which can for example be installed as an add-on in existing cars) preferably uses automatic heat and/or light sensors to decide what to do and preferably uses low energy methods and/or for example operates when the user is about to enter the car and/or also when people are in the car. This can be done for example in at least one of the following variations:
1. Preferably the car uses smart windows which can be automatically adjusted for example for heat permeability and/or light permeability for example mechanically and/or electronically (for example by their own nature and/or by command). The idea of using smart windows also in cars is not new, but what is missing is automatic smart control. Preferably electronically controlled smart windows are used, such as for example the already existing Suspended Particle Device (SPD) windows, which are comprised of two panes of glass sandwiched around a special film containing a liquid suspension, as described for example in http://64.233.183.104/custom?q=cache:IB0A6tTIBUUJ: www.sun-sentineL com/technology/chi-windows.0.2384687.story+ %22Scientists+see +improved+windows %22&hl=UTF˜8. In the liquid suspension are microscopic light-absorbing particles that are randomly scattered to block the passage of light for making the window dark. When an electric charge is applied the particles line up in tight rows, allowing light to pass through for making the window transparent. SPDs also allow a range of transparency, permitting for darker or lighter window tints depending on the amount of voltage applied. Research Frontiers Inc., (RFI) of Woodbury, N.Y., holds over 360 patents relative to SPD technology and is actively licensing the technology to film and glass manufacturers worldwide. Unlike other smart window technologies it's durable, cheap and relatively easy to make and apply, and it is expected to cost around $15 to $30 per square foot, compared for example o $80 to $150 per square foot for electrochromics or LCD windows. This is also much better than LCD windows, since LCD windows typically enable only a dark and a bright state without in-between states. SPD windows are capable of going from completely dark to clear almost instantaneously. In darkened mode, the glass appears a very dark blue (Chicago Bears blue) with lighter tint levels having a slightly blue cast. However, a 100-square-foot window uses about the same amount of electricity as a 60-watt light bulb, which means that preferably the car is able to apply smart energy considerations as explained below. Another possible variation is to use for example the smart windows described in http://www.nature.com/news/2004 /040809/pf/040809 2 pf.html, published online on Aug. 10, 2004. According to this article, a team of researchers has created a window coating that reflects the Sun's heat without filtering out visible light. At lower temperatures the new coating allows through both visible and infrared rays, just like normal glass, but once it heats up above 29° C., its atomic structure changes and it begins to reflect heat. It was invented by chemist Troy Manning together with Ivan Parkin at University College London and is made from vanadium dioxide mixed with 1.9% tungsten metal, and apparently they have been able to change the mixture to reach also lowers threshold temperatures, even a slow as 5° C., which means that various glasses can be prepared according to the desired threshold. However, such a window is problematic for computerized control since it does not respond automatically to computerized control, so preferably such a windows is used in combination with a window than can change on command, such as for example the SPD windows, so that for example the glass contains for example both the coating needed for the Automatic changing by temperature, and an inner layer of the material needed for SPD. Another problem is that since car windows are usually specific for each car model, thus creating problems for mass production, and since the solution is preferably made available also for existing car owners, preferably the vanadium dioxide mixture (and/or for example other mixtures with similar properties) can also be marketed for example as a spray or other means which the user can use to coat exiting windows and/or for example similar spray or other coating means which can be sold to car manufacturers for easy addition to their production lines. Similarly, the SPD windows could have an even bigger problem in creating two layers for car windows, since that might mean having to create for example two layers of half-thickness for each type of window glass for each model in order to add the SPD layer in between. Therefore a better solution is that preferably for example instead of two glass layers only one layer of glass is used, and preferably the SPD layer is coated for example on the inside or outside of the glass (but more preferably inside), and preferably an additional transparent coating is added over the SPD, preferably to insulate and protect it. This additional layer can be for example based on some transparent nylon or plastic, which is also preferably electrically insulating, since electricity needs to be run through the SPD layer. The means for adding these two layers (the SPD layer and the additional cover layer) can also be sold for example to car manufacturers for preferably easy integration with their production lines, for example in the form of a spray, and/or for example sold also to existing users, preferably as a kit, preferably with some means for ensuring that the layers have been coated in a sufficiently thick and regular way, and/or sold at least to garages or other professional services which can preferably easily add these coatings to existing car windows. Another possible variation is that for example the vanadium dioxide mixture layer (and/or for example other mixtures with similar properties) is preferably also covered with an additional transparent protection layer for example to protect it from peeling off or being scratched. An article in Israeli news paper Maariv from Aug. 25, 2005 suggests using in cars windows that change light by changing polarization but does not show any enabling way to do it. This would be problematic since car windows are rectangular and the short article in Maariv does not refer to this problem or show how to do it in practice. So preferably if such a solution is used, preferably it is done by adding for example between two layers of glass (in which preferably only one of them is preferably polarized) a third preferably circle shaped polarized layer which can preferably be rotated preferably by electronic command between the two external layers, thus preventing the user from being physically disturbed by the rotation. However, this means that only part of the window can be darkened this way. Another possible variation is for example to use more than one such circle in the inner layer, so that better covering is available (for example 2-10 or any other convenient number), and/or using for example more than one layer, so that there are preferably much less holes between the circles, for example by partial overlap between circles and/or for example enabling partial overlap between the circles within the same inner space, so that for example two or more preferably thin inner circles can be rotating partially on top of each other. This material can be for example based on preferably thin plastic compared to the car's glass, such as for example the material from which polarized add-ons for sun glasses are made (for example 1 mm or less in thickness). The control of the rotation of these circles can be for example based on small electric engines. (Of course a circular shape is just an example and other shapes can also be used, such as for example elliptical shapes or for example multi-rib shapes). However this solution seems more crude and probably less efficient than for example SPD glass or similar solutions. Another possible variation is to use for example one or more inner layers which can be for example moved up or down independently of the Window itself (but preferably not higher than the window), so that for example 1-4 or more inner layers coated with different combinations of vanadium dioxide can be preferably automatically moved up or down, each suited for a different threshold. Similarly another possible variation is that for example an inner layer with the SPD material can be for example automatically lowered up or down so that for example for keeping the windows clear during parking (for example in the winter), the car preferably simply lowers them, thus reducing any energy requirements to 0. On the other hand, for example in the summer the car might for example most of the time decide on maximum darkness, which means simply automatically turning off the energy to the SPD layer during parking. However, if for example the car decides on an intermediate state, preferably it can be made for example by either pulling the SPD layer partially in or out of position, and/or activating the SPD control for a certain intermediate level of dimming. Another possible variation is to simply use for example a light opaque layer of cheap material or materials (for example thin layer of plastic) which the car can automatically move up or down during parking, so that for example during parking if the car and/or the user decides on heat reduction, this layer is preferably automatically moved up. In this case this layer can be for example on the inner side of the windows without being between two glasses, since it would be normally used only when parking, thus not disturbing the passengers or driver when they are in the car. Another possible variation is that such a layer might be moved also from other directions but moving a thin layer automatically up and down for example from the same inner space in the door when the window is, is of course much easier and requires little change in car design. Of course, for example while parking, the car might decide automatically to what height to pull this layer up or down, thus for example reaching any range of desired heat penetration in-between states. Another possible variation, for example if 2 or more glass layers are already used, is to use for example a combination with a low-e type of glass such as for example the type described in http://www.energydepot.com/aglc/library/newpages/effwindo.asp, which can reflect for example between 70%-75% of the heat that would normally go to the outdoors, back in, during winter. However, in the Summer, according to that article, “low-E glass reflects about 25% more heat back outside than a single-paned window and 11% more than a standard double-paned window. The U-value for a double-paned window with Low-E glass starts at about 0.4. If a Low-E film is suspended between the glass panes then U-values approach 0.333 and even more of the harmful ultraviolet rays are blocked. A newer type of Low-E glass, often referred to as ‘southern’ Low-E glass, is designed to be most effective during the summer, by reflecting much of the sun's heat away from the inside of the home. Very often Low-E glass is combined with gas filling for U-values as low as 0.15”.
2. In some types of smart windows energy is required to keep the window dark and in some energy is needed to keep the window open to light, however since either way the car might need to choose levels different from the lowest energy state, preferably the computerized system also senses automatically the power level of the car's battery and preferably if the remaining energy goes down beyond a certain level then preferably the system can automatically for example reduce the operation of the automatic heat control and/or for example stop it and/or for example automatically start the engine preferably for a short time to charge the battery. Of course this could create dangerous air pollution if done in a closed space, but since the car preferably uses automatic sensors there is usually no problem since the car would normally have no reason to activate these means anyway in a closed space, such as for example in a garage on in an underground parking place, unless for example pre-heating is used automatically. Preferably the car senses automatically according to the temperature and/or light level and/or other measurements what is most desirable. For example in a cold winter day preferably the car automatically brightens the car windows while parking, preferably till the desired temperature is reached, and for example on a hot summer day preferably the car automatically darkens the windows while parking. (However, for example on a snow day darkening the windows might for example be an advantage because darker windows become hotter in the Sun and thus can for example better melt for example ice or snow that might otherwise accumulate on the window, however on the other hand if the snow has already accumulated then melting a the snow will create more ice). Or for example on a mildly cold day if the car is in a shaded parking place then preferably the car might automatically brighten the windows or for example leave or change them into an intermediate state and/or for example if the car is in the Sun then automatically the windows are made darker. Although for example a heat sensor within the car might be sufficient for example for deciding if to make the windows brighter or lighter, using for example also a light sensor can be important and can improve the decision making of the car, and also it can help for example for determining if the car is in a closed underground place or closed garage indoors, which means that for example the car must know automatically not to activate the engine for recharging the battery, since that could create dangerous air pollution. However, with a light sensor alone there is a problem of determining for example if a darkness is due to being in a closed place or due to night time, so the car preferably uses also a real-time digital clock which takes into account also the time in the day. In addition, preferably the car uses more than one temperature sensor, since for example the temperature inside the car might be considerably higher than the outside temperature, so preferably the car has at least one sensor in the car and at least one outside, in order to be able to make also smarter predictions based on outside temperature and not only depending on the internal temperature sensing. Another possible variation is that for example the car automatically adjusts the light permeability of the windows and/or the heat permeability of the windows when people are in the car, for example according to the operation of the air conditioner, so that for example if the air conditioner is set to cool, the car preferably automatically also reduces the heat permeability and/or light permeability of the windows and if it is set to heat then preferably vice versa (However when people are in the car of course preferably the light permeability is not reduced below a level that would cause visibility problems). Preferably the windows are capable of changing in more than one dimension, so that for example the heat and light permeabilities can preferably be controlled at least somewhat independently, so that for example the car can change the windows independently for visibility and for heat considerations.
3. Preferably the car can automatically activate for example the fan when the heat exceeds a certain temperature, so that preferably fresh air is automatically circulated through the car and the warm air gets thrown out of the car. Typically a car fan without activating the air conditioner can for example consume approximately 40 watts, which is much less then if for example the air conditioner is activated, and could run for example for 12 hours or more before draining the car's battery. However this is of course much less efficient unless combined with much smarter methods, which preferably enable the activation of this only when the user is about to return to the car or for example this is automatically stopped if the battery goes below a certain level, as explained above, and/or the car's engine can be for example automatically started preferably for a short time for recharging the battery and then stopped automatically, as explained above. These solutions are preferably applied also for example to SPD windows or other solutions that consume energy unless they are is the state that requires no energy, since if the glasses of the car windows for example altogether have a size of about 3.15 square meters (which is about 33 square feet), about 20 watts of electricity is required for example for keeping them clear. However, as explained above being able for example to also automatically move the SPD layer in or out of position for example while parking is better. Another possible variation is that for example at least one additional fan, preferably with at least one additional tunnel that can allow air in or out of the car, can be used, in order to improve the circulation of the air. This additional fan can be for example on the back side of the car, so that for example preferably both fans can work at the same time, preferably one for pushing fresh air into the car and one for pulling air out of the car.
4. When the user leaves the car preferably he/she can set a timer which tells the car approximately when he/she is about to return. This can be for example by rotating a mechanical timer button or for example pressing or rotating a button which controls a digital display, and/or for example the car can ask the user automatically, for example by voice communication when he leaves the car when approximately he/she is about to return, etc., and then for example he she can set the timer manually and/or for example also by voice command, which the car preferably acknowledges to make sure it got it correctly.
5. Another possible variation is that the user can for example use a remote car control which can preferably send a message to the car for example from a distance of preferably up to a few hundred meters or more (or any other convenient distance) to automatically prepare the car for entry, for example by reaching a pre-defined temperature (which can mean for example heating in the winter and cooling in the summer, etc.). This can be done for example by a radio signal from the remote control and/or for example by cell phone communication, etc.
6. Another possible variation is to use similar methods for example for automatically dimming the light when the sun is disturbing the driver, so that for example light sensors preferably automatically make the appropriate window or part of it darker if the car senses that the sun is blinding the user directly, and/or for example doing this automatically also for passenger windows. Another possible variation is that for better efficiency preferably this is combined also with sensing for example the position of the driver and/or the passenger and/or for example being able to darken or brighten one or more smaller specific areas in the window (For example by using SPD windows or LCD windows with smaller controllable areas that can change independently), so that for example the car can automatically darken for example only a smaller square near the point where the sun is seen and for example leave the rest of the window brighter.
7. In addition, preferably if the car can for example sense, for example by motion detectors and/or weight detectors and/or other detectors that for example a child or animal has been left in a closed parked car, it can for example start making sound and/or visual warnings and/or for example can automatically activate cooling controls for example more vigorously, such as for example also the air conditioner itself at least once in a while when needed and/or for example automatically opening one or more window at least partially, etc., and/or for example sending an automatic cellular phone message to the driver, etc. However, preferably the car can of course differentiate between a situation in which for example a child or animal was left by mistake in the car and a situation in which users are normally sitting within the parked car—for example by assuming that if the key is still in the ignition keyhole then the users are in control of the car, and, as implied above, manual override is preferably possible at all the states. So preferably if for example the key is in the ignition keyhole and there are people in the car while the gear is in parking then preferably nothing is done and/or for example only automatic heat permeability controls are used without automatically making the windows darker (and/or for example the user can allow the car to that also automatically for example even when there are people in the car together with the key). For example when the car is in parking without people inside then preferably both automatic heat permeability and/or automatic windows darkening is used if needed (for example according to the actual temperature and/or light conditions and/or time of day), preferably by default, preferably unless for example the users for example change some switch which overrides partially or in whole such automatic controls for example in general or for times of parking.

Of course, various combinations of the above solutions can also be used. Another possible variation is that for example when the gear control lever is in Parking state the car can preferably automatically activate also the handbrakes (for example every time or for example only if the car is for example in a steep slope, which can be sensed for example by an automatic horizontal balance sensor) and preferably when the gear control is removed out of parking state preferably the car can automatically also release the handbrakes. However, if for example the car is on a steep slope, automatically releasing the handbrakes at the wrong time might be dangerous, so preferably in such cases it is released automatically for example only after the gear is for example in Drive or in Reverse and the driver presses the gas lever, and/or for example at least in some cases a warning is automatically issued to the driver to release it instead of automatically releasing it. And of course if such automatic activation and/or release of the handbrakes is possible, preferably the deriver can also cancel this automatic mode, for example by changing some switch.

Another problem which cars is that for example the upper part of the engine is oiled automatically only when the user starts the engine, which is too late and causes the engine to be gradually damaged each time for about 1-2 second when the engine is being started, since it takes about 2 second for the oiling to reach the engine. Fiat solved this by activating the oiling when the user starts turning the key, however this still is not reliable since many times the user turns the key too fast and thus still starts the ignition before sufficient oil reaches the engine (in addition they added a mechanism for taking care of the excess oil while the engine is still not running). Therefore a better solution is to preferably use earlier sensing, such for example start oiling when the driver opens the door and enters or for example when he/she sits in his/her seat (for example by weight sensors and/or electromagnetic sensors and/or movement sensors) or for example when his/her hand moves toward the ignition keyhole (for example by infrared short range sensor, or any other relevant sensor). This is more preferable than sensing for example sitting, since it might take sometimes even a few minutes or more, or he/she might even for example prefer to remain parking for some time. On the other hand, after the driver inserts the key he/she usually starts the engine almost immediately, however he/she might for example just rotate the key partially for the electricity and stay parked for a while. So most preferably the sensor is based on the driver nearing his hand to the key (preferably for example by infrared sensor as explained above), since that is the most reliable predictor, since the driver won't normally hold his/her hand there unless he/she indeed wants to start the engine. Another possible variation is that preferably the system can also automatically stop the oiling—for example if the sensor is activated but more than a certain time passes and the engine has not been started yet (for example 30 or 60 seconds or any other convenient time). However, preferably this deactivation is not used if the user's hand itself is sensed near the ignition keyhole, since when there the chance is very large that the user will start the engine any second. Another possible variation is for example when an RFID immobilizer is installed, or with any other RFID for example on the key and/or keyholder and/or remote control, sensing automatically when the user's key is close enough to the ignition keyhole, however, as explained above that is less reliable than sensing the user's hand at that position. However redesigning the engine for enabling the circulation of the extra oil even when the engine is not yet running might be expensive. Therefore another possible variation is for example to add one or more preferably small oil containers preferably above the engine, which are preferably automatically full all the time or at least when parking, and when the user starts the engine preferably the top container or containers are automatically opened preferably instantly and pour their oil on the engine until the oil from the normal pump reaches the engine. Another problem is the inefficiency and waste of gas and air pollution when the car stops or moves very slowly for example in red lights or in traffic jams. This has been solved in hybrid cars (in which the car has an additional electric engine with special batteries for it) or mild hybrid cars (which use the alternator and the normal car battery for a short electrical push when the car begins to move after a stop) by automatically switching to electric engine when the car stops or moves below a certain speed. So in these cases preferably the system oils the engine automatically a short time before switching to the combustion engine. Another possible variation is that instead of or in addition to hybrid or mild hybrid solutions, preferably when the car stops and/or when it starts moving sufficiently slowly preferably the engine can automatically go down to a very low speed in which very low energy is used and preferably exhaust levels are very low, but preferably this speed is sufficient to enable the car to preferably instantly or almost instantly go back to normal speed when needed. Another possible variation is that preferably the car (preferably with the aid of its computer) can measure automatically for example the level of brakes fluid and/or the wear-out condition of the breaks. Preferably the car can sense if the brakes have worn out for example by measuring automatically for example the amount of pressure that needs to be exerted when braking, preferably while taking into account also the speed and preferably also for example the inclination of the road (for example up or down, for example by using a level measure). Preferably the car can sense for example if brake fluid is missing before the user needs to press the brakes, for example by adding a spring which keeps the clippers away from the brake's disc, so that preferably a small amount of pressure can be applied automatically to the brakes fluid for example all the time or once in a while, and so the pressure needed for example for creating a small displacement in the spring can be measured, or for example even without the spring a small displacement of the clippers can be created automatically for example without actually letting the clippers touch the discs, and thus the pressure needed for that displacement can be measured, or for example by an mechanical or optical sensor which can measure the thickness of the disc or of the clippers. Another preferably improvement is that for example in cars that work on hydrogen preferably the water vapor from the exhaust can be used for additional energy boost preferably through steam—in a way that is more efficient than adding steam to a normal car. Preferably this is done by mixing the exhaust water vapor with water preferably by streaming it back into a container with the water, and thus converting the high temperature lower pressure vapor into a lower temperature higher pressure steam, which can preferably be used for example for rotating a turbine, thus giving additional boost to the car. This is much more efficient than using a heat exchange for creating steam for example in cars that don't run on Oxygen.

Another problem is creating smarter preferably computerized vehicles which can preferably use virtual tracks and thus can for example replace LRT (Light Rail Transit). There is for example a new smart 2-part or 3-part articulated bus called Phileas, which is now in experimental stage in Netherlands, which can follow a virtual track marked by a magnet every 4 meters, which identifies the magnets by sensors, and each set of wheels is steer-able, so that each part of the articulated bus can more easily maneuver into the desired position. This can save a lot on infrastructure, however since there are at most 3 parts per bus, in terms of cost per passenger, in high demand routes this can still be operationally more expensive than running a light train (after the rail already exists). The Phileas is intended to be a hybrid bus, thus saving on gas and pollution. Another smart computerized solution is the Civis bus, which is guided by a camera at the front of the vehicle, which follows special stripes at the center of the traffic lane, and this detection device works up to a distance of 30 meters. The driver can take over the control at any moment. The Civis (which is 18.5 m long) will operate in Clermont-Ferrand and Rouen in France, and in Las Vegas, USA. However, the Civis uses a lot of fuel due to its considerable weight (17 tons), and another disadvantage is that the guidance is less reliable if the detection is based on fewer than three guidance stripes. In Netherlands the authorities decided that the visual tracking system is not sufficiently reliable, due to rain, autumn leaves, snow, and the low angle of the sun, and that is why they decided to use instead the Phileas. Both of these buses are examples of BRT (Bus Rapid Transit) systems. A better solution would be preferably to enable more parts for the articulated bus and/or additional coaches, and/or preferably enable an even cheaper virtual rail, which will still be preferably reliable enough, and/or preferably enable greater flexibility in deviating from the track. This is preferably done by preferably giving each coach and/or articulated part the ability to preferably automatically follow and imitate the same steering movements of the driver in the first part. This can be done for example by computerized control and communications, so that preferably each coach and/or articulated part preferably knows, preferably exactly, the distance (preferably for example in terms of number of wheel rotations) between it and the previous part and/or between it and the first part, and preferably all the steering actions of the driver of the first part are preferably automatically transmitted also to the other parts (for example by digital communication), so that preferably each articulated part and/or coach can preferably automatically repeat the same steering actions at the same position in the road (for example by doing exactly the same as the driver after the correct number of wheel rotations has occurred). This can enable easily using more than 2-3 parts, such as for example even 4-10 or even more articulated parts or coaches. However, such a method alone would have the disadvantage that various deviations might accumulate after a while if there is no self-correcting direct feedback. Therefore, preferably this system is preferably combined with automatic ability to sense the correct position relative to the virtual track and/or automatically correct the accumulated deviation, preferably compared to the first part (i.e., preferably the deviation is corrected to be the same as the deviation of the 1^{st} part from the virtual track, since the driver would normally know best the desired deviation, even though another possible variation is for example to correct the deviation compared for example to general guidelines regardless of the deviation of the first part, but that is less preferable since the driver might have for example deviated on purpose for various reasons, such as for example a temporary problem on the track). This is preferably done for example by visual sensors that can automatically sense the marked trail (for example by video cameras). This has the advantage that it is cheaper than the Phileas method (since the track has to be marked anyway also for humans to know the track of the virtual railway, and thus no additional magnets or other indications are needed), and secondly, this is now much more reliable and less vulnerable to problems even when the marks are for example temporarily partially covered for example by leaves or by snow, since the parts can follow the first part's driver's steering movements automatically and thus the visual tracking can be used for example to correct errors for example once in a while and can be much more robust for example in cases where the marks temporarily cannot be seen. Another advantage is that this way for example there can be more than one such bus line so that for example each line has a different route but for example at least some sections are shared by more than one line. This would be very difficult in a system that is based only on following a marked rail without being also automatically able to imitate the driver's steering, since the other parts would not know which of the routes to follow for example after the vehicle exits the section of the route which is shared by more than one line. Another possible variation is to use for example a different color (and/or other different visual indication or indications, such as for example different line widths and/or patterns and/or other visual means and/or other means) for each line so that preferably the sensors of each vehicle can preferably also be instructed to follow the correct marking. This is better than using for example the Phileas magnets every 4 meters, since these magnets would make it more difficult to mark different routes (unless for example each such magnets can also have a special pattern or fingerprint and for example more magnets are used at least in shared sections, which is preferably done anyway, for example also in order to prevent the system from becoming confused for example if other magnets or magnetic fields or electromagnetic fields are in the area). Preferably there are multiple sensors on each part and preferably the part's computer preferably takes into account the average deviation from the marked track so that if for example the track is temporarily not visible then preferably it keeps for example following just the steering actions preferably until it becomes visible again, and also it can preferably for example understand for example that according to the steering moves performed it couldn't have moved for example more than a certain distance from the track, for example in case part of the mark is covered and for example the sensor for example perceives by mistake another mark, for example on the other side of the road, and/or for example it can see that according to the current angle between it and the first part and/or the previous parts and/or the new angle that would be created by moving to that mark this cannot be the correct mark. Such a system is also much more flexible than a light train because if for example there is a problem in the installation pipes below the road (which is the reason why so much money is spent on moving the pipes sideways before putting the tracks so that they are not under the tracks), and/or for example in case of temporary road blocks, under-road piping repairs, or other problems, preferably the driver can for example easily deviate for example 1 or even more meters from the normal route. Preferably the system also transmits automatically to the other parts the current deviation between the first part to the virtual track, and thus preferably automatically preferably each part can adjust its deviation to the deviation that was broadcast by the first part, preferably when reaching the same position in which that deviation was relevant. Another possible variation is that the driver can even deviate completely from the marked track when desired (for example if there is a suspect object that needs diverting traffic away), and then preferably the driver can for example send the other parts (for example by pressing a button or moving a lever) an automatic command to temporarily ignore the marked virtual track altogether and just follow the steering movements of the first part and/or at least temporarily use other means for correcting accumulated deviations. Of course various combination of the above and other variations can also be used.

Another possible variation is that for example in straight sections the driver can for example issue a command to the other parts to align themselves automatically so that they become preferably exactly straight after the first part and/or for example each part after the previous part, and/or for example the parts can decide do this automatically for example when the first part transmits that the steering position of the driver's wheels for example are exactly balanced, thus indicating a straight line. For the creating the actual alignment preferably the parts can for example use visual means such as for example video cameras and/or other sensors in order to measure for example the difference in the distances between each part to the previous part on the right side compared to the left side, and/or for example the hinge or hinges between each two parts can automatically measure and report the angle in which it is currently in. For making the actual correction preferably the parts use of course the ability to steer preferably each wheel or each pair of wheels independently. This is another way of getting rid of the accumulated deviations. This way the need for marking the virtual track or depending on it can be even further reduced. Another possible variation is that for example even without a visually marked track the first part can for example broadcast to the other parts at least once in a while (for example every 30 seconds or for example a few minutes or any other convenient interval, or for example when the first part senses conspicuous elements in the contour which can be used as good reference points) various automatic measurements of its position relative to the road or to the surroundings or to said conspicuous elements, for example by radar and/or the visual imagery and/or other sensors, and thus for example the computerized system on each part can for example compare the data it received from the first part with its own measurements when it reaches the same spot and thus automatically calculate the amount of the current deviation. Like in the adjustment according to the marked virtual track, in this case also preferably the system automatically takes into account for example the reasonable possible deviation for example according to the recent steering maneuvers performed and/or according to the current angles, so that preferably it will not make a correction for example if the projected correction means significant deviation from the current angle and/or position. Of course various combination of the above and other variations can also be used.

Of course, if for example 1 or 2 electrical wires are used on top of the route for supplying electrical power to the smart bus, then preferably this can be used is addition to or instead of the visual tracking, and this means that preferably each part has at least one or more arms which connect to the top electrical wire or wires, and preferably these arms are flexible and extendable, for example by being able to change their angle and/or preferably automatically become shorter or longer as needed (for example like a foldable antenna, for example of the type that uses movable tubes within each other or for example like multiple connected X's which can become shorter or longer by changing the angle of each X), so that preferably they can work OK for example even if the part deviates for example even 1 or a few meters (or less or more) from the normal route, and preferably each such arm also automatically senses the distance between the part and the electrical wire. Another possible variation is to add for example to each part also automatic impending collision detectors (for example visual and/or by radar and/or laser and/or any other known means) for example sideways and/or also forwards and/or backwards, so that preferably, for example even when the part automatically adjusts its position, it preferably automatically avoids moving in a way that would cause it to collide into something. Preferably such sensors are also added for example between the wheels, so that preferably they can detect also for example if a child or an animal runs or is about to run between the wheels and can preferably automatically take evasive actions, such as for example maneuvering sideways to avoid the collision and/or for example causing automatic braking or at least slowing, etc. However, the visual sensing and automatic correction in combination which the automatic imitation of the steering actions of the driver is just an example, and this can be used for example also in combination with any other sensing methods, such as for example in combination with the Phileas, since the automatic imitation automatically makes it more reliable to use the feedback sensing, since preferably the sensing is needed just for correcting deviations at least once in a while, and preferably in all of these variations preferably the deviation of the first part from the route is preferably automatically sensed by the first part and preferably automatically conveyed by communication also to the other parts. Another possible variation is that for example in systems like the Phileas, even without steering motions imitation, preferably the first part can automatically for example instruct the other parts to repeat the same deviation of the 1^{st} part, so that for example if the driver deviates for example even 1 or more meters from the normal tracks for example due to some problem, preferably the other parts can automatically try to reach the same deviation (for example at least in one of the possible operation modes), preferably at the same spot, preferably for example also by counting wheel turns. So for example at stations with special elevated platforms preferably the driver can for example instruct the other parts to alight themselves automatically with the exact markings (and/or for example there is a special signal at such stations with issues that command automatically to the parts, for example by wireless and/or special magnetic patterns and/or for example special optical marks), and for example during travel or in normal stations without elevated platforms preferably the parts are automatically in the mode that imitates the deviations of the first part (with or without imitating the steering movements of the driver of the first part). (Actually even for example in stations with elevated platforms the driver will typically move the first part as close as possible, so the other parts can do the same anyway, so preferably the other parts can be for example in imitation mode all the time). However even for example in a system like Phileas, adding for example also the ability to imitate steering motions means very little addition in costs (since it is mainly some additional communication and some additional computer control), and has the advantage of for example enabling the bus much more easily for example to temporarily deviate entirely from the marked route and/or for example enables much better control when for example more than one line share a common section, as explained above.

Of course various combination of the above and other variations can also be used. Of course, like other features of this invention, these features can be used also independently of any other features of this invention.

Similarly, preferably the car alarm is improved so that if the car is being stolen, preferably the alarm system automatically broadcasts a distress signal (preferably secretly), preferably through a hidden cellular device, and preferably indicates the position of the car for example according to GPS and/or for example according to the nearest cell positions in the cellular system. Another possible variation is that for example the car's system can automatically broadcast for example to parents if their son or daughter drive carelessly (for example too fast, or with too sharp turns and/or other indicators of dangerous driving which can preferably be automatically measured by the car itself). Although there are systems today where other drivers are asked to report this to the parents, it is much more preferable that the car's computerized system can report it directly by itself, preferably through the same cellular system that can be used also by the automatic alarm for example if the car is being stolen. In airplanes for example a similar system can preferably also sense for example if the plane has been hijacked, for example by sensing that the biometrics of the pilot indicate a different pilot (for example by automatic fingerprint readers in at least some of the controls which the pilot has to touch and/or for example automatic iris readers in the pilot's helmet) and/or sensing that unauthorized persons are in the cockpit (for example by sensing one or more people standing or sitting in a suspicious position for example for more than a limited period) and then for example the system can automatically send a wireless warning to various ground stations (and preferably also for example automatically open one or more microphones and/or video cameras which automatically broadcast what is going on in the cockpit and/or for example the microphones and/or video cameras normally broadcast the situation automatically every once in a while to one or more ground stations even when no special event is detected) and/or for example to security persons on the plane itself and/or for example the system can ask the pilot (preferably by a hidden method of for example displaying some digits which have a special meaning or for example flushing them. ,etc.) for identifying himself with a special code which only the legitimate pilot would know, and so for example if a hijacker is sitting in the seat instead of the pilot he would not know the correct response or even that he was asked to respond and if the pilot is still in the seat and the hijacker is standing next to him the hijacker preferably would not be able to see the signal (for example by using viewing angles which only the sitting pilot can see) or would not understand it and then the pilot can for example ignore it or enter a special code instead of his/her normal code that indicates that the plane has been hijacked and/or can convey other messages) and/or for example one or more controls in the cockpit can be used by the pilot to indicate various problems (which can preferably automatically activate for example automatic wireless warnings), for example by moving a lever into a special position which has no real mechanical function but is used in that position to activate automatic warnings, etc. In addition, in cockpits preferably the computerized system preferably has also means for automatically disabling hijackers, such as for example shooting tranquilizer arrows or needles (or for example electric shocker needles) at anyone who is standing at a certain height and/or who is standing next to the pilot for more than a certain time limit and/or who is standing at an unauthorized position (for example automatically or for example upon a hidden command from the pilot or for example upon hidden wireless command by ground control, preferably with high encryption that makes sure that only authorized commands will go through) and/or for example at the person in the pilot's seat (for example if the system has determined that the pilot is not legitimate) (and/or for example automatically electrically shocking the illegitimate person and the pilot's seat) and/or for example releasing a preferably odorless gas, preferably together with automatically activating an automatic pilot and/or for example activating a special mode which takes navigation commands from the secure wireless channel. In addition, preferably the cockpit is protected by a system of at least two preferably fortified preferably closed automatic doors, so that any person entering or leaving must first pass one door, then close it and then pass the other door. This is better then the prior art since in the prior art cockpits are either not protected by a fortified door or are protected by only a single fortified door, which is still not safe enough because a hijacker can for example run in when the door opens for the pilot to go to the toilet for example. If the passage near the cockpit is too small for adding normally the second fortified door then preferably one of the doors can be for example based on a rotating part-circle, or for example the two doors are connected with a foldable sleeve (for example like an accordion) which is pulled out only when someone has to pass through the two-door system.

Another possible improvement is for example improving the software in cellular phone networks and/or in the cellular phone itself so that for example the phone can preferably indicate to the user differently for example in cases of bad reception if the bad reception is on the side of the user or on the side of the other person with whom he/she is trying to talk. This is better than the prior art, in which the phone indicates when there is bad reception but does not indicate if it is caused by the side of the user or by the side of the other person. This information can be for example supplied to the phone by the cellular network and/or the phone itself can deduce it automatically for example from the quality of its connection with the cell in comparison to the quality of the connection with the other phone. Another possible variation is that for example the cellular phone can automatically indicate to the user the current level of radiation it is using, for example by some visual indication and/or for example by some auditory indication, especially for example if the radiation becomes higher than a certain limit. Preferably the user himself/herself can manually set the threshold. Another possible variation is that for example when there is a bad reception and the user for example prefers to talk later when the reception improves, preferably the user can tell the phone for example to indicate to him/her automatically when the reception improves (which can be done for example by a special ring). In this case, preferably the indication can be for example different according to the source of the bad reception, so if the source was the user's own phone then preferably the phone simply indicates when the connection with the cell becomes better, and if it was the other phone then preferably the cellular system automatically informs the user's phone when the reception is better, preferably according to the information it receives from the cells near the other phone.

Another possible variation is to create for example a smart computerized (wheeled) shopping cart for supermarkets, or for example a hand held gadget, for example for DVD libraries or book libraries in which for example items that can be bought or loaned preferably each has an RFID which can respond to queries from the gadget or from the shopping card, and so for example the user can type or speak the name of a desired item and the cart or gadget preferably shows for example on some small screen the list of items that fit the query, and if the user clicks on one of them preferably the cart or gadget can for example show its position according to its own database (which is preferably updated for example preferably at least daily for example by communication with the store's main computer) and/or can for example locate items, at least when they are not in the expected place, for example by sending RFID queries to them and using preferably more than one sensor in order to triangulate their position.

Another possible variation is to create for example preferably computerized smarter water disposal systems in homes, so that for example if the user wants to user “grey water” (i.e. for example water from the shower) for example to water the garden, preferably the water goes through one or more sensors which can preferably (for example by visual and/or spectroscopic analysis and/or other preferably cheap and preferably instant on-the-fly means) find out for example if the water contains soap or is sufficiently clear, and thus can for example automatically toggle a valve which dispenses the water for example either to the sewer system or to the garden. This can be very useful since for example when people take a shower it is undesirable that the soap reach the garden (which might even create the danger of polluting deep underground water reserves), but for example perhaps in 90% or more of the shower time the soap has already been washed away so the water is relatively clear, and thus this clear water can preferably be safely identified and used this way. Preferably this system lets the water pass through a temporary buffer in order to create some delay for deciding about the clarity of the water, however this may be unnecessary since for example decision according to visual analysis can be more or less instantaneous. Of course this can also be used for example in combination with one or more filters. Another possible variation is to use for example a smart computerized toilet water stream controller which for example uses a still and/or video camera (such as for example a preferably cheap preferably wide-angle view web-cam) to view the toilet seat's internal walls and for example automatically directs the stream mainly towards the dirty area or areas (for example by controlling a rotate-able faucet head which sprays the water (another possible variation is for example, in addition or instead, to add for example a rotate-able manual control, for example to the button that activates the toilet washing stream, so that the button is for example at the end of a rotate-able handle and the user can for example rotate the handle to control the main direction of the stream. However, it is much more convenient to have it computer-controlled since this may enable better cleaning even for example with a smaller amount of water, thus saving also ecologically.

Another possible variation is to create for example a smarter refrigerator which for example uses a computerized system and/or smart sensor or sensors which can for example warn the user automatically, preferably by auditory and/or visual cues, if it has been left open for example for more than a minute (or other reasonable time period, preferable changeable by the user) or for example is not closed well (for example by sensing a gap of more than a minimal threshold distance between the door and the side which the door has to attach to when closed (this sensor or sensors can be for example optical ad/or mechanical and/or electromagnetic and/or for example based on induction. Another possible variation is that the refrigerator can also for example inform the user about this for example through a smart home network, for example directly to his/her computer, or for example send the user an automatic phone call or SMS, for example if the user is out of the house. Similar warnings can be attached also to other devices, such as for example detecting gas leakage if the user forgot the gas open. This is preferably done by gas flow detectors for example in the home gas supply (preferable for each of the turnable gas faucets, preferably together with heat and/or light detectors which can detect for example if a fire is burning on the open gas faucet or not and/or for example smell detectors which can detect the smell of gas.

Another problem is that for example in laptops typically the hard disk is significantly slower than in non-mobile computers, in order to save power and extend the number of hours until the batteries run out of power, which causes many programs to load considerably more slowly and to work slower when saving or reading files. However this creates the absurd situation that even though the laptop might be used most of the time on a desk, connected to the wall electricity outlet, the disk still works at the low speed all the time. So this is preferably solved by using a variable-speed hard disk which can automatically work significantly faster when the laptop is connected to the network electricity. So preferably the computer and/or the OS and/or the disk itself can automatically increase or decrease the speed of the hard disk according to sensing if the computer is currently connected to the network electricity or is currently running on the batteries. In addition, preferably the user can also for example press some button or request the OS to increase temporarily the disk's speed to the fast mode even when not connected to the external electricity (for example if the user needs something done fast, and then preferably the disk for example automatically reverts back to the slow speed for example after 5 or 10 minutes or any other convenient time, and/or for example according to the amount of power left and/or the current processes running, such as for example until one or more specific tasks finish). Similarly, preferably when the portable computer is connected to the wall preferably the hardware and/or the OS can also for example automatically increase the speed of the CPU so that it consumes more power and works faster (and/or the user can for example request it explicitly for example at least for a short time even when the portable is not connected to the electrical outlet) and/or for example automatically (and/or by temporary user request) increase the brightness of the screen, and/or for example increase the speed and/or power consumption of other elements. In case the user requests the increase in disk speed and/or the other increases in power consumption explicitly while the computer is working on batteries, preferably the system resorts automatically to normal power consumption for example after a specific task is completed and/or for example after a certain time period (which can be for example set automatically or by the user). However, there is a problem that if the disk's engine is optimized to work efficiently when the power is on, it might work considerably inefficiently when running on the batteries, and if it optimized to run at high efficiency when running on the batteries it will not run efficiently when running for example in double speed when connected to the wall, thus increasing even further the heat dispersion problem in the laptop. In order to solve this, preferably the disk has at least two sets of engines or at least two sets of coils, which are used for example at different combinations in order to work efficiently in the low speed or in the fast speed (or other speeds if more than two speeds are available). In addition, preferably the disk's DSP automatically starts working for example at higher MHz when the wall power is sensed and/or for example more than one DSP can be used in order to speed up the processing. Another possible variation is using for example a disk with more heads on the same arm (which is typically moved in rotational movement part of a circle from the side, in a way similar to a phonograph's needle, typically by a voice coil), so that for example less movement is sufficient to cover the entire range. Although this means also having to move more mass, the arm is typically much more massive then its tip with the head, so adding one or more additional heads that point for example sideways, as shown in FIG. 5a below, will not change much. Another possible variation is adding also for example additional heads, so that for example there are more heads at the length of the arm, however that could create a linearity problem. Other possible improvements that should enable faster disks with very little energy increase or even a reduction in energy consumption are shown in FIG. 5b-c. Another possible variation is to use for example instead of moving heads some elongated multi-head structure which does not have to move at all, so that preferably the point of reading is chosen electronically, for example by varying the position of some crossing point electronically. (Such a solution of course could make also normal hard disks work considerably faster). Another possible variation is to use even more than two speeds or modes. Another possible variation is that for example the user can choose in advance when buying the laptop if he/she prefers to get the laptop with a faster speed hard disk (for example a double-speed hard disk that will cause the battery power to run out for example after 2 hours), or a slow speed typical laptop hard disk which is for example twice slower but allows the battery with average usage to last for example for 3 hours). The heat dissipation problem with the faster disk is preferably solved for example by activating automatically for example an additional fan when the disk works at the higher speed, and/or adding for example additional heat conductors between the internals of the laptop to its outer shell. Of course, various combinations of the above and other variations can also be used. Of course, like other features of this invention, these features can be used also independently of any other features of this invention.

Another problem is that in computer cases that have a dust filter, the user has no indication when the filter becomes clogged, except when the situation reaches the point that for example the CPU reaches a temperature that activates an alarm for example by the temperature monitor. So preferably this is improved so that for example a sensor (or sensors) on or near the filter can automatically sense how covered with dust the filter already is (for example by measuring electrical resistance and/or for example air flow and/or other parameters), and then can preferably automatically warn the user (for example by activating an application which displays for example a visual and/or auditory warning) when the filter is too clogged and needs cleaning—before the CPU becomes to hot. Another possible variation is that for example when the sensor indicates a certain level of blockage of the filter (and/or even for example on a regular basis even without the sensor) the system can preferably automatically clean the filter, for example by moving one or more brushes or other moving elements (which can also be for example charged with static electricity) for example sideways over the side on which the dust collects and for example pushing the dust for example to a cavity in the sides and/or in the bottom which can collect the dust so that it does not obstruct the air flow. In this case preferably there is an additional sensor (or sensors) which notifies the user when this additional cavity (or cavities) become too full and need to be emptied. Similar solutions can be used also for other devices that have air filters, such as for example clothes driers.

Another issue that has to do with the reliability issue is the fact that when people use Windows for example from an Internet Cafe, many times they forget to close down open connections and/or at least they leave behind traces such as for example various cookie files, temporary files, history logs, etc. There have already been cases that users who subsequently used the same computer misused this for example to send a false suicide note or to send a false kidnapping message, etc. Although some web based email sites, such as for example Hotmail and Yahoo, allow the user to mark when he/she is using a public computer, this relies on the user marking it and is anyway just a limited solution. Therefore, preferably the OS itself, preferably during installation, enables the administrator to specify that this is a public-use computer, and preferably this setting can be changed only for example with the original installation disk and/or with a password. Preferably when defined as a public computer, the OS itself indicates this in outgoing electronic communications such as for example emails, for example by adding this info at the socket layer, and preferably any session-related traces are automatically removed by the system for example after a short time of inactivity and/or if the user does not re-enter a password chosen by the original person that started the session, or for example such traces are not saved at all. Another possible variation is that in addition, for example the OS allows the user to send additional email messages from the same session only if he know the password entered or chosen by the user when he/she started the session, etc.

### BRIEF DESCRIPTION OF THE DRAWINGS

FIG. 1 is a flow chart of a preferable way the Instant Reset and Instant boot are implemented.

FIG. 2 is an illustration of a preferable example of using a separate area with separate heads on the disk or other non-volatile memory for running a hardware supported rollback feature.

FIG. 3 is an illustration of a preferable example of using a separate area with separate heads on the disk or other non-volatile memory for running one or more hardware supported FAT areas.

FIG. 4 is an example of one of the best MIDI search engine's results (prior art).

FIGS. 5a-c are illustrations of a few preferable configurations that can considerably increase the speed of the hard disk, and preferably also reduce its power consumption.

FIG. 6 is an example of multiple checkboxes that can be marked or unmarked by the user.

FIG. 7 is an illustration of an improved computer case in which at least the area that supports the external CD and/or DVD drives is preferably rotate-able between two positions, so that the same case can be used either as a desktop case or as a tower case.

### IMPORTANT CLARIFICATION AND GLOSSARY

All these drawings are just exemplary drawings. They should not be interpreted as literal positioning, shapes, angles, or sizes of the various elements. Throughout the patent whenever variations or various solutions or improvements are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Eventhough the preferred embodiments use mainly the terminology of Microsoft Windows, which is the most common and familiar operating system, the current invention can be used also in other operating systems, such as for example Linux, Macintosh, or other operating systems, even if they use different terminologies or different implementations of various features. “OS” as used throughout the patent, including the claims, means Operating System. FAT is short for File Allocation Table. However, as used throughout the patent, including the claims, FAT can mean also any other central data structure related to file allocation or management. “Scandisk” is the typical software used in Microsoft Windows to scan the disk. On normal runs it is used mainly to find inconsistencies between actual file sizes and the sizes reported in the FAT, but it can be used also for example for thorough scan to check for bad sectors, etc. As used throughout the patent, including the claims, “Scandisk” means either Scandisk, or any other similar software for checking the Integrity of the files or directory structures. “Image”, as used throughout the patent, including the claims, means a non-volatile memory Image of the OS state and preferably also loaded programs, loaded drivers, memory status, status of peripheral devices, and/or any other data that is needed for creating a sufficient snapshot of the computer's condition, so that the computer can be instantly restored to that state and operate properly by restoring or using the data from said Image. Throughout the patent, including the claims, whenever “disk” or “disks” is mentioned, it can be either a hard disk or hard disks, or any other type of fast access not-volatile memory, such as for example MRAM (Magnetic RAM), 3d Nano-memory chips, etc., and whenever heads are mentioned, it can be either read/write heads of disks, or any access mechanism for areas in other types of non-volatile memory, including when such access means do not require actual physical movement by a mechanical element. “Preview images” or “Preview windows” refer to small images of actual windows which are used to help the user choose the correct window for example from the task bar or from a group of tab handles (this can show for example simply a reduced image of the window and/or for example certain more important features of it which can help differentiate between it and the other windows or tabs, and may include for example even streaming data or movement, such as for example a reduced image of a playing video). Throughout the application, including the claims, whenever is says for example that the OS and/or for example the security system can do something, it can be done of course also for example by some other application and/or driver. Group icon refers to the square button on the typically bottom taskbar which represents a group of open windows of the same application (or otherwise defined category).

### DETAILED DESCRIPTION OF THE PREFERRED EMBODIMENTS

All of descriptions in this and other sections are intended to be illustrative examples and not limiting.

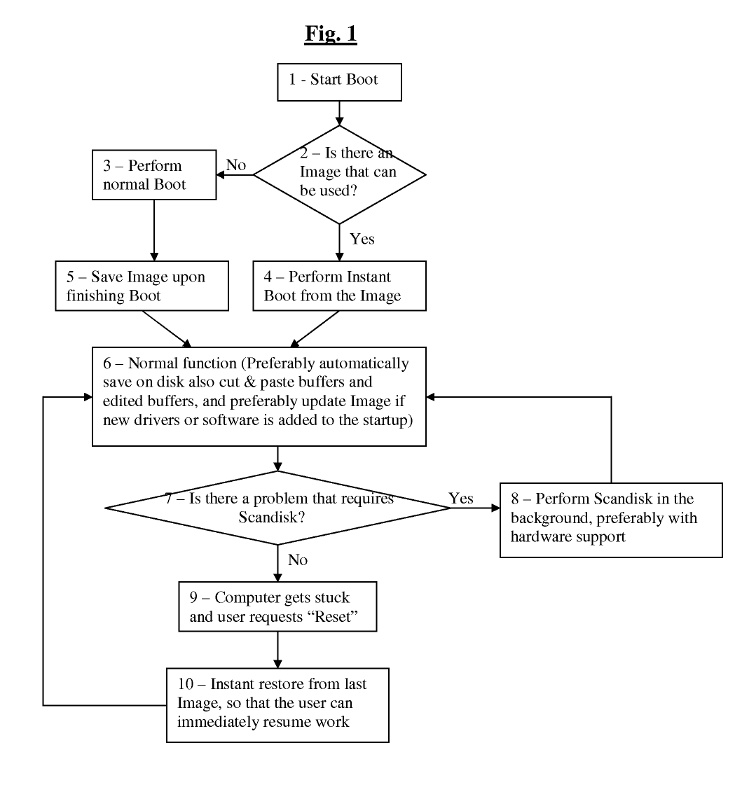

Referring to FIG. 1, I show a flow chart of a preferable way the Instant Reset and Instant boot are implemented. When a boot sequence starts (1), preferably the system checks if there is an Image that can be used for instant boot (2), and, if so, performs instant boot by loading the Image into memory (4), otherwise it performs normal boot (3) and preferably saves the OS Image upon finishing the boot. The OS Image preferably contains also all needed info about loaded drivers and/or other loaded software and preferably also for example about the state of peripheral devices, and/or any other data that is needed for creating a sufficient snapshot of the computer's condition, so that the computer can be instantly restored to that state and operate properly by restoring or using the data from said Image.

Regarding the state of the peripheral devices and resetting them, it can be handled for example in at least one of the following ways:
1. Preferably peripheral devices can be preferably instantly reset to their original status as it would exist after a normal boot, preferably for example by improving the standard protocol of drivers so that preferably each driver and device has a function for instant reset. Another possible variation is that preferably each device driver can preferably instantly query the device to see if it is in a proper state or needs to be reset.
2. Preferably the system constantly updates some area in non-volatile memory or for example some buffer or stack with the current state of the devices, so that it can be preferably instantly determined if any of the devices was involved for example in a crash or needs reset.
3. Preferably at least one or more of the devices can be kept in its current state if the user so desires instead of resetting, so that for example if the user was in the middle of an Internet connection, the user can for example remain connected without having to reset the modem or Ethernet card and reconnect. Preferably during or after the reset the system asks the user if he wants various devices to remain in their previous states or for example it is defined as default before any reset is needed and the user can change it, and during the reset the system decides what do to with such devices according to the last given instructions. As in clause 2 above, preferably this is done by automatically saving the current state of the devices in a buffer or stack.
4. If any tests or resets are still needed in one or more devices which cannot be done instantly, preferably the system can automatically decide which devices are not critical and can therefore be dealt with in the background after the user can already start working, in a way similar to postponing the disks scan, so that for example if it takes some time to check a CD device, preferably this is done after the user can already start working, since the user typically will not need to access the CD immediately. This option can be preferably used also in normal boots or instant boots or when restoring from hibernate.
5. Preferably when a Reset or an instant boot is performed, the image is first reloaded into memory including all the drivers as if they have already checked and/or reset the relevant devices, and THEN the drivers are instructed to activate the instant actual reset on the actual devices, so that the state of the device conforms to the state that the driver is supposed to represent.
6. Preferably the data on the status of any peripheral devices that can be saved in the image includes also any plug and play data for such devices and/or for any other card or relevant elements in the computer, so that preferably no plug and play automatic tests are normally needed during booting. Preferably at least during any boot or reset that is not based on turning off and turning on again the computer (cold boot) there is no need for any plug and play check for example at least of installed cards since the devices and cards that are coupled to the mainboard do not change, so preferably the system can automatically identify if it is being reset or rebooted without a cold boot, and if so, it preferably simply uses automatically the plug-and-play solution or configuration that was used last time as saved in the image. However the user might for example remove the keyboard or the mouse or a printer cable even without turning off the computer, so preferably the system checks if such devices have changed. Another possible variation is that even if a cold-boot is done, preferably the system can check instantly if the configuration of devices and/or cards and/or other relevant elements has changed or is the same as the last image, and thus avoid for example any unnecessary plug-and-play checks and instantly choose the configuration used last time, preferably as saved in the image, if the configuration has not changed.

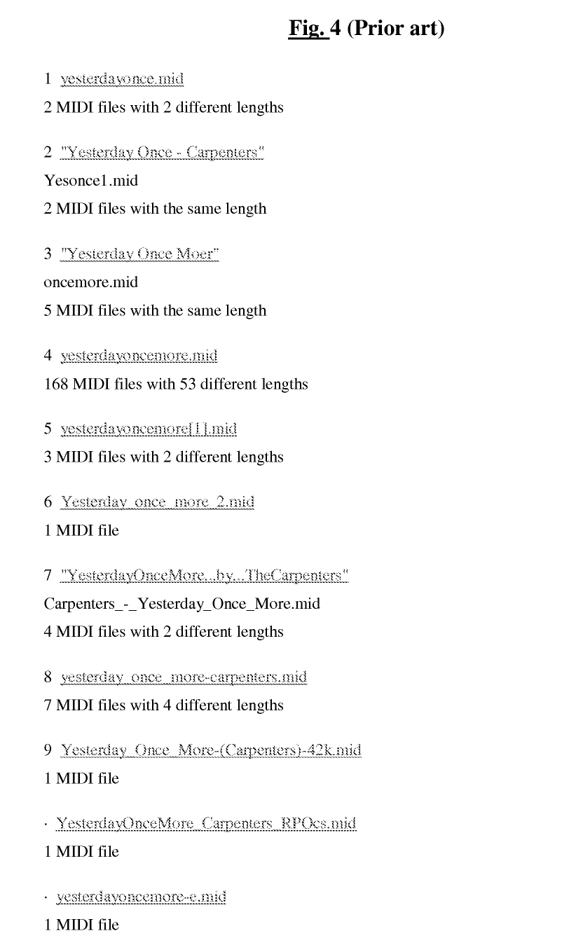

The Image is preferably saved on the disk or other non-volatile memory with at least some preferably fast compression that allows faster transfer of the data to and from the disk. The system then preferably allows the user to start working immediately (6), and preferably immediately afterwards checks if there is a problem that requires Scandisk (7). If there is such a problem, then preferably Scandisk is performed at the background without interrupting the user's work (8), preferably with hardware support that enables it to finish even much faster, as explained in the reference to FIG. 3. Preferably the system allows a “Reset” function, which means that whenever the system gets stuck (9), preferably the user is able to press some special button or some key or keys on the keyboard in a way that causes the computer's memory to instantly Reset from the saved Image, without a need to go through a boot sequence at all (10). The special button or key is preferably sensed either by hardware or by some process which preferably runs below the Operating system and thus is not affected even when the system becomes stuck. After activating the Reset (10), preferably the system again checks if there is a problem that requires Scandisk (7), and, if so, preferably performs it again in the background as explained above (8). In addition, during normal operation, preferably any cut & paste buffers are automatically saved also on the disk or other non-volatile memory, so that they can be immediately available on the next boot or after the next Reset. Similarly, preferably any currently edited files or windows are preferably automatically saved on the disk or other non-volatile memory preferably after sufficient minimal changes have accumulated (such as for example after at least 10 new characters have been added or changed) or every short while (for example every 30 seconds), so that they can be immediately available on the next boot or after the next Reset. Although something like this exists for example in Word, it is not available in many other programs, so preferably this is ensured by the OS itself. Preferably the System allows also “undo” in case the “Reset” button or command was pressed by accident, for example by saving an additional Image of the OS and of open windows/applications before restoring the boot Image. Of course, preferably any of the above principles or variations can be used also during recovery from hibernate and/or during any boot or instant boot, such as for example the instant boot described by IBM, since in these processes too reducing any waste of time on dealing with the peripheral devices and/or any waste of time for scandisk, can allow the user to be able to start working much sooner. However, there is of course a difference between instant boot or reset and restoring from hibernate, since in the instant boot or reset the drivers have to typically be reset to the initial state after boot, whereas when restoring from hibernate they have to typically be restored to their exact state at the time of requesting the hibernate. Another possible variation is that for example when restoring from hibernate or from Reset, the system can also automatically for example continue printing from the point it stopped, for example by saving the relevant information about the process of printing and preferably being able to query the printer exactly where it stopped for example in terms of characters and/or in terms of printed pages. Another possible variation is that the user can define or save for example the normal task bar itself or parts of it, so that for example upon any boot by default some Dos window will be open at a certain directory or for example Word will be open with a certain file, until changed by the user and/or for example the internet connection will be automatically activated and some browser windows will automatically open at certain sites. Another possible variation is that the user can for example define group-icons, which means that a single icon can connect a number of icons so that when the user clicks on the group icon a number of applications will open automatically, with or without restoring also for example their exact arrangement on the desktop. This way for example if some users are used to work with Word on the left side of the screen and some excel table on the right side, then clicking on the group icon or saving this as boot default will automatically open the two or more applications in the correct configuration. Another possible variation is that preferably the last sleep mode that was used is by default not erased and the user is offered for example upon normal reboot as one of the options the possibility to return as if from the last sleep mode, except that some programs that were running then will not be restored (since if it is a normal reboot then these processed have already been closed). For this preferably the OS can for example automatically add to the last sleep mode data for example upon normal shutting down and/or when specific processes have ended, the information that these processes are no longer relevant. Of course, various combinations of the above and other variations can also be used.

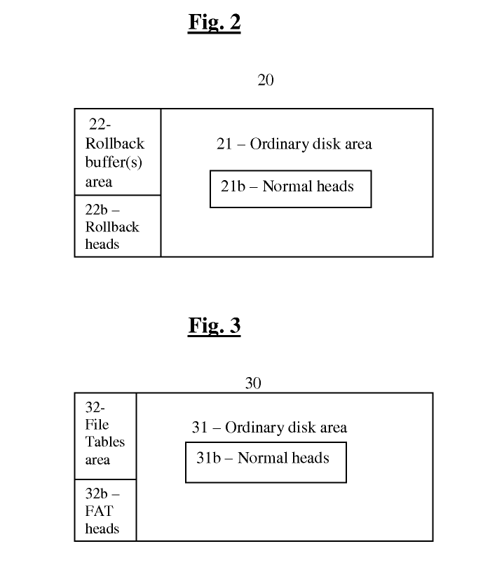

Referring to FIG. 2, I show a preferable variation where for example any changes at all that happen for example on the hard disk or other non-volatile preferably fast-access memory (20) (and possibly even on other connected writeable media, such as for example CD or DVD or other backup media) at any time are completely undo-able at least for a certain time period (or as long as there is sufficient room to save the info needed for the undo), in a way similar for example to the undo feature in a single Word document. If this is implemented also for example for other connected media, the rollback areas for them can be for example on those media and/or for example on a separate rollback area or areas or on part of the normal rollback area within the disk (or other fast non-volatile memory). This is preferably accomplished by keeping one or more rollback logs, preferably backed up by appropriate hardware on the disk. The rollback can be enabled for example by creating a backup of each changed file or directory in another area at least for a certain time period or until for example the backup buffer becomes full and older backups have to be deleted automatically. Another possible variation, which saves much more space, is for example to keep a rollback log of all changes for example of directories, files, FAT areas, and/or any other data (such as for example even any low-level changes in disk tracks), so that any changes that were made on the storage media can be rolled back by simply tracing back the log of changes (this way only the changes have to be saved). Preferably this log or rollback buffer or buffers are encrypted and are highly guarded and/or are kept also in more than one place, in order to reduce the chance of its destruction by mistake or by some malicious software. This way even if the user has made a horrible mistake and the entire system has been compromised, even the worst damage can preferably still be automatically undone. Preferably the Operating System or a special Security System constantly guards itself and its files and preferably also these logs from any unauthorized changes. Another possible variation is that even commands such as for example format or re-partition or even low-level format are not able to destroy the rollback areas, so that for example at least a certain percent of the disk or other non-volatile memory is always reserved for the rollback info. Preferably the rollback logs or buffers or at least the most recent changes in them are always backed up in at least two or more separate places and/or also protected by additional encryption and/or redundancy data, so that damages can be fixed. Another possible variation is that the rollback feature is supported also by hardware, for example by a special area in the CPU or on the hard disk interface card, so that it is always available for example from a special ROM even if for example the system has been booted from another device, such as for example a diskette or CD or network drive. If it is an inherent part of the hard disk, this has the additional advantage that preferably at least part of the overhead of keeping the rollback files is run by special hardware for example on the hard disk's interface card, so that it does not burden the system or slow down disk operations. This can be done for example by keeping one or more additional read/write heads (22b) constantly near a special area of the disk (22) that is used for the rollback logs, so that accessing it for every disk change causes no additional access or seek activity of the normal read/write heads. Such an implementation can be also more secure since access to the rollback area can be limited for example on a hardware level, so that for example only an explicit command by the user entered directly by the user to the operating system through a direct command can restore changes from the rollback, so no malicious program can for example activate the command. Preferably when the user requests to restore things from the rollback, the following part of the rollback buffer is still kept, so that the user can for example also redo the “undo” by simply moving again forward on the rollback log, thus reinserting the cancelled changes. Preferably new changes to the rollback from that point on are kept on a separate part or buffer or branch, so that making additional changes from that point on will not overwrite the original “forward” part of the rollback, otherwise even changing one character after the undo can destroy the possibility of undoing the undo and returning to the original situation before the undo. (This is unlike for example the undo feature in Word, where undoing something and then adding new changes destroys the ability to go back to the situation before the undo). Preferably when going again forwards the user is shown the various branches that exist and can choose the appropriate one. Another possible variation is to apply this taking into account of branching also for example when the user moves backwards and forwards for example with web browsers, so that for example if the user chooses a different link after going back to a previous page and then for example goes back again, preferably the browser automatically displays the different paths available if the user moves forward again (for example in the form of branching chart). Another possible variation is to add such features also for example to word processing programs, such as for example Word, so that there too the user can choose which Redo he wants if there are a number of possible branches to choose from. Another possible variation is to add to word processing programs such as for example Word also an option that if the user for example types something by mistake while “overwrite” is pressed when he/she actually intended to use normal insert mode (which can happen quite often) preferably the overwritten part is always saved automatically for example in some buffer and preferably the user can press some button (or for example a combination of two buttons) which instantly restores the lost text as if the mode had been “insert” instead of “overwrite” (this can be called for example “retroactively changing mode”), instead of having to use cut or copy to save the new part, than use undo, and then use paste again. Another possible variation is that the user can for example chose some menu options or type some control which locks the Insert mode and thus prevents the user from moving by mistake into the overlay mode (which happens many times if the user for example wants to press the Del button but instead presses by mistake the Ins button), since most users almost never need to use the Overwrite (OVR) mode. Preferably the Undo in word processors such as for example Word is also improved so that even deleting the entire contents of the file and saving it is undoable. This is very important since in the prior art for example if the user by mistake presses “ˆa” (which stands for “mark all the text”) instead of “ˆs” (save) and then presses backspace to delete one or more characters and then for example presses “ˆs” again, the entire contents of the file can be erased and then saved like this, and then the undo does not work, so the entire file can become lost. Another possible variation is that for example when using cut & paste if the user for example presses by mistake again “ˆC” (copy) instead of ˆv (paste) (for example over the section that was supposed to be written over)(which happens many times since these are adjacent keys on the keyboard), the new copied text normally overwrites the previous one in the copy buffer. So preferably the user can press some undo key which brings back the previous copy buffer. This can be easily implemented for example by saving the copy buffers automatically in some stack. Another possible variation is that the user can for example automatically mark text or all the text within frames in the drawings (for example by a special control key, like ˆA, except that in the prior art ˆA effects only normal text outside the drawings) and/or for example the normal ˆA is improved to mark also he text within the frames in the drawings and then make for example global changes on these texts, such as for example absolute or relative enlarging or reduction, changing of font or color, etc. Similarly preferably the normal search within the documents is preferably improved to take into account automatically also for example the text in the frames within the drawings.m,

Since the area assigned for keeping the rollback logs is necessarily limited, preferably the rollback file or files use one or more circular buffers, so when it is full the oldest changes logged are deleted by overwriting them with the new data, and pointers to the logical beginning and end of each circular buffer are updated accordingly. If the rollback is hardware based, another possible variation is that since it can preferably work even below the operating system level, the rollback is based for example on low-level hard disk data, such as for example simply recording all changes in disk tracks or sectors, etc., so that it is independent of any file formats used by the operating system. However, this can be problematic since hard disks today typically have for example auto-moving of bad tracks to a hidden pool of “spare” tracks, so this is preferably taken into consideration. Another possible variation is that the lower level hardware is also aware of upper formats. The variations of using special hardware for example in the hard disk itself are more preferable since this is safer and faster, and can be also immune to changes done while the computer was booted from another source, unless for example a malicious software booted from another source makes on purpose so many changes that the rollback logs become overwritten. In order to prevent this, one possible variation is that for example if the hard disk senses that the boot was not made from it, it will block all further changes for example after the log file becomes too full (for example counting the cumulative amount of changes since the boot), and request the user to boot from the hard disk. Another possible variation is for example some combination between the OS and the hardware support, so that for example there are two types of low-level write commands, one with rollback enabled (for example called RWrite, for Rollback enabled Write, or for example called SafeWrite) and one without, so that for example the operating system decides to use the safe (rollback enabled) write automatically for example when allowing changes in highly strategic directories and/or files, such as for example system files, “.doc” files and program source files. Another possible variation is that for example the Operating System or the computer's security system decide when to use the rollback enabled write and when the normal write, and for example takes care that normal files or directories are changed with the safe write, but for example swap files and other temporary files are changed with the normal write, in order to avoid burdening the rollback buffer with unimportant changes. This is less safe than the variation where every change is logged on the rollback files but has the advantage that the rollback buffer is reserved for more important changes, so they can be kept for a longer time than if also less important changes are kept on the logs. Another possible variation is that for example normal programs can also choose to use it depending on the importance of the files. However, a malicious program might for example try to create on purpose so many changes as to fill the rollback circular buffer and make it lose more real changes. Therefore, such behavior is preferably intercepted by the Operating System or a special Security system as a highly suspicious behavior (for example by identifying programs which keep rewriting the same files again and again apparently for no reason, or other suspicious or unusual behaviors). Therefore, preferably for example only the security system and/or the operating system can have access to the saving or restoring from the rollback buffer. However, if every change in the disk is automatically saved in the rollback buffer, then still a malicious program might create endless changes on purpose, so preferably it is intercepted preferably after a short time as highly suspicious behavior. Another possible variation is that for example each program or each installation directory has by default only up to a certain percent of the rollback areas allocate to it, so that it cannot take up too much of the rollback resources unless given explicit permission by the user (in this case preferably each has its own rollback circular buffer). However, a hardware based general rollback feature also can have a serious drawback that changes for example in one important file can only be undone by undoing changes in the entire disk, so for example to fix a damage that was caused to that file two months ago the user would have to undo changes of two months in the entire disk, restore the file, and then restore back the last two months on the entire disks—a very dangerous activity if anything goes wrong during the process for some reason. Therefore, a more preferable variation is that the hardware supported rollback or undo can be used also for each file separately or directory, for example by saving a separate rollback buffer or entry for each file, or for example each log entry contains also the name and full path of the relevant file (passed to it for example as a parameter during the write operation), so that the user can choose for example if to use an “undo” on the entire disk or only on a specific file or directory or group of files or group of directories or for example a specific partition. Preferably this path info changes only when the changes start referring to a separate file, so as long as the changes are in one file, no overhead of repeating the path is needed. Another possible variation is that for example the Security system and/or the operating system use the rollback log automatically for backing up any changes in highly strategic directories and/or files without hardware support. Of course, similar principles can be used also in other types of non-volatile memory that exist or will exist in the future, so that for example if some MRAM (Magnetic RAM) or 3D memory chips are used, preferably the rollback area or areas have independent access control for fast access without slowing down the normal access the actual data areas. These rollback features can be used also independently of any other features of this invention. Of course, various combinations of the above and other variations can also be used.

Referring to FIG. 3, I show an illustration of a preferable example of using a separate area or areas (32) with separate read-write heads (32b) on the disk (or other non-volatile memory)(30) for running one or more hardware supported FAT (File Allocation Table) areas. Preferably, during or after a fast-boot or a Reset that uses the memory Image (and/or even during or after a normal boot), if the FAT of the disks needs to be checked, preferably it is done in the background, after the user can already start working, since waiting for scandisk to finish can take several minutes and can be very aggravating to most users. Preferably the Scandisk (disk canning software) or similar software is backed up by special Hard-disk hardware, in a way similar to the hardware that supports automatic disk rollback, described in the reference to FIG. 2. Preferably this is done by using hard-disks wherein a special area or areas (32) is dedicated for FAT information, and preferably independent head or heads (32b) are used for read and write in those areas. Another problem with scandisk is that for example in Windows 98 scanning the drive where the OS is installed (typically drive C:) can take a long time, since many background operations can cause the scan to restart. So preferably even if there are problematic background changes at the time of the scan, preferably the system automatically keeps track of its recent scanning activity and thus preferably can jump back and forth temporarily if needed but does not need to restart the scan after such changes. This has the further advantage that also with normal disk activity any reading or writing of files can become faster even if they are fragmented, since less movements of the heads are needed to access the FAT area each time some jump is needed. Since each disk can have more than one partition, preferably the FAT areas of all partitions are kept in the same special area or areas (32). Preferably these areas are also guarded better in terms of security, so that for example any write-access to them is monitored more closely. Of course, various combinations of the above and other variations can also be used, such as for example various combinations of features of FIG. 2 with features FIG. 3, so that for example both separate FAT area or areas with special access and other separate Rollback area or areas with special access are used, or for example the same special area or areas are used for both the rollback and the FAT. Another possible variation is that the disks or other non-volatile memory contain also one or more processors that can themselves conduct the comparison between the files and the FAT, so that it can be done in the background even with little or no consuming of CPU resources from the computer itself. Of course, similar principles can be used also in other types of non-volatile memory that exist or will exist in the future, so that for example if some MRAM (Magnetic RAM) or 3D memory chips are used, preferably the FAT area or areas have independent access such as for example independent communication channel and/or processor for fast access without slowing down the normal access the actual data areas. Similar principles can be used for example to speed up writing and/or reading for example on CDs, DVDs, and writeable or rewriteable CDs or DVDs (for example by using two or more separate laser beams—one or more for the normal data and one or more for a FAT or similar area), since jumping back and forth between the FAT area and the normal data areas is one of the things that most slow down such devices for example when copying a large number of files to them. Of course, these features can be used also independently of any other features of this invention. Of course, various combinations of the above and other variations can also be used.

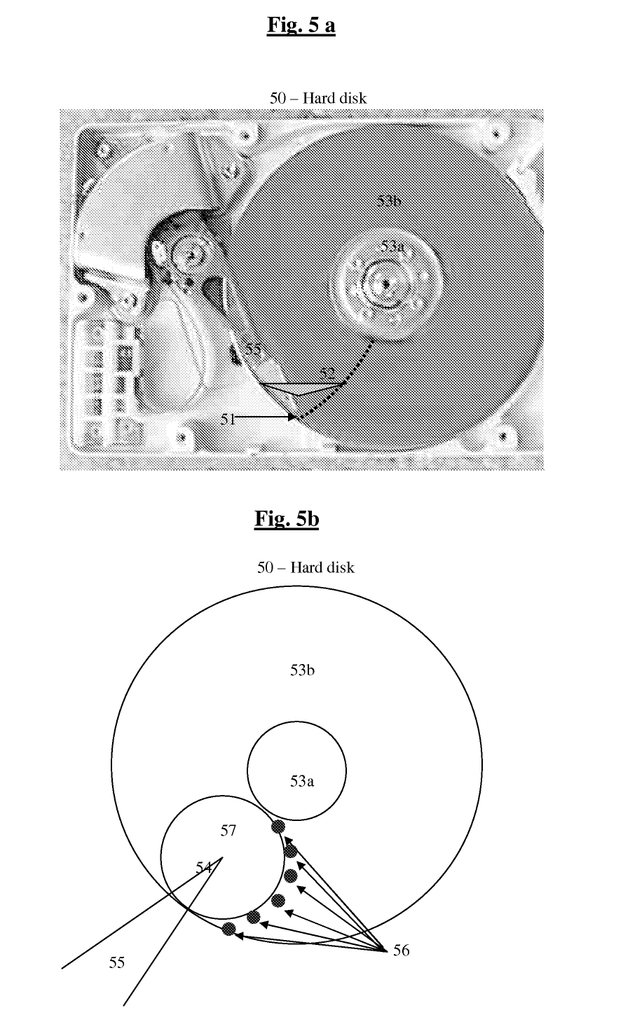

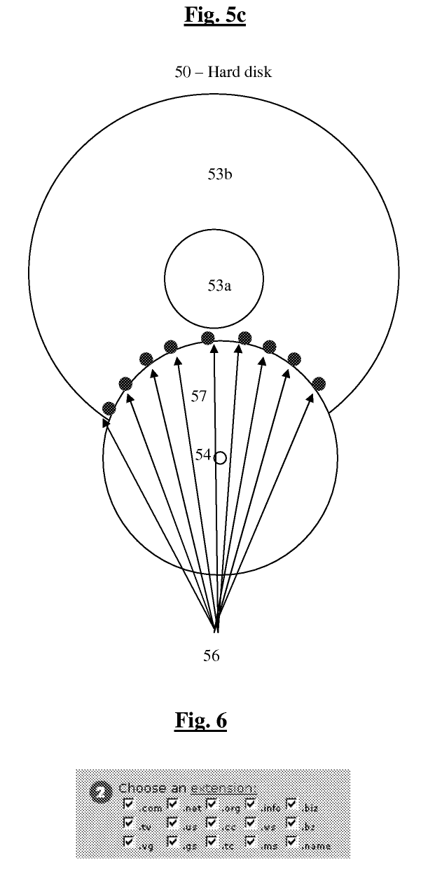

Referring to FIGS. 5a-c I show illustrations of a few preferable configurations that can considerably increase the speed of the hard disk and/or reduce its power consumption. FIG. 5 a shows a hard disk (50) with one of the rotating plates (53a) and its central hub (53b). As can be seen, the arm (55) that contains the read-write head (51) rotates part of a circle (along the dotted arc) in order to reach any desired track in the disk. Typically there are multiple such plates, and the arms go also between them, so that typically each arm can read/write the relevant sides of both the plate that is above it and the plate that is below it. (Typically all the arms move together between the plates, thus reading and writing the same tracks on multiple plates at the same time, however making for example one or more of these arms independent from the group can supply for example the desired independent heads for the independent rollback area and/or independent FAT area that were discussed above). By adding for example a preferably small fork with an additional head (52) the arm now only needs to move half of the way in order to reach any desired track, so that for example head 52 can take care of all the inner tracks and for example head 51 can take care of all the outer tracks. Since the arm itself is much more massive than the heads, this addition should not cause a significant addition to the total mass of the arm. An additional improvement in this variation is that preferably both heads can now read and write at the same time, thus doubling also the speed of data transfer. Of course, this is just an example and for example more than one additional head can be added in a similar way to each arm, so that for example there are a number of such forks (for example all at one side, or more preferably at both sides of the arm, to keep the balance, so that head 51 becomes in the middle. (Like head 51, the added head 52 is preferably actually two heads, one for reading the appropriate side of the plate that is below it and one for reading the appropriate side of the plate that is above it, and as explained above this is preferably repeated for all the plates). FIG. 5b shows a similar solution, except that the arm (55) is now stationary, preferably reaching the middle track, and preferably at its tip (54) is connected an additional preferably thin rotating plate (57) which contains preferably multiple read-write heads (56). This plate is preferably rotated by a flat step engine or voice coil, and its mass is now preferably much smaller and also the amount of rotation needed is much smaller (for example only ⅙ or the original arc, if there are now for example 6, preferably double sided, read/write heads). And like in FIG. 5a, preferably each head covers only its own range of tracks and all heads can preferably work simultaneously, so that preferably when the data is written it is also spread between the tracks accordingly, thus increasing the read/write transfer rate by a factor of 6, in this example. (Of course 6 heads is just an example and any other convenient number can also be used). The smaller mass of plate 57 and the much smaller range of rotation that is needed can thus also reduce considerably the power consumption and thus can be especially fit for example also for hard disks in laptops (mobile computers). However, using such a round small plate has a problem that the movement of the heads in relation to the disk is not linear, so that for example the heads that are near the innermost track and near the outermost track move much less than the middle heads, thus creating a large difference in the thickness of the corresponding tracks. Therefore, instead of a round small plate preferably the heads are on a special shape that corrects for this non-linear movement—for example some concave hyperbolic shape or cycloid shape or other mathematically appropriate shape (this can be done for example by changing the shape of the plate and/or by changing the positions of the heads instead of being all on the edges). On the other hand there is no such problem if the additional forks are added in the configuration of FIG. 50a—if all the tips with the head are on the same dotted arc (Although in this case also the linearity is not complete, the distortions are much smaller due to the remote axis of rotation of the arm, and therefore they are not important, since each head keeps using the same path for writing and for reading). The configuration of FIG. 5c is very similar to that of FIG. 5b, except that the hub (54) of plate 57 is now outside the area of the disk's rotating plates (53b), thus allowing more room for the mechanics of the engine that rotates plate 57 and reducing the non-linearity problem, however the shape of plate 57 is preferably also corrected for linearity in this case like in plate of FIG. 5b. Both in the configurations of FIG. 5b and of FIG. 5c the heads can be for example just on one side of the plate (like in FIG. 5b) or on both sides (like in FIG. 5c), however if both sides are used then preferably the heads on the right are shifted in position compared to the heads on the left, so that altogether each head covers a different range of tracks. This has the advantage that more resolution in dividing the tracks between the heads can be achieved without putting the heads too close to each other. Another advantage of the configurations of FIGS. 50a-c that since each head has its own range of tracks, another possible variation is that preferably the heads that deal with more external tracks use higher frequency and thus can write more data per each track in the external tracks, thus preferably creating more even data density across the disk, unlike the current disks, in which the amount of data on the outer tracks is the same per track as in the inner tracks, thus wasting a lot of space. This can thus in addition increase the available space on the disk on average for example by a factor of 2 or more. In this case preferably each head writes according to the highest density that can be used in the most inner track within its sub-range of tracks, however another possible variation is that each head can also increase its frequency when moving into the more external tracks within its range. Of course these configurations are preferably used for all the layers of the disk, so that preferably multiple such side plates replace the normal arms. Another possible variation is that, for example in the configurations of FIGS. 5b and/or 5c, instead of jumping into a certain position each time, plate 57 for example constantly rotates (thus removing the need for fast acceleration and stopping for each jump), and the rotations of plate 57 and of the disk's plates (53b) are specially correlated. In this case also, the shape of the plates is preferably specially designed to correct for various linearity problems and/or to create special more desired patterns of intersection with the disk's rotating plates. However this solution is much more problematic and requires unusual read/write patterns. Another possible variation is for example independent arms for each sub-range of tracks, or for example multiple independent arms (so that for example there are 2-3 hinges of arms sets instead of 1). This can for example also further increase the efficiency of access order optimizations, such as for example NCQ & TCQ). Of course these are just examples and other configurations with similar principles can also be used. Of course, various combinations of the above variations can also be used. Of course, like other features of this invention, these features can be used also independently of any other features of this invention.

FIGS. 4 & 6 have been mentioned briefly in the patent summary and are just used for illustrating certain points in the prior art.

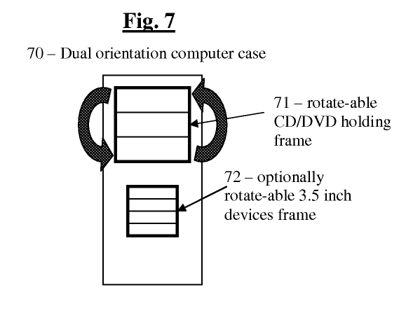

Referring to FIG. 7 I show an illustration of an improved computer case (70) in which at least the area that supports the external CD and/or DVD drives (71) is preferably rotate-able between two positions, so that the same case can be used either as a desktop case or as a tower case, thus giving the user much more flexibility in choosing the most convenient orientation without having to buy different cases. This is preferably done by making the case strong enough to support even large screen on top of it when used in the desktop orientation, and preferably at least the area that supports the external CD and/or DVD drives (71), is preferably rotate-able between two positions, preferably in 90 degrees (preferably only back and forth between the two position—to avoid excess bending of the cables), so that preferably the user can easily choose one of these two positions, at least by screwing the part when the case is open, but even more preferably the user can for example press one or more levers or buttons and then can preferably rotate the part even when the case is closed. Another possible variation is that for example the frame that holds the 3.5 devices (72) is also similarly rotate-able, although that is less important since for example zip drives, hard disks and normal diskette devices can work ok both in the horizontal and ion the vertical position. Preferably the rotating frame can be for example pulled a little out to the front and then rotated when slightly outside of the case—so that the corners of the frame can rotate freely (preferably the inner part of the frame has a part with round edges), or for example the rotating frame has its corners always a little in front of the case, so that it can be rotated even without having to pull it out forwards.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A System for improving the efficiency, comfort, and/or reliability in Operating Systems, comprising at least one of:
a. A mechanism for instant Resetting of the OS into the normal state it would be in after a successful boot, without the need to boot at all;
b. A mechanism for automatically scanning the nonvolatile memory in the background without significantly slowing down the computer after a boot or a Reset while allowing the user to immediately start working after the boot or Reset;
c. A mechanism for preventing other programs from snatching the focus while the user is typing;
d. A mechanism for allowing the user to install a new Operating System in another partition or directory with copying the desktop of the original system to the new system and automatically converting as many programs as possible to work in the new system;
e. An automatic rollback feature that is adapted to enable undoing any changes on the non-volatile memory;
f. Independent access mechanisms to at least one rollback area, so as not to adversely affect speed of access to the normal data areas;
g. Independent access mechanisms to at least one FAT area, so as not to adversely affect speed of access to the normal data areas;
h. Improved versions of at least one of Word processors and Internet browsers and/or other applications.

2. A method for improving the efficiency, comfort, and/or reliability in Operating Systems, based on at least one of the following steps:
a. Providing a mechanism for instant Resetting of the OS into the normal state it would be in after a successful boot, without the need to boot at all;
b. Providing a mechanism for automatically scanning the nonvolatile memory in the background without significantly slowing down the computer after a boot or a Reset while allowing the user to immediately start working after the boot or Reset;
c. Providing a mechanism for preventing other programs from snatching the focus while the user is typing;
d. Providing a mechanism for allowing the user to install a new Operating System in another partition or directory with copying the desktop of the original system to the new system and automatically converting as many programs as possible to work in the new system;
e. Providing an automatic rollback feature that is adapted to enable undoing any changes on the non-volatile memory;
f. Providing independent access mechanisms to at least one rollback area, so as not to adversely affect speed of access to the normal data areas;
g. Providing independent access mechanisms to at least one FAT area, so as not to adversely affect speed of access to the normal data areas;
h. Providing improved versions of at least one of Word processors and Internet browsers and/or other applications.

3. The method of claim 2 wherein in at least one word processor at least one of the following features exists:
a. Switching the dictionary also automatically switches the language correspondingly in the small window or area where the word has to be entered;
b. When using the dictionary the user can use also forward and/or backwards movement, so that he can go back or forward to previously checked words;
c. When opening files with the windows dialogue box the dialogue box automatically adjusts its size to a size that is sufficiently large to display the full file name if one or more of the file names that are displayed is longer than the default, and/or a slide bar is added (for example at the bottom) that allows the user to scroll and see the full name;
d. When deleting a file in the dialogue box that displays existing file names, by default immediately after the deletion the display is updated so that the list of files is displayed more or less in the same position;
e. The word processor program allows the user also options of searching for the next marked changes;
f. If the user wants to mark large areas with the mouse, pressing some key can significantly increase the speed of the scrolling;
g. If the user wants to mark large areas with the mouse, moving the mouse further to a more extreme position significantly increases the speed of the scrolling;
h. If the user already marked a section for example with the mouse and then uses the mouse to click on something else and then wants to go back and increase or decrease the marked area, he/she can still use the mouse and/or other keys to go back and extend or reduce the section without having to start marking again from the beginning;
i. If the user first marks the entire file he/she can then use the mouse and/or other keys to reduce the marked section or remove parts of it;
j. The user can also search for numbers or letters of logical paragraph numbering;
k. The user can automatically reformat all the logically numbered paragraphs globally or in a marked section that contains multiple indentation levels, by at least on of: defining the indentation for each level, and defining general incremental indentation rules.

4. The method of claim 2 wherein in at least one word processor at least one of the following features exists:
a. The user can also search for numbers or letters of logical paragraph numbering;
b. The user can automatically reformat all the logically numbered paragraphs globally or in a marked section that contains multiple indentation levels, by at least on of: defining the indentation for each level, and defining general incremental indentation rules;
c. When the track changes feature is on and the user breaks an automatically numbered paragraph, only the new break and the change in subsequent renumbering are shown, and the part after the break is not marked as new text, and when comparing files the same consistent difference is shown;
d. When a text is marked as deleted as a result of track changes or of file comparison the user can mark the deleted text or part of it and press a key or button or otherwise execute a command which can instantly undelete it;
e. The user can mark and copy text that is marked as deleted or any part of it and can paste it back at the same place or elsewhere as normal text;
f. The user can use a command that fades (or otherwise changes) the color of the older changes so that all the new changes from that point on will stand out;
g. The user can define separate colors for displaying the changes on the screen and when printed;
h. The user can define separate colors for displaying the changes on the screen and when printed, and by default the on-screen display is the automatic colors, and the printing by default in black if a black and white printer driver is used;
i. When comparing a group of two or more files, a summary table or other type of index can be automatically generated so that the table or index indicates which color was added on which date, so that the user can clearly see which change was entered at each date;
j. When comparing a group of two or more files, the date in which each section or element was added or changed is automatically indicated near the relevant text;
k. When comparing a group of two or more files, the files are automatically sorted by date before creating the comparison, and each new section or element is dated automatically according to the first time it appeared.

5. The system of claim 1 wherein at least one of the following features exists:
a. When copying a large group of files the user also has an option of “No to all” if he is asked if to overwrite files with the same name;
b. When the user searches for files on the computer the “find files” window allows him/her to enter also more than one file name at the same time, so that all the files can be searched for during the same disk access;
c. The user can request to run various procedures also on lists of variables defined by exclusion;
d. The user can mark a group of links in the history list and/or in the bookmarks list of the browser, and/or in any web page that contains links, so that after the user marks the desired group or groups of links, the browser can automatically open multiple windows so that each window accesses automatically one of the marked links and/or the browser can save multiple files automatically;
e. If multiple files are saved automatically, they are saved by default with their original names, or the user can define a group name which is incremented automatically to differentiate between the files in the group, and/or the system can automatically read he title in each of the files or web pages and use that as the name;
f. The user can easily reduce or increase the size of the printed fonts, by at least one of: A specific command when printing, and reducing or increasing the size of the fonts on the screen so that this affects automatically also the printing;
g. Reducing or increasing of fonts can be also done for a specific web page and/or for a specific site instead of Globally, since for example in Netscape the changed size remains also when;
h. The same command that reduces or increase the font size on the page (and/or another command) can cause also the images to automatically grow or shrink in addition to or instead of the fonts, and this can be done independently of changing the size of the Window;
i. The http protocol is improved so that images are automatically saved by web servers in more than one size and the browser can automatically request the same image again with some parameter that tells the server to send it in a larger size and then the server automatically sends again the same image in a larger size;
j. The user can mark a group of links in the history list and/or in the bookmarks list of the browser, and/or in any web page displayed by the browser that contains links, and can automatically print the group;
k. In sites where the user has to print separately each page in a document, the browser can allow the user to define a set of steps to be performed automatically, such as pressing the icon or link that leads to the next page and then printing it, so that after pressing the “next page” link and printing it, the user can activate a command that tells the browser for repeat the last N actions an additional M times and/or until it is no longer possible;
1. When pressing a Javascript button which designates a link with the right mouse key, the same options are available as when pressing the right mouse button over normal links, such as Open in a new Window instead of in the current window, or Save the link target instead of opening it;
m. When typing one or more words or part of a url address in the location window of the browser, the browser does not attempt to go automatically to the “.com” address, but can check also if the address can be resolved also to other Top Level Domains or domain extensions, and then preferably the browser opens e a scroll Window of the existing addresses and lets the user choose the desired one, and/or the browser can also check automatically in the background, which of these possibilities shows up higher and then sort the options by popularity or even choose automatically the most popular option;
n. The user can tell the OS and/or the browser and/or the service that the user acquired domain names from, to automatically perform all the actions necessary to renew one or more specific domains on time even if the user forgets to do it, by at least one of the following methods: 1-The browser can automatically login to the site and perform the necessary actions for renewal, 2-The service is instructed to renew it automatically like a subscription if the user does not cancel the automatic renewal until the automatic renewal time;
o. The OS and/or the browser can automatically sense the width or size of the screen and/or the resolution and/or number of fonts available, so that if a table does not fit in the page and necessitates creating automatically a horizontal scroll bar, the browser and/or the OS can decide automatically to reduce the font size accordingly so that the scroll bar is not needed and/or reduce only the width of the fonts, so that the fonts become thinner.

6. The system of claim 1 wherein when Internet pages are printed, the browser and/or the OS and/or the printer driver automatically check if lines are about to be truncated in the printing and, if so, this is automatically prevented by at least one of:
a. Automatically converting to landscape mode;
b. Automatic additional line wrapping if possible;
c. Automatically reducing the left and/or right page margins;
d. Automatically reducing the font size;
e. Informing the user about the problem and asking him to choose from a number of possible solutions;
f. Allowing the user to decide to truncate less important parts on the left of the pages;
g. The user can mark just part of the displayed HTML page and then use a command that prints only the marked area.

7. The system of claim 1 wherein at least one of the following features exists:
a. The user can disable the Autorun feature that enables programs on CD's to start running automatically when the CD is inserted into the computer, without having to disable for that the Auto insert notification for that drive;
b. When printing Internet pages the browser or the printer driver shows the number of pages that will be printed before the user starts the actual printing;
c. The user can logically disable or change the function that pressing various keyboard keys has on the OS and/or on any programs that are running;
d. The dynamic linking possibilities are improved so that the user can call and use any Windows DLL from a DOS program and/or vice versa, so that Windows modules and DOS modules can transfer data between them without having to use intermediary file storage;
e. The dynamic linking possibilities are improved so that the user can call and use any Windows DLL from a DOS program and/or vice versa, by defining appropriate stubs and/or API interfaces that bridge between the two types, including any necessary conversions that are needed for compatibility, and/or using sockets and/or client/server connections within the same computer;
f. When the user searches for programs in the “Start menu” the user can request the System to automatically sort the list of installed programs in the start menu by alphabetic order, or to jump automatically to a given program in the list by typing the first letters of its name and/or a search string that is at least similar to the desired name.

8. The system of claim 1 wherein at least one of the following features exists regarding changing the size of fonts and/or icons and/or images:
a. The user can reduce the size of fonts and/or icons and/or images on the computer's desktop by a command that affects the entire desktop and/or a marked section in it by any desired factor, and without having to restart the computer to see the change, and the change is seen instantly, like when increasing or reducing the font size in the browser;
b. If increasing the size of fonts and/or of icons on the desktop causes a problem that some icons no longer fit on the desktop, this is automatically handled by at least one of: 1. Creating vertical and/or horizontal scroll bars at the edge of the desktop, like in a normal directory window in which there items that don't fit in the Window, so that the user can drag items back in and/or resize the desktop in order to get rid of the scroll bars; 2. The system can automatically reduce spaces between icons and/or recommend to the user the maximum size that can be used without problems;
c. The OS supplies the user with an Undo command and/or a Redo command for changes in the desktop icon sizes and/or for moving icons;
d. The OS supplies the user with an Undo command and/or a Redo command for changes of moving and/or resizing icons in a directory and/or in other windows;
e. The undo of moving and/or resizing icons is incremental, so that the user can roll back till the start of the changes;
f. The OS automatically prevent the possibility that reducing the resolution and/or increasing the system font size can cause the window that asks if to keep the new resolution to appear outside of the desktop and/or cause the text is various system message windows to appear truncated, by automatically calculates the new size and ratios and thus makes sure that all the message windows appear in a visible area and that the text size in them fits the message window;
g. If the user changes the screen resolution, the fonts and/or icons on the desktop and/or in other places or applications by default remain more or less the same size, by automatically correcting for the changes caused by the changed resolution, so that if the user increases the resolution the fonts and/or icons and/or images can be automatically increased in size to compensate for this and if the user decreases the resolution the fonts and/or icons and/or images can be automatically reduced in size to compensate for this, with or without keeping the aspect ratio between height and width;
h. The user can also undo or redo changes such as for removing or adding or changing the position of items that constantly appear near the task bar;
i. By default at least the distances between the icons are corrected in each direction by its appropriate ratio of change.

9. The system of claim 1 wherein in Tablet PC's and/or similar devices and/or other devices that accept direct input by handwriting, when the user enters text in handwriting, the system automatically solves the problem of insufficient room in a text input box or window by at least one of the following ways:
a. Letting the user continue his/her writing even beyond the edge of the input box, and then the Operating System and/or the browser or other application automatically knows from the continuity of the written text and/or from the continuity in time that this is the continuation of the same text, and therefore interprets it correctly as if it is still in the input box even if its spills out;
b. If the user runs out of space in the input box, the System and/or the browser and/or other relevant application automatically extends the box to the appropriate direction;
c. The area where the user is writing can automatically be zoomed in, however this automatic zoom does not effect the user's hand writing itself, so that the handwriting can remains at the same size and position;
d. At least the part of the handwriting that spills out of the input box is at least partially transparent and/or is visible only when the user hovers or positions the pen and/or cursor and/or mouse near it;
e. If the user for example is entering text by handwriting in some open text window and his handwriting exceeds the edge of the window, the System automatically recognizes by the continuity of the hand writing and/or of the temporal sequence that this belongs to the same text and thus the system keeps the focus in the current application even if the user for spills letters on another nearby window of another application.

10. The system of claim 1 wherein the installation disk of the OS contains also one or more typical usable disk images, so that the system can be instantly installed from the most appropriate image, and then the system automatically determines the actual computer's configuration and simply corrects and/or adds appropriate device drivers and/or makes other necessary adjustments, as if the system was already installed on that computer and the hardware was later changed.

11. The system of claim 1 wherein at least one of the following features exists in at least one word processor:
a. The user can mark one or more areas in which track changes is marked as On or Off, so that different areas can be with the track changes On or Off at the same time;
b. The user can use a mode which automatically adds the words “(Currently amended)” when the user makes changes in a claim, and the words “(Currently amended)” are automatically added without track changes;
c. The user can use a mode in which deleting an entire claim automatically causes the deleted text to disappear, and the word “(Canceled)” to automatically appear instead, as if track changes has been temporarily suspended;
d. The user can use a mode in which when adding new claims at the end of the claims section, the track changes is automatically set to Off and the word “(New)” is automatically inserted at the beginning of the new claim;
e. The user can mark any area in an image or part of it and at least one of:
delete it, copy it, move it, and rotate it so that all the elements in the marked section are rotated in synchrony, etc.;
f. The copy command can also be activated cumulatively, so that a sequence of copy commands can create a cumulative buffer of consecutively pasted texts, so that afterwards for example pasting at a certain position will paste back the consecutive group of pasted texts as one sequence;
g. in searching the dictionary and/or the thesaurus the user can search for synonyms of words with a specific pattern or length, or for the word itself when partial data exists, so that for example the user can use question marks or other designation to designate unknown characters.

12. The system of claim 1 wherein in at least one of word processing programs and/or Internet browsers and/or other software the user can move any icon and/or any menu item and/or sub-menu item to any desired position by dragging it with the mouse and at least one of the following features exists:
a. The same icon and/or menu item automatically continues functioning on the new position;
b. This new position is saved automatically also after the user closes the application;
c. The user can also undo any such changes;
d. The user can also undo any such changes even after the application has been closed and reopened;
e. This feature is supported automatically for by compilers, so that the programmer does not have to do almost anything in order to enable it.

13. The system of claim 1 wherein when opening additional pages in the browser as additional tabs within the same window, the browser and/or OS are changed so that Alt-F4 closes only the current page (tab) and/or Alt-Tab switches also between the tabs, and/or when closing a tab page by Alt-F4 the browser or the OS warns the user or asks if he/she wants to close just that page or the entire browser window with all the open tabs.

14. The system of claim 1 wherein at least one of the following features exists:
a. When more than one OS is installed on the same computer the user can switch the default OS to whichever option he/she wants and/or change the order of the options (where typically the first option becomes the default) by letting the user drag an option line with the mouse to a different position in the screen that asks which system to boot;
b. When more than one OS is installed on the same computer the system automatically remembers the boot option that was last chosen and makes it automatically the default for the next boot until the user changes it;
c. When more than one OS is installed on the same computer the system automatically makes the chosen option in the boot menu into the first choice on the boot menu on the next boot;
d. Network computers in wireless networks use also automatic triangulation of the source of transmissions, so that the coordinates of the allowed space are entered into the system and/or only specific locations of known devices are white-listed, and so any intruder from an outside position cannot pretend to be an authorized user even if he succeeds in finding a vulnerability in the encryption.

15. The system of claim 1 wherein in order to save bandwidth when looking for updates, at least one of the following is done in browsers and/or the html protocol is changed:
a. The html protocol is changed so that it is possible to define “refresh on a need basis”, which means that the refresh command is initiated automatically by the site when there is any change in the page, so that the browser can get a refresh even if it didn't ask for it;
b. The html protocol is changed so that the browser asks for refresh more often, but if nothing has changed then the browser gets just a code that tells it to keep the current page or window as is;
c. When the refresh is sent, it can be a smart refresh, which tells the browser only what to change on the page instead of having to send the entire page again;
d. The page or part of it can remain open like a streaming audio or video so that the browser always waits for new input but knows how to use the new input for updating the page without having to get the whole page again and doesn't have to do anything until the new input arrives.

16. The system of claim 1 wherein at least one of the following features exists:
a. When the user enters the task manager he/she can mark multiple programs and then tell the OS to close all of them at once;
b. When the user tries to force the closing of an application through the task manager and/or in other contexts, in case said application hasn't been closed, the OS automatically tries again repeatedly to close it at least for a certain number of times and/or till a certain time limit.

17. The system of claim 1 wherein at least one of the following features exists in at least one word processor:
a. If track changes is used and the strikeout text contains letters on which it is hard to notice the strikeout, the strikeout line is automatically moved higher or lower on such characters, and/or for strikeout line is automatically made of a different thickness and/or length and/or angle and/or color;
b. Striked-out words behaves like normal words on the dictionary;
c. The user can mark one or more areas in the file and activate the “accept changes” command and then the “accept all changes” can be automatically done only in the marked areas;
d. When there are different sets of marked changes, the user can instruct the word processor to automatically accept all the changes but only from a certain date or dates or a certain source or sources;
e. The dictionary allows the users to use back arrows in order to go back to previous points in the dictionary. Another preferable improvement for example in words processors, and especially for example;
f. When the user wants to correct intermittently two or more sections in the same file, the user can press a key or combination of keys which causes the position in the word processor to jump automatically between the various last edited sections;
g. The word processor automatically checks the date in the system in short intervals and thus updates the date field automatically whenever it has changed, and not just if the user reopens file or prints it;
h. The user can mark with the mouse more than one area at the same time by pressing some key that tells the application not to remove the mark from the previous marked area or areas;
i. When track changes is used and a section is deleted and then reentered next to the deleted text, the word processor can automatically integrate then by removing the deleted redundant part;
j. Word processors and/or other applications and/or the dialogue box can remember and display automatically the last requested file pattern when the user tries to open a new file and if the user presses Enter then this last pattern is used;
k. When the user tries to make a repeated change but confirm it at each step (instead of just global change), the position of the search-and-replace dialogue box is always kept constant and the text itself is automatically always scrolled so that the relevant part is visible;
1. When the user tries to make a repeated change but confirm it at each step (instead of just global change), the position of the search-and-replace dialogue box can move, but when it moves the mouse cursor automatically jumps with it, so the user does not have to move the mouse to correct for the change is the position of the search-and-replace dialogue box;
m. If the user copies and pastes a new http link over a previous http link, the word processor (or other application) automatically replaces also the internal link to automatically comply with the visible link, or saves only the visible link and uses that information when the user tries to access the link;
n. When the thesaurus is used the dictionary shows near each newly found word of the thesaurus also its translation to the other language and/or a short description of its more precise meaning in a few words;
o. The thesaurus and/or the dictionary automatically takes into consideration the context in which the word exists in the file, so that when displaying semantic trees or groups of semantic branches the groups or branches are pre-sorted according to the most likely meaning when taking said context into consideration and/or only the most likely meaning branch is shown;
p. The automatic typing-error-correction system takes into account also the context, and at least one of: The system chooses the word most likely according to context when there is more then one reasonable correction and/or in cases the system is not sure it shows the user that there is more than one likely correct word and asks him/her to choose the preferred one;
q. The user can activate a command which automatically indicates all the words in which spelling errors were previously automatically corrected the word processor, so that the user can check specifically these words to see if there were any such errors of changing the word to something that was not indented by the user;
r. The user can change page definitions also for a single page or range of pages and not just automatically for all the pages;
s. When using cut & paste if the user presses by mistake again “AC” (copy) instead of AV (paste), the user can press some undo key which brings back the previous copy buffer;
t. word processors and/or editors that are used for editing software programs can mark automatically matching pairs of brackets in a way that the user can easily see the matching pairs and wherein said marking is done by at least one of: Showing each pair in a different color and Show the matching pairs in a different style or for in a different height.

18. The system of claim 1 wherein at least one of the following features exists:
a. In the dialogue box that allows the user to choose directories and files and/or in the explorer Window file extensions are shown even when the associated application is known;
b. In the dialogue box that allows the user to choose directories and files and/or in the explorer Window in addition to the icon that shows the associated application the window shows also an additional Icon that represents the general type of the file regardless of the associated application;
c. The user can change the position of the normal boxes on the taskbar that represent normally running programs by dragging them with the mouse, so that the user can conveniently re-arrange their position without having to close and reopen these programs.

19. The system of claim 1 wherein at least one of the following features exists:
a. If the user aborts a virus scan and later wants to continue, the program can automatically continue from the last point reached;
b. The user can add to a portable computer a mini-keyboard which completes for the side keypad and/or any other keys in a way that tells the portable computer not to regard it as a replacement keyboard that disables the portable's built-in keyboard but regard it as adding certain keys to the internal keyboard;
c. The user can use the combined fax/printer/scanner and/or a normal scanner to send faxes directly through the Internet through the computer's Internet connection, which is enabled by a change in the device's firmware and/or by adding the appropriate software to the computer, so that the user can send faxes directly and instantly the same as he/she would be sending them through a normal phone line, except that the fax is sent through the Internet;
d. If the user for closes an application window he/she can still press some undo button which automatically reopens the last closed file, and this is enabled by the relevant applications and/or the OS creating automatically a temporary backup of the open window or file when the user closes it;
e. When trying to delete a directory through a command prompt window the OS tells the user that it is a directory and tells him/her also the number of subdirectories and/or the total number of files in that directory tree and/or the total size;
f. The user can tell the OS not to enter sleep mode until a specific application has finished running;
g. The user can tell the OS not to enter sleep mode until a specific application has finished running by clicking on the applications window or for example on the square that represents it in the task bar and marking the relevant option in a menu;
h. If the user does not find a certain file name the OS automatically checks for similar names and shows the user the list of closest file names available, sorted by closeness;
i. When an internal Window of a program is in front of a background window of that program and does not allow accessing the background window until the front window is closed, the OS automatically allows the user at least to move the previous window and/or perform at least other acts that do not change the way the software behaves but allows the user at least to control the view of the background window;
j. The fax logs automatically indicate near each communication also the resolution that was used in the transmission and/or if the fax was in B/W or in color;
k. The user can indicate example that the firewall should not close the web and/or the screen saver should not be activated until a certain application has finished performing some operation;
1. When a computer becomes compromised by a Trojan and becomes a spam-relay station, there are special sites or routers which identify the attacking computers and can send the users who's compromised computers have participated in the attack automatic warning messages, directly to their IP address or to their email;
m. IP addresses of compromised computers are automatically updated in one or more special URLs in real time and the OS and/or the browser automatically checks regularly in one of these official sources and sees if the IP address fits the real current IP address of the current user's computer and then warns the user;
n. The firewall and/or the Security system and/or the OS can also indicate to the user automatically whenever some application is trying to download a file, or the user is warned only if an apparently executable file is being downloaded;
o. The firewall allows the user to change the permissions of multiple applications at the same time in the firewall's table by marking entire columns or other areas and then changing automatically the permissions in the marked areas.

20. The method of claim 2 wherein in order to market the OS in low-income countries without damaging sales in countries where a normal price can be charged, the OS is sold at the desired low-income countries at the low price with few or no limitations that result in reduced functionality to the user, at least one of the following steps is used:
a. Limiting these cheap versions so that at least part of the interface and/or some application works only in languages that are not useful to most people outside the cheap countries;
b. Displaying a warning whenever the OS is started that it is illegal to use this version of the OS in any either countries than the list of qualifying countries, unless the user has a citizenship of one of these countries and/or is resident there;
c. The OS checks automatically when the user connects to the internet if his/her IP address is in one of the qualified countries and, if not, require some certification to be filed which proves that the user is entitled to use that version of the OS outside of those countries and/or automatically stop working or start working with only limited functionality after a certain time period if said certification has not been filed.

21. The system of claim 1 wherein at least one of the following features exists:
a. If there are more than once CD and/or DVD installed on the same computer they can be connected to a common audio connector in parallel or with some multiplexor, or cables from more than one drive can lead to a common connector or multiplexor near or at the sound card;
b. No direct connection to the sound card is needed from any of the drives, and each CD or DVD that contains sound is played by activating the sound card directly through the software that plays the data, in the same way that the sound is played from an avi file on the hard disk.

22. The system of claim 1 wherein at least one of the following features exists:
a. When uploading a file while submitting form in an Internet browser, the browser specifically warns the user about the file name and/or path and/or size, so that the warning is more specific about such files, instead of or in addition to the normal warning if the user really intends to submit the form itself;
b. When the user types text for entering in some field in a form, the browser and/or the OS can keep it automatically in some buffer, so that if the user starts to type before the actual form field is reached, the typing is not lost but is added automatically the browser or by the OS to the beginning of the input line;
c. The user can perform commands that affect a group of open windows, such as entering a command that prints all of them or that saves all of them or that bookmarks all of them—by entering the global command in one of the open windows of the same application, or by marking multiple boxes in the task bar and then entering the command;
d. The user can perform commands that affect a group of open windows, and in this mode the user choose automatic carrying out of the global command or to be prompted for each of the windows with the option to choose yes or no in each case;
e. The internet browser lets the user to darken with the mouse a group of checkboxes and then with one command mark or unmark the entire group;
f. The internet browser lets the user drag the mouse over a group of checkboxes, so that dragging it with the left button pressed immediately marks each box on the way and dragging it with the other button pressed unmarks each checkbox on the way, or vice versa;
g. When the user is filling Online forms, the Internet browser can automatically take into account the language of the text near each form field and automatically accept by default the input in the appropriate language;
h. The user can unmark a radio button by clicking on it again or by using another mouse key.

23. The system of claim 1 wherein at least one of the following steps is used to protect the user from phishing attempts:
a. The browser or the email client automatically indicates to the user when the real href is different from the http address that is visibly shown in a link, or warns the user about this after he/she clicks on the link and gives him/her a chance to cancel before actually going to the link;
b. The browser or email client automatically indicates to the user also the real url that is within the href in the normal display of the page—next to the link or superimposed on it;
c. The browser automatically makes sure that the url in the location window is indeed displayed exactly like the actual url that it connects to, and if there are unprintable characters then they are marked with some sign and do not effect the printing of the rest of the url;
d. If there is any attempt by Javasrcipt or Active-X or some other portable code or any other program on the user's computer to put other data on top of the location Window then this is automatically prevented by the browser and/or the OS and/or the computer's Security System;
e. If there is any attempt by Javasrcipt or Active-X or some other portable code or any other program on the user's computer to put other data on top of the location Window then this is automatically prevented by automatically preventing other programs from putting any windows in front of the browser window unless the user explicitly transfers the focus to them, and/or by automatically intercepting windows that have a suspect size or shape or location or that otherwise have suspicious or unusual qualities;
f. Email messages that contain clearly misleading hrefs where the visible link does not fit the real link can be automatically blocked by spam filters, thus not reaching the user at all;
g. Normal spam filters are also improved to identify automatically for example typical patterns of mixing digits with letters in a way that tries to bypass word filters;
h. When the browser enters a site it automatically checks also a relevant WHOIS database and displays to the user automatically also the name under which that domain is registered and/or the country and/or other details that can easily indicate to the user if a site is phony.

24. A portable computer wherein the computer and/or the OS and/or the relevant part of the hardware can automatically increase or decrease its power consumption according to sensing if the computer is currently connected to the network electricity or is currently running on the batteries and/or the user can request it explicitly for a short time, wherein at least one of the following is done:
a. The hard disk's speed can be considerably improved;
b. The disk has at least two sets of engines or at least two sets of coils, which are used at different combinations in order to work in the low speed or in the fast speed; and/or the disk's DSP automatically starts working at higher MHz when the wall power is sensed, and/or more than one DSP can be used in order to speed up the processing;
c. The speed of the CPU can be improved so that it consumes more power and works faster;
d. The brightness of the screen can be increased.

25. The method of claim 2 wherein the automatic error checking of at least one word processor includes also at least some statistical and/or semantic checking of unreasonable words or word combinations that are probably a typing error even if there is such a word and/or even if it is grammatically possible.

26. The method of claim 25 wherein the word processor uses at least one of the following methods to check for such errors:
a. Using at least some taxonomy of semantic knowledge;
b. Using a database of typical texts in which words and/or word combination of up to a few words are indexed according to their frequency of appearance;
c. Learning from the user's own behavior when such errors are made and then corrected by user.

27. The system of claim 1 wherein the user can use a fax card or a combined fax-scanner-printer which is connected to the computer in order to actually send digital data files eventhough the connection starts like a fax communication.

28. The system of claim 27 wherein at least one of the following features exists:
a. The sending device can send one or more pseudo fax images which are actually digital data, and when it is transmitted by Fax the sending device uses a special code to tell the receiving device that one or more pseudo page images are actually a digital file, and the receiving fax is either a computer with a fax/modem card or for example a combined fax-scanner-printer which is also connected to a computer and thus can transmit the digital file to the computer as a digital file;
b. The two devices can automatically recognize each other during the handshake as having more than Fax communication capabilities, and thus can automatically switch to some other electronic file transfer protocol between them for exchanging digital files.

29. The system of claim 1 wherein at least one of the following features exists:
a. When the user asks Windows to create a restoration point, the user has a choice of indicating if he/she wants a normal restoration point or also creating a full snapshot of the main system and registry files and/or the user can define in general if and/or when snapshot or normal restoration point will be generated when the system automatically creates them and/or the system automatically creates the snapshot files whenever it is about to make highly significant changes for example in the system;
b. Rollback info is saved automatically in more than one place, together with a copy of a sufficient reference base-point, so that the system has a much better chance of restoring it even if the registry becomes seriously damaged;
c. The registry entries are made independent of each other so that even if part of the registry is damaged it will not effect anything else;
d. The system uses transaction sequences in the registry and/or in other important system files or system areas like in a normal database with automatic rollback in case the transaction has not been completed;
e. If when trying to boot the system discovers that the system needs to load a previous snapshot of the registry and/or other critical system files, during boot the user is advised of the situation and can automatically view a list of the most recent snapshots and/or otherwise possible restoration points and can choose the most preferred ones to attempt and then the system restores it automatically and continues to boot;
f. At least one of the registry and other critical system files that are needed for snapshots are always automatically kept in at least two copies so that if one copy becomes unusable there is always an immediate backup of the most up to date version;
g. During boot the system uses the wasted time on the part of the user to display to the user at least one of: Details about the number of safe restoration points that exist, various indicators of the health of the system, the current automatic back-up policy that exists, the amount of remaining free space on the disk, and the percent of disk fragmentation.

30. The system of claim 1 wherein the system includes a firewall which allows giving specific applications differently rights for downloading and/or uploading information from the Internet and/or through all available communication channels or through specific communication channels.

31. The system of claim 30 wherein the different upload versus download permissions are enabled by at least one of:
a. Automatically showing the user the statistics of sending/receiving information near each application that has been allowed to access the Internet;
b. Defining a maximum ratio between upstream and downstream for each application;
c. Defining a maximum ratio between upstream and downstream for each application and automatically blocking excess uploading and/or warning the user and/or asking for his/her authorization;
d. Defining a maximum absolute amount of information that can be sent out per time;
e. Programs that the user wants to allow only to download data but not upload data are automatically prevented from any real access to the web, and the OS and/or the firewall and/or the security system intercept any attempt that these application make to contact the web and send the requests instead, and so only valid normal protocol requests for accessing web pages and/or for downloading data which are recognized by the firewall or other intermediate agent are allowed to go through;
f. The firewall or other agent for example cal also notice other suspect behaviors, such as requesting a web page with an unreasonable large parameters line or frequent repeated similar connections with parameter lines that keep changing.

32. The system of claim 1 wherein the user can have two or more Operating systems running at the same time so that the user can jump between them by pressing some key or key combination or clicking on some icon, instead of having to shut down Windows and reboot, without using emulation, and wherein at least one of the following features exists:
a. There is a mirror image of the loaded and running OS like in sleep mode, so that while the user is in one OS the other OS is dormant;
b. The user can switch between the OS's after entering sleep mode;
c. Both Operating systems can be actually running at the same time and one or more additional OS elements are operating below the two (or more) Operating Systems and are in charge of the resource sharing between them;
d. Both Operating systems can be actually running at the same time and in this mode certain functions are automatically disabled or are available to only one OS.

33. The system of claim 1 wherein at least one of the following features exists:
a. The hard disk has one or more separate heads which are used only for checking the media for errors and move automatically all the time or periodically once in a while to check this without interfering with the normal function of the hard disk;
b. The task manager automatically shows near each process also to which program and/or path and file name it belongs;
c. The OS and/or the word processor can identify automatically incremental updates of the same file according to at least one of the beginning of the file name and/or sequential numbering and/or date and time and/or by keeping automatically a log of the sequence of updating a file incrementally;
d. The OS and/or the word processor can use the knowledge of the update sequence of a series of files to search for each section or sentence when was the first time that it was entered;
e. The word processing program can ask the user automatically if various changes in the way the word processor operates are intended only for the current file or for all the files in the same directory or all the files of the same sequence or all files in general;
f. The word processor is improved so that when automatically saved files are offered after a crash, even if the user closes automatically offered files, he/she can still activate an option that restores them, even if the user in the meantime closes the word processor and then later reopens it;
g. The word processor keeps one or more buffers which point to the automatically saved files and has an indication which groups of files belong together and/or to which crash event they are related, and these files are kept in the original directories of the relevant files and/or in a special directory at least for a certain time period and/or as long as there is sufficient disk space and/or until their cumulative total space exceeds some value;
h. In the word processor the user can mark one or more sections and then toggle automatically between modes so that automatic numbers and/or letters can become manual letters and/or numbers and vice versa;
i. When the user searches for a specific file or file pattern in the windows explorer and/or in similar utilities either the files are displayed by default before the directory names or the user can easily indicate if he/she prefers the directory names before the file names or vice versa.

34. The system of claim 1 wherein at least one of the following features exists:
a. After programs finish installing and request a restart, by default the OS automatically determines if a full restart is needed, and then the OS automatically performs just logoff and logon instead of a full restart whenever it can determine that this is sufficient;
b. Program installers are improved so that the software vendors can easily indicate if after installation logoff-logon is sufficient instead of full restart;
c. When the user himself/herself initiates a restart command, the OS automatically asks the user if he/she really wants a full reboot and, if not, offers the user to automatically perform logoff-logon instead;
d. The logon/logoff is added also to the normal Restart/Turnoff menu, so that for instead of showing only 3 options (Standby, Turnoff and Restart) the option of fast Logoff/Logon is also added;
e. If the user chooses full reboot and/or even if he/she chooses just logoff and the system begins to close applications, first of all only user applications are closed and not system processes, and the user can still press some key if he/she changes his/her mind in order to abort the reboot, and then the attempt to reboot is aborted if it has not gone too far, and/or the system can automatically undo the process and even return the OS to the state it was before the reboot was requested.

35. The system of claim 1 wherein at least one of the following features exists:
a. DVDs and/or blue-ray or High Definition DVDs and/or other larger capacity drives support also smaller pocket-size DVD's as burn-able media and/or as ready pre-recorded media;
b. DVD capacity is further increased by using UV or extreme-UV lasers instead of red or blue;
c. The bookmarks list in the internet browser automatically shows also near each bookmark the date it was entered, and/or the bookmarks are automatically grouped by days, with a different color for each group and/or some border marked between the groups;
d. The Internet browser keeps in memory recent changes to various form fields in the same page and/or also on previous pages, so that jumping back to a previously filled field on the same page or also on a previous page or pages will still allow the user to undo changes in that field;
e. If the user wants to copy more than one application at the same time from the “all programs” pop-up list which is activated through the Start button, to the desktop, then the user can mark more than one item at a time and/or the list remains open even after dragging an item;
f. The user can drag a shortcut also from open applications on the taskbar and/or by dragging something from the top and/or other parts of an open window and/or from the file name as it appears in a DOS or cmd window;
g. If the user wants to uninstall more than one program at the same time, the user can mark multiple programs and then all the marked programs are uninstalled automatically;
h. The user can activate a command which automatically jumps each time to the next window in the normal task bar on in the internal group of open windows that belong to the same application or between open tabs in the same application, so that each time the user moves to the next window systematically;
i. The user can define drives and/or directories to become shared when connected by cross-linked Ethernet cable between two computers so that they become automatically not shared when connected by normal cable to the Internet;
j. If the OS gets stuck during or after the boot, the system can automatically sense it after a short time and automatically identify the driver or application that caused it to get stuck and can automatically roll-back to the state it was in before the problematic driver or application was loaded and/or before the registry change or other relevant change and can automatically continue without the problematic driver or application and/or can for automatically search for a replacement driver or application and/or automatically instruct the user what to do in order to fix the problem;
k. At least part of the OS runs below the normal OS and contains also a knowledge base about known problem that can occur, with instructions on how to solve it and automatically tries to follow those self-repairing instructions whenever possible and involves the user only if for some reason it is unable to perform whatever is necessary;
1. At least part of the kernel and/or part of the OS, which is hardware independent, is able to boot properly even if there are a lot of hardware changes, so that any adjustment problems can then be fixed after this initial boot;
m. When the OS does not allow the user to access a file because it is locked by another process, the OS also lets the user know the identity of the clashing process and the clashed resource and allows the user also options such as terminate the clashing process or freezing it temporarily until the user releases again the problematic resource;
n. When there is more than one physical hard disk on the same computer and more than one partition on at least some of these disks, the OS automatically adds some mark to each drive name that indicates to which physical hard disk it belongs.

36. The system of claim 1 wherein at least one of the following features exists:
a. Fax machines are programmed by default (and/or at least the user can choose this option) to respond with fax sounds only if fax sounds are heard in the incoming phone call;
b. The receiving fax is improved so that it is preferably able to automatically identify voice calls and thus avoids making fax sounds if it identifies human voice and/or stops immediately and gets off the line even if it started making fax sounds, as soon as it identifies the human voice;
c. The ability of the scanner/copier to overcome wrinkles in papers or overcome the black stripe that appears when scanning or photocopying books when the user can't press the book down strongly enough—is improved by adding at least one more light source in the scanner, so that shadows are automatically reduced.

37. The system of claim 1 wherein at least one of the following features exists:
a. The user is supplied with an electronic pen which can write on normal paper and at the same time both writes with visible ink on the paper and transmits the writing sequence to the computer, so that the user can write normally while also obtaining an automatic copy on the computer;
b. In tablet PC's and/or in digital book readers and/or in programs such as winamp or other software media players and/or in other gadgets for playing songs or films, the software and/or the device is able to measure automatically not only which songs or films or books (or other media) are more or less liked by the user, but also which parts or sections in them are the best and/or which parts are less good or problematic.

38. The system of claim 1 wherein at least one of the following features exists:
a. The user can create a copy of the OS on another partition with an automatic command, and then the system with the installed programs is automatically copied to the new partition and the drive letter references in the new installation are automatically updated to refer to the new drive letter, and the choice of the new partition is automatically added to a boot selector;
b. The user can also change the name of a boot option and/or add comments to it, while booting and/or from one or more applications that are available after the boot;
c. The user can also use an update or synchronize command, which automatically updates any differences between two or more such OS-installed partitions, so that the user can update the other partition according to additional changes made in the original partitions, and/or the opposite—automatically correct the original partition according to one of the backup partitions, and/or the user can also request automatic undo of such updates;
d. Even the new partition itself for the automatically copies OS installation can be automatically created by the special copy command, if needed, so that the user does not even need to have a new partition ready before requesting the special OS-copy command;
e. The user can mark only one or more specific installed programs and/or drivers and/or other parts to be automatically copied to the other partition, instead of automatic full copy of all the installed elements into the other partition;
f. The user can automatically backup one or more installed programs to a back-up media, so that automatically the relevant registry entry is copied to the backup media and all the relevant components are automatically copied through the relevant registry information;
g. When activating for a command like SFC (which checks the integrity of installed system files and/or compares them to their source on the installation CD and restores them when needed), this or similar commands can be used also from another OS or another installation of the OS on another partition and/or from the installation CD or DVD itself.

39. The system of claim 1 wherein in order to prevent debug features in motherboard bridges from being used for hardware-based attack below the OS, at least one of the following is done:
a. The motherboard chipset is changed so that such debug features and/or direct communications between hardware cards and the hard disk are enabled only if some hardware element allows it, such as a jumper or a switch which has to be manually enabled by the user;
b. The user can add a card to one of the PCI slots and/or add another external device which keeps sending commands to the bridges which can over-ride any attempt by other devices to tell the bridge to sniff on data or to communicate directly with the hard drive and/or the communication channels;
c. The OS and/or a software Security System is able, through the OS kernel or even below it, to take complete control of the bridge and give it instructions that override any undesired attempts by hardware elements to sniff data and/or access directly the hard disk and/or the communication channels;
d. If some devices need to be able to exchange data with the hard disk directly, at least any command sent from the device to the hard disk can be monitored and filtered by the OS and/or by a security system installed on the OS, so that the OS and/or the security system can control what files and/or directories can be accessed directly from the device and what commands can be transmitted to the hard disk.

40. The system of claim 1 wherein computer cases are improved so that the same case can be used either in desktop position (lying in a horizontal orientation) or as normal tower (vertical orientation), thus giving the user more flexibility in choosing the most convenient orientation without having to buy different cases, and at least one of the following features exists:
a. The case is made strong enough to support even large screen on top of it when used in the desktop orientation;
b. At least the area that supports the external CD and/or DVD drives is rotate-able between two positions, so that the user can easily choose one of these two position, at least by screwing the part when the case is open, and/or the user can rotate the part even when the case is closed;
c. The frame that holds the 3.5 devices is also similarly rotate-able.

41. A method for avoiding “DNS poisoning” comprising at least one of the following steps:
a. Internet Browsers and/or other internet applications which need to access domains automatically query multiple DNS servers in different locations and if there is a mismatch between the IP address reported by them for the same domain then the browser (or other application) checks in additional DNS servers and chooses the one that appears in most places, and also warns immediately the user that there might still be a risk due to the mismatch;
b. The browser or other Internet application checks in one or more domain name registrars to see if the IP address given to the domain is compatible with the DNS servers that are associated with the domain's records;
c. The browser (or other Internet application) keeps historical data of IP addresses of domains that the user has accessed and whenever there is suddenly a change performs automatically various checks;
d. The browser (or other Internet application) keeps historical data of IP addresses of domains that the user has accessed and whenever there is suddenly a change performs automatically various checks, and said checks are at least one of: querying multiple DNS servers, and checking in one or more domain name registrars;
e. The browser (or other Internet application) keeps historical data of IP addresses of domains that the user has accessed and whenever there is suddenly a change performs automatically various checks and said checks are done before letting the user access the site;
f. The DNS servers themselves perform automatically similar checks to those described above, such as keeping historical data and checking with multiple sources;
g. The DNS servers themselves perform automatically similar checks to those described above, such as keeping historical data and checking with multiple sources immediately when there is a change, and/or checking with multiple sources whenever new data arrives;
h. Using long encryption keys for any communication between DNS servers;
i. The DNS automatically identifies “birthday attacks” (statistical bombardment with guessed session Ids in order to find the correct session Id) or other statistical based attacks by keeping track of multiple communication attempts with false session Ids purportedly coming from the same server;
j. The DNS automatically identifies “birthday attacks” (statistical bombardment with guessed session Ids in order to find the correct session Id) or other statistical based attacks by keeping track of multiple communication attempts with false session Ids purportedly coming from the same server and then automatically ignores any packets from the spoofed other DNS and automatically switches to other DNSs at least for a certain time;
k. The browser (or other Internet application) and/or DNS server automatically checks back any IP address in multiple reversed databases which find the domain name from an IP address;
1. The browser (or other Internet application) and/or or DNS server automatically checks back any IP address in multiple reversed databases which find the domain name from an IP address whenever giving it in a reply or when it changes;
m. The browser (or other Internet application) and/or NDS servers check how long the IP address has been associated with the domain according to registrar records, and if it has been associated for a short time below a certain threshold performs various checks and/or warns the user;
n. When an IP address changes, the browser (or other Internet application) and/or DNS server checks in one or more reversed Databases (which give the domain name from the IP address) if the original IP address now indeed points to a different domain, and if it is still pointing to the original domain then it is perceived as indication of possible DNS poisoning.

42. The system of claim 1 wherein when the OS and/or various applications support 3D objects, at least one of the following features exists:
a. The objects can be resized or moved in various directions in a way similar to the current processing of 2d objects;
b. The objects can be resized or moved in various directions in a way similar to the current processing of 2d objects and size parameters are automatically updated and displayed;
c. A large taxonomy of object prototypes is available to choose from, and these objects or prototype objects can be dragged into position and then can be changed on the spot by fast scrolling over multiple objects of that prototype or sub-prototype, so that the object changes immediately in view, and/or this scrolling can be done also for modular elements of the objects;
d. A large taxonomy of object prototypes is available to choose from, and these objects or prototype objects can be dragged into position and then can be changed on the spot by fast scrolling over multiple objects of that prototype or sub-prototype, so that the object changes immediately in view, and/or this scrolling can be done also for modular elements of the objects, while the mouse drags a scroll bar next to it;
e. Various elements can be reshaped dynamically in a way similar to the Goo program, except that when pulling on a part only that part is reshaped without affecting the parts next to it.

43. The system of claim 1 wherein at least one of the following features exists in at least one word processor:
a. When the word processor automatically offers the user automatically saved files, the word processor automatically runs file comparison between each such file and the equivalent last saved version and shows the user by track changes the differences between this and the saved version;
b. When the word processor automatically offers the user automatically saved files, the word processor automatically runs file comparison between each such file and the equivalent last saved version, and if there are no differences then the word processor automatically does not even offer that file;
c. When the word processor automatically offers the user automatically saved files, the word processor automatically runs file comparison between each such file and the equivalent last saved version and shows the user by track changes the differences between this and the saved version, and when showing automatically the differences, the word processor marks them differently from previous marked changes;
d. When the word processor automatically offers the user automatically saved files, the word processor automatically runs file comparison between each such file and the equivalent last saved version, and the word processor automatically indicates the amount of difference;
e. When the word processor automatically offers the user automatically saved files, the word processor automatically runs file comparison between each such file and the equivalent last saved version, and the word processor can let the user jump automatically to those sections where the changes are;
f. The system indicates to the user when he/she is about to undo things to a state before the last saved version of the file and asks for his/her confirmation for that;
g. The user can search for a specific text which has one or more specific attributes, such as underline, color, marked changes, marked new text, marked deleted text, or other attributes or styles;
h. The user can define or chose from a number of available options how marked text will be shown instead of being inversed;
i. When normally searching for text marked by track changes, the word processor does not mark the changed section in black but simply jumps to its beginning, since it is already marked anyway;
j. In Word 2003 the user can toggle between viewing track changes in the old or in the new format without affecting the way the headlines and page breaks and/or images are shown;
k. The user can automatically convert marked additions to normal underlines, and/or vice-versa—automatically convert underlined sections into sections marked with track changes;
1. When searching for word combinations the word processor has an option of automatically ignoring redundant spaces;
m. When the user saves a file under a different name the user has an option to request to automatically keep open also another window with the original file.

44. The system of claim 1 wherein at least one of the following features exists:
a. When the computer is in standby (hibernate) mode, even if the user turns the power off or even plugs the electrical wire out of the wall, when the user returns the power, the system still automatically tries to return from standby instead of normal boot;
b. When the user activates standby mode, the system first creates the image and then can for go into a mode where power is used only or mainly for keeping the RAM refreshed, and so if the power remains on, when waking up the system does not even have to restore itself from the image, and if power has been turned off then the system automatically checks first to see if there is a recent image and then recovers from the image if possible.
c. Word processors or browser or other application can remember the last search strings or search strings that were used the pervious time one or more windows of the application were open, and lets the user choose automatically the last search string or chose from a group of recent search strings;
d. Before sending an email with attachments the user can easily change the order within the list of attachments;
e. Before sending an email with attachments the user can easily change the order within the list of attachments by pointing the mouse to one of the attachments and dragging it to a different position in the list;
f. When printing pdf files from the Internet, the pdf viewer automatically adds the url info at least on the first page of the printing or on each page;
g. When saving web files the browser and/or pdf viewer and/or other applications automatically add the url info to the file, in the form of a comment or any other form which does not effect the way the file is displayed, or add it as a visible text on each page or at least on the first page;
h. The user can request to automatically reopen the entire set of windows and/or tabs that was opened last time when reopening the browser after previously closing it even after the user closes it normally;
i. Even after the user tells the browser to start from the beginning or closes the various windows or tabs, the user can enter some history list which contains the previous states of multiple browser windows and/or tabs, and thus the user can scroll back to previous sets of tabs and/or windows that were previously open together and can go back to that same state of multiple open windows and/or tabs.
j. When deleting directories the system automatically keeps a backup of the directory structure and/or a rollback log, so that if the user made a mistake the directory tree can be instantly restored;
k. When the user moves backwards and forwards with web browsers, if the user chooses a different link after going back to a previous page and then goes back again, the browser automatically displays the different paths available if the user moves forward again.

45. The system of claim 1 wherein in 3D map applications at least one of the following features exists:
a. The 2D images are processed in advance to create extrapolated 3D representations according to relevant visual cues, and/or by making the photographs in advance with two or more lenses or 2 or more cameras;
b. At least in popular public places, multiple photographs from multiple angles are added, which are automatically combined into the processed 3D representations and/or at least become automatically integrated when the rotation and/or angle is appropriate;
c. At least in popular public places, one or more local streaming video cameras are added, which broadcast real time streaming data, so that when the location and/or angle is appropriate the real time streaming data is automatically integrated;
d. The displayed normal images include special marks which indicate to user “hotspots” where addition 3D images are available and/or more details are available and/or live streaming data is available;
e. The displayed normal images include special marks which indicate to user “hotspots” where addition 3D images are available and/or more details are available and/or live streaming data is available, and the user can ask the program to automatically take him/her to such spots automatically;
f. When the user for example wanders sideways the program automatically guesses from the pattern and/or direction and/or speed of the user's movement where he/she is most likely to continue next and so the details for next area or areas are downloaded in advance before the user goes there, thus preferably reducing significantly the waiting experience;
g. If the user clicks on s point he/she is interested in and then continues with the zoom, the spot that was clicked upon is automatically moved by the application to the center so that is remains in focus;
h. The system can automatically predict the zooming sequence of the user, so that if a user is apparently trying to zoom into the marked spot, the system tries in advance to get each time the additional details at least one step before the user requests it.

46. The system of claim 1 wherein at least one of the following features exists:
a. The user can indicate or mark to the OS a set or range of hours in which the computer will automatically go into sleep mode (hibernate) at a certain set of hours;
b. The user can change the size of all the open windows and/or tabs of the same application or make other format changes that affect automatically all of them;
c. If the user wants to print an article and does not notice that there is a link for a printer friendly version, the browser looks for this link automatically in the page and can ask the user automatically if he/she wants indeed to print the page as is or to use the printer friendly link;
d. web servers are improved so that if a page is not found the server itself offers a list of likely pages according to similar pages in the same directory and/or in similar directories;
e. The firewall protects also additional communication devices in addition to or apart from the network card or modem, and even when the user supposedly allowed such a device to be accessed, the user is given also a real time indication that the device is working;
f. When the webcam is filming and/or recording, the security system and/or the OS and/or some other software and/or and/or the webcam itself continuously flash some light and/or otherwise indicates to the user clearly that the webcam is currently filming and/or recording what is happening in the room;
g. In shopping meta-search the meta-search engine automatically deduces the user's country according to his/her IP and/or example asks the user about the country where he/she wants the goods shipped to, and can automatically mark near each shop alternative if it has shipments to the user's country and/or puts such shops in a separate group, and/or can exclude shops that don't ship to the user's county if the user requests that;
h. When searching for academic results, the user can request the search engine to show only results from articles from a certain date onward or before a certain date or within one or more range of dates;
i. When searching for normal web pages, the user can request the search engine to show only results from pages which were last updated from a certain date onward or before a certain date or within one or more range of dates;
j. The search engine uses its historical data to estimate if the amount of change and/or the type of change justifies regarding the page as recently updated;

47. The system of claim 1 wherein a firewall and/or security system is used that protects against tempering with DLLs and/or other components that are used for accessing the web by at least one of:
a. Automatically checking for in certified database or databases the correct CRC or other fingerprint or fingerprints of the various known components and thus determining automatically if some component is suspiciously with a wrong fingerprint;
b. Lookup in encrypted database or databases of the OS, in order to check that relevant OS components have not changed;
c. When such a component is changed the firewall warns the user about it after the change or when they are changed and/or the next time the relevant application that uses the changed component tries to access the web;
d. When such a component is changed the firewall warns the user about it, and is also able to tell the user which application changed it and when;
e. Constantly monitoring the relevant components and intercepting at the moment that an application is trying to make a change and asking the user if to allow it and which program is trying to change the component.

48. The system of claim 1 wherein accessing directories with a large number of files or sub-directories through the dialogue box is speeded up by saving automatically the structure of the current directory in at least one buffer in memory (and/or even in the disk) in the same sorted order in which it is displayed, and wherein at least one of the following features exists:
a. The at least one buffer is automatically updated in memory (and/or on the disk) when something changes in the directory;
b. This is done automatically for any directory recently accessed by the dialogue box, and/or the word processor (and/or other applications) can tell the OS already when they are activated to prepare the at least one buffer of their current default directory in memory;
c. An additional sorted copy of directory entries is saved automatically for directories anyway;
d. Changes in file names and/or additions and/or deletions of files are automatically updated in the at least one buffer by merging them with the already sorted directory, instead of re-sorting it again each time.

49. The system of claim 1 wherein at least one of the following features exists:
a. When open windows of the same application are shown in the lower task bar as one group, the other windows of the same group can be shown in another task bar;
b. When open windows of the same application are shown in the lower task bar as one group, the other windows of the same group can be shown in another task bar at the top of the screen and/or at least when the user is viewing at least one of the windows of the group, and/or within the typically blue top of the main open window of the group and/or at least the user can toggle into this mode;
c. When the user clicks on the icon of a group of windows in the lower taskbar, instead of a list of names in lines below each other, the group can automatically expand into small images of the relevant Windows;
d. When the user clicks on the icon of a group of windows in the lower taskbar, instead of a list of names in lines below each other, the group can automatically expand into small images of the relevant Windows and the size of the images is preferably automatically determined by the number of windows;
e. When the user clicks on the icon of a group of windows in the lower taskbar, instead of a list of names in lines below each other, the group can automatically expand into small images of the relevant Windows, and by clicking on any of these preview images the user can jump into it;
f. When the mouse is on top of an icon in the bottom task bar and a preview small image of the window is shown, if the icon is below a certain minimal width, the image is automatically made wider than the icon;
g. The user can choose the desired size of these preview windows so that by resizing such a window the other preview windows will be of the new size defined by the user, until he/she resizes it again, and/or at least as long as it is above some minimum size defined by the system;
h. As the user moves the mouse vertically up or down over the list of names in grouped items, a preview image of the window which the mouse is currently over its name appears near the item and/or near the list.

50. The system of claim 1 wherein at least one of the following features exists:
a. If a file name is even too long to fit the line even when the dialogue box is in full size and/or to fit the top line of the Word Window and/or the window of other applications and/or the explanation box, the filename is preferably automatically wrapped into two or more lines and/or the font that displays the file name is automatically reduced in size by making it smaller and/or by making it thinner, and/or the user can click or otherwise jump to the end of the line and see the rest of the file name and/or cause the filename to scroll;
b. The speed of the hard disk is increased and/or its power consumption is reduced, by at least one of Using multiple independent arms (so that there are multiple hinges of arms sets instead of one; and Using multiple independent arms (so that there are multiple hinges of arms sets instead of one), in combination with access order optimization, such as NCQ & TCQ;
c. There is a command which allows moving only between the windows of the same group, unlike alt-tab which moves also between the other open windows;
d. If the user does not find a certain file name in the start menu or on the desktop the OS automatically checks for similar names and shows the user the list of closest file names available, sorted by closeness;
e. There are on the internet databases which automatically link email addresses or other identity indictors with the current IP of the user, which are automatically updated each time the user connects or disconnects from the Internet and allow also efficient searching according to the IP, and they can be used for sending automatic email warnings to users who's computers have been compromised and have become spam relay stations;
f. When the user presses the Shift key (or some other key), marking or unmarking 2 checkboxes also marks or unmarks all the checkboxes in between;
g. The word processor or browser can keep in memory different search strings in different open windows of the same application, so that the user indicates if he/she prefers sharing search strings between the open Windows or having one for all;
h. After the user makes changes in a certain position in the documents which causes jumping there he/she can also jump back to the position he/she was before the jump;
i. When copying text for example by copy & paste into an empty new file the headers and/or other file parameters can be automatically inserted into the new file automatically. Preferably the headers and/or other parameters are copied automatically but the user preferably can also choose for example to disable this feature or for example to disable parts of it;
j. When copying text for example by copy & paste into an empty new file the headers and/or other file parameters can be automatically inserted into the new file automatically, and the user can also choose example to disable this feature or to disable parts of it;
k. The user can simply jump between two places and then press some key (or click one of the mouse buttons) which marks the entire block between them;
1. The user can mark one place and then jump to another place and when reaching the desired destination press some key (or a mouse button) and the entire area between the two marks becomes marked;
m. The user can tell the browser to automatically merge two or more bookmark files while keeping the date of visiting and/or any other criteria as the ordering factor
n. Copy & paste are automatically available from any messages displayed on the screen;
o. Copy & paste are automatically available from any messages displayed on the screen and/or the OS or some special application automatically allows the user to copy and paste from any text that appears on the screen, regardless of which program it belongs to;
p. Partitions can be identified also by names longer than 1 letter, so that these longer names can be used in the same ways that any 1-letter name partition can be used;
q. The configuration can be set to enable such a debug feature only for one or more specific slots and/or one or more specific devices, and/or other limitations are enforced.

51. The system of claim 1 wherein in at least one word processor at least one of the following features exists:
a. If the user wants to mark large areas with the mouse, moving the mouse further to a more extreme position significantly increases the speed of the scrolling and said effect is at least one linear and exponential;
b. The word processor program allows the user also options of searching for the next word marked as possible error;

52. The system of claim 1 wherein in statistical packages when correlations or other types of output are displayed for a large number of variables, at least one of the following features exists:
a. The user can choose if the correlations will be sorted by absolute correlation, with negative correlations mixed with positive correlations, or the negative correlations appear separately;
b. The user can request that the sorting by correlation level be done separately automatically for each variable, so that for each variable the correlations are automatically sorted;
c. The user can request a combination, so that there is a sorting within each variable, but the variables themselves are automatically sorted so that the variables that have the highest correlations in general appear first.

53. The system of claim 1 wherein at least one of the following steps is used to protect the user from phishing attempts:
a. The browser or the email client automatically indicates to the user and/or warns him/her when the real href is different from the http address that is visibly shown in a link, or warns the user about this after he/she clicks on the link and gives him/her a chance to cancel before actually going to the link, and/or warns him/her that the link is phony, and/or displays an explicit recommendation not to click on the link even before the user clicks on it;
b. The browser or email client automatically indicates to the user also the real url that is within the href in the normal display of the page—next to the link or superimposed on it;
c. The browser or email client automatically indicates to the user also the real url that is within the href in the normal display of the page—next to the link or superimposed on it, and the browser or other application makes sure that this is clearly visible and/or ignores any font size and/or font color command which might hide it and/or makes it automatically even more conspicuous than the normal text;
d. The browser automatically makes sure that the url in the location window and/or in the display of real url which is shown even before the user clicks on the link is indeed displayed exactly like the actual url that it connects to, and if there are unprintable characters then they are marked with some sign and do not effect the printing of the rest of the url;
e. If there is any attempt by Javasrcipt or Active-X or some other portable code or any other program on the user's computer to put other data on top of the location Window then this is automatically prevented by the browser and/or the OS and/or the computer's Security System;
f. If there is any attempt by Javasrcipt or Active-X or some other portable code or any other program on the user's computer to put other data on top of the location Window then this is automatically prevented by automatically preventing other programs from putting any windows in front of the browser window unless the user explicitly transfers the focus to them, and/or by automatically intercepting windows that have a suspect size or shape or location or that otherwise have suspicious or unusual qualities;
g. Email messages that contain clearly misleading hrefs where the visible link does not fit the real link can be automatically blocked by spam filters, thus not reaching the user at all;
h. Normal spam filters are also improved to identify automatically for example typical patterns of mixing digits with letters in a way that tries to bypass word filters;
i. When the browser enters a site and/or for even before the user presses the link, or when the mouse is near the link, the browser automatically checks also a relevant WHOIS database and displays to the user automatically also the name under which that domain is registered and/or the country and/or the length of time this domain has existed and/or other details that can easily indicate to the user if a site is phony;
j. If the browser and/or the OS and/or the security system and/or other software also checks in one or more databases for known phishing sites, it also identifies suspect servers which were known to host such sites before and/or also checks if the domain seems to be related in one or more ways to previously known phishing domains, such as being registered to the same people, having the same email of the technical contact or billing contact, etc.;
k. There is one or more database on the Internet which collects typical word combinations and/or other typical patterns of phishing email messages, which the browser and/or other application can consult automatically, and/or the browser and/or other internet application accumulates the typical wording patterns itself automatically when it identifies a phishing email by other methods, and thus the browser or other application can warn the user automatically of any email that seems like a typical phishing attempt;
1. The browser and/or other application and/or one or more internet database gather list of at least the most common organization names used in typical phishing attempts, so that the browser (or other application) gathers this lists by itself and/or gets it from one or more online database, and then warns the user automatically about urls which contain the name of the organization in suspicious places.
